(19) United States
(12) Patent Application Publication
(10) Pub. No.: US 2017/0092045 A1
(43) Pub. Date: Mar. 30, 2017

(54) GAMING MACHINE

(71) Applicants: Universal Entertainment Corporation, Tokyo (JP); Aruze Gaming (Hong Kong) Limited, Hung Hom (HK)

(72) Inventors: Kenta KITAMURA, Tokyo (JP); Kenji ENOKIDO, Tokyo (JP); Hiroki SAITO, Tokyo (JP); Bungo MATSUMURA, Tokyo (JP)

(21) Appl. No.: 15/273,822

(22) Filed: Sep. 23, 2016

(30) Foreign Application Priority Data
Sep. 25, 2015 (JP) 2015-188992

(51) Int. Cl. G07F 17/32; G07F 17/34

(52) U.S. Cl. CPC G07F 17/3213; G07F 17/34; G07F 17/329; G07F 17/3267; G07F 17/3209

(57) ABSTRACT

To provide a gaming machine that can realize a new gaming characteristic in which effective lines are variable so that the winning probability can be changed. A slot machine 1 executes games and controls, according to the games, a lower image display panel 141 having video reels 151 to 155 each including a symbol array in which symbols 501 that are rearranged in display blocks 28 are arranged. When a predetermined number or more of symbols 501 of the same type are located on any of effective lines, the slot machine 1 awards a line dividend. The slot machine 1 determines whether or not to expand the video reels 151 to 155 to add the display blocks 28 before the rearrangement of the symbols 501, and arrange top symbol 503a with the highest line dividend in the display blocks 28 irrespective of the symbol arrays when it is determined that the display block 28 are added, and determines the line dividend according to effective line based on all the display block 28 including the display block 28 added.

### CROSS REFERENCE TO RELATED APPLICATIONS

This application claims priority to Japanese Patent Application No. 2015-188992 filed on Sep. 25, 2015, the entire contents of which are hereby incorporated by reference.

### BACKGROUND OF THE INVENTION

Technical Field

The present invention relates to a gaming machine.

Background Art

In a conventional gaming machine, when a player presses a spin button after betting credits, a plurality of symbols are displayed in a scrolling fashion on a display installed on the front of the housing and then the symbols are automatically stopped in a plurality of blocks arranged in a matrix. When a predetermined number or more of symbols of the same type are stopped (rearranged) on an effective line, the player wins the game and can receive a dividend. On the other hand, the player loses the bet credits when losing the game.

There is a gaming machine in which effective lines are determined by a “LEFT TO RIGHT” type rule (for example, patent documents 1 and 2). In one format of the “LEFT TO RIGHT” type rule, all the blocks arranged in a matrix are made effective and all the lines connecting the blocks become effective lines. Each effective line is constituted of the same number of blocks as the number of columns and one block is selected for each column of the matrix.

### PRIOR ART DOCUMENT

### Patent Document

[Patent Document 1] US patent application publication No. 2004/0053676

[Patent Document 2] U.S. Pat. No. 8,740,689

### SUMMARY OF THE INVENTION

### Problem to be Solved by the Invention

As described above, in a conventional gaming machine employing a “LEFT TO RIGHT” type rule, all the lines connecting the blocks arranged in a matrix become effective lines but the effective lines do not change and therefore the winning probability does not change. Thus, there is a possibility of discouraging the game player from continuing to play.

The present invention has been made in view of the above circumstances, and it is, therefore, an object of the present invention to provide a gaming machine that can realize a new gaming characteristic in which the effective lines are variable so that the winning probability can be changed.

### Means for Solving the Problem

A gaming machine of the present invention includes:

a symbol display device having a plurality of variable display regions, in each of which, after a symbol array in which symbols are arranged is variably displayed, some of the symbols arranged in the symbol array are rearranged one each in a plurality of blocks in the variable display regions; and

a controller configured to execute games and control the symbol display device according to the games;

wherein the controller awards, when a predetermined number of or more symbols of the same type are located on any of effective lines selecting one block of each of the variable display regions as a result of the rearrangement of the symbols, a line dividend according to the type of the symbols and

wherein the controller determines whether or not to expand the variable display regions to add the blocks before the rearrangement of the symbols, and arrange top symbols with the highest line dividend in the blocks irrespective of the symbol arrays when it is determined that the blocks are added, and determines the line dividend according to effective lines based on all the blocks including the blocks added.

According to the above configuration, the effective lines can be increased by adding blocks to the blocks arranged in a matrix. In addition, symbols with the highest dividend are rearranged in the added blocks irrespective of the symbol arrays. This increases the number of effective lines including the symbols with the highest dividend increases and, therefore, increases the winning probability of the line dividend from the symbols with the highest dividend. Consequently, it is possible to realize a new gaming characteristic in which the effective lines are variable so that the winning probability can be changed.

The gaming machine of the present invention further includes a storage part for storing probability information for a lottery corresponding to the number of blocks to be added to each of the variable display regions,

wherein the controller may determine the number of blocks to be added to each of the variable display regions based on the probability information stored in the storage part when it is determined that the blocks are added.

According to the above configuration, patterns in terms of how many blocks are to be added in which variable display regions are stored in the storage part. Thus, when it is determined that the blocks are added, the number of blocks to be added in each of the variable display regions can be determined simply by selecting one of the patterns on the basis of probability information.

It is possible to provide a gaming machine to realize a gaming characteristic in which the effective lines are variable so that the winning probability can be changed.

### BRIEF DESCRIPTION OF THE DRAWINGS

FIG. 1 is an explanatory view, illustrating an operating state of a gaming machine.

FIG. 2 is an explanatory view, illustrating an operating state of the gaming machine.

FIG. 3 is an explanatory view, illustrating an operating state of the gaming machine.

FIG. 4 is an explanatory view, illustrating an operating state of the gaming machine.

FIG. 5 is an explanatory view, illustrating a function flow of the gaming machine.

FIG. 6 is a block diagram of a gaming system.

FIG. 7 is a perspective view of a slot machine.

FIG. 8 is an explanatory view of button arrangement on a control panel.

FIG. 9 is an electrical block diagram of the gaming machine.

FIG. 10 is an explanatory view, showing symbols and a dividend table.

FIG. 11A is an explanatory view of symbol arrays in a base game.

FIG. 11B is an explanatory view of symbol arrays in the base game.

FIG. 11C is an explanatory view of symbol arrays in the base game.

FIG. 11D is an explanatory view of symbol arrays in the base game.

FIG. 12A is an explanatory view of symbol arrays in a free game.

FIG. 12B is an explanatory view of symbol arrays in the free game.

FIG. 13A is an explanatory view of an arrangement pattern of display blocks in a symbol display region.

FIG. 13B is an explanatory view of an arrangement pattern of display blocks in the symbol display region.

FIG. 13C is an explanatory view of an arrangement pattern of display blocks in the symbol display region.

FIG. 13D is an explanatory view of an arrangement pattern of display blocks in the symbol display region.

FIG. 14 is a diagram, showing the number of display blocks for each arrangement pattern.

FIG. 15 is a diagram, showing the size of empty space for each arrangement pattern.

FIG. 16 is an explanatory view of an example of winning determination under a “LEFT TO RIGHT” rule.

FIG. 17 is an explanatory view of the flow of a base game, bonus games and a jackpot game.

FIG. 18 is an explanatory view, illustrating one example of display screen in the base game.

FIG. 19 is an explanatory view, illustrating one example of display screen in the base game.

FIG. 20 is an explanatory view, illustrating one example of display screen in the base game.

FIG. 21 is an explanatory view, illustrating one example of display screen in the base game.

FIG. 22 is an explanatory view, illustrating one example of display screen in the base game.

FIG. 23 is an explanatory view, illustrating one example of display screen in the base game.

FIG. 24 is an explanatory view, illustrating one example of display screen in the base game.

FIG. 25 is an explanatory view, illustrating one example of display screen in the base game.

FIG. 26 is an explanatory view, illustrating one example of display screen in the base game.

FIG. 27 is an explanatory view, illustrating one example of display screen in the base game.

FIG. 28 is an explanatory view, illustrating one example of display screen in the base game.

FIG. 29 is an explanatory view, illustrating one example of display screen in the base game.

FIG. 30 is an explanatory view, illustrating one example of display screen in the base game.

FIG. 31 is an explanatory view, illustrating one example of display screen in the base game.

FIG. 32 is an explanatory view, illustrating one example of display screen in a branching game.

FIG. 33 is an explanatory view, illustrating one example of display screen in the branching game.

FIG. 34 is an explanatory view, illustrating one example of display screen in the branching game.

FIG. 35 is an explanatory view, illustrating one example of display screen in the branching game.

FIG. 36 is an explanatory view, illustrating one example of display screen in the branching game.

FIG. 37 is an explanatory view, illustrating one example of display screen in the branching game.

FIG. 38 is an explanatory view, illustrating one example of display screen in the branching game.

FIG. 39 is an explanatory view, illustrating one example of display screen in the branching game.

FIG. 40 is an explanatory view, illustrating one example of display screen in a mini-bonus game.

FIG. 41 is an explanatory view, illustrating one example of display screen in the mini-bonus game.

FIG. 42 is an explanatory view, illustrating one example of display screen in the mini-bonus game.

FIG. 43 is an explanatory view, illustrating one example of display screen in the mini-bonus game.

FIG. 44 is an explanatory view, illustrating one example of display screen in the mini-bonus game.

FIG. 45 is an explanatory view, illustrating one example of display screen in the mini-bonus game.

FIG. 46 is an explanatory view, illustrating one example of display screen in the mini-bonus game.

FIG. 47 is an explanatory view, illustrating one example of display screen in the mini-bonus game.

FIG. 48 is an explanatory view, illustrating one example of display screen in the mini-bonus game.

FIG. 49 is an explanatory view, illustrating one example of display screen in the mini-bonus game.

FIG. 50 is an explanatory view, illustrating one example of display screen in the mini-bonus game.

FIG. 51 is an explanatory view, illustrating one example of display screen in the mini-bonus game.

FIG. 52 is an explanatory view, illustrating one example of display screen in the mini-bonus game.

FIG. 53 is an explanatory view, illustrating one example of display screen in the mini-bonus game.

FIG. 54 is an explanatory view, illustrating one example display screen in a minor bonus game.

FIG. 55 is an explanatory view, illustrating one example display screen in the minor bonus game.

FIG. 56 is an explanatory view, illustrating one example display screen in the minor bonus game.

FIG. 57 is an explanatory view, illustrating one example display screen in the minor bonus game.

FIG. 58 is an explanatory view, illustrating one example display screen in the minor bonus game.

FIG. 59 is an explanatory view, illustrating one example display screen in the minor bonus game.

FIG. 60 is an explanatory view, illustrating one example display screen in the minor bonus game.

FIG. 61 is an explanatory view, illustrating one example display screen in the minor bonus game.

FIG. 62 is an explanatory view, illustrating one example display screen in the minor bonus game.

FIG. 63 is an explanatory view, illustrating one example display screen in a major bonus game.

FIG. 64 is an explanatory view, illustrating one example display screen in the major bonus game.

FIG. 65 is an explanatory view, illustrating one example display screen in the major bonus game.

FIG. 66 is an explanatory view, illustrating one example display screen in the major bonus game.

FIG. 67 is an explanatory view, illustrating one example display screen in the major bonus game.

FIG. 68 is an explanatory view, illustrating one example display screen in the major bonus game.

FIG. 69 is an explanatory view, illustrating one example display screen in the major bonus game.

FIG. 70 is an explanatory view, illustrating one example display screen in the major bonus game.

FIG. 71 is an explanatory view, illustrating one example display screen in the major bonus game.

FIG. 72 is an explanatory view, illustrating one example display screen in a grand bonus game.

FIG. 73 is an explanatory view, illustrating one example display screen in the grand bonus game.

FIG. 74 is an explanatory view, illustrating one example display screen in the grand bonus game.

FIG. 75 is an explanatory view, illustrating one example display screen in the grand bonus game.

FIG. 76 is an explanatory view, illustrating one example display screen in the grand bonus game.

FIG. 77 is an explanatory view, illustrating one example display screen in the grand bonus game.

FIG. 78 is an explanatory view, illustrating one example display screen in the grand bonus game.

FIG. 79 is an explanatory view, illustrating one example display screen in the grand bonus game.

FIG. 80 is an explanatory view, illustrating one example display screen in the grand bonus game.

FIG. 81 is an explanatory view, illustrating one example display screen in the grand bonus game.

FIG. 82 is an explanatory view, illustrating one example display screen in the grand bonus game.

FIG. 83 is an explanatory view, illustrating one example display screen in the grand bonus game.

FIG. 84 is an explanatory view, illustrating one example display screen in the grand bonus game.

FIG. 85 is an explanatory view, illustrating one example display screen in the grand bonus game.

FIG. 86 is an explanatory view, illustrating one example display screen in a jackpot game.

FIG. 87 is an explanatory view, illustrating one example display screen in the jackpot game.

FIG. 88 is an explanatory view, illustrating one example display screen in the jackpot game.

FIG. 89 is an explanatory view, illustrating one example display screen in the jackpot game.

FIG. 90 is an explanatory view, illustrating one example display screen in the jackpot game.

FIG. 91 is an explanatory view, illustrating one example display screen in the jackpot game.

FIG. 92 is an explanatory view, illustrating one example display screen in the jackpot game.

FIG. 93 is an explanatory view, illustrating one example display screen in the jackpot game.

FIG. 94 is an explanatory view, illustrating one example display screen in the jackpot game.

FIG. 95 is an explanatory view, illustrating one example display screen in the jackpot game.

FIG. 96 is a flowchart of base game execution processing.

FIG. 97 is a flowchart of mystery lottery processing.

FIG. 98 is an explanatory view of a display pane expansion generation lottery table.

FIG. 99 is an explanatory view of a reel pane lottery table.

FIG. 100 is an explanatory view of a symbol change mystery bonus generation table.

FIG. 101 is an explanatory view of a top symbol-based bonus generation lottery table.

FIG. 102 is an explanatory view of a top symbol addition table.

FIG. 103 is an explanatory view of a change symbol lottery table.

FIG. 104 is a flowchart of branching game processing.

FIG. 105 is an explanatory view of a bonus game distribution lottery table.

FIG. 106 is an explanatory view of an at-Naval-bonus-determination panel durability table.

FIG. 107 is an explanatory view of an at-Ghost-Ship-bonus-determination panel durability table.

FIG. 108 is an explanatory view of an at-Kraken-Free-game-determination panel durability table.

FIG. 109 is an explanatory view of an at-Treasure-Island-bonus-determination panel durability table.

FIG. 110 is flowchart of mini-bonus game effect processing.

FIG. 111 is an explanatory view of expected dividend value lottery table.

FIG. 112 is an explanatory view of a Zako (low-ranking) sea soldier dividend arrangement pattern table.

FIG. 113 is an explanatory view of a Zako (low-ranking) sea soldier dividend pattern lottery table.

FIG. 114 is an explanatory view of a dividend set determination table.

FIG. 115 is an explanatory view of an admiral dividend table A.

FIG. 116 is an explanatory view of an admiral dividend table B.

FIG. 117 is an explanatory view of an admiral dividend table C.

FIG. 118 is an explanatory view of the flow of transition of scenes in the minor bonus game.

FIG. 119 is a flowchart of minor bonus game execution processing.

FIG. 120 is a diagram, illustrating a branch flow for determining a scene for use in the minor bonus game.

FIG. 121 is an explanatory view of a junction 1 transfer destination lottery table.

FIG. 122 is an explanatory view of a junction 2 transfer destination lottery table.

FIG. 123 is an explanatory view of a junction 3 transfer destination lottery table.

FIG. 124 is an explanatory view of a junction 4 transfer destination lottery table FIG. 125 is an explanatory view of a junction 5 transfer destination lottery table.

FIG. 126 is an explanatory view of an expected dividend value determination table.

FIG. 127 is an explanatory view of an arranged coin number table.

FIG. 128 is an explanatory view of a basic dividend table.

FIG. 129 is a flowchart of treasure house scene dividend determination processing.

FIG. 130 is a flowchart of major bonus game execution processing.

FIG. 131 is a flowchart of additional dividend processing.

FIG. 132 is an explanatory view of a leg dividend pattern table.

FIG. 133 is an explanatory view of a leg dividend table A.

FIG. 134 is an explanatory view of a leg dividend table B.

FIG. 135 is an explanatory view of a leg dividend table C.

FIG. 136 is an explanatory view of a leg dividend table D.

FIG. 137 is an explanatory view of a leg dividend table E.

FIG. 138 is an explanatory view of a head dividend table A.

FIG. 139 is an explanatory view of a head dividend table B.

FIG. 140 is an explanatory view of a head dividend table C.

FIG. 141 is a flowchart of grand bonus game execution processing.

FIG. 142 is an explanatory view of a map pattern table.

FIG. 143 is an explanatory view of a treasure chest content table.

FIG. 144 is an explanatory view of a treasure box map table A.

FIG. 145 is an explanatory view of a treasure box map table B.

FIG. 146 is an explanatory view of a treasure box map table C.

FIG. 147 is an explanatory view of a treasure box map table D.

FIG. 148 is an explanatory view of a treasure box map table E.

FIG. 149 is an explanatory view of a jewel dividend table.

FIG. 150 is an explanatory view of a final treasure dividend table.

FIG. 151 is an explanatory view of a progressive mini-game generation lottery table.

FIG. 152 is an explanatory view of a progressive initial value settable pattern table.

FIG. 153 is a flowchart of jackpot game execution processing.

FIG. 154 is an explanatory view of a progressive reel content table.

FIG. 155 is an explanatory view of a JP symbol lottery table.

FIG. 156 is an explanatory view of a JP symbol lottery table.

FIG. 157 is an explanatory view of a JP symbol lottery table.

FIG. 158 is an explanatory view of a JP symbol lottery table.

FIG. 159 is an explanatory view of a JP symbol lottery table.

FIG. 160 is an explanatory view of a JP symbol lottery table.

FIG. 161 is an explanatory view of a JP symbol lottery table.

FIG. 162 is an explanatory view of a JP symbol lottery table.

FIG. 163 is an explanatory view of bet configuration.

FIG. 164 is an explanatory view of a spin table.

FIG. 165 is an explanatory view of a WIN effect.

FIG. 166 is an explanatory view of a WIN effect.

FIG. 167 is an explanatory view of a WIN effect.

FIG. 168 is an explanatory view of a WIN effect.

FIG. 169 is an explanatory view of a WIN effect.

FIG. 170 is an explanatory view of a WIN effect.

FIG. 171 is an explanatory view of a WIN effect.

FIG. 172 is an explanatory view of a WIN effect.

FIG. 173 is an explanatory view of meter display.

FIG. 174 is an explanatory view of touch icons.

FIG. 175 is an explanatory view of a help screen.

FIG. 176A is an explanatory view of manipulation of a control panel on the help screen.

FIG. 176B is an explanatory view of manipulation of a control panel on the help screen.

FIG. 176C is an explanatory view of manipulation of a control panel on the help screen.

FIG. 177A is an explanatory view of a ticket out screen.

FIG. 177B is an explanatory view of a ticket out screen.

FIG. 178A is an explanatory view, illustrating one example of a gamble game.

FIG. 178B is an explanatory view, illustrating one example of a gamble game.

FIG. 178C is an explanatory view, illustrating one example of a gamble game.

FIG. 178D is an explanatory view, illustrating one example of a gamble game.

FIG. 178E is an explanatory view, illustrating one example of a gamble game.

FIG. 178F is an explanatory view, illustrating one example of a gamble game.

FIG. 178G is an explanatory view, illustrating one example of a gamble game.

FIG. 178H is an explanatory view, illustrating one example of a gamble game.

FIG. 178I is an explanatory view, illustrating one example of a gamble game.

FIG. 178J is an explanatory view, illustrating one example of a gamble game.

FIG. 178K is an explanatory view, illustrating one example of a gamble game.

FIG. 179A is an explanatory view, illustrating a win increment operation.

FIG. 179B is an explanatory view illustrating a win increment operation.

### DETAILED DESCRIPTION OF THE PREFERRED EMBODIMENT

A gaming machine of the present invention is described with reference to the drawings.

(Outline of Gaming Machine)

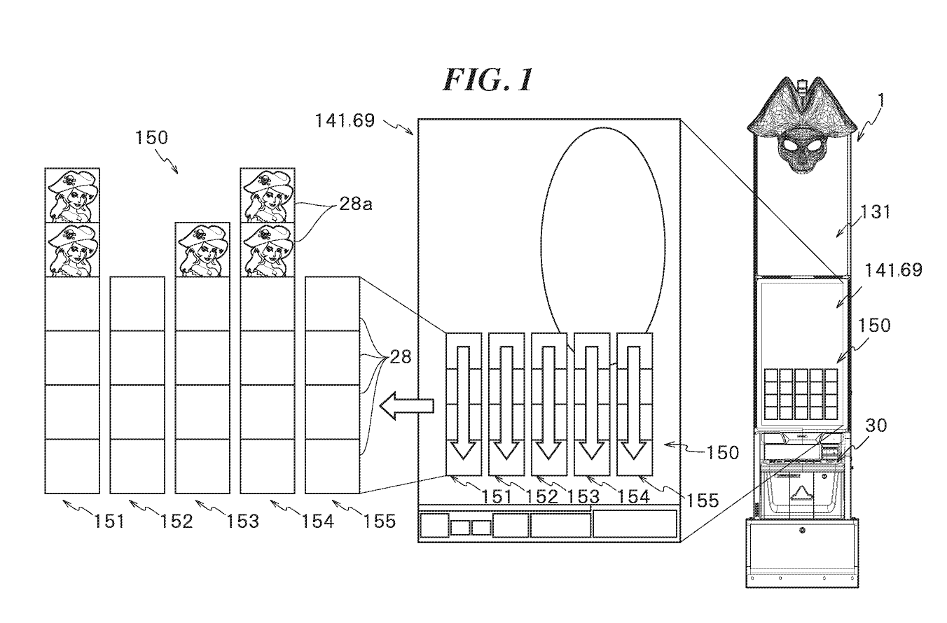

As shown in FIG. 1, a slot machine 1 as a gaming machine includes a lower image display panel 141 as a symbol display device. The lower image display panel 141 is provided with a touch panel 69. The touch panel 69 functions as an input device that can receive manipulation by a player.

The slot machine 1 executes a base game, as an entertainment, that is started by a bet on condition that credit values are consumed. The slot machine 1 controls the lower image display panel 141 according to the base game. Specifically, the lower image display panel 141 has a symbol display region 150 (video reels 151 to 155) as a plurality of variable display regions. In the slot machine 1, according to the base game, after a symbol array in which symbols 501 are arrayed is displayed in a variable fashion in each of the video reels 151 to 155, a symbol 501 in each symbol array is rearranged in each display block 28 of the video reels 151 to 155. Basically, four display blocks 28 are arranged in each of the video reels 151 to 155. In other words, basically, a matrix of twenty display blocks 28 arranged in 4 by 5 is formed in the symbol display region 150.

A plurality of effective lines are set in the symbol display region 150. One effective line is constituted of five display blocks 28 in total. Each of the five display blocks 28 of each effective line is one selected from each of the video reels 151 to 155. In this embodiment, the effective lines are determined by so-called a “LEFT TO RIGHT” type rule. After the symbols 501 are rearranged, the slot machine 1 determines a line dividend for every effective line. In other words, when a predetermined number or more of symbols 501 of the same type are included in the five display blocks 28 of each effective line, the slot machine 1 awards a line dividend corresponding to the symbol 501 of the type.

As described above, in this embodiment, the credit amount for a line dividend is determined based on the type of the symbol 501. In the following, the symbol 501 with the highest line dividend among the symbols 501 is referred to as “top symbol.” The line dividend resulting from a predetermined number or more of symbols of a certain type being rearranged is simply referred to as “line dividend from the symbols.” The number of symbols that generate a line dividend is referred to as “kind.” For example, when four top symbols are rearranged on an effective line, it is referred to as “four kinds of the top symbol.”

Before the symbols 501 are rearranged, the slot machine 1 determines whether or not to expand the video reels 151 to 155 to add display blocks 28 (additional display blocks 28a). When additional display blocks 28a are added, the slot machine 1 arranges the top symbol 503a with the highest line dividend in the display blocks 28 independently of the symbols 501 arrayed in the symbol arrays, and determines line dividends in the effective lines based on all the display blocks 28 including the additional display blocks 28.

As described above, in this embodiment, display blocks 28 (additional display blocks 28a) can be added to the matrix of display blocks 28 to increase the number of effective lines. In addition, the top symbol 503a with the highest line dividend is rearranged in the additional display blocks 28a independently of the symbol arrays. This increases the number of effective lines including the top symbol 503a with the highest line dividend and, therefore, increases the winning probability of the line dividend from the top symbols 503a. Consequently, a new gaming characteristic in which the effective lines are variable so that the winning probability can be changed can be produced.

The slot machine 1 has stored the number of display blocks 28 that are added to each of the video reels 151 to 155 in association with probability information for lottery. When display blocks 28 are added, the slot machine 1 determines the number of display blocks 28 (additional display block 28a) that are added to each variable display region based on the stored probability information.

As described above, the slot machine 1 stores patterns of how many additional display blocks 28a are added to which variable display regions. Thus, when the addition of additional display blocks 28a is determined, the above matters can be easily determined by simply selecting a pattern on the basis of the probability information.

In this embodiment, the bonus where display blocks 28 in which the top symbol 503 is arranged are added is referred to as “top symbol stacking mystery bonus” or “top symbol topping additional bonus.”

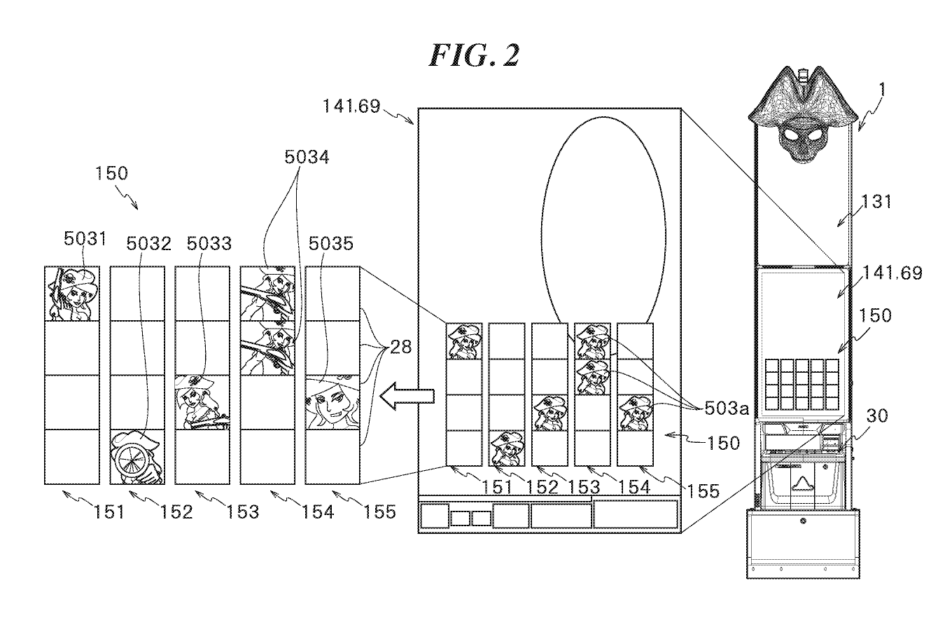

As shown in FIG. 2, when there is a line dividend from the top symbols 503a with the highest line dividend, the slot machine 1 displays different animations in each of the video reels 151 to 155 in the regions of the display blocks 28 in which the top symbol 503a is rearranged.

As a result, even when there are line dividends of plural types of symbols 501, only the top symbols 503a are displayed in different animations (top symbol animations 5031 to 5035) in each of the video reels 151 to 155. Thus, it is highly possible that the player easily recognizes that there is a line dividend from the top symbols 503a. Consequently, it is possible to produce a new form of winning notification that notifies that the player is awarded a prize by the top symbols 503a, from which the highest dividend can be acquired.

Also, the slot machine stores predetermined symbols 501 except the top symbols 503a in association with probability information for lottery. The slot machine 1 determines whether to execute change symbol processing for changing one of the predetermined symbols 501 to the top symbol 503a. When the change symbol processing is executed, the slot machine 1 determines which of the predetermined symbols 501 are changed to the top symbol 503a on the basis of the stored probability information. The slot machine 1 treats the determined predetermined symbol 501 as the top symbol 503a when determining the line dividends of the effective lines.

As described above, in this embodiment, one of the predetermined symbols 501 can be treated as the top symbol 503a. This increases the possibility of providing the line dividend from the top symbols 503a. This also increases the possibility of the top symbols 503a being rearranged in the symbol display region 150. Thus, the possibility of allowing the player to visually recognize the animations of the top symbols 503a as a new form of winning notification is increased.

In this embodiment, the bonus where one type of predetermined symbols 501 are changed to the top symbols 503a is also referred to as “symbol chance mystery bonus” or “top symbol rewriting bonus.”

In this embodiment, the slot machine 1 is configured such that a bonus game can be triggered in the base game. Plural types of bonus games exist. When a bonus game is triggered in the base game, a branching game is executed to diverge to one of the plural types of bonus games. When a branching game is executed, one of the plurality of existing bonus games is selected. The types of bonus games include mini-bonus game, minor bonus game, major bonus game and grand bonus game. The slot machine 1 is configured such that a jackpot game can be triggered from each bonus game.

In the following, a branching game executed to diverge to one of the plurality of existing bonus games is also referred to as “Bonus Selection” or “Way to Treasure Island.” The mini-bonus game is also referred to as “Naval Battle.” The minor bonus game is also referred to as “Ghost Ship Adventure.” The major bonus game is also referred to as “Kraken Free Game.” The grand bonus game is also referred to as “Treasure Island Bonus.” The jackpot game is also referred to as “Challenge for Jackpot” or “progressive mini-game.”

The slot machine 1 stores the dividend that is awarded to the player in the minor bonus game (Ghost Ship Adventure) as an expected value. In other words, the player can acquire the same number of credits as the expected value by playing the minor bonus game. The expected value means credits that can be expected to be acquired. Thus, even if the bonus game is played plural times, credits equal to the expected value are not necessarily obtained every time.

The slot machine 1 awards two types of dividends in the minor bonus game to the player. Specifically, the dividends of the minor bonus game consist of an acquired dividend and an additional dividend.

The acquired dividend is a dividend that is determined on the basis of a manipulation on a touch panel 69 by the player. The additional dividend is a dividend that is determined on the basis of the expected value and the determined, acquired dividend.

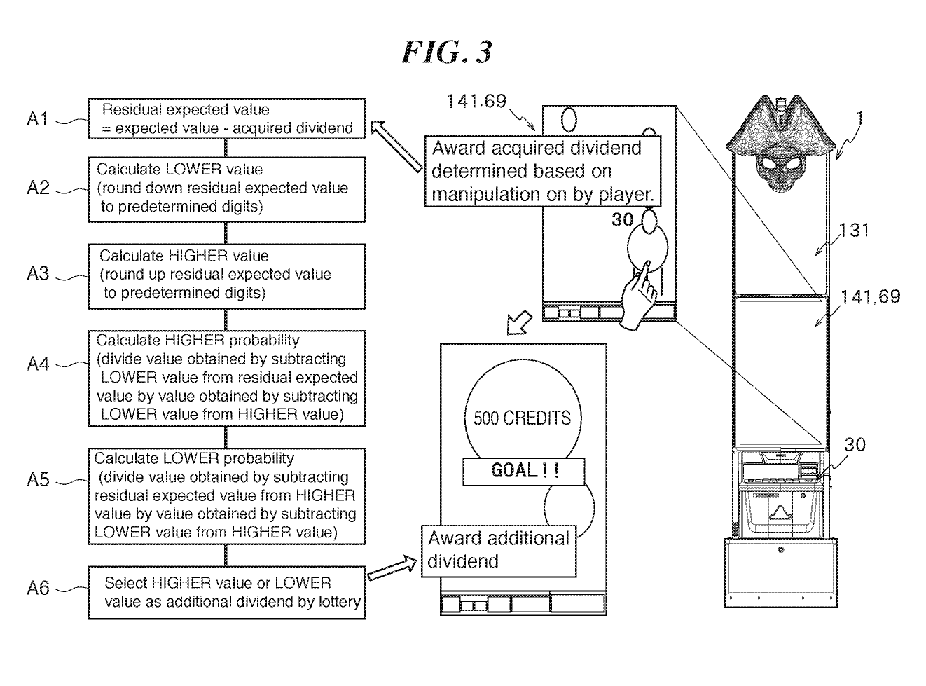

As shown in FIG. 3, the additional dividend can be calculated. First, a residual expected value is calculated by subtracting the acquired dividend from the expected value and then stored (A1). Then, a LOWER value is calculated by rounding the residual expected value down to predetermined digits (A2). A HIGHER value is calculated by rounding the residual expected value up to predetermined digits (A3). The additional dividend is selected from the LOWER value and the HIGHER value.

Next, a HIGHER probability is calculated by dividing the value obtained by subtracting the LOWER value from the residual expected value by the value obtained by subtracting the LOWER value from the HIGHER value (A4). Then, a LOWER probability is calculated by dividing the value obtained by subtracting the residual expected value from the HIGHER value by the value obtained by subtracting the LOWER value from the HIGHER value (A5). Then, a lottery in which the HIGHER value is selected with the HIGHER probability and the LOWER value is selected with the LOWER probability is used to determine which value is used as the additional dividend (A6).

Because this allows the additional dividend to have a round number with the last predetermined number of digits being “0,” for example, the possibility of the player recognizing that the credits that can be obtained in the entire minor bonus game is previously determined may be reduced. Consequently, there is a possibility that the player can retain an interest in the intervention into the progress of the bonus game.

The minor bonus game consists of a plurality of stages that are selected by lottery, and a stage dividend is associated with each of the stages. Then, the sum of the stage dividends associated with all the stages constituting the minor bonus game is equal to the expected value. This allows the expected value to be different every time the minor bonus game is executed, and therefore can further reduce the possibility of the player recognizing that the credits that can be obtained in the entire minor bonus game is previously determined.

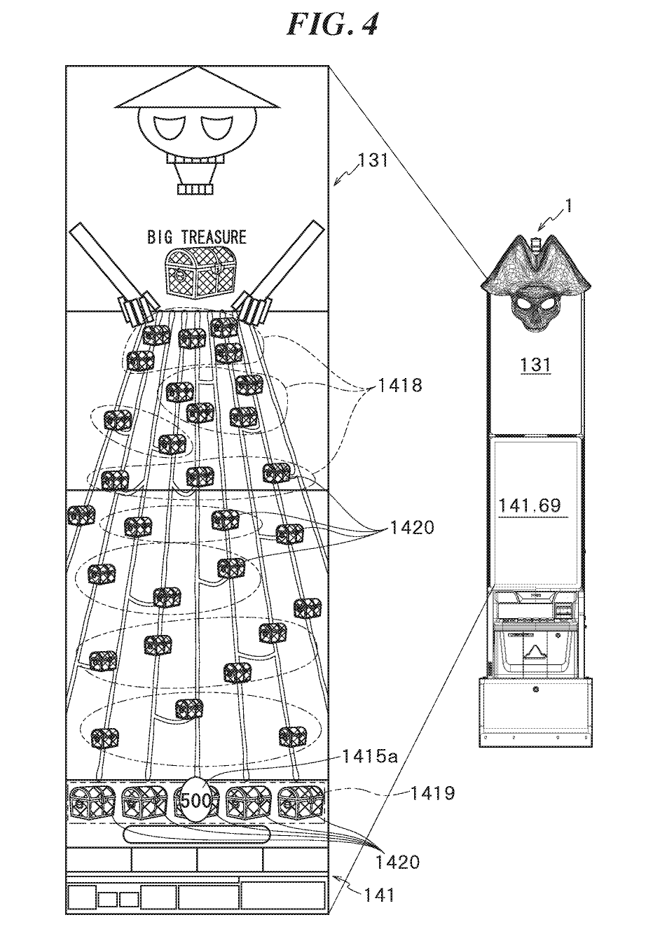

As shown in FIG. 4, the slot machine 1 is configured to execute a grand bonus game (Treasure Island Bonus) in which the plurality of stages are executed sequentially. Each stage is a pick game consisting of options (treasure chests 1420) set to an upper limit or less. In other words, the grand bonus game consists of plural times of pick games. The number of options in each pick game of the grand bonus game is set equal to or less than an upper limit. Thus, the player can play pick games (stages) with different number of options.

The number of options in each pick game of the grand bonus game is previously set in a map pattern. In other words, the slot machine 1 uses one map pattern selected from a plurality of map patterns stored when executing a grand bonus game. An option set 1418 for one stage is set in each map pattern. Each option set 1418 has options equal in number to or less than an upper limit. The slot machine 1 selectably displays the option sets 1418 relating to a plurality of stages of the determined map pattern on the lower image display panel 141. When an option is selected by the player, the slot machine 1 displays the result of the stage (for example, the award of a dividend by a jewel 1415a appearing from a treasure chest 1420) based on the selected option, and then terminates this stage.

As described above, in the grand bonus game, a plurality of stages associated with the selected map pattern are executed sequentially. In each stage, option sets each consisting of options set in a map pattern and being equal in number to or less than an upper limit are selectably displayed, and the result of the stage based on the selected option is displayed. As described above, the fact that a different number of options can be displayed in each stage can make the bonus game more entertaining.

The option set for each stage of a map pattern includes a terminating option that terminates the bonus game, dividend option that awards a dividend to the player, and a prize-up option that increases the dividends from the dividend options. The options including them are indiscernibility displayed before the player makes a selection.

When the player completes all the stages of the determined map pattern without selecting the terminating option, the slot machine 1 awards a goal dividend to the player on the basis of the stage results in all the completed stages. In other words, when the player selects the terminating option, the grand bonus game is terminated without awarding the goal dividend. This discourages the player from terminating the grand bonus game in the midst of a stage and makes the bonus game much more entertaining.

The slot machine 1 sets the dividends from the dividend options higher every time the player selects a prize-up option. The slot machine 1 sets the goal dividend higher every time the player selects a prize-up option. Thus, the player can select from among different types of options that provide a benefit to him or her. This makes the bonus game much more entertaining.

### DEFINITIONS AND SO ON

The slot machine is a kind of gaming machine. The base game and free games (Kraken Free Game) in this embodiment are slot games in which plural symbols are rearranged.

The term “rearrangement” refers to a state where symbols are arranged again after the arrangement of symbols is cancelled. The term “arrangement” refers to a state where the symbols can be visually recognized by an external player. Specifically, the term “rearrangement” refers to a state where the symbols are stopped in a display window as the rotation of the reels is stopped to stop the variable display of the symbols after the symbols on the reels are variably displayed by rotating the reels.

The free games may be games of any type as long as their play style is different from that of the base game. A free game means a game that is able to be played with a bet of less game value than that required in the base game. “Being able to be played with a bet of less game value” includes a case where the bet is “0.” Thus, a “free game” may be a game which can be played without betting a game value and in which game values in an amount determined based on the rearranged symbols are awarded. In other words, a “free game” may be a game that is started without involving the consumption of a game value. In contrast to this, the “base game” is a game which cannot be played without betting a game value and in which game values in an amount determined based on the rearranged symbols are awarded. In other words, the “base game” is a game that is started on condition that game values are consumed.

The term “game value (credit)” means coins, bills or electronical valuable information equivalent thereto. The game value in the present invention is not particularly limited. For example, the game value may be game media such as medals, tokens, electronic money, and tickets. The tickets are not particularly limited. For example, the tickets may be bar-coded tickets as described later or the like. Further, the “game value” may be game points without valuable information. In this embodiment, description is made on the premise that the game value means credits. In other words, the base game is played with the consumption of credits.

(Description of Function Flow Diagram)

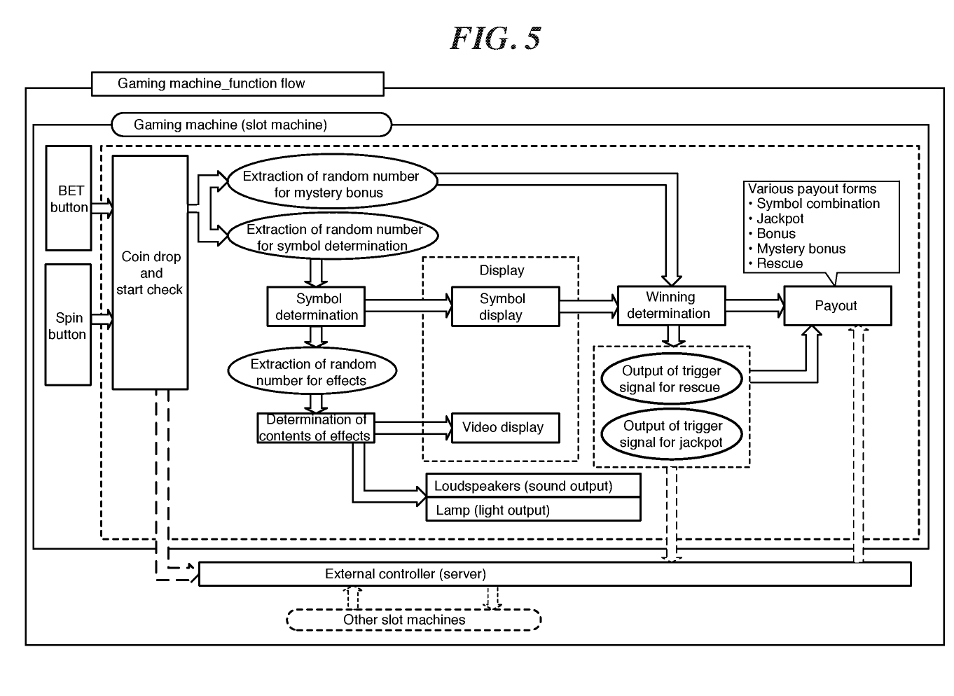

With reference to FIG. 5, the basic functions of the slot machine according to an embodiment of the present invention are described. FIG. 5 is a diagram, showing the function flow of the slot machine according to an embodiment of the present invention.

<Start check> First, the slot machine checks whether a BET button has been pressed or not by the player and sequentially checks whether a spin button has been pressed or not by the player.

<Symbol determination> Next, if the spin button has been pressed by the player, then the slot machine extracts a random number for symbol determination to determine the symbols to be displayed for the player in each of the plurality of video reels displayed on the display when the scroll of the symbol array is stopped.

<Symbol display> Next, the slot machine starts the scroll of the symbol array of each video reel and stops the scroll so that the determined symbols are displayed to the player.

<Winning determination> Next, when the scroll of the symbol array of each video reel is stopped, the slot machine determines whether or not the combination of the symbols displayed to the player relates to winning.

<Payout> Next, when the combination of the symbols displayed to the player relates to winning, the slot machine offers to the player a benefit determined on the basis of the type of the combination of the symbols. For example, when a combination of the symbols relating to payout of coins is displayed, the slot machine pays out coins, the number of which is determined based on the combination of the symbols, to the player.

When a combination of symbols relating to a free game trigger is displayed, the slot machine starts a free game. In the embodiment of the present invention, a game (free game) in which a lottery relating to the determination of symbols to be stopped as described above is executed a predetermined number of times without the consumption of coins is executed as the free game.

The slot machine provides another benefit called “mystery feature” in addition to the above benefit. In the mystery feature, a predetermined number of free games are awarded to the player when the player wins in a dedicated lottery. When the spin button is pressed, the slot machine extracts a random number for mystery bonus, and determines by lottery whether or not to establish a mystery feature trigger.

In this embodiment, “rescue” is a function provided for the purpose of rescuing the player from the situation in which no free game is played for a long period of time (“rescue” is a function of offering some return (rescue) to the player when the number of times of a game in which a predetermined benefit is not offered has reached a predetermined number).

It is a free choice of the administrator of the slot machine whether or not to enable the rescue function. If the rescue function is enabled, then the slot machine starts counting the number of times of games. Then, when the counted number of games reaches a predetermined number without the payout of a large sum from a free game or other games, the slot machine offers a benefit, such as a free game.

The slot machine may be configured to pay out the amount of coins in a jackpot to the player when a combination of symbols relating to a jackpot trigger is displayed. The jackpot refers to a function of accumulating some of the coins consumed by the players in each slot machine in a jackpot and paying out the coins accumulated in the jackpot to a slot machine in which a jackpot trigger is established. In this case, the slot machine calculates the amount to be stored (accumulated amount) in the jackpot in each game and transmits it to an external controller, which accumulates the amount transmitted from each slot machine in the jackpot.

<Determination of effects> The slot machine produces effects by displaying images on the display, outputting light from lamps, and outputting sounds from loudspeakers. The slot machine extracts a random number for effects and determines the contents of effects based on the symbols selected by lottery or the like. That is all the description of the basic functions of the slot machine.

(Overall Game System)

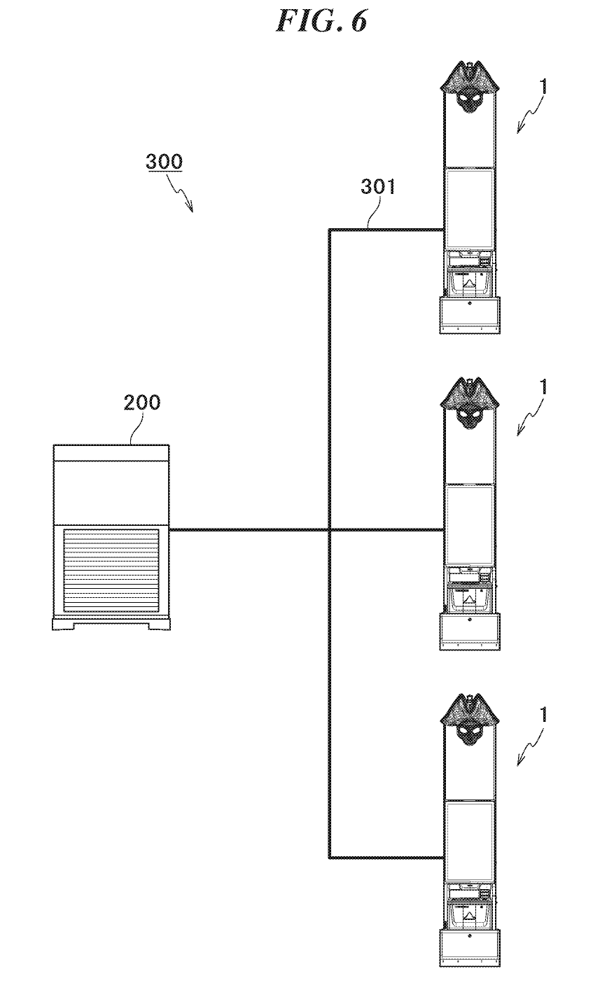

Referring to FIG. 6, a game system including the slot machine is next described. FIG. 6 shows a game system including the slot machine according to an embodiment of the present invention.

A game system 300 includes a plurality of slot machines 1 and an external controller 200 that is connected to each of the slot machines 1 via a communication line 301.

The external controller 200 controls the plurality of slot machines 1. In an embodiment, the external controller 200 is what is called a hall server installed in an entertainment facility having a plurality of slot machines 1. A unique identification number is allocated to each slot machine, and the external controller 200 identifies the source of data sent from the slot machines 1 on the basis of the identification number. The identification number is also used to specify the transmission destination when data is sent from the external controller 200 to any of the slot machines 1.

The game system 300 may be constructed within a single entertainment facility where various games can be played, such as a casino, or may be constructed among a plurality of entertainment facilities. When the gaming system 300 is constructed in a single entertainment facility, the gaming system 300 may be constructed in each floor or section of the entertainment facility. The communication line 301 may be wired or wireless, and can be constructed using a dedicated line, switched line or the like.

(Mechanical Configuration of Slot Machine)

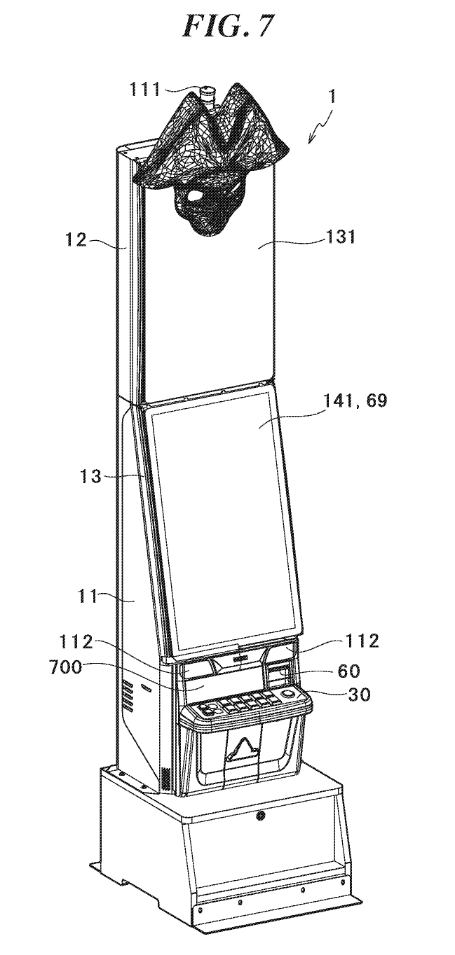

Referring to FIG. 7, the overall structure of the slot machine 1 is described.

In the slot machine 1, electronical, valuable information, such as electronic money, is used as the game value. The game value is not limited to electronical valuable information. Coins, medals, tokens or bar-coded tickets, for example, may be employed as the game value.

The slot machine 1 includes a cabinet 11, a top box 12 mounted on top of the cabinet 11, and a main door 13 at the front of the cabinet 11. The main door 13 has loudspeakers 112.

A lower image display panel 141 as a symbol display device is provided on the main door 13. The lower image display panel 141 is formed of a liquid crystal panel. A display screen of the lower image display panel 141 is described later in detail.

A touch panel 69 is provided on the front of the lower image display panel 141. The touch panel 69 allows the player to input various commands by touching the display screen of the lower image display panel 141. Input signals are transmitted from the touch panel 69 to a main CPU 71.

An upper image display panel 131 is provided on the front of the top box 12. The upper image display panel 131 is formed of a liquid crystal panel and constitutes a display. On the upper image display panel 131, images relating to effects and images that introduce the contents of the game and explain the rules of the game are displayed. The top box 12 has a lamp 111. The slot machine 1 produces effects by displaying images and through the emission of sound and light.

A PTS device 700 and a bill entry 60, in addition to a control panel 30 on which various buttons are arranged, are provided below the lower image display panel 141.

The bill entry 60 validates bills and accepts authentic bills into the cabinet 11. The bill entry 60 is electrically connected to the PTS device 700. When the bill entry 60 accepts a authentic bill, it transmits an input signal based on the value of the bill to the PTS device 700. The input signal includes information such as credit data about the accepted bill.

The PTS device 700 is a unit in which a LCD (liquid crystal display), a human detection camera, a microphone and so on are integrated. The human detection camera has a camera function that makes it possible to detect the presence of a player. The microphone is used for allowing the player's participation in a game by voice and the authentication of a player by voice recognition. The PTS device 700 has a card insertion slot through which an IC card can be inserted. Thus, the player can insert the IC card into the card insertion slot to use credits stored in the IC card in the slot machine 1.

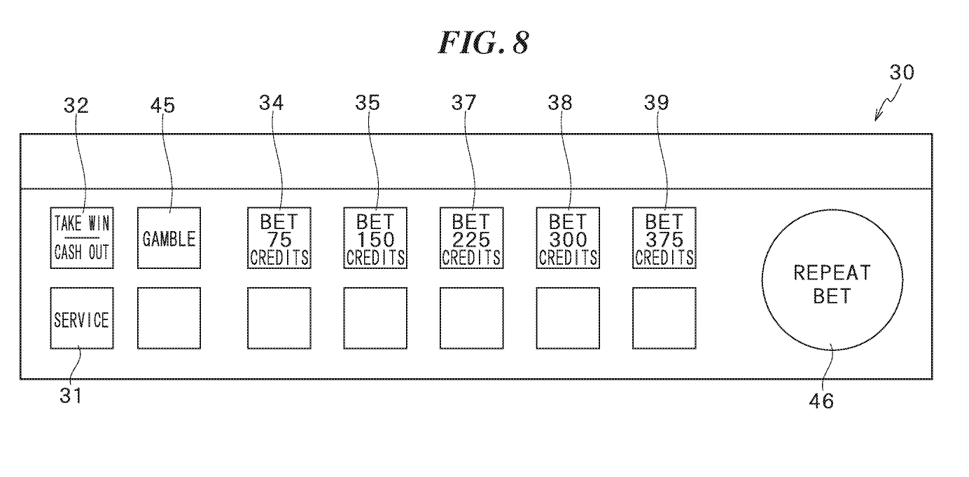

As shown in FIG. 8, the control panel 30 has a plurality of buttons arranged in two, upper and lower, rows, and a repeat bet button 46 at a right end thereof. Specifically, a cashout button 32, a gamble button 45, a first BET button 34, a second BET button 35, a third BET button 37, a fourth BET button 38, and a fifth BET button 39 are arranged from left to right in the upper row of the control panel 30. A service button 31 is located in the lower row of the control panel 30. The button design of the control panel 30 may be changeable depending on the type of the game and the like.

The service button 31 is an operation button that is used when the player leaves the machine or when the player askes an attendant of the entertainment facility to exchange money. The cashout button 32 is what is called a settlement button by which credit data relating to the credits acquired in various games is added to the credit data stored in the IC card inserted into the PTS device 700.

The BET buttons 34, 35, 37, 38 and 39 are buttons used to start a base game with a bet of credits set for each button. The default set values in this embodiment are 75 credits, which is the minimum standard bet, for the first BET button 34, 150 credits for the second BET button 35, 225 credits for the third BET button 37, 300 credits for the fourth BET button 38, and 375 credits for the fifth BET button 39. The repeat bet button 46 is a button used to start a game with the same bet as in the previous game.

As described above, the first to fifth BET button 34, 35, 37, 38 and 39 and the repeat bet button 46 have a function of determining the bet and also functions as a button for starting to spin symbol arrays in the symbol display region 150. The repeat bet button 46 also functions as a button for starting a bonus game and adding the dividend acquired in a bonus game to the credits.

The gamble button 45 is an operation button that is used for move on to a gamble game after, for example, a bonus game is completed. Here, a gamble game is a game that is played using acquired credits.

(Electrical Configuration of Slot Machine)

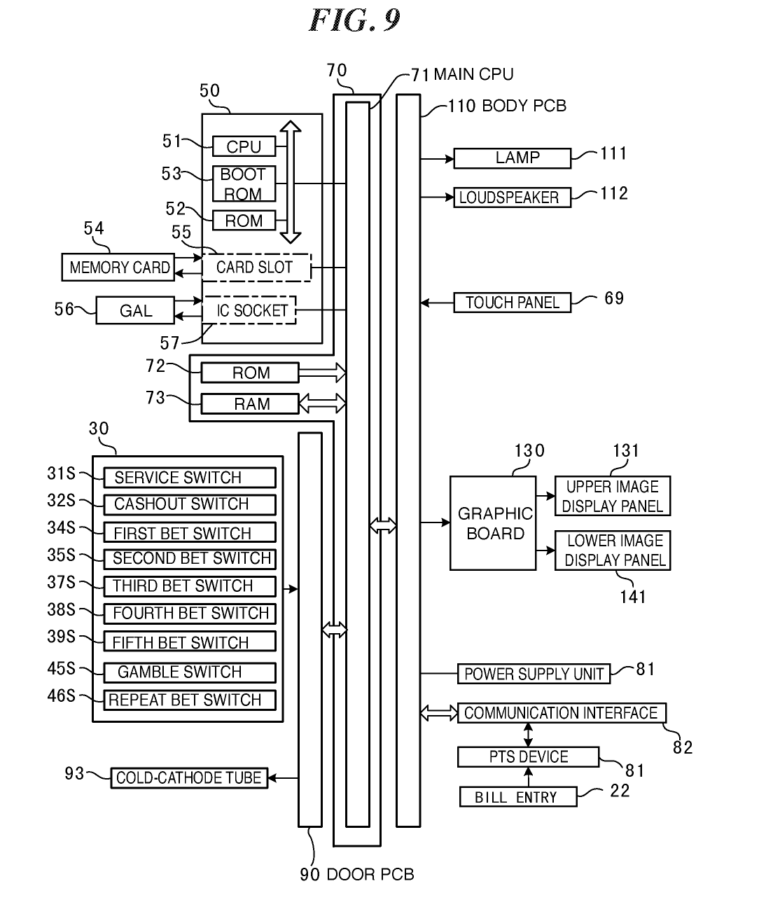

With reference to FIG. 9, the configuration of a circuit in the slot machine 1 is described.

A gaming board 50 includes a CPU 51, a ROM 52 and a boot ROM 53 that are mutually connected by an internal bus, a card slot 55 compatible with a memory card 54, and an IC socket 57 compatible with a GAL (generic array logic) 56.

The memory card 54 includes a non-volatile memory, and has stored a game program. The game program includes a program relating to the progress of games, and an effect program for producing effects by means of images and sounds.

The card slot 55 is configured to allow insertion and removal of the memory card 54, and is connected to a motherboard 70 through an IDE bus. Thus, the types and contents of the games played on the slot machine 1 can be changed by removing the memory card 54 from the card slot 55, writing another game program into the memory card 54 and inserting the memory card 54 into the card slot 55.

The GAL 56 is a type of PLD (programmable logic device) having a fixed OR array structure. The GAL 56 has a plurality of input ports and output ports. A prescribed input into any of the input ports causes output of corresponding data from the output ports.

The IC socket 57 is configured to allow attachment and detachment of the GAL 56, and is connected to the motherboard 70 through a PCI bus. The contents of the game to be played on the slot machine 1 can be changed by replacing the memory card 54 with another memory card into which another program has been written or by rewriting the program in the memory card 54 to another program.

The CPU 51, the ROM 52 and the boot ROM 53 mutually connected by an internal bus are connected to the motherboard 70 by the PCI bus. The PCI bus allows signal transmission between the motherboard 70 and the gaming board 50, and allows power supply from the motherboard 70 to the gaming board 50.

An authentication program is stored in the ROM 52. A backup authentication program, a program (boot code) for the CPU 51 to activate the backup authentication program and so on are stored in the boot ROM 53. The authentication program is a program (falsification check program) for authenticating the game program. The backup authentication program is a program for authenticating the authentication program. The authentication program and the backup authentication program are written according to the procedure (authentication procedure) by which the subject program is proved to be unfalsified.

The motherboard 70 is constituted using a commercially available versatile motherboard (printed circuit board on which basic components for a personal computer are mounted), and includes a main CPU 71, a ROM (read only memory) 72, a RAM (random access memory) 73, and a communication interface 82. The motherboard 70 corresponds to a game controller 100 of this embodiment.

The ROM 72 is constituted of a memory device such as a flash memory, and stores permanent data and programs such as BIOS (basic input/output system) that is executed by the main CPU 71. When the BIOS is executed by the main CPU 71, processing for initializing prescribed peripheral devices is executed and processing for loading the game program stored in the memory card 54 through the gaming board 50 is also started. In the present invention, the ROM 72 may or may not be rewritable.

Data that is used for the operation of the main CPU 71 (various tables as described later and so on) and programs such as a symbol determination program are stored in the RAM 73. For example, when the processing for loading the aforementioned game program or authentication program is executed, the RAM 73 can store the program. The RAM 73 has work areas for execution of these programs. For example, the RAM 73 has an area in which counters for managing the number of games played, the number of bets, the number of payouts, and the number of credits are stored, an area in which the symbols (code numbers) determined by lottery are stored, and so on.

The communication interface 82 communicates with the PTS device 700 or an external controller (not shown). The PTS device 700 transmits, upon receipt of an input signal from the bill entry 22, the credit data included in the input signal to the main CPU 71 via the communication interface 82. The PTS device 700 also transmits, upon insert in of an IC card into the card insertion slot, the credit data stored in the IC card to the main CPU 71 via the communication interface 82. On the basis of a control signal received from the main CPU 71 via the communication interface 82, the PTS device 700 writes credit data into the IC card in the card insertion slot.

A door PCB (printed circuit board) 90, which is described later, and a main body PCB 110 are connected, each by a USB, to the motherboard 70. In addition, a power supply unit 81 is also connected to the motherboard 70. When power is supplied from the power supply unit 81 to the motherboard 70, the main CPU 71 of the motherboard 70 is activated, and power is supplied to the gaming board 50 via the PCI bus to activate the CPU 51.

Input devices such as switches and sensors and peripheral devices the operations of which are controlled by the main CPU 71 are connected to the door PCB 90 and the main body PCB 110. The control panel 30 and a cold-cathode tube 93 are connected to the door PCB 90.

The control panel 30 is provided with a service switch 31S, a cashout switch 32S, a first BET switch 34S, a second BET switch 35S, a third BET switch 37S, a fourth BET switch 38S, a fifth BET switch 39S, a gamble switch 45S, and a repeat bet switch 46S in one-to-one relationship with the above-mentioned buttons. Each switch outputs a signal to the main CPU 71 upon detection of its corresponding button being pressed by the player.

The cold-cathode tube 93 functions as a backlight installed behind the upper image display panel 131 and the lower image display panel 141, and lights up on the basis of a control signal output from the main CPU 71.

The upper image display panel 131, the lamp 111, the loudspeakers 112, the touch panel 69, the bill entry 22, and a graphic board 130 are connected to the main body PCB 110. The loudspeakers 112 output sound such as BGM based on a control signal output from the main CPU 71.

The touch panel 69 detects the position on the lower image display panel 141 that the player's finger or the like touches, and outputs a signal corresponding to the detected position to the main CPU 71.

The bill entry 22 validates bills and accepts authentic bills into the cabinet 11. Credits equivalent to the bills accepted into the cabinet 11 are added as credits owned by the player.

The graphic board 130 controls the display of images on the upper image display panel 131 and the lower image display panel 141 on the basis of control signals output from the main CPU 71. The graphic board 130 includes a VDP (video display processor) for generating image data and a video RAM for storing image data generated by the VDP. The image data used by the VDP to generate image data is included in the game program that is read from the memory card 54 and stored in the RAM 73.

The graphic board 130 also includes a VDP (video display processor) for generating image data on the basis of control signals output from the main CPU 71, a video RAM for temporarily storing the image data generated by the VDP, and so on. The image data used by the VDP to generate image data is included in the game program that is read from the memory card 54 and stored in the RAM 73.

A controller in the present invention includes the main CPU 71, the ROM 72, the RAM 73, and the memory card 54, in which the game program and game system program have been stored, and configured to control the slot machine by executing the game program and the game system program in the main CPU 71. The controller, however, is not limited to such a configuration. It is understood that the game program and the game system program may be stored, not in the memory card 54, but in the ROM 72.

(Symbols)

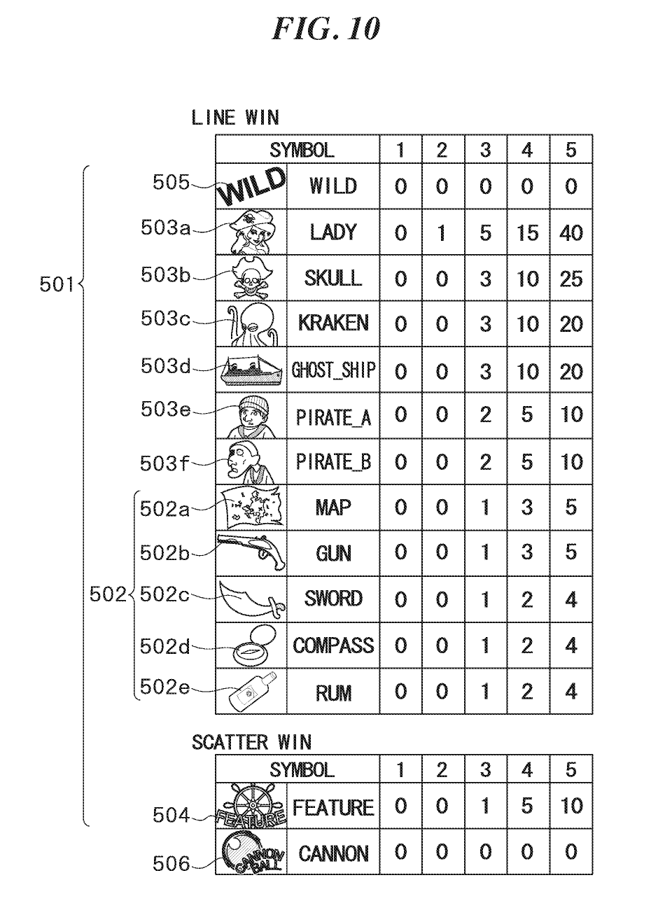

FIG. 10 shows types of symbols 501, and the dividend for each symbol 501. As shown in FIG. 10, symbol 501 is a collective term for symbols including wild symbol 505 (“WILD”), top symbol 503a (“LADY”), skull symbol 503b (“SKULL”), Kraken symbol 503c (“KRAKEN”), ghost ship symbol 503d (“GHOST_SHIP”), pirate A symbol 503e (“PIRATE_A”), pirate B symbol 503f (“PIRATE_B”), map symbol 502a (“MAP”), gun symbol 502b (“GUN”), sword symbol 502c (“SWORD”), compass symbol 502d (“COMPASS”), rum symbol 502e (“RUM”), feature symbol 504 (“FEATURE”), and cannon symbol 506 (“CANNON”).

In the following description, the top symbol 503a, the skull symbol 503b, the Kraken symbol 503c, the ghost ship symbol 503d, the pirate A symbol 503e and the pirate B symbol 503f are collectively referred to as “superior picture symbols 503,” and the map symbol 502a, the gun symbol 502b, the sword symbol 502c, the compass symbol 502d and the rum symbol 502e are collectively referred to as “inferior picture symbols 502.”

The wild symbols 505 are symbols that can be used as any type of symbols in the determination of the line dividend. Even when a predetermined number or more of the wild symbols 505 are rearranged, line dividend is generated. The wild symbols 505 are provided only in the symbol arrays of the video reels 152, 153 and 154.

The superior picture symbols 503 and the inferior picture symbols 502 are symbols 501 regarded as subjects of determination of line dividends. In other words, a line dividend is awarded when a predetermined number or more of the same type of superior picture symbols 503 or inferior picture symbols 502 are rearranged on one effective line. In this embodiment, top symbols 503a are the only symbols that award a line dividend when two or more of them are rearranged on one effective line. In the case of other symbols, a line dividend is awarded when three or more of the same symbols are rearranged on one effective line.

As shown in FIG. 10, when the kind number is the same, the top symbols 503a may award a higher line dividend than the other symbols 501 used as subjects of determination of line dividends. The inferior picture symbols 502 may change to the top symbols 503a. In other words, the map symbol 502a, the gun symbol 502b, the sword symbol 502c, the compass symbol 502d, and the rum symbol 502e function as predetermined symbols that may be dealt with as the top symbols 503a.

The feature symbols 504 are determined in a scatter fashion. In other words, a scatter dividend is awarded to the player regardless of the effective lines when three or more feature symbols 504 are rearranged in the symbol display region 150. When three or more feature symbols 504 are rearranged in the symbol display region 150, a branching game for selection of a bonus game is started. In other words, the feature symbols 504 function as a trigger for a bonus game. The feature symbols 504 are used only in the base game.

The cannon symbols 506 are used only in the major bonus game (Kraken Free Game). Although neither a line dividend nor a scatter dividend results from the cannon symbols 506, the Kraken Free Game progresses in favor of the player when the cannon symbols 506 are rearranged. The cannon symbols 506 are determined in a scatter fashion, and the Kraken Free Game progresses more in favor of the player as the number of the rearranged symbols is greater. The number of symbols of the same type that are determined in a scatter fashion is also expressed in kind number. For example, when three feature symbols 504 are rearranged, it is expressed as three kinds of the feature symbol 504.

In FIG. 10, dividends at a time when the standard bet is 25 credits are shown. Thus, when the standard bet is 50 credits, each dividend shown in FIG. 10 is doubled. When the standard bet is 75 credits, which is the default value, each dividend shown in FIG. 10 is tripled. When the standard bet is 100 credits, each dividend shown in FIG. 10 is quadruplicated.

(Symbol Arrays)

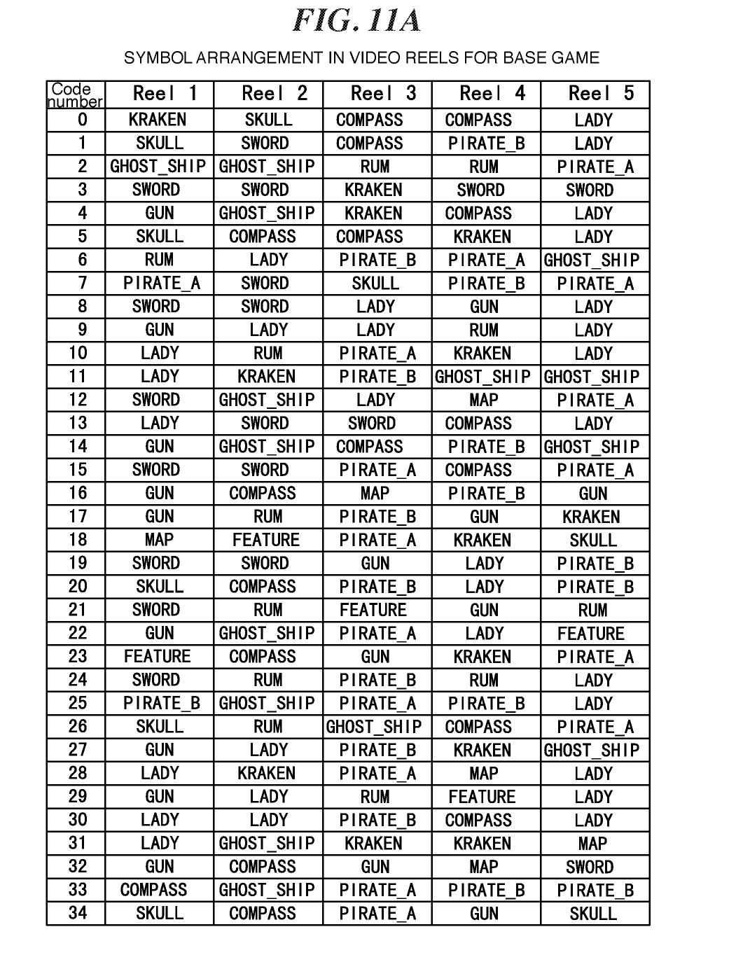

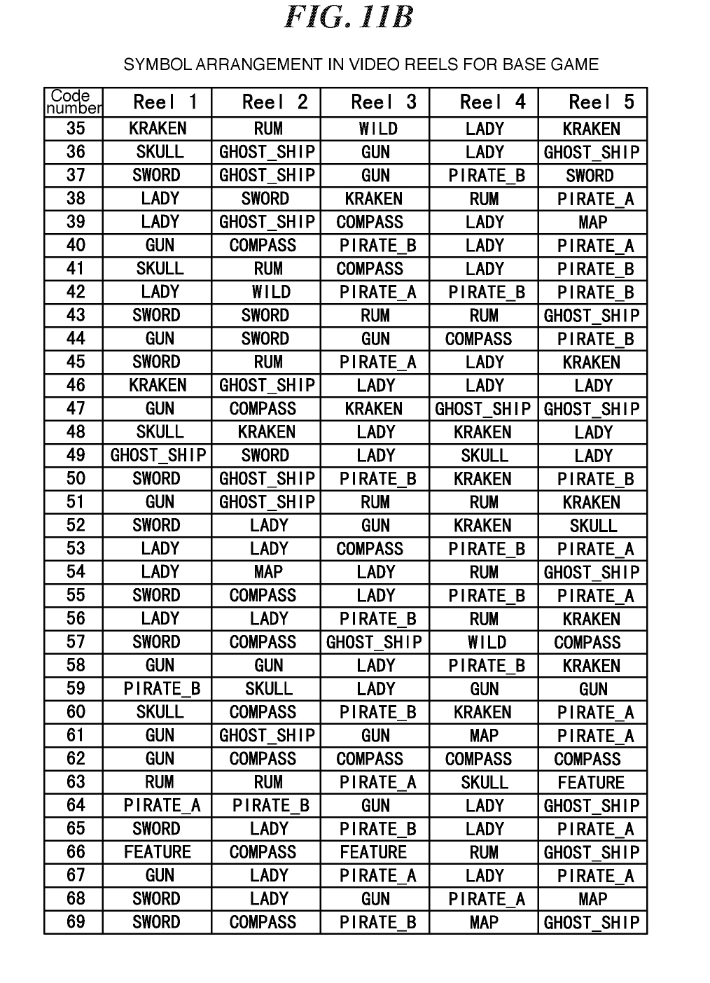

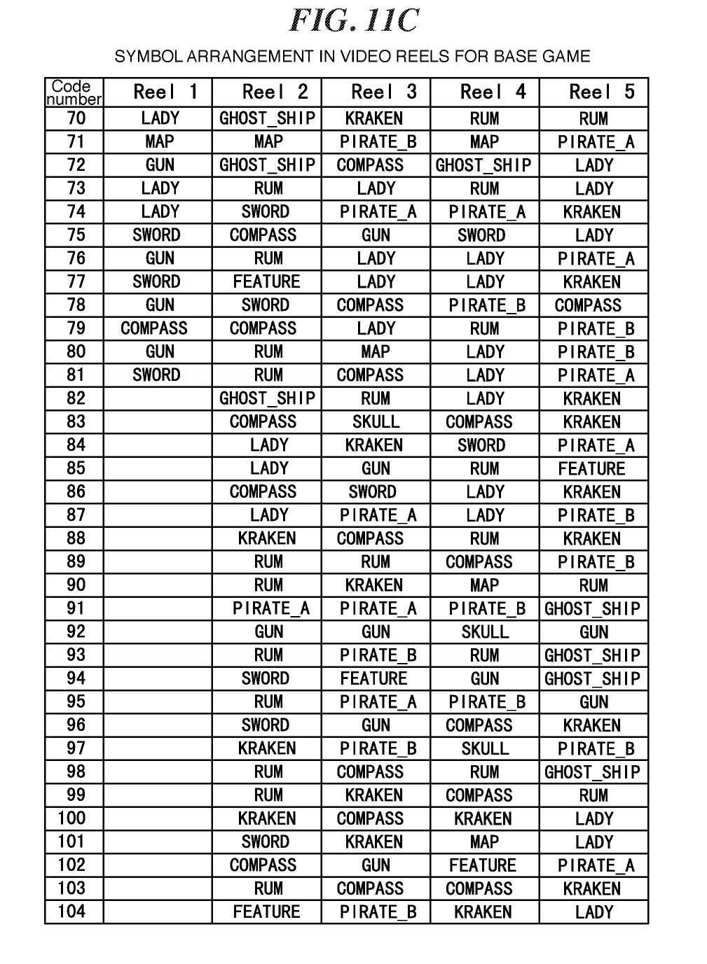

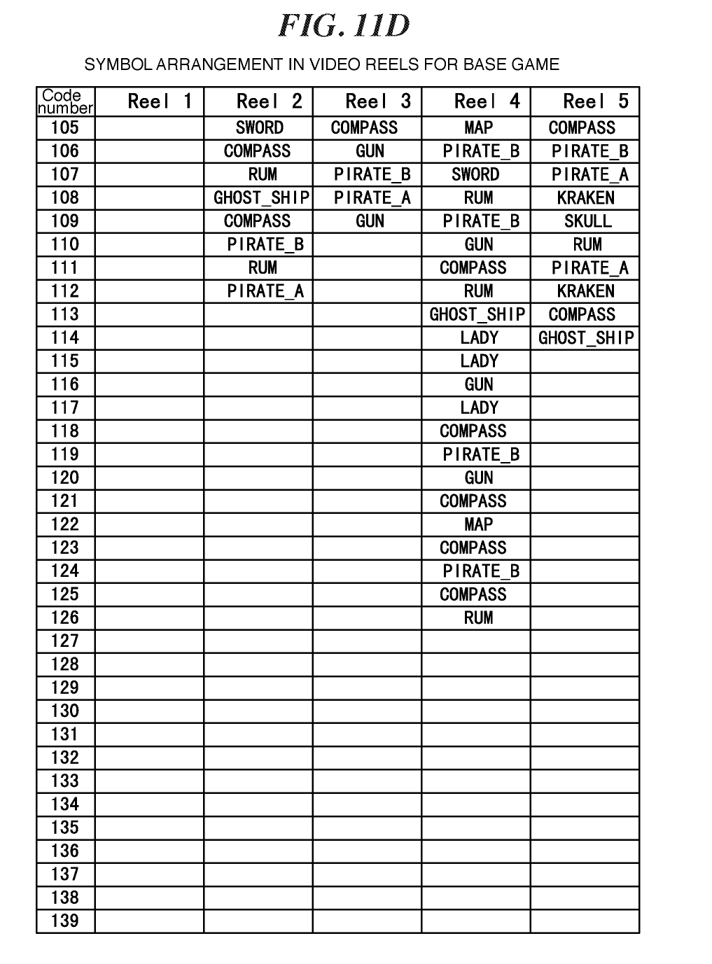

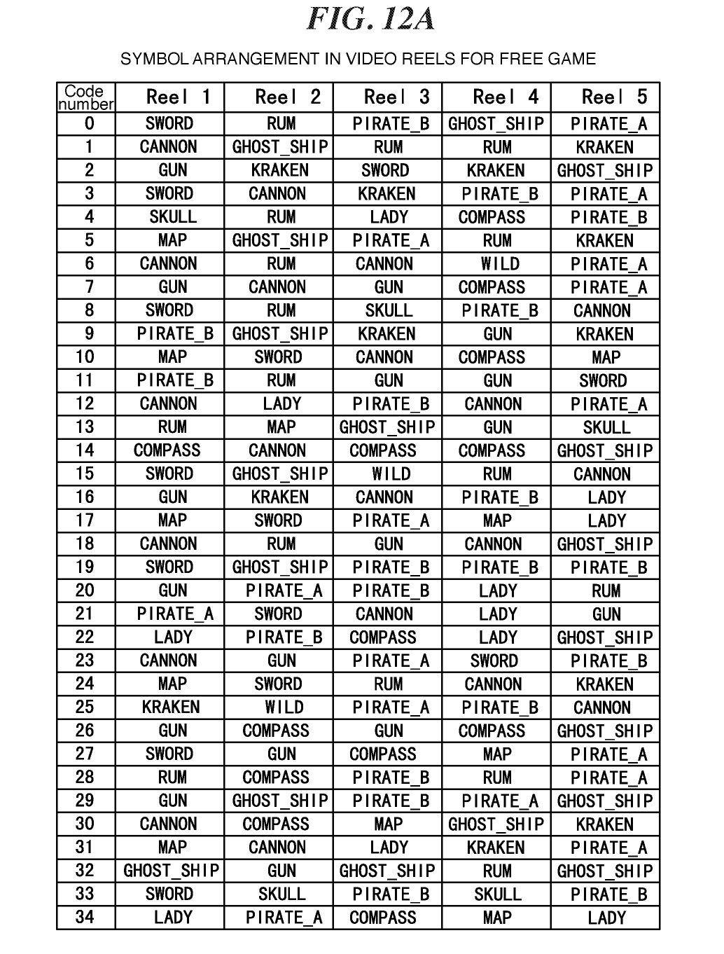

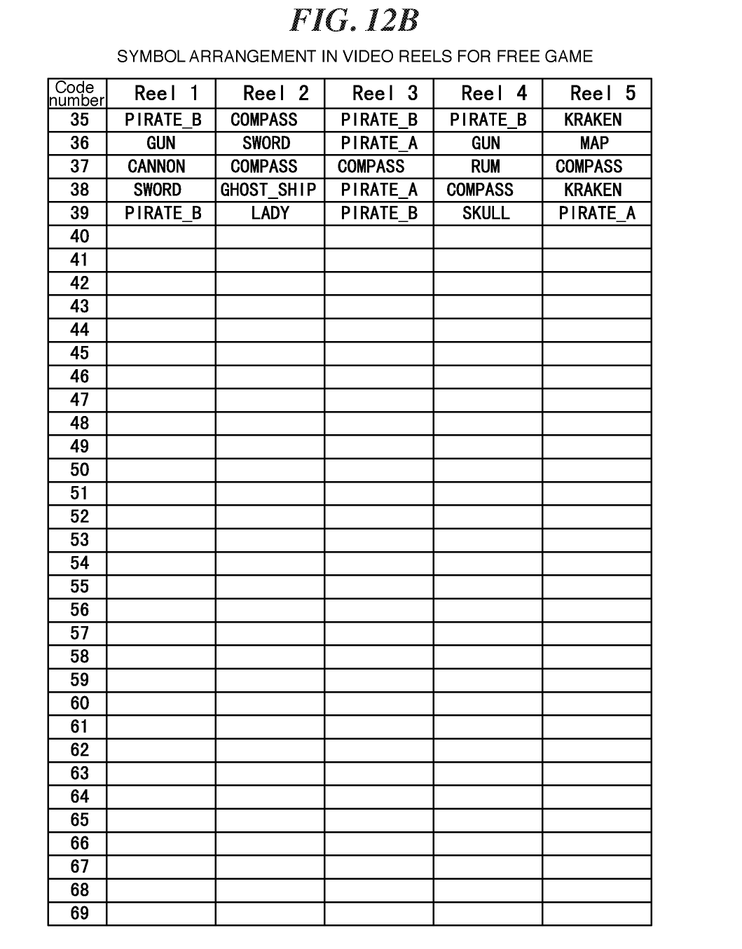

As shown in FIG. 11A, FIG. 11B, FIG. 11C, FIG. 11D, FIG. 12A and FIG. 12B, symbol arrays are formed by combining the symbols 501 as described above. In the base game, a symbol array set shown in FIG. 11A to FIG. 11D is used. In the major bonus game (Kraken Free Game), a symbol array set for a free game shown in FIG. 12A and FIG. 12B is used. As described above, the cannon symbols 506 are included only in the symbol array set for a free game. Each of the symbols constituting the symbol arrays is given a certain code number. In the base game and the free game, the symbols 501 to be rearranged in the symbol display region 150 are determined by selecting a code number for each of the video reels 151 to 155 by lottery.

(Display Blocks)

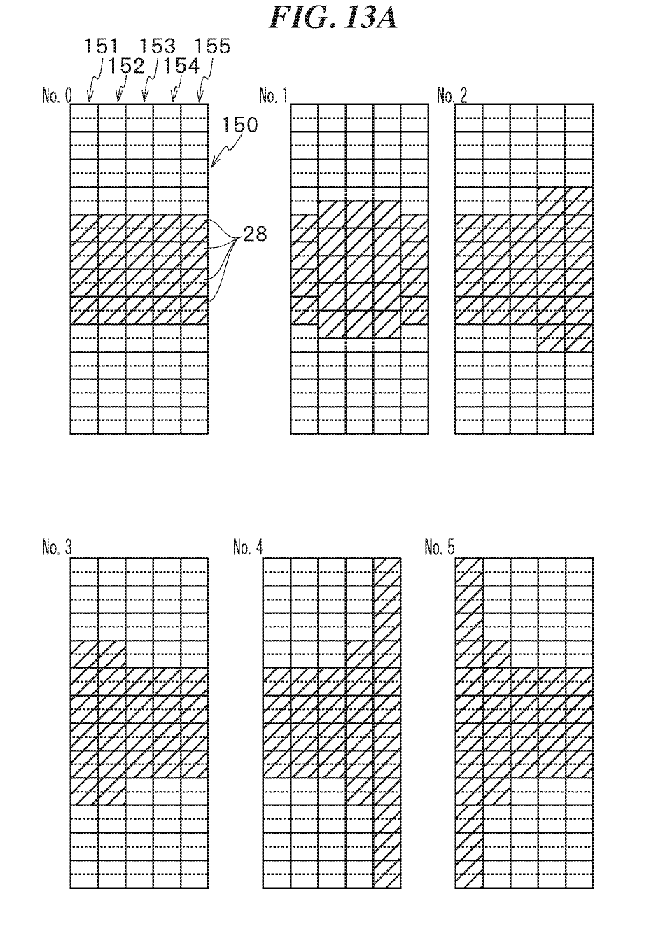

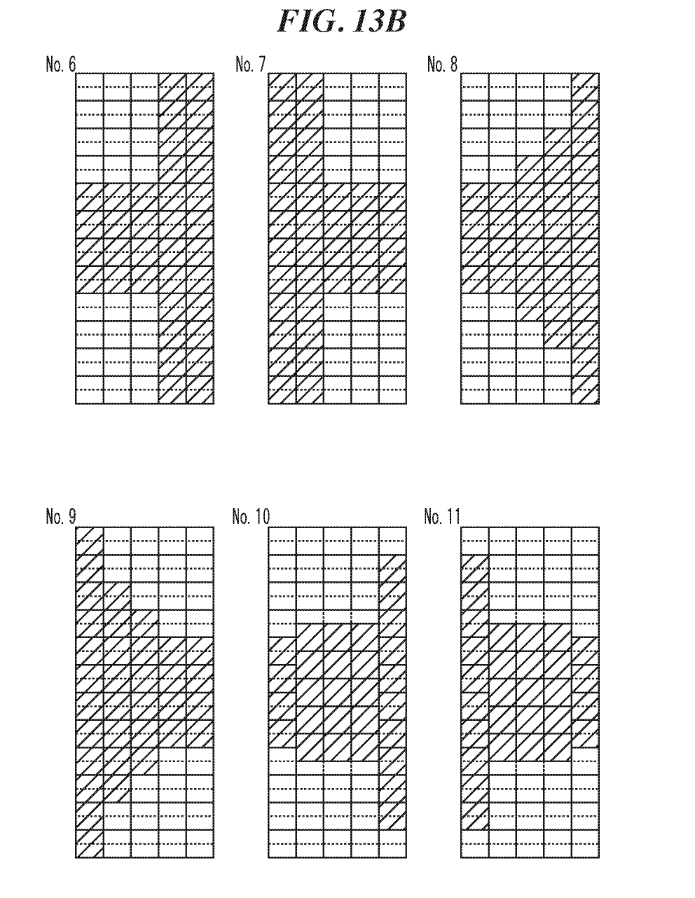

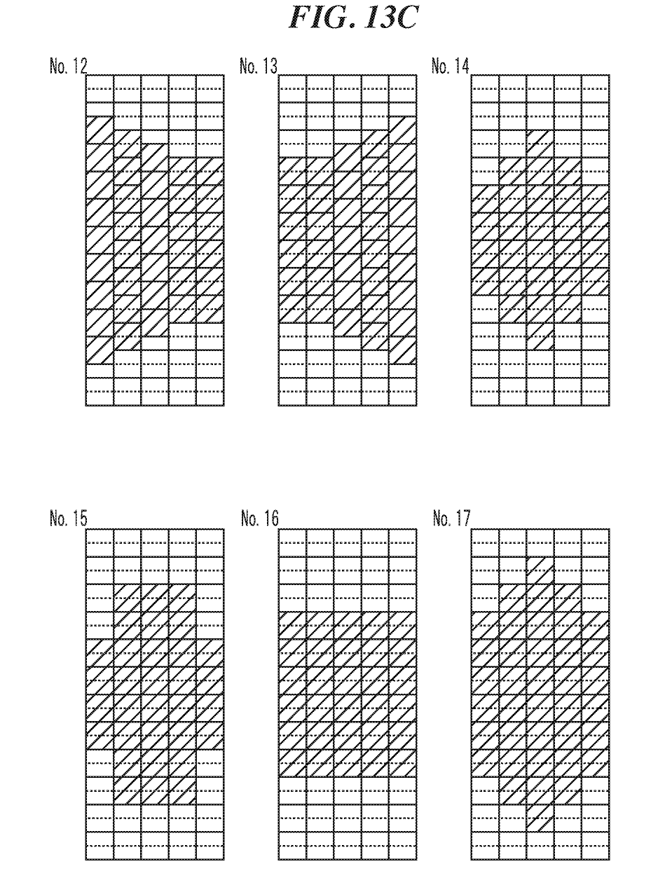

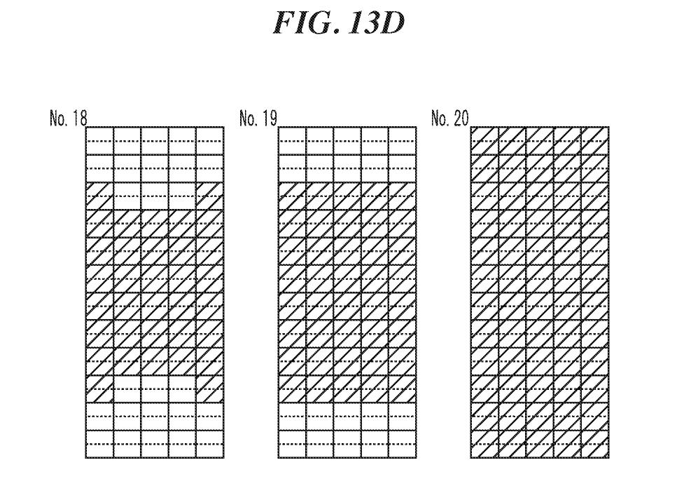

As shown in FIG. 13A to FIG. 13D, in this embodiment, the number of the display blocks 28 that are set in the symbol display region 150 is variable. In other words, the number of the display blocks 28 each of the video reels 151 to 155 has is variable. A plurality of arrangement patterns, from No. 0 to No. 20, each having a set of numbers of the display blocks 28 to be arranged in the video reels 151 to 155, is previously determined. The No. 0 arrangement pattern is an arrangement pattern of the display blocks 28 used as a standard, and four display blocks 28 are arranged in each of the video reels 151 to 155. In other words, the display blocks 28 are arranged in a five-column by four-row matrix. The maximum number of the display blocks 28 that can be arranged in each of the video reels 151 to 155 is twelve, and the display blocks 28 are arranged in a five-column by twelve-row matrix at a maximum.

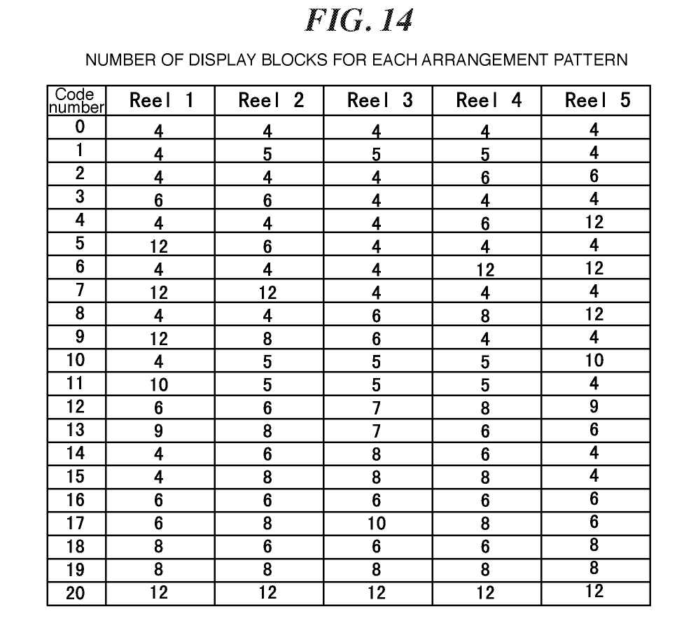

As shown in FIG. 14, in the arrangement patterns No. 1 to No. 20, a greater number of the display blocks 28 are arranged than in the arrangement pattern No. 0. As described above, the situation in which the number of the display blocks 28 to be displayed is increased from the number in the arrangement pattern No. 0 is also referred to as “expansion of the reel display panes.” In the base game, it is determined by lottery whether the arrangement pattern No. 0 of the display blocks 28 is used or the display blocks 28 are increased before the rearrangement of the symbols 501. Then, when the display blocks 28 are increased in the symbol display region 150, one of the arrangement patterns No. 1 to No. 20 is selected by another lottery.

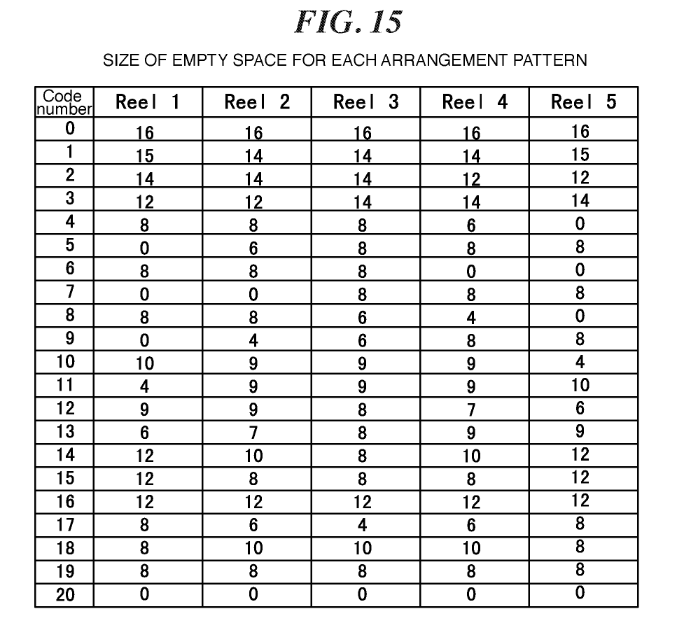

FIG. 15 shows the sizes of the empty spaces that are formed in the video reels 151 to 155 in the symbol display region 150. The size of an empty space is expressed by the number of regions formed by vertically dividing one display block 28 into two. As shown in FIG. 13A to FIG. 13D, when the display blocks 28 arranged in each of the video reels 151 to 155 is regarded as forming one region, each region is centered vertically in the symbol display region 150. Thus, the size of the empty space is the total of the spaces formed above and below the display blocks 28.

(LEFT TO RIGHT)

As described above, the winning determination is made according to a “LEFT TO RIGHT” type rule. In this embodiment, because all the displayed display blocks 28 are made effective, the player is awarded a prize if a predetermined number or more of symbols of the same type continue from the video reel 151 to the video reel 155. In other words, a winning determination is made for all the effective lines each selecting one display block 28 from each of the video reels 151 to 155. However, it is necessary that symbols of the same type are continuously rearranged from the video reel 151.

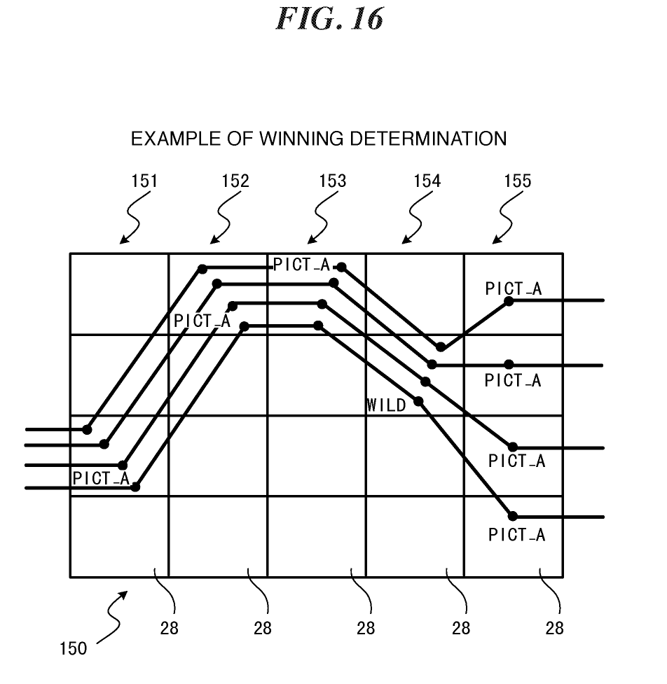

For example, as shown in FIG. 16, all the display blocks 28 are regarded as subjects of winning determinations (made effective). Then, when certain symbols (PICT_A, including a WILD symbol) have been stopped in the bottom column of the video reel 151, the top column of the video reel 152, the top column of the video reel 153, the second top column of the video reel 154, and the top, second top, second bottom and bottom columns of the video reel 155, four prizes, each having five symbols (PICT_A) continuing from the video reel 151 to the video reel 155 (“LEFT TO RIGHT”), are established. As described above, according to a “LEFT TO RIGHT” type rule, even when it looks as if the symbols are stopped randomly at a first glance, a prize is awarded if the same symbols continue from the video reel 151 to the video reel 155. While such a “LEFT TO RIGHT” type rule is employed in this embodiment, a type may be employed in which a dividend is awarded when a predetermined number or more of symbols of the same type are rearranged on an effective line even if they are not continuous, or a scatter type may be employed in which a dividend is awarded when a predetermined number or more of symbols of the same type are rearranged anywhere in the symbol display region 150. Alternatively, a type may be employed in which the number of the display blocks 28 that are made effective varies depending on the bet number.

(Game Flow)

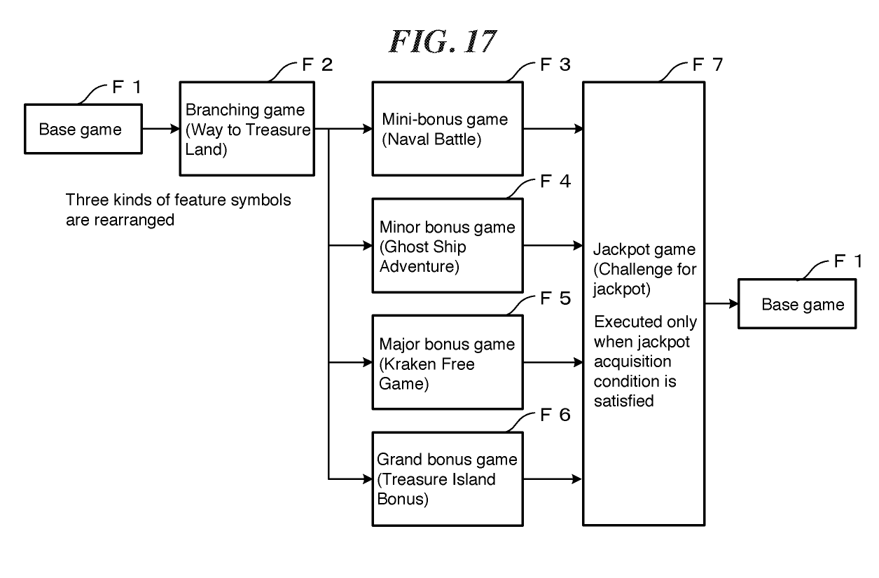

With reference to FIG. 17, the flow of the base game, the bonus games and the jackpot game is described. First, the base game is executed (F1). When three kinds of the feature symbols 504 are rearranged in the base game, the branching game (Way to Treasure Land) is executed. The branching game is a game for determining which bonus game will be executed. After each branching game, a bonus game selected from the mini-bonus game (Naval Battle) (F3), the minor bonus game (Ghost Ship Adventure) (F4), the major bonus game (Kraken Free Game) (F5), the grand bonus game (Treasure Island Bonus) (F6) is executed. After the bonus game is terminated, the jackpot game (Challenge for Jackpot) is executed only when a jackpot acquisition condition is satisfied. After that, the flow returns to the base game (F1).

(Display Screens)

The display screens displayed on the upper image display panel 131 and the lower image display panel 141 in the base game, the bonus games and the jackpot game executed according to the flow as described above are described.

(Display Screens: Base Game)

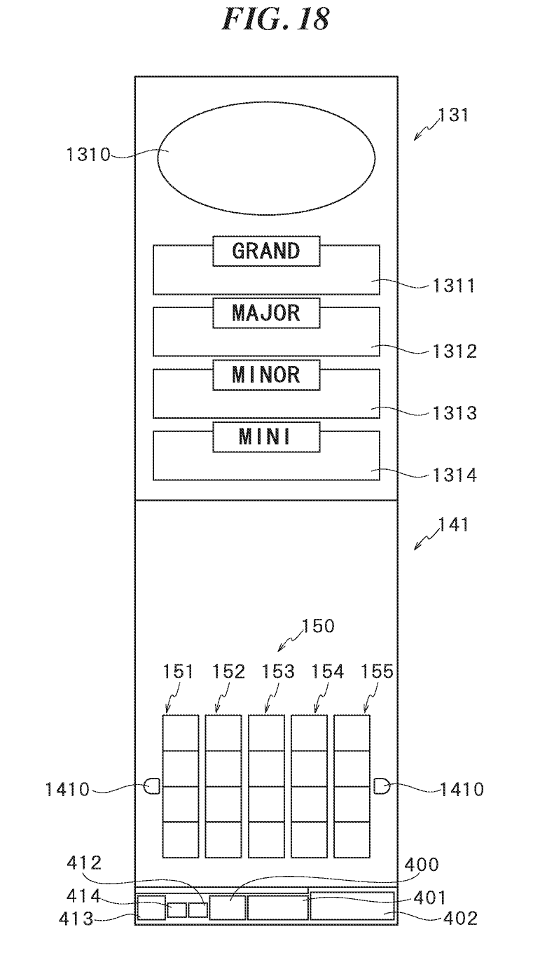

With reference to FIG. 18, the basic configurations of the display screens that are displayed on the upper image display panel 131 and the lower image display panel 141 during the base game are described.

As shown in FIG. 18, a title logo image 1310, a grand progressive amount display part 1311, a major progressive amount display part 1312, a minor progressive amount display part 1313, and a mini-progressive amount display part 1314 are displayed on the upper image display panel 131. The machine type of the slot machine 1 is shown in the title logo image 1310. Various types of progressive amounts are shown in the grand progressive amount display part 1311, the major progressive amount display part 1312, the minor progressive amount display part 1313, and the mini-progressive amount display part 1314. Each of the progressive amount display parts 1311 to 1314 is set to display two digits for the currency sign+10-digit number+one digit after the decimal point at a maximum when displaying the amount of money.

A denomination display 413, a menu touch icon 414, a volume level touch icon 412, a credit meter 400, a bet meter 401, and a win meter 402 are provided at a lower part of the lower image display panel 141. The symbol display region 150 having the video reels 151 to 155 is provided above them. A line number display 1410 is provided on each side of the symbol display region 150.

The language can be switched with the menu touch icon 414. Upon switching the language, the way of expression in the credit meter 400, the bet meter 401 and the win meter 402 are changed. The figures displayed on the credit meter 400, the bet meter 401, and the win meter 402 are switchable between the number of credits and the amount of money. Commas, which are used to separate numbers into groups of three digits, are not used when the figures are expressed in the amount of money. The credit meter 400 is set to display two digits for the currency sign+10-digit number+one digit after the decimal point at a maximum when displaying the amount of money. The credit meter 400 is set to display a 10-digit number at a maximum when displaying the number of credits. The bet meter 401 is set to display two digits for the currency sign+four-digit number+one digit after the decimal point when displaying the amount of money. The bet meter 401 is set to display a four-digit number at a maximum when displaying the number of credits. The win meter 402 is set to display two digits for the currency sign+11-digit number+one digit after the decimal point at a maximum when displaying the amount of money. The win meter 402 is set to display an 11-digit number at a maximum when displaying the number of credits.

As described above, the number of display blocks 28 that are displayed in each of the video reels 151 to 155 in the symbol display region 150 is variable, and the sizes of the video reels 151 to 155 is also changeable accordingly. The logo “EVERYWAY” is displayed in the line number displays 1410 to show that determination of line dividends is made according to a “LEFT TO RIGHT” type rule with all the display blocks 28 made effective.

(Display Screen: Expansion of Reel Display Panes)

In the base game, the expansion of the reel display panes may be determined by lottery with a prescribed probability.

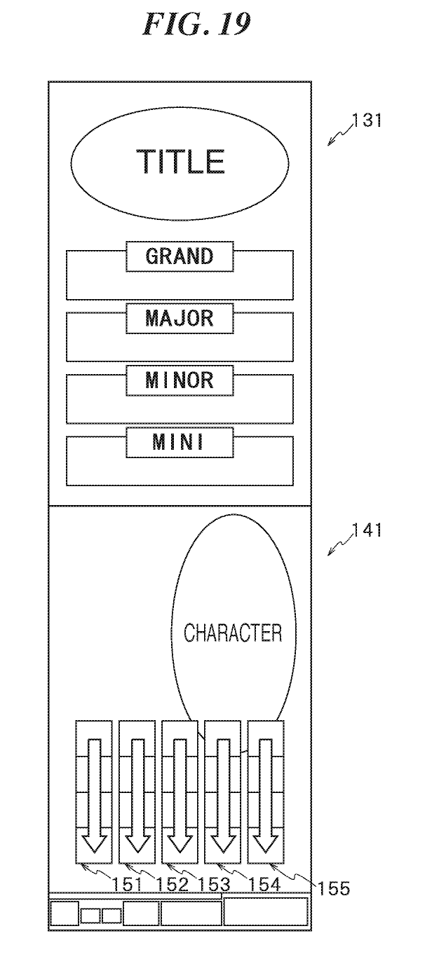

As shown in FIG. 19, when the spin button is pressed, scroll display of the symbol arrays is started in the video reels 151 to 155. When the reel display panes have been expanded in the immediately preceding base game, the standard arrangement pattern in which the display blocks 28 are arranged in a five-column by four-row matrix is produced in 0.2 seconds after the start of the scroll display of the symbol arrays. This state is continued for 1 second after the start of the scroll display of the symbol arrays.

There are two types of effect patterns in which the reel display panes are expanded: a one-step change pattern in which the arrangement of the display blocks 28 is changed in only one step and a two-step change pattern in which the arrangement of the display blocks 28 is changed in two steps.

(Display Screen: Expansion of Reel Display Panes: One-Step Change Pattern)

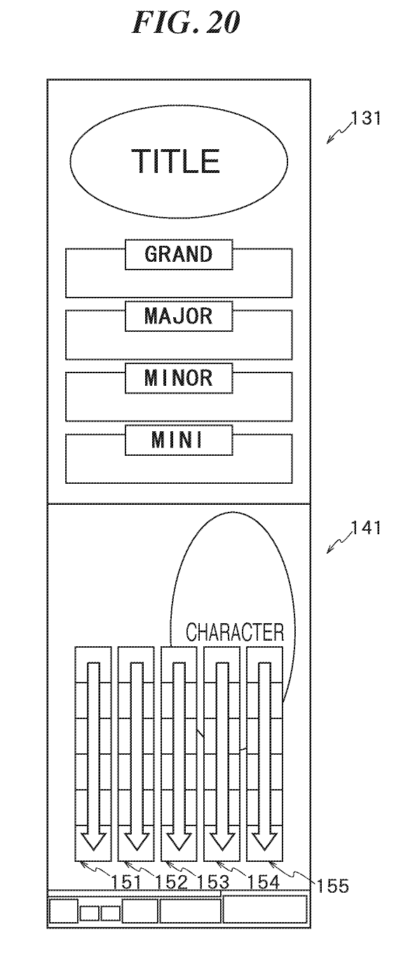

As shown in FIG. 20, in the one-step change pattern, the arrangement pattern is changed one second after the start of the scroll display of the symbol arrays. The arrangement pattern is changed in taking 0.8 seconds. In the one-step change pattern, the change is completed in one step and the scroll display of the video reels 151 to 155 is stopped in sequence. Then, winning determination is made.

(Display Screen: Expansion of Reel Display Panes: Two-Step Change Pattern)

As also shown in FIG. 20, in the two-step change pattern, the video reels 151 to 155 undergo a first change of the arrangement pattern one second after the start of scroll display of the symbol arrays as in the case of the one-step change pattern. The arrangement pattern is changed in taking 0.8 seconds.

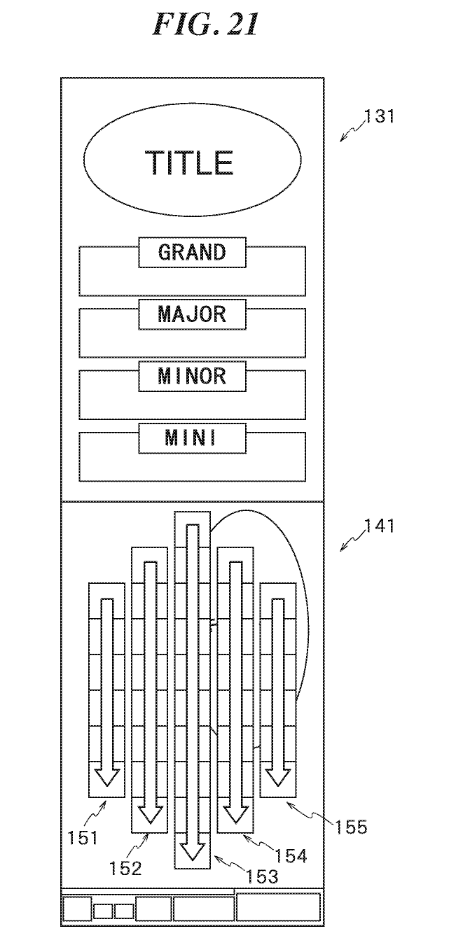

As shown in FIG. 21, in the case of the two-step change pattern, the video reels 151 to 155 undergo a second change of the arrangement pattern in taking another 0.8 seconds after the first change of the arrangement pattern is completed. The second change of the arrangement pattern is started one second after the completion of the first change of the arrangement pattern. After that, the scroll display of the video reels 151 to 155 is stopped in sequence, and winning determination is made.

(Display Screen: Top Symbol Stacking Mystery Bonus)

Next, the display screen that is displayed when a top symbol stacking mystery bonus is generated after the scroll display of the video reels 151 to 155 is started as shown in FIG. 19 is described.

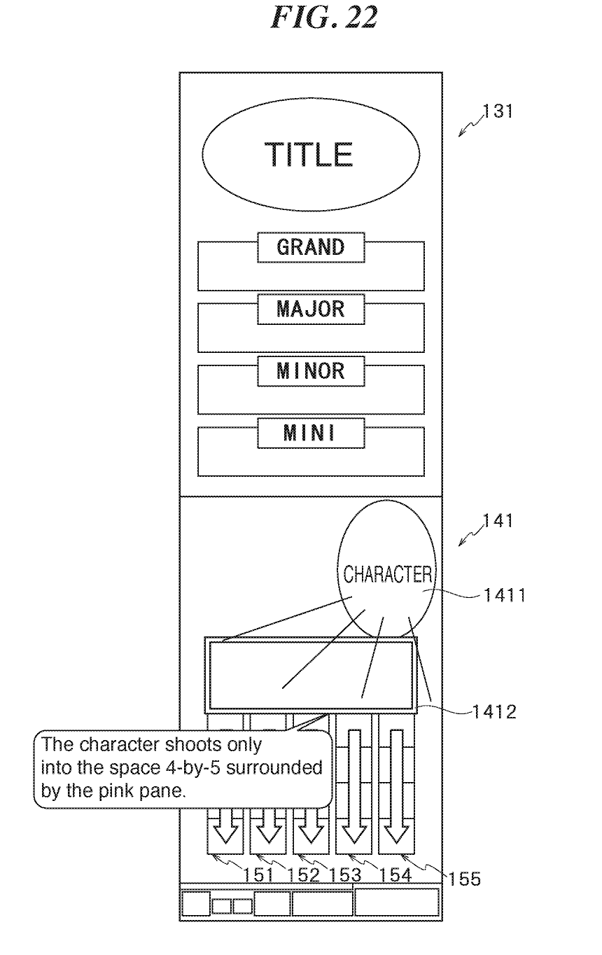

First, as shown in FIG. 22, when a top symbol stacking mystery bonus is generated, a character 1411 appears in an upper right part of the lower image display panel 141 and a pane 1412 is displayed above the video reels 151 to 155 while the video reels 151 to 155 are rotating. Then, the voice of the character 1411 suggesting that the region in the pane 1412 will be changed is output from the loudspeakers 112 (refer to FIG. 7). Then, an effect in which the character 1411 shoots the region in the pane 1412 above the video reels 151 to 155 with a gun is displayed.

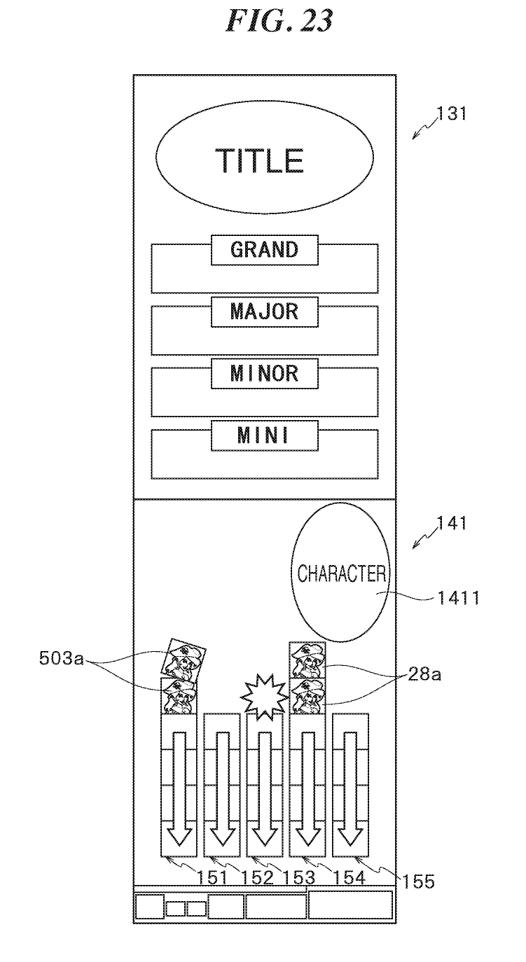

As shown in FIG. 23, additional display blocks 28a with the top symbol 503a arranged therein appear in the region in the pane 1412 shot by the character 1411 with a gun. Specifically, images of the top symbol 503a are first displayed. Then, after an effect in which the top symbols 503a bounce is produced, additional display blocks 28a appear to surround the top symbols 503a. The regions which the images of the top symbol 503a enter from the additional display blocks 28a when they bounce are cleared.

The additional display blocks 28a are displayed in sequence every time the effect in which the character 1411 shoots the region is produced. When plural additional display blocks 28a are displayed on one of the video reels 151 to 155, they always appear as if they are stacked from bottom up. In other words, the additional display blocks 28a are not displayed in such a manner that there is a space between the additional display blocks 28a and the video reels 151 to 155.

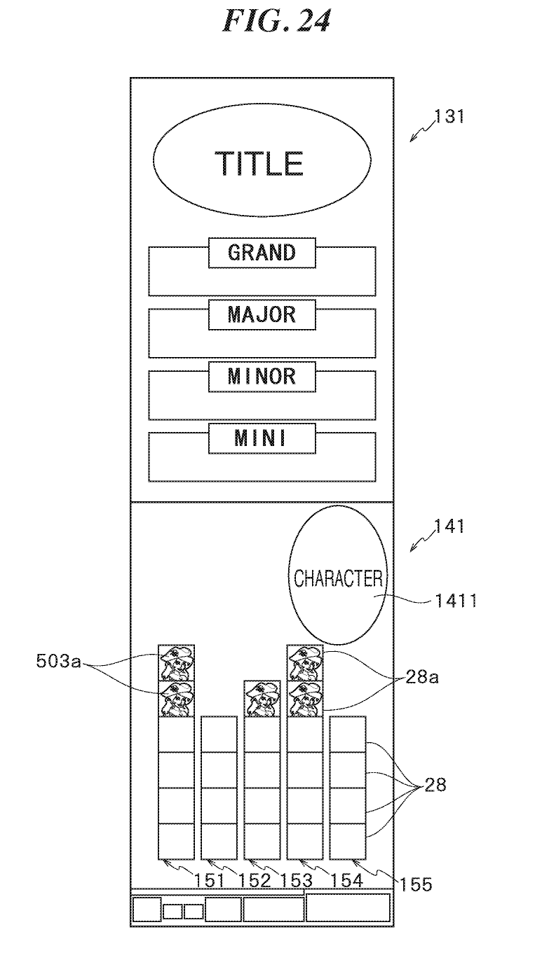

Then, as shown in FIG. 24, the symbols 501 are rearranged in the five-column by four-row matrix of the video reels 151 to 155 according to the symbol arrays. As a result, a line dividend is determined on all the effective lines based on all the display blocks 28 including the additional display blocks 28a added to the display blocks 28 in the video reels 151 to 155.

As described above, it is determined whether to generate a top symbol stacking mystery bonus that adds additional display blocks 28a to the video reels 151 to 155 before the symbols 501 are rearranged in the video reels 151 to 155. Then, when the top symbol stacking mystery bonus is generated, the video reels 151 to 155 are expanded to add additional display blocks 28a. Then, the top symbols 503a with the highest line dividend are arranged in the added additional display blocks 28a irrespective of the symbol arrays displayed in the video reels 151 to 155 in a scrolling fashion. Then, the line dividends are determined in the effective lines based on all the display blocks 28 including not only the display blocks 28 arranged in the video reels 151 to 155 before the expansion but also the added additional display blocks 28a.

As described above, additional display blocks 28a can be added to the display blocks 28 arranged in a matrix to increase the effective lines. In addition, the top symbols 503a with the highest line dividend are rearranged in the added additional display blocks 28a irrespective of the symbol arrays. As a result, the number of effective lines including the top symbols 503a with the highest line dividend increases, and the probability of achieving the line dividends derived from the top symbols 503a increases. Consequently, a new gaming characteristic in which the effective lines are variable so that the winning probability can be changed can be realized.

(Display Screen: Symbol Chance Mystery Bonus)

Next, the display screen that is displayed when a symbol chance mystery bonus is generated after the scroll display of the video reels 151 to 155 is started as shown in FIG. 19 is described.

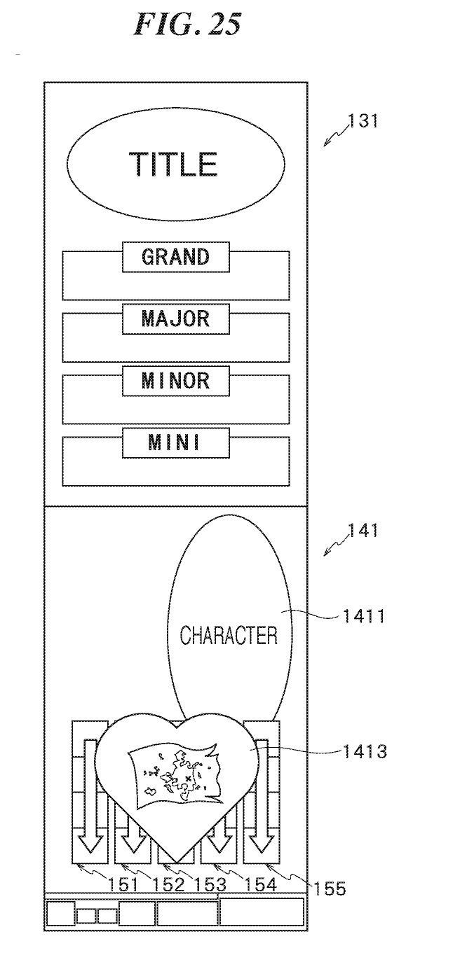

First, as shown in FIG. 25, when a symbol chance mystery bonus is generated, the voice of the character 1411 is output from the loudspeakers 112 (refer to FIG. 7). Then, a change symbol determination image 1413 is displayed at the center of the video reels 151 to 155 after an effect in which the character 1411 throws a kiss is produced. The change symbol determination image 1413 has a heart-shaped pane in which an image of one of the inferior picture symbols 502 as a subject of the symbol chance mystery bonus is displayed. In other words, the inferior picture symbol 502 displayed in the change symbol determination image 1413 changes to the top symbol 503a. In the example shown in FIG. 25, an image of the map symbol 502a is displayed in the change symbol determination image 1413.

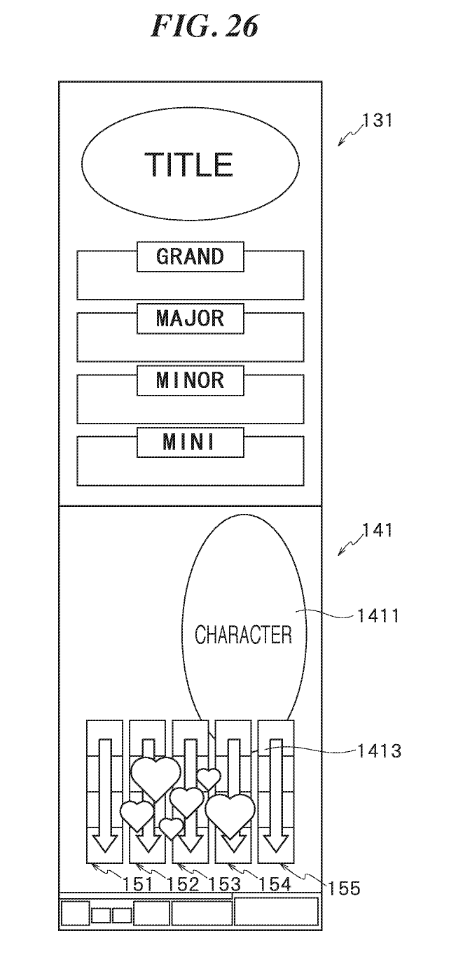

Then, as shown in FIG. 26, the change symbol determination image 1413 is cleared, and an effect in which plural hearts enter the video reels 151 to 155 is produced. This effect may not be created, though.

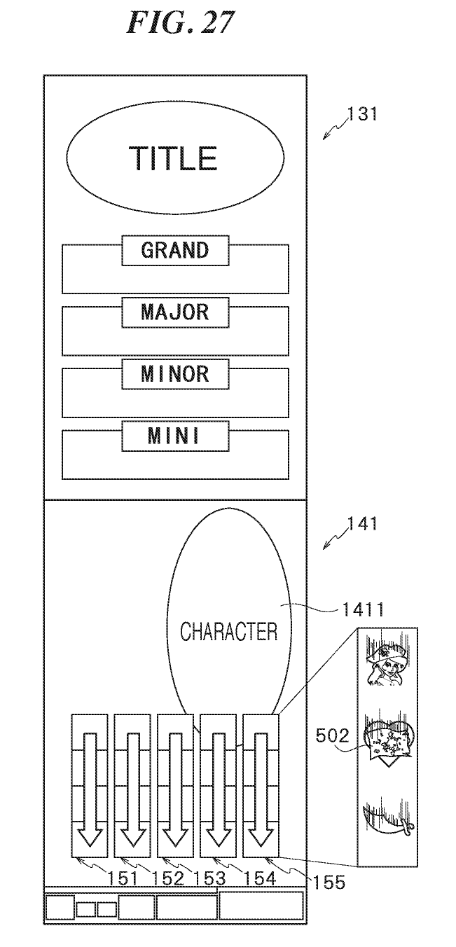

Then, as shown in FIG. 27, a heart-shaped background is added only to the inferior picture symbols 502 as subjects of the symbol chance mystery bonus in the symbol arrays displayed in a scrolling fashion. When expansion of reel display panes is made in the same base game, a heart-shaped background is added to the images of the inferior picture symbol 502 as subjects of the symbol chance mystery bonus, and then the reel display panes are expanded.

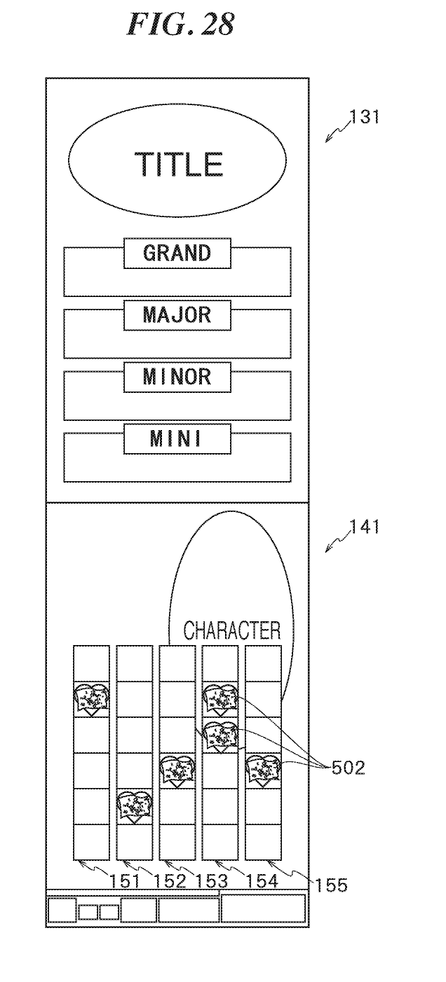

FIG. 28 shows an example in which the inferior picture symbols 502 as subjects of a symbol chance mystery bonus were rearranged after the reel display panes had been expanded as shown in FIG. 20, for example. As shown in FIG. 28, the inferior picture symbols 502 with a heart-shaped background are rearranged.

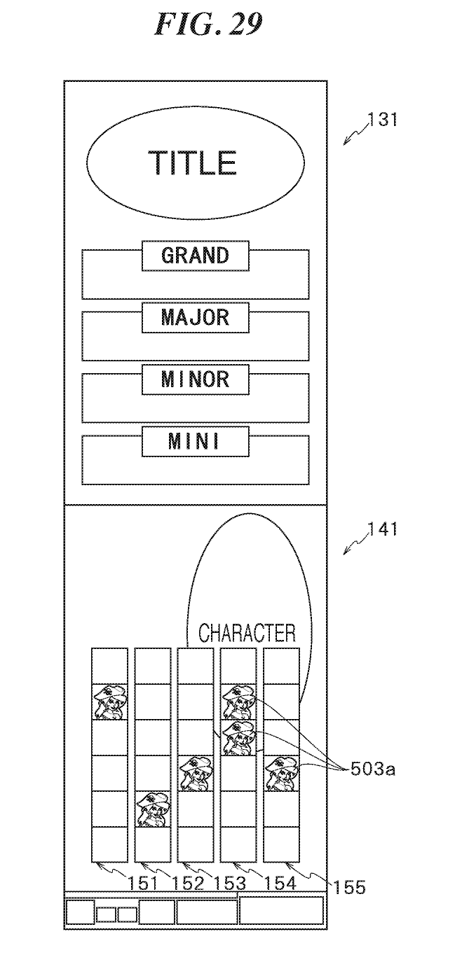

Then, as shown in FIG. 29, the inferior picture symbols 502 with a heart-shaped background are changed to the top symbols 503a at once. Then, winning determination is made. In the winning determination, the inferior picture symbols 502 with a heart-shaped background are dealt with as the top symbols 503a.

(Display Screen: Animation of Top Symbols)

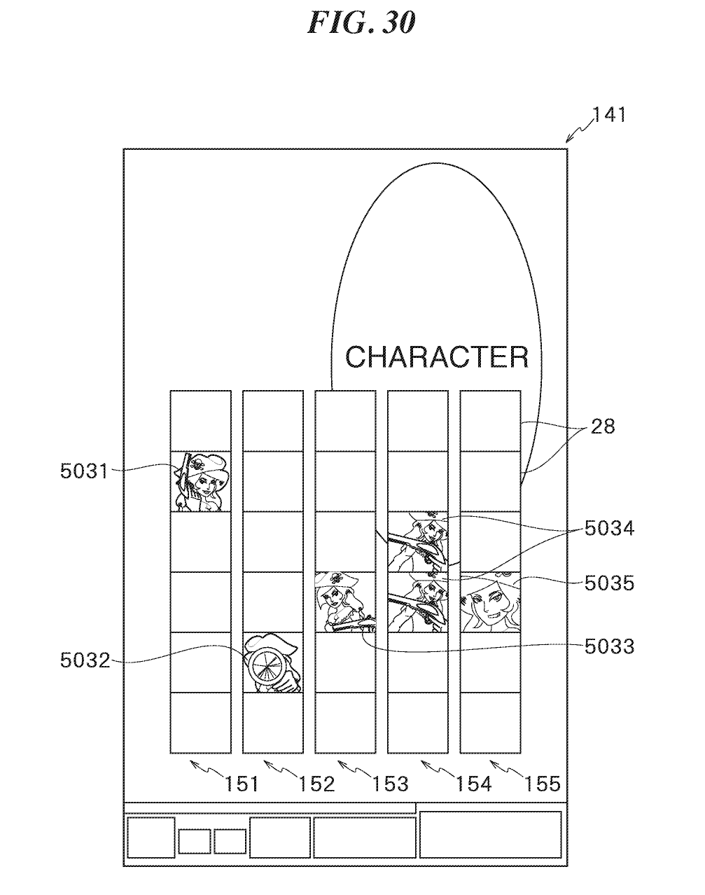

As shown in FIG. 30, when there is a line dividend from the top symbols 503a as a result of winning determination, different animations are displayed for each of the video reels 151 to 155 in the regions of the display blocks 28 in which the top symbol 503a is rearranged. Specifically, a top symbol animation 5031 dedicated for the video reel 151 is displayed in the video reel 151, a top symbol animation 5032 dedicated for the video reel 152 is displayed in the video reel 152, a top symbol animation 5033 dedicated for the video reel 153 is displayed in the video reel 153, a top symbol animation 5034 dedicated for the video reel 154 is displayed in the video reel 154, and a top symbol animation 5035 dedicated for the video reel 155 is displayed in the video reel 155. Different animations are used for each of the top symbol animations 5031 to 5035. As described above, different top symbol animations 5031 to 5035 are employed for each of the top symbols 503a rearranged in different video reels 151 to 155. As a result, each of the top symbol animations 5031 to 5035 of the top symbols 503a rearranged in the video reels 151 to 155 can be likened to a frame of a five-frame cartoon constituted of the top symbol animations 5031 to 5035 and add narrativity to the game.

Because only the top symbols 503a are displayed by the top symbol animations 5031 to 5035 which are different for each of the video reels 151 to 155, when there are line dividends of a plurality of types of symbols 501, it is highly possible that the player can easily recognize that there is a line dividend from the top symbols 503a. Consequently, it is possible to realize a new form of winning notification that notifies that the player is awarded a prize by the top symbols 503a, from which the highest dividend can be acquired.

(Display Screen: Bonus Selection (Branching Game))

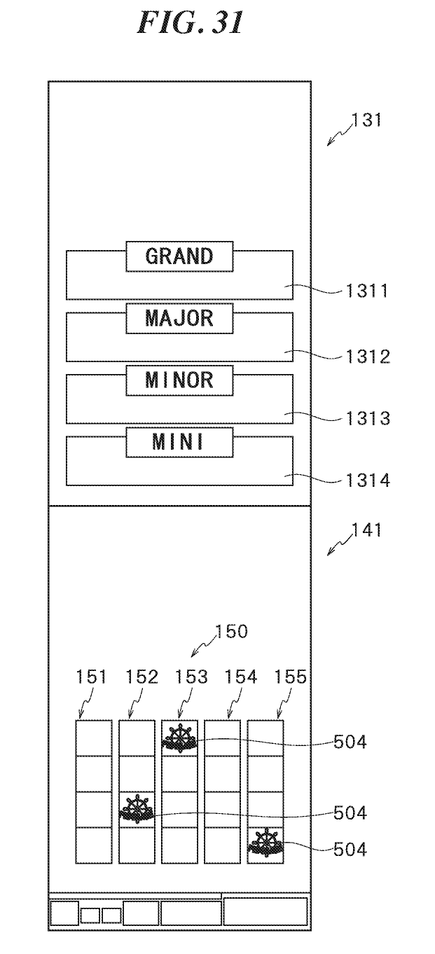

As shown in FIG. 31, when three or more feature symbols 504 are rearranged in the video reels 151 to 155 in the base game, a bonus selection is started.

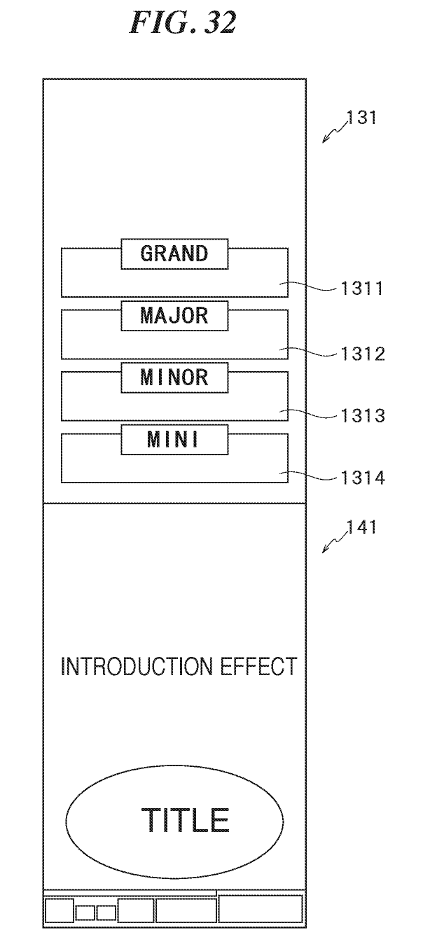

First, as shown in FIG. 32, when a bonus selection is started, a title logo is displayed and an introduction effect is produced in a lower part of the lower image display panel 141. The title logo of the bonus selection is displayed only during the introduction effect.

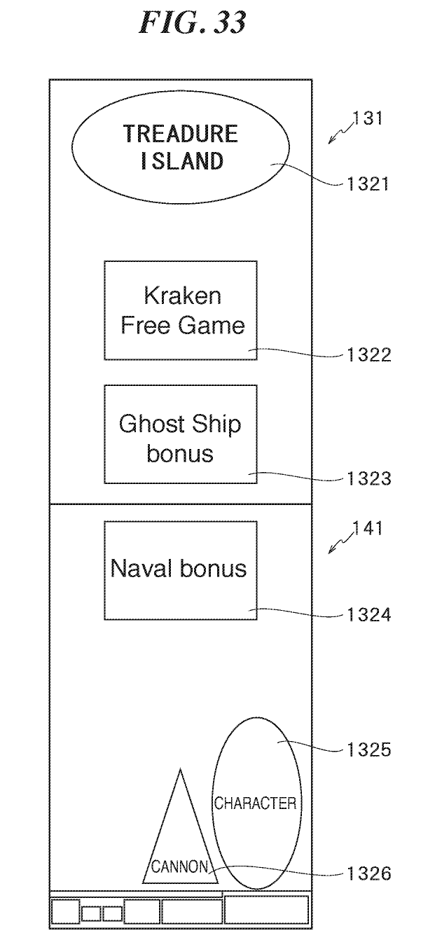

Next, as shown in FIG. 33, the grand progressive amount display part 1311, the major progressive amount display part 1312, the minor progressive amount display part 1313 and the mini-progressive amount display part 1314 are cleared from the upper image display panel 131. Then, a grand bonus game image 1321 representing the grand bonus game, a major bonus game panel image 1322 representing the major bonus game, and a minor bonus game panel image 1323 representing the minor bonus game are displayed on the upper image display panel 131. A mini-bonus game panel image 1324 representing the mini-bonus game is displayed in an upper part of the lower image display panel 141. The grand bonus game image 1321 is shown by an image of Treasure Island. Each of the panel images 1322 to 1324 has a rectangular pane in which a title logo representing the corresponding bonus game is shown. The panel images 1322 to 1324 have different background according to their superiority. A character 1325 and cannon 1326 are displayed in a lower part of the lower image display panel 141.

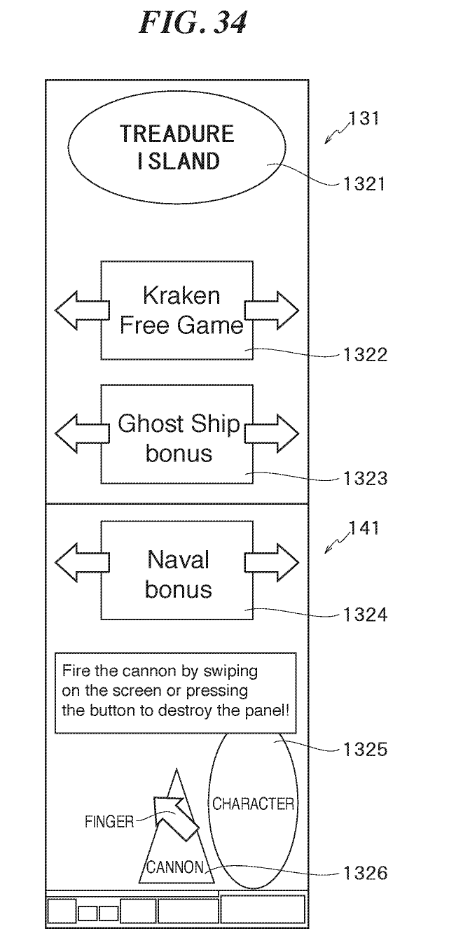

Next, as shown in FIG. 34, an instruction signboard on which rules are written is displayed. At this time, an effect is produced in which the panel images 1322 to 1324 move randomly to right and left. An image of a finger for instructing manipulation is displayed on the cannon 1326. In other words, an effect is produced in which cannonballs are shot in three directions, i.e., toward the upper left, upward and toward the upper right, by swiping the cannon 1326. While the instruction signboard is displayed, an effect is produced in which the image of a finger for instructing manipulation displayed on the cannon 1326 also moves in three directions, i.e., to the upper left, upward, and to the upper right. The instruction signboard is displayed for four seconds.

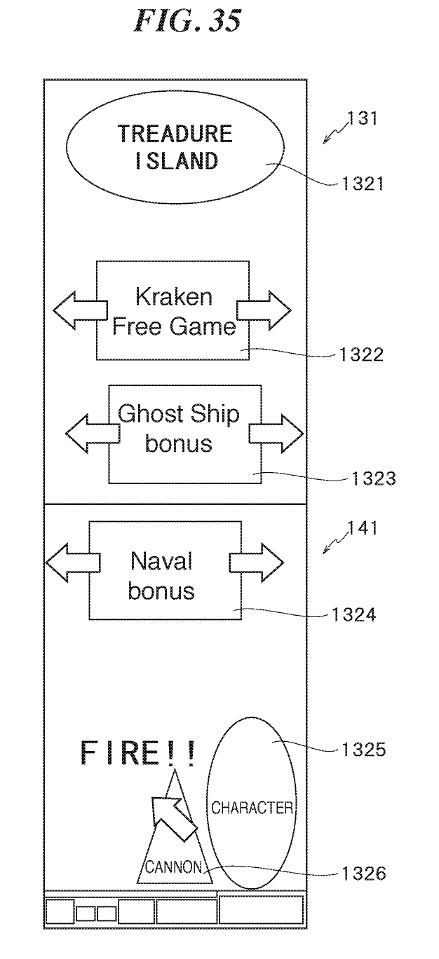

Next, as shown in FIG. 35, the text “FIRE!!” is displayed in the vicinity of the cannon 1326 after the instruction signboard is cleared. Along with the display of the text “FIRE! !,” a voice is output from the loudspeakers 112. When the player swipes the cannon 1326 on the lower image display panel 141 or presses a button on the control panel 30, the cannon 1326 is fired. At this time, an effect is produced in which the finger image for instructing manipulation moves only upward. The period of time during which the cannon 1326 can be fired is limited to 15 seconds.

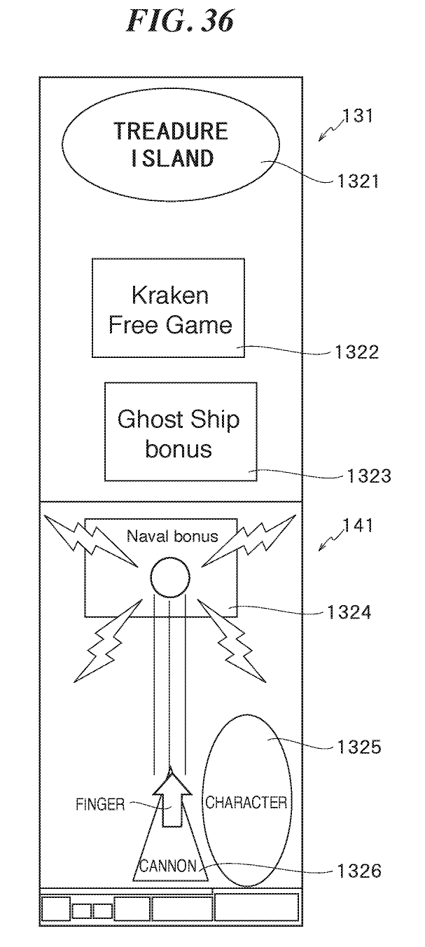

Next, as shown in FIG. 36, when the cannon 1326 is fired, an effect is produced in which a cannonball flies along an arcuate path toward the panel images 1322 to 1324. The cannonball proceeds in the direction in which the region of the cannon 1326 on the lower image display panel 141 is swiped. Specifically, when the region of the cannon 1326 is slid rightward on the lower image display panel 141, the cannonball proceeds upper right. When the region of the cannon 1326 is slid upward on the lower image display panel 141, the cannonball proceeds upward. When the region of the cannon 1326 is slid leftward on the lower image display panel 141, the cannonball proceeds upper left. When the cannon 1326 is fired by pressing a button on the control panel 30, the direction of the cannonball is randomly determined.

There are plural patterns of effects in which the way of flying of the cannonball are different. When the cannonball proceeds upward, there are three patterns; “overshoots,” “undershoots” and “hits.” When the cannonball proceeds toward the upper right or upper left, there are four patterns; “overshoots,” “undershoots,” “proceeds upward but misses” and “hits.” When the cannonball hits any of the panel images 1322 to 1324, an effect is produced in which the image gets cracked. When the cannonball hits one of the panel images 1322 to 1324 a specified number of times, an effect is produced in which the panel image is broken.

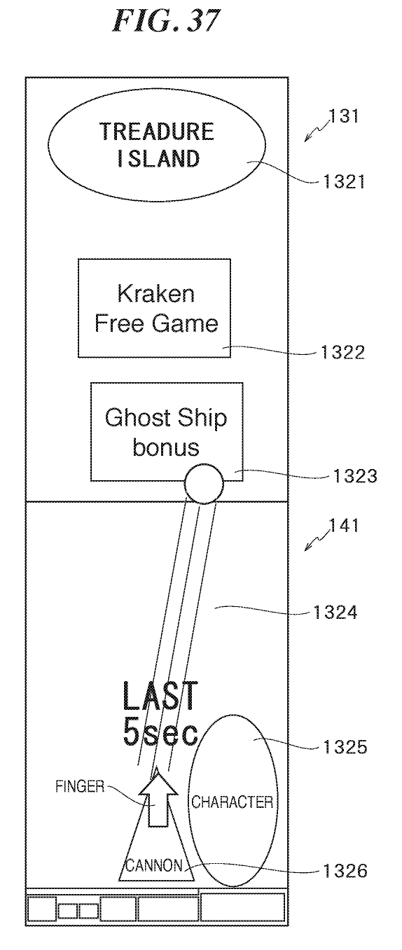

Next, as shown in FIG. 37, when the time limit approaches, countdown starts from five seconds above the cannon 1326 on the lower image display panel 141. When the time limit is reached before the player performs any manipulation to fire the cannon 1326, the same number of cannonballs as the panel images 1322 to 1324 remaining are automatically shot from the cannon 1326 and a previously determined bonus is offered. For example, when the previously determined bonus is the major bonus game, the mini-bonus game panel image 1324 is destroyed by the first cannonball and the minor bonus game panel image 1323 is destroyed by the second cannonball.

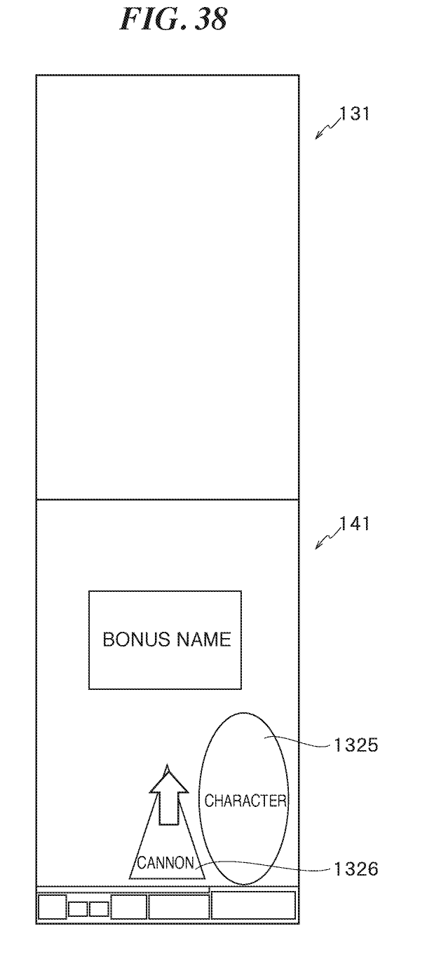

Next, as shown in FIG. 38, when the time limit is reached before all the panel images 1322 to 1324 are not destroyed, an effect is produced in which the lowermost panel image of the panel images 1322 to 1324 remaining undestroyed is moved to the center of the lower image display panel 141. All the panel images except the panel image corresponding to the determined bonus are cleared. Then, the voices of the characters 1325 determined for each bonus are output from the loudspeakers 112 after an effect is produced in which the character 1325 performs actions.

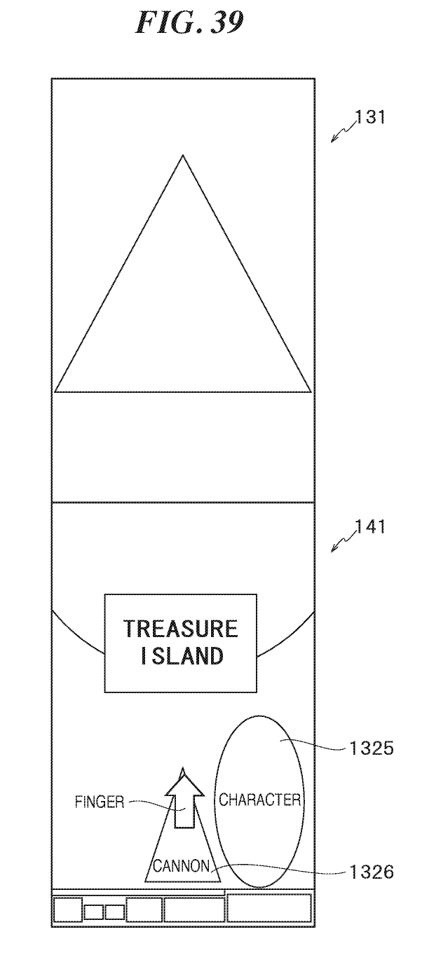

As shown in FIG. 39, when all the panel images 1322 to 1324 are destroyed before the time limit is reached, an effect is produced in which a vessel (not shown) with the character 1325 on board travels and reaches the grand bonus game image 1321 shown by an image of Treasure Island. Then, the voices of the characters 1325 determined for each bonus are output from the loudspeakers 112 after an effect in which the character 1325 performs actions is produced.

(Display Screen: Naval Battle (Mini-Bonus Game))

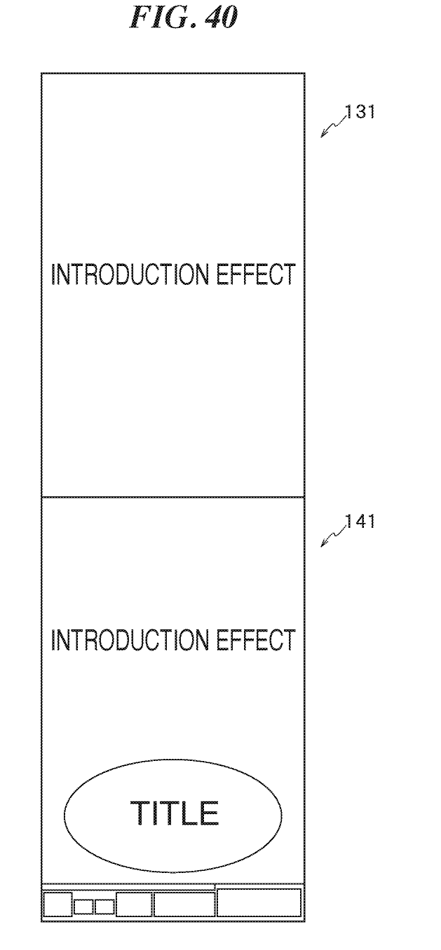

As shown in FIG. 40, when the mini-bonus game is selected in the bonus selection, an introduction effect is produced on the upper image display panel 131 and the lower image display panel 141. Specifically, an introduction effect of the story in which Naval Battle appears and a battle starts is produced. The title logo of Naval Battle is displayed only during the introduction effect.

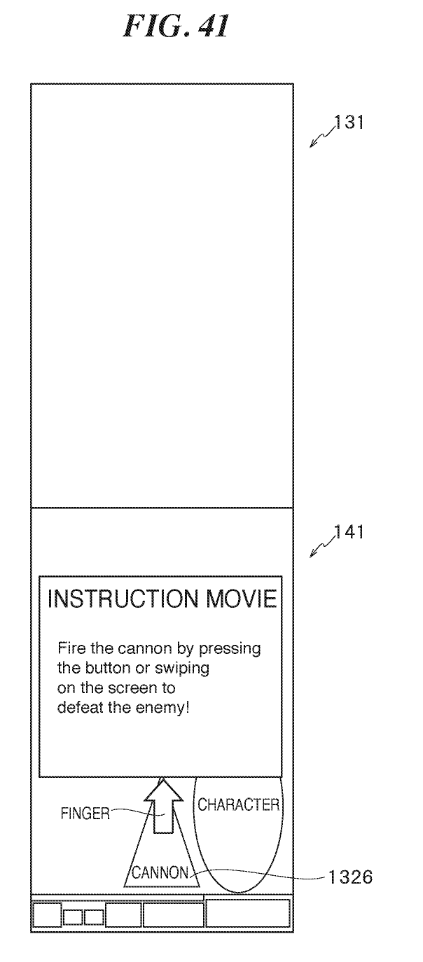

After that, as shown in FIG. 41, an instruction movie is displayed. Along with the display of the instruction movie, an animation is displayed in which an image of a hand swipes the cannon 1326 upward. An effect is produced in which cannonballs are shot in three directions, i.e., toward the upper left, upward and toward the upper right, by swiping the cannon 1326. While the instruction movie is displayed, an effect is produced in which the hand image displayed on the cannon 1326 also moves in three directions, i.e., to the upper left, upward and to the upper right. As the instruction movie, a video in which the cannon 1326 is fired to defeat sea soldiers is displayed. At this time, no dividend is displayed. The instruction movie becomes skippable three seconds after the start. Then, the text “Start” is displayed on the lower image display panel 141, and Naval Battle starts.

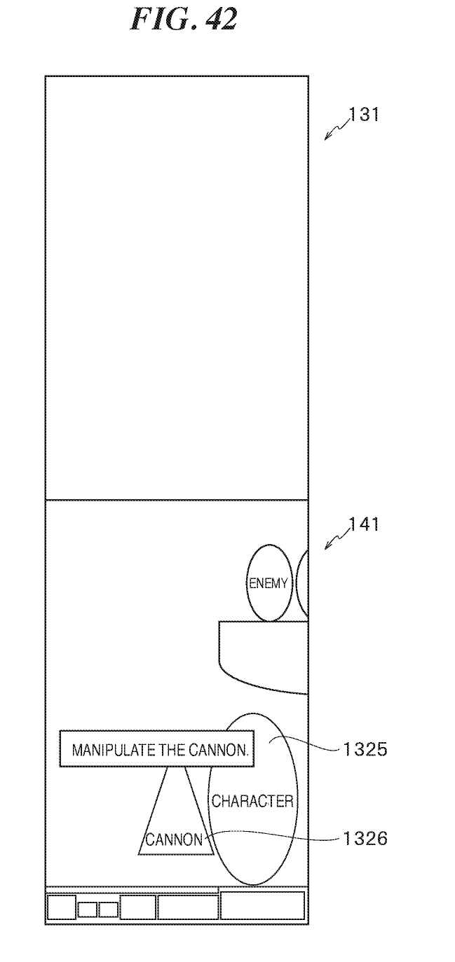

As shown in FIG. 42, when Naval Battle starts, a naval vessel ship with soldiers on board appears from the right side on the lower image display panel 141. Zako (Low-ranking) soldiers (enemies) line up on the naval vessel. The naval vessel scrolls from right to left to look as if it passes by the player's vessel. When the player does not perform any manipulation for three seconds, a message prompting the player to manipulate the cannon is displayed.

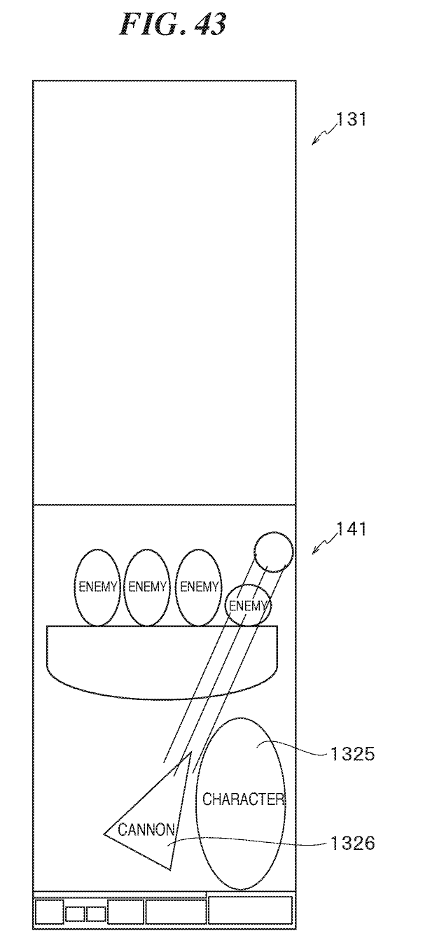

As shown in FIG. 43, one of the soldiers crouches at random once in every five seconds. Each solder crouches for five seconds, during which cannonballs from the cannon 1326 do not hit the crouching soldier.

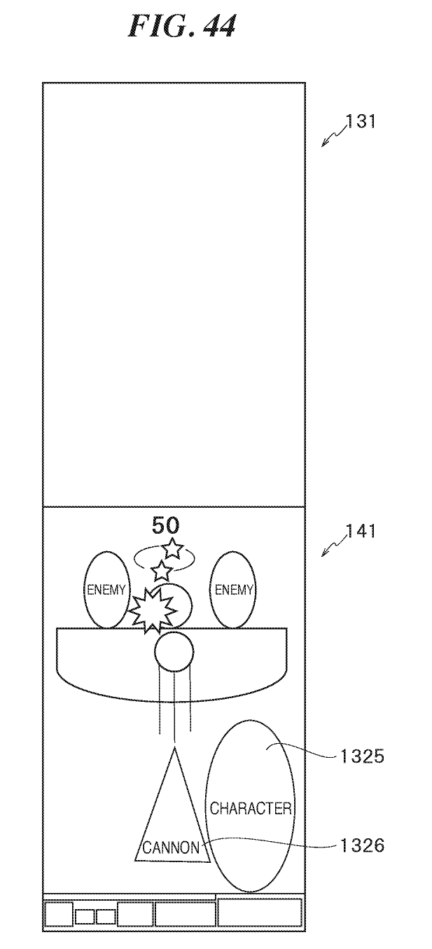

As shown in FIG. 44, when a cannonball from the cannon 1326 hits an enemy, an effect is produced in which the enemy loses consciousness, and a dividend amount is displayed above the head of the enemy. The displayed dividend amount is added to the WIN meter 400. In other words, no dividend is displayed until a cannonball hits an enemy. When no cannonball is shot from the cannon 1326, the naval vessel simply scrolls. The trajectories of the cannonballs from the canon 1326 are selected from only straight lines directed toward the upper left, upward and toward the upper right depending on the manipulation by the player. Twenty enemies in total appear on two vessels in this phase, and the game moves on to the next phase in 60 seconds.

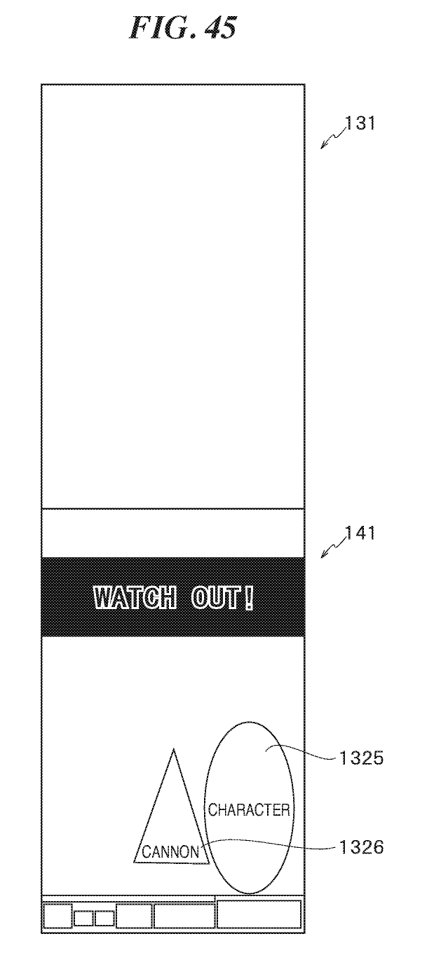

After that, as shown in FIG. 45, the message “WATCH OUT!” is displayed and a state in which no enemy appears is produced. During this time, the cannon 1326 cannot shoot any cannonball.

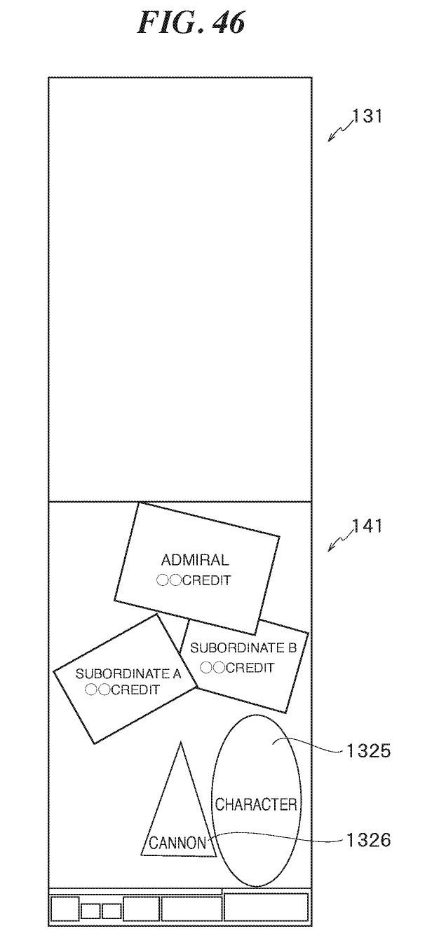

After that, as shown in FIG. 46, the dividends of an admiral character, a subordinate A character and a subordinate B character are displayed on poster-like signboards. During this time, the cannon 1326 cannot shoot any cannonball.

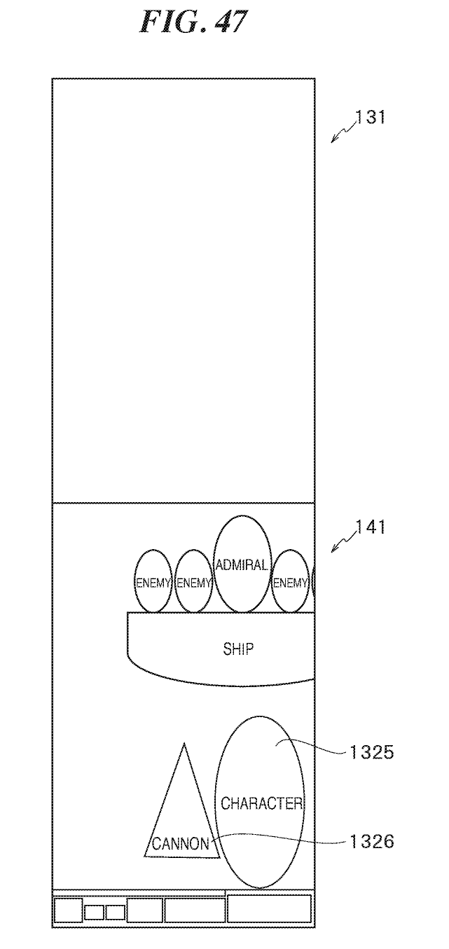

As shown in FIG. 47, the signboards shown in FIG. 46 are cleared, and then the admiral character and his four subordinate characters on a vessel are displayed. During this time, the cannon 1326 cannot shoot any cannonball. The subordinate A character and the subordinate B character are displayed in different colors and graphics.

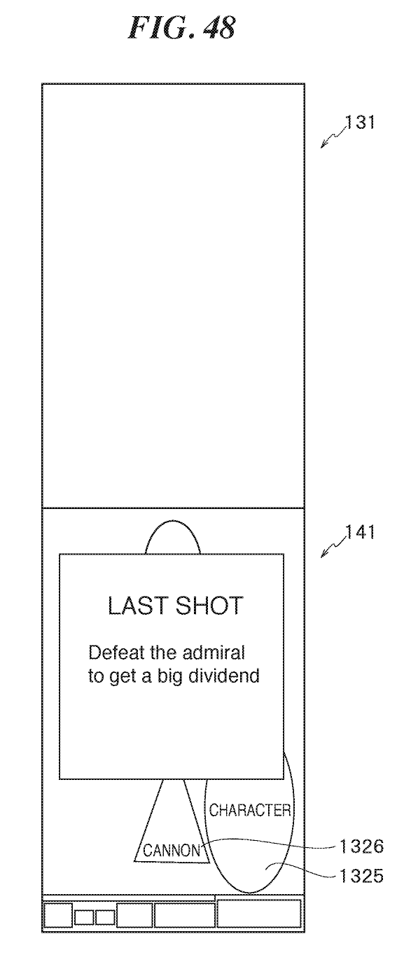

As shown in FIG. 48, when the admiral character and his four subordinate characters are placed in position, a signboard showing the rules of the subsequent battle with the admiral character is displayed. After the two seconds' display of the signboard, the game moves on to the next phase. During this time, the cannon 1326 cannot shoot any cannonball.

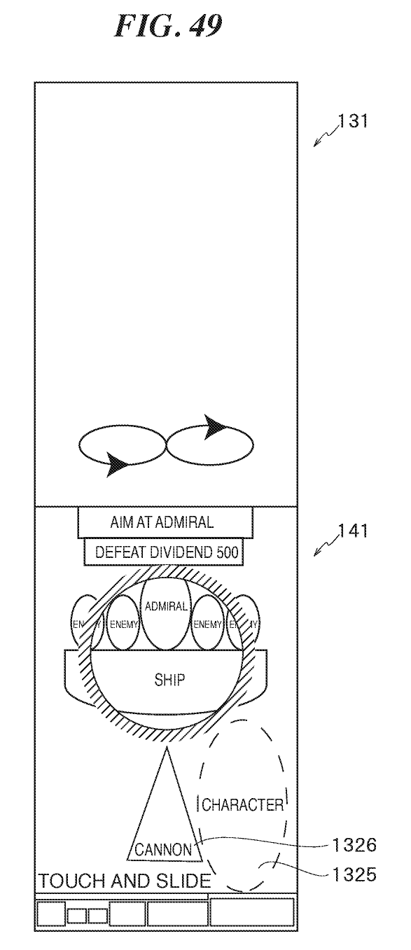

After that, as shown in FIG. 49, an effect is produced in which a gun is aimed at the admiral character and his four subordinate characters. The vessel with the admiral character and his four subordinate characters on board moves along a prescribed orbit, for example, in a figure of eight. At this time, the text “Aim at Admiral” and a text showing the dividend are displayed. A text urging the player to perform manipulation is displayed. This phase has no time limit, and a standby state is maintained until the player fires the cannon 1326 with the touch panel or a button.

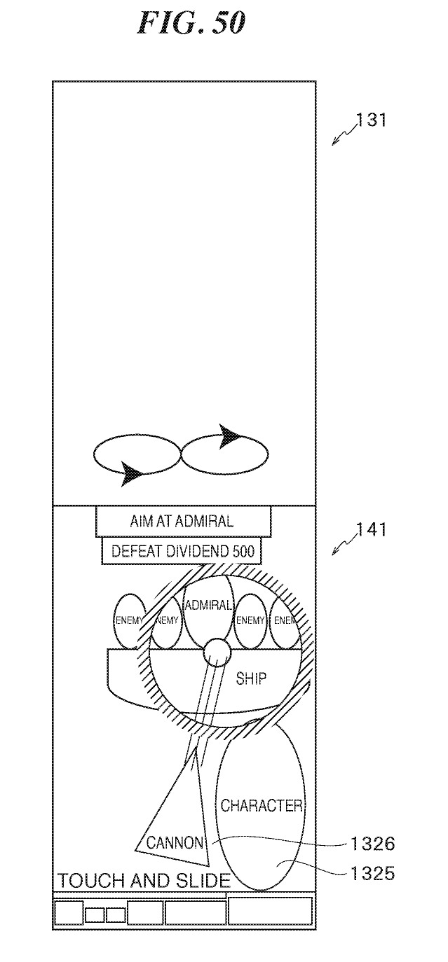

As shown in FIG. 50, the player can shoot cannonballs from the cannon 1326 at different angles. When the player performs a manipulation to fire the cannon 1326, an effect is produced in which a cannonball is shot from the cannon 1326. Simultaneously with the shooting, the text prompting the player to perform manipulation is cleared. The target of the cannonball from the cannon 1326 is previously determined. The cannonball certainly hits any of the characters, and a dividend is awarded.

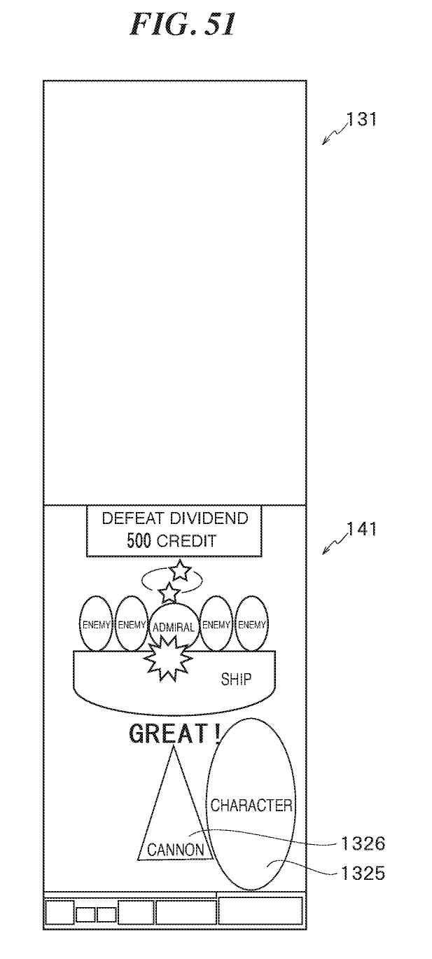

As shown in FIG. 51, when a cannonball hits the admiral character, an effect is produced in which the admiral is suffering from damage. Then, after the text “GREAT!” is displayed, a dividend signboard is displayed. After that, the displayed dividend is added to the win meter 402. Then, a scene in which the character 1325 is greatly delighted is displayed.

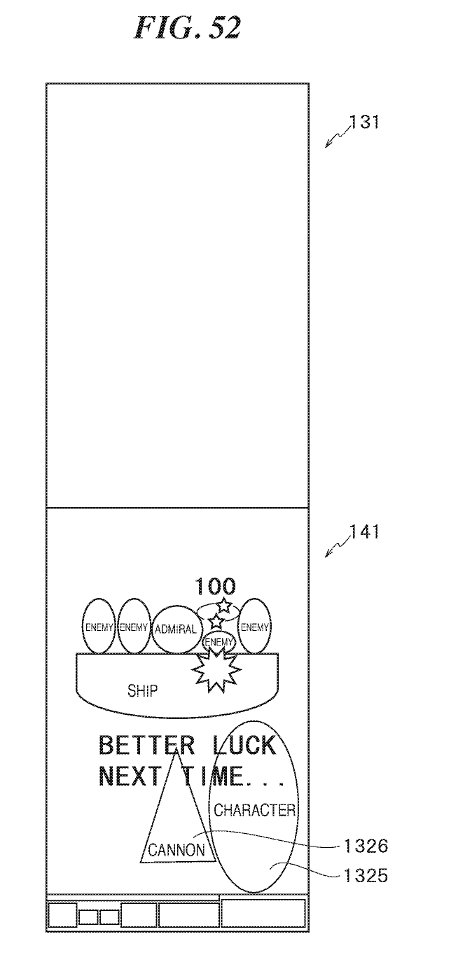

As shown in FIG. 52, when a cannonball hits a subordinate character, an effect is produced in which the subordinate is suffering from damaged. Then, the dividend amount is displayed in a highlighted fashion above the head of the subordinate. Then, after the text “Better luck next time . . . ” is displayed, a scene in which the character 1325 slightly rejoices is displayed.

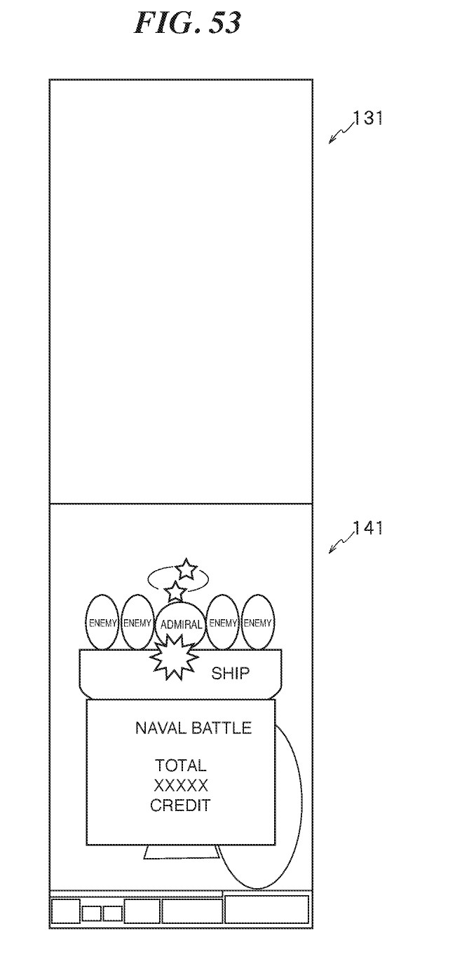

Then, as shown in FIG. 53, a total win signboard is displayed. The maximum digit number of the signboard is six. When the total win has reached 25 times or more of the bet number in the base game in which this bonus game is triggered, an effect is produced in which a rain of coins falls on the display screen. When the total win has reached 50 times or more of the bet number in the base game in which this bonus game is triggered, an effect is produced in which a rain of coins and jewels falls on the display screen. After that, if the player is awarded a jackpot game, the game moves onto the jackpot game. If the player is not awarded a jackpot game, the game returns to the base game.

(Display Screen: Ghost Ship Adventure (Minor Bonus Game))

As shown in FIG. 40, when the minor bonus game is selected in the bonus selection, an introduction effect is produced on the upper image display panel 131 and the lower image display panel 141. Specifically, an effect of the story in which a character gets on Ghost Ship and explores the inside of it is produced as the introduction effect. The title logo of Ghost Ship Adventure is displayed only during the introduction effect.

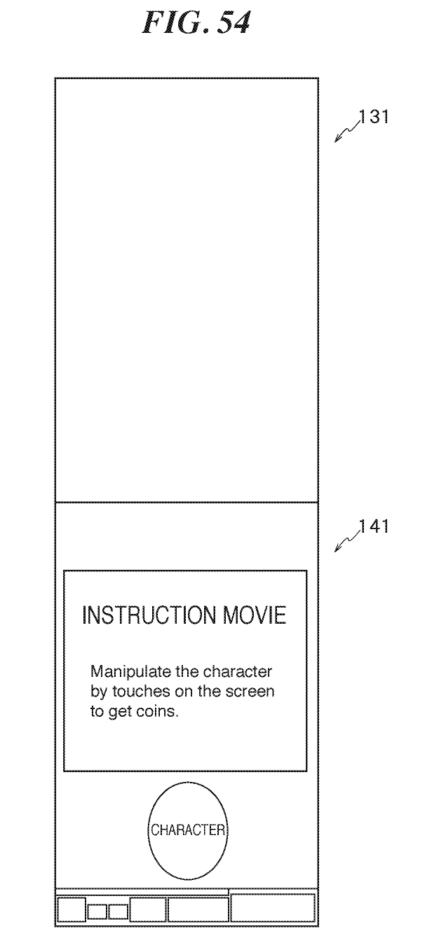

After that, as shown in FIG. 54, an instruction movie is displayed. As the instruction movie, an animation for instruction in which a character actually collects coins is displayed. In the instruction movie, the dividend that is awarded every time the character acquires a coin is also displayed. The instruction movie becomes skippable three seconds after the start of display. The text “start” is then displayed on the lower image display panel 141, and the minor bonus game is started.

As shown in FIG. 55, when the minor bonus game is started, a scene in which the character starts running down a corridor at a high speed is started. Specifically, an effect is produced in which the background of the character moves downward so that the character looks like running. The player can move the character to right and left by touching the lower image display panel 141. When the player is not touching the lower image display panel 141, a text prompting the player to perform manipulation is displayed, and the text is cleared when the player touches the lower image display panel 141. Coins are placed in front of the character (above the character on the lower image display panel 141), and move downward on the lower image display panel 141.

As shown in FIG. 56, the player moves the character to right and left by touching the lower image display panel 141, and can acquire dividends by overlapping the character with the coins moving downward. When the character overlaps with a coin, the coin moves upward and a dividend amount to be obtained is displayed on the coin. As described above, dividends (coins) can be acquired based on manipulation by the player (manipulation of the character). The acquired dividend is the total of the coin dividends acquired by overlapping the character with coins in such a corridor scene. The maximum digit number of the dividend amount that is displayed on the coins is five. The game moves on to the next phase every 10 second.

Obstacles are placed in addition to coins. When the character overlaps with an obstacle, the character performs the action of getting damaged and becomes semi-transparent. While the character is semi-transparent, no dividend can be achieved even when the character overlaps with a coin. As the obstacles, there exist barrels, wooden boxes, stings, falling lamps, wooden boxes that collapse sideways, rolling barrels, monsters that move sideways and so on. The moving obstacles include ones that form an obstacle in their destinations and ones that change the region they occupy when they move to an obstacle.

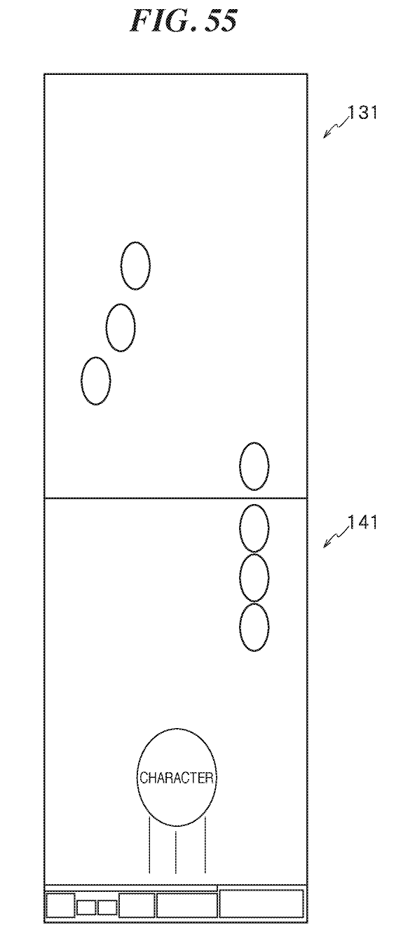

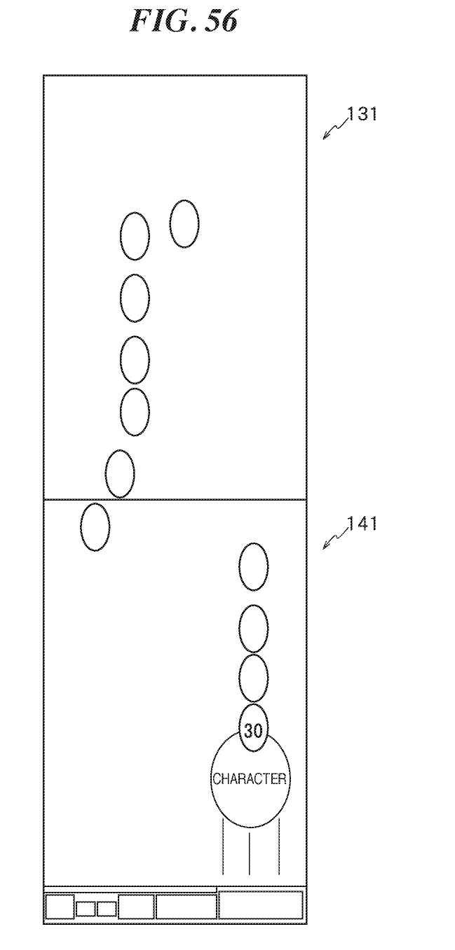

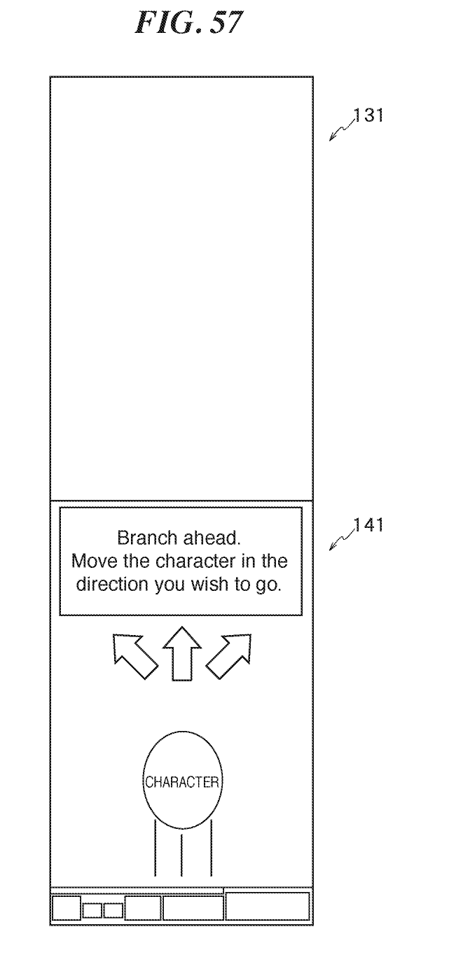

As shown in FIG. 57, before the game moves on to the next phase, a signboard notifying the existence of a branch is displayed. The branch occurs three seconds after the display of the notification signboard.

As shown in FIG. 58, the player selects from among three paths leading to different directions at the branch. The player can select a path to the desired direction by moving the character in the direction he or she wishes to go. There are the following two patterns of selecting a path. In other words, there is a pattern in which the player selects from among ascending stairs, descending stairs and going down a straight path and a pattern in which the player selects from among turning left, going down a straight path and turning right. An effect is produced in which the player eventually reaches a treasure house or a dead end after passing through a plurality of phases with such branches existing therebetween.

Specifically, as shown in FIG. 59, an effect is produced in which the character reaches a door. An effect is produced in which the motion of the character is slowed in front of the door. This can increase a sense of expectation of the player. A treasure is placed beside the door to further increase a sense of expectation of the player. Behind the door is the next stage, a treasure house or a dead end. When an effect is produced in which the door opens, it means that the player moves on to the next stage (phase) or enters the treasure house. When an effect is produced in which the door does not open, it means that the player has reached a dead end. When the player moves on to the next stage as a result of the door opening, a game in which the player collects more coins is restarted.

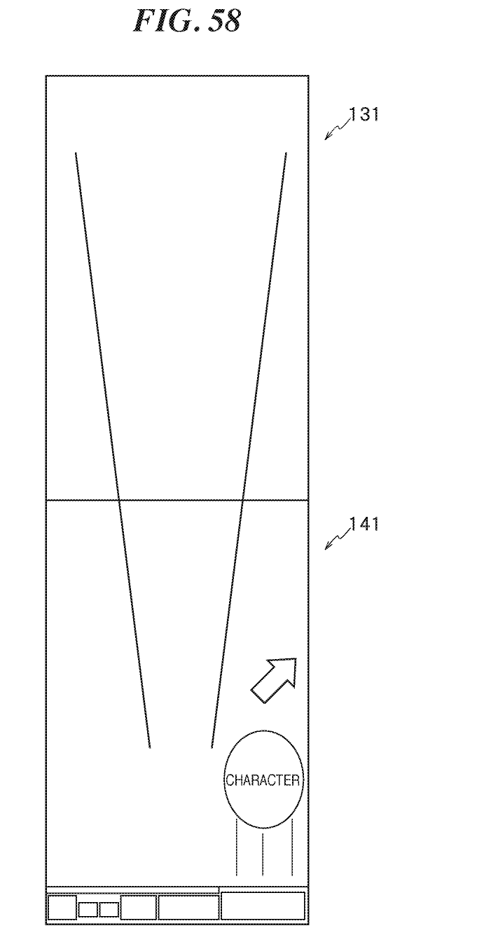

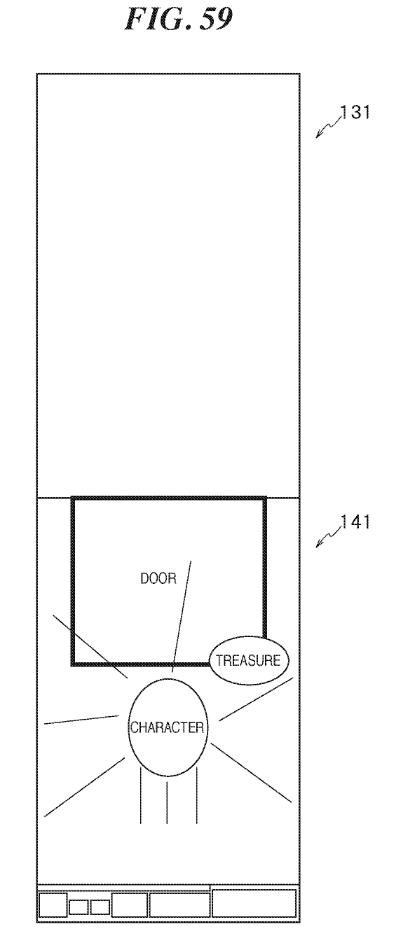

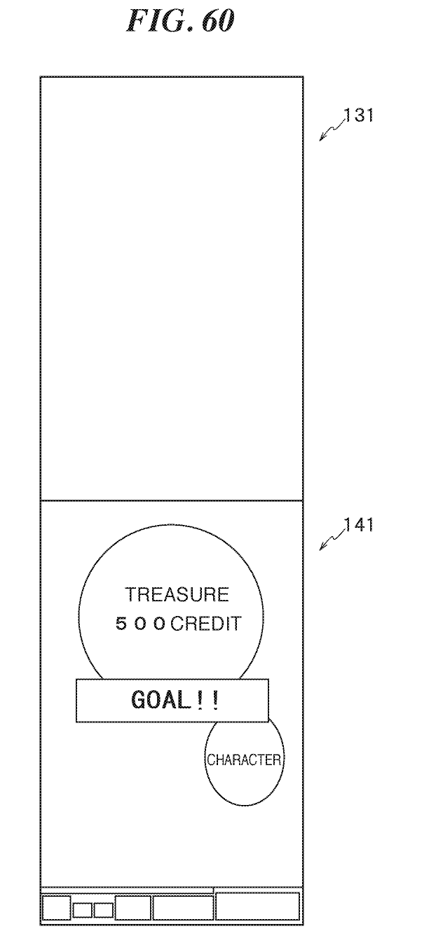

As shown in FIG. 60, when the player is in a treasure house as a result of the door opening, the player is awarded a further dividend (additional dividend) in addition to the dividend acquired by collecting coins. The video picture of the treasure house is selected from three types of video pictures with different amounts of treasures. The text “GOAL!!” is displayed together with an effect in which the character performs some action.

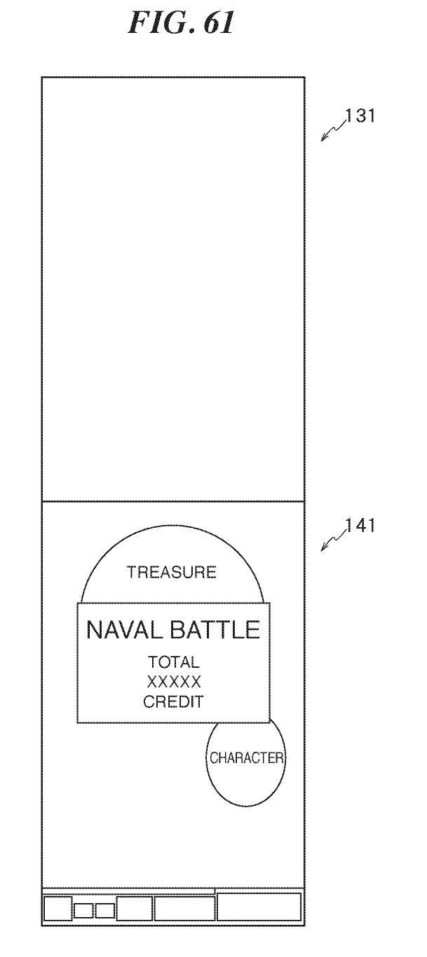

Then, as shown in FIG. 61, a total win signboard is displayed. The maximum digit number of the signboard is six. When the total win has reached 25 times or more of the bet number in the base game in which this bonus game is triggered, an effect is produced in which a rain of coins falls on the display screen. When the total win has reached 50 times or more of the bet number in the base game in which this bonus game is triggered, an effect is produced in which a rain of coins and jewels falls on the display screen. After that, if the player is awarded a jackpot game, the game moves onto the jackpot game. If the player is not awarded a jackpot game, the game returns to the base game.

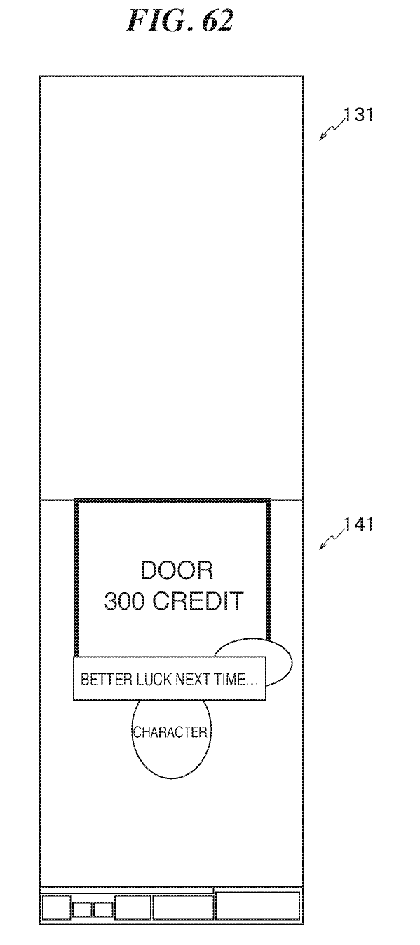

As shown in FIG. 62, when the door does not open and the player reaches a dead end, an effect is produced in which the character bumps into the door, and the voice of the character is output from the loudspeakers 112. The text “Better luck next time . . . ” is displayed on the screen. When the effect in which the character bumps into the door is produced, an effect is produced in which a treasure comes out of an object placed such as a barrel. After that, a total win signboard is displayed as shown in FIG. 61.

The video picture of the door is selected from among those of an ordinary door (first door), a steel door (second door), and a door locked with a chain (third door). When the player ends up with a dead end, the third door is most liable to be selected. Specifically, the first door has a weight of 20, the second door has a weight of 30, and the third door has a weight of 50. It is determined by lottery which of the video pictures of the doors is used. When the next stage is behind the door, the first door is most liable to be selected. Specifically, the first door has a weight of 60, the second door has a weight of 30, and the third door has a weight of 10. It is determined by lottery which of the video pictures of the doors is used. When a treasure house is behind the door, all the doors are selected by lottery with the same probability (all the doors have a weight of 33).

(Display Screen: Kraken Free Game (Major Bonus Game))

As shown in FIG. 40, when the major bonus game is selected in the bonus selection, an introduction effect is produced on the upper image display panel 131 and the lower image display panel 141. Specifically, an effect of a story in which Kraken comes to attack is produced as the introduction effect. The title logo of the Kraken Free Game is displayed only during the introduction effect.

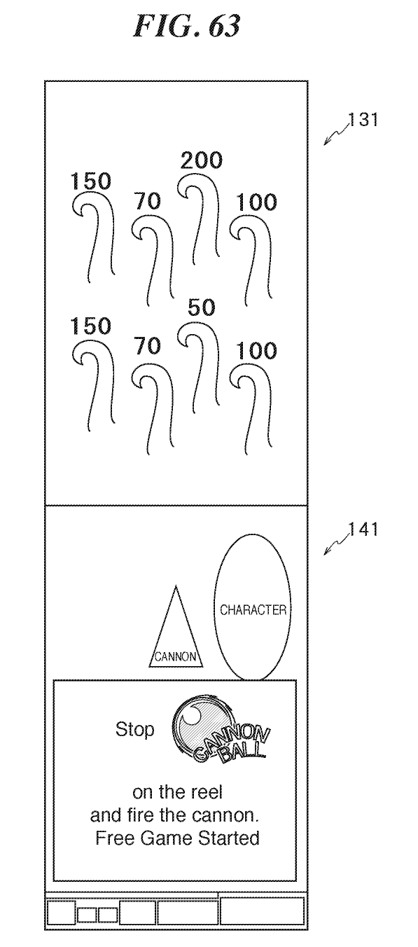

As shown in FIG. 63, after a scene in which Kraken dives into the sea after attacking the vessel with its legs is displayed, images of the Kraken's eight legs are displayed on the upper image display panel 131. A dividend is attached to each of the images of the legs of Kraken. After that, the voice of the character (“Defeat Kraken to get dividends!”) is output from the loudspeakers 112, and a signboard with the text “Free Game Started” is displayed. An instruction signboard is displayed in the entire reel pane. The text “Free Game Started” is skippable.

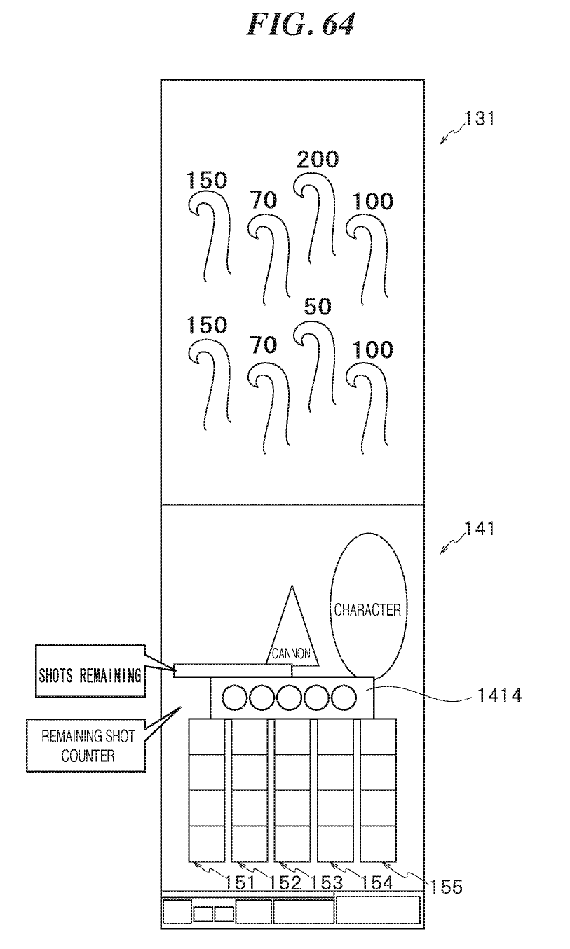

As shown in FIG. 64, the video reels 151 to 155 are fixed at four by five. A remaining shot counter 1414 is placed above the video reels 151 to 155 on the lower image display panel 141. The text “SHOTS REMAINING” is displayed above the remaining shot counter 1414. When no cannon symbol 506 is rearranged after the video reels 151 to 155 rotate, a winning effect similar to that in the usual base game is produced.

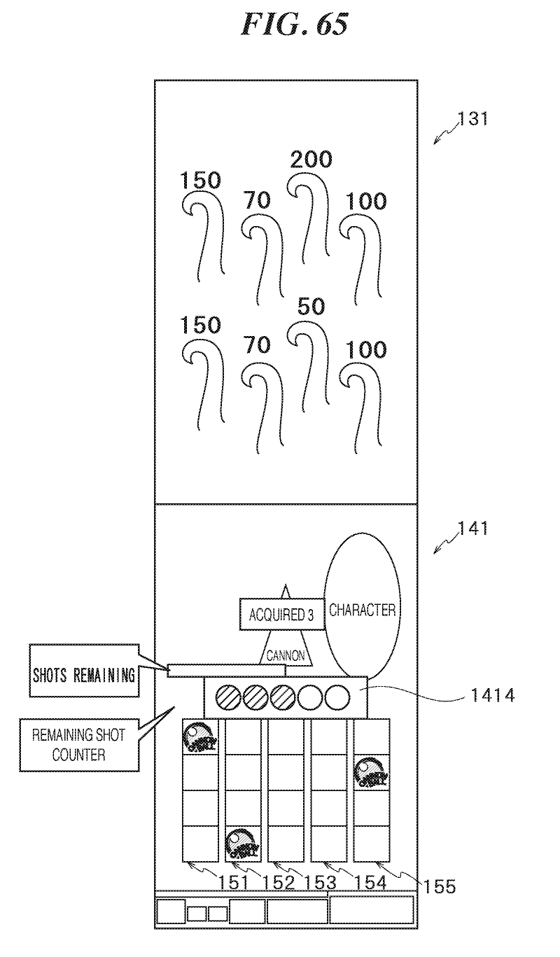

As shown in FIG. 65, when at least one cannon symbol 506 is rearranged after the video reels 151 to 155 rotate, the number of rearranged cannon symbols 506 is displayed in text and also displayed in the remaining shot counter 1414 simultaneously with the rearrangement.

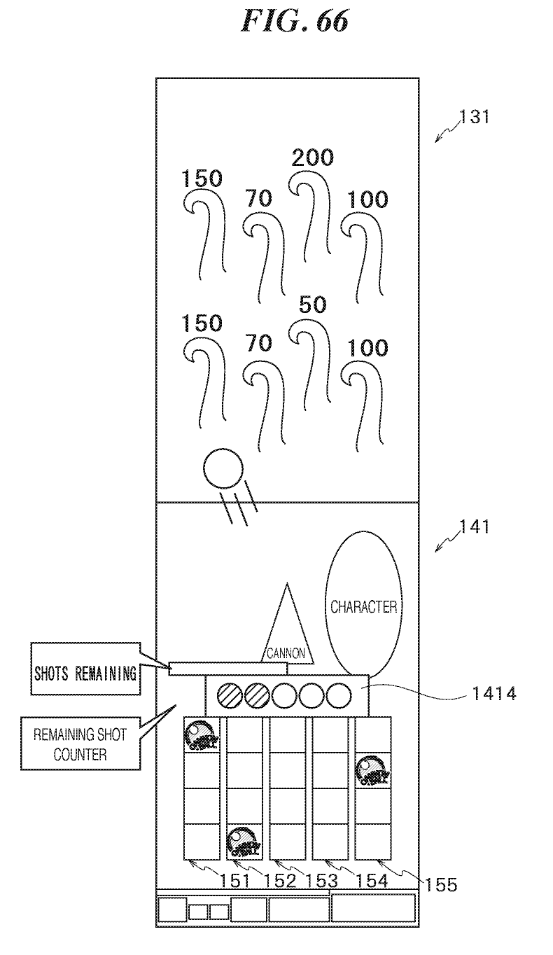

As shown in FIG. 66, after an animation of the character is displayed and the voice of the character is output from the loudspeakers 112, cannonballs are shot. Every time a cannonball is shot, a cannonball displayed in the remaining shot counter 1414 is cleared.

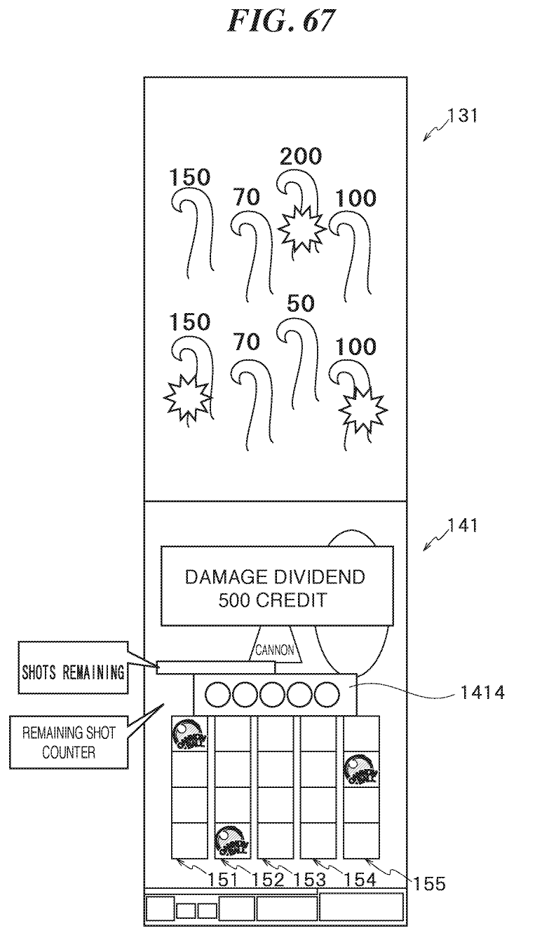

As shown in FIG. 67, when a cannonball hits a leg image on the upper image display panel 131, an animation in which the leg image is destroyed is displayed. Then, the total amount of the dividends attached to the destroyed leg images is displayed on a signboard. In addition, the total amount is added to the win meter 402. When there is a BIG WIN derived from a line dividend at the same time, the signboard showing the dividend acquired by destroying the leg images (damage dividend) is displayed for one second, and the BIG WIN is displayed after the signboard is cleared.

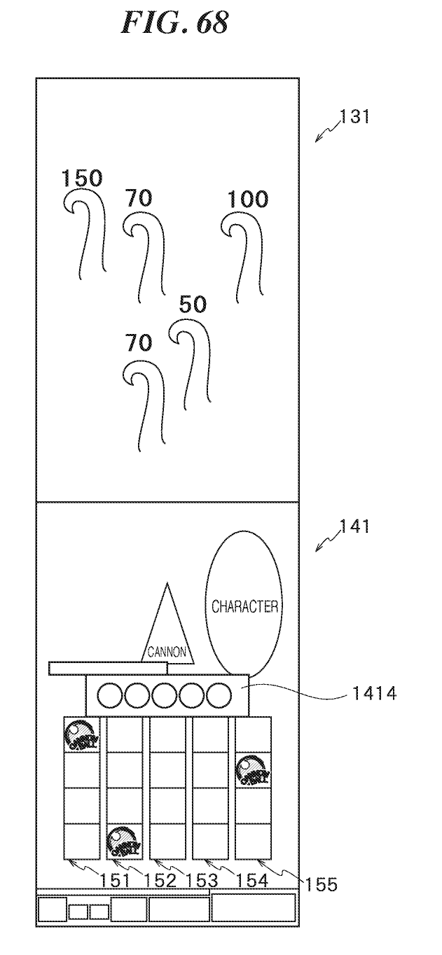

As shown in FIG. 68, the leg images destroyed by the cannonballs are cleared from the upper image display panel 131, and then the next free game is started. The free game is repeated until all the leg images on the upper image display panel 131 are cleared.

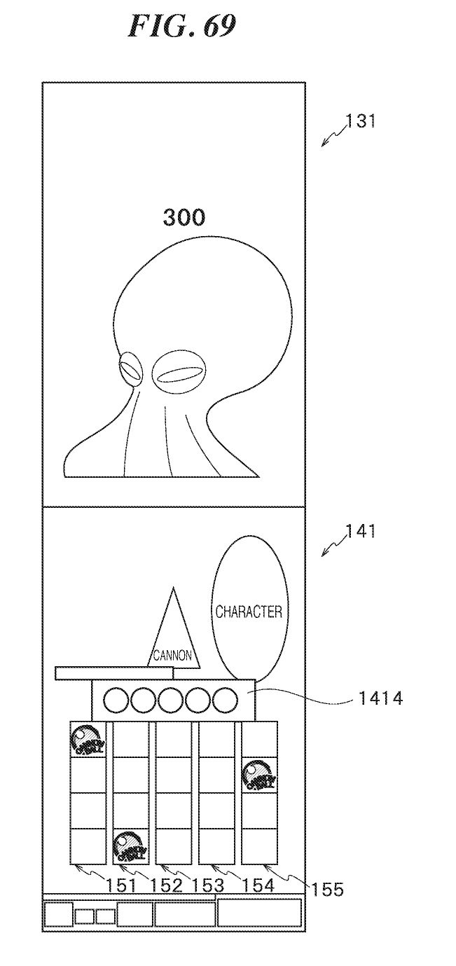

As shown in FIG. 69, when all the leg images are cleared, an image of the head of Kraken is displayed on the upper image display panel 131 after the text “WATCH OUT!” is displayed. When the cannonballs acquired in the same free game are used to clear the leg images and display the head image simultaneously, effects are produced in the following order. In other words, the total dividend acquired by destroying the legs is first displayed, and it is cleared after an effect is produced in which the character performs the action of delighting. Then, the text “WATCH OUT!” is displayed and cleared, and then the head image is displayed. After that, the voice of the character is output, and then the cannonballs remaining after destroying the leg images are shot. Then, the damage dividend derived from the head image is displayed on a signboard and added to the win meter 402.

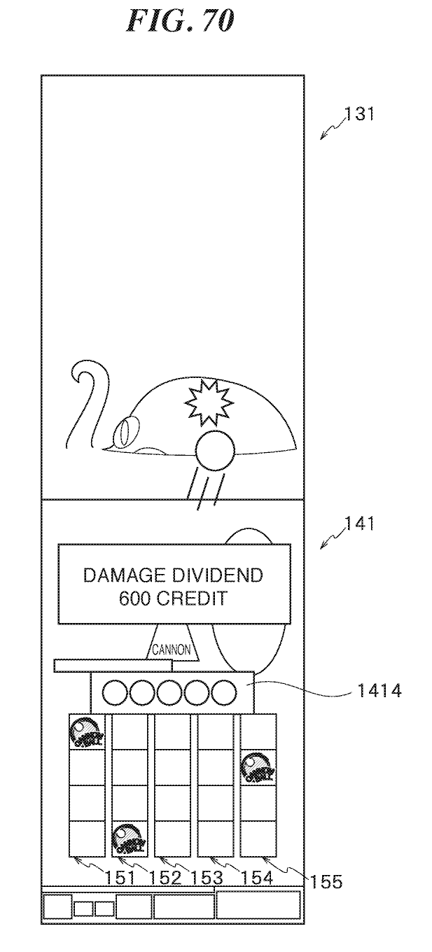

As shown in FIG. 70, the same number of cannonballs as the number of rearranged cannon symbols 506 can be shot from the cannon to acquire a dividend. The dividend is displayed on a signboard. When a plurality of cannonballs hits the head, the dividend amount on the signboard increases each time. When at least one cannon symbol 506 is rearranged in the last free game, an effect is certainly produced in which Kraken is destroyed. Specifically, the signboard showing the damage dividend is cleared before the last cannonball is shot, and the text “LAST SHOT” is displayed and the voice of the character is output. When the last cannonball hits, an effect is produced in which Kraken struggles in agony. Even when an effect in which Kraken is destroyed is produced, no additional dividend is awarded.

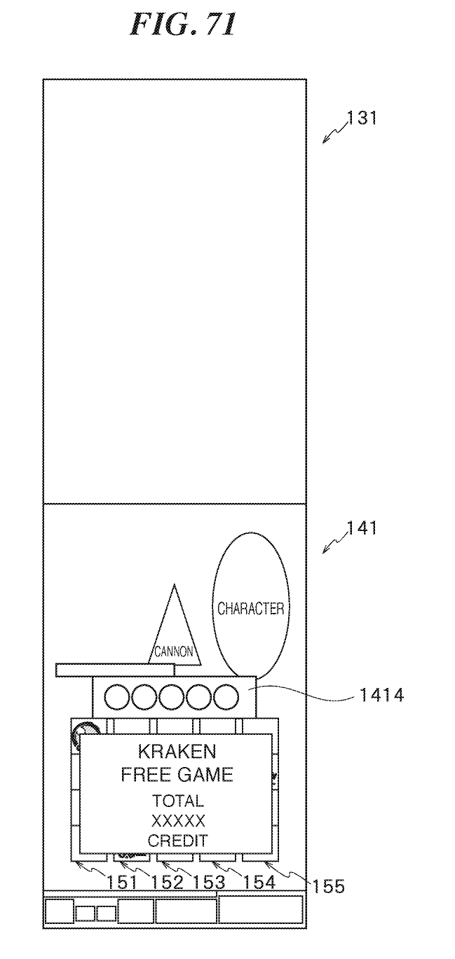

Then, as shown in FIG. 71, a total win signboard is displayed. The maximum digit number of the signboard is six. When the total win has reached 25 times or more of the bet number in the base game in which this bonus game is triggered, an effect is produced in which a rain of coins falls on the display screen. When the total win has reached 50 times or more of the bet number in the base game in which this bonus game is triggered, an effect is produced in which a rain of coins and jewels falls on the display screen. After that, if the player is awarded a jackpot game, the game moves onto the jackpot game. If the player is not awarded a jackpot game, the game returns to the base game.

(Display Screen: Treasure Island Bonus (Grand Bonus Game))

As shown in FIG. 40, when the grand bonus game is selected in the bonus selection, an introduction effect is produced on the upper image display panel 131 and the lower image display panel 141. Specifically, an effect of the story in which the player finds a treasure room while exploring Treasure Island is produced as the introduction effect. The title logo of Treasure Island Bonus is displayed only during the introduction effect.

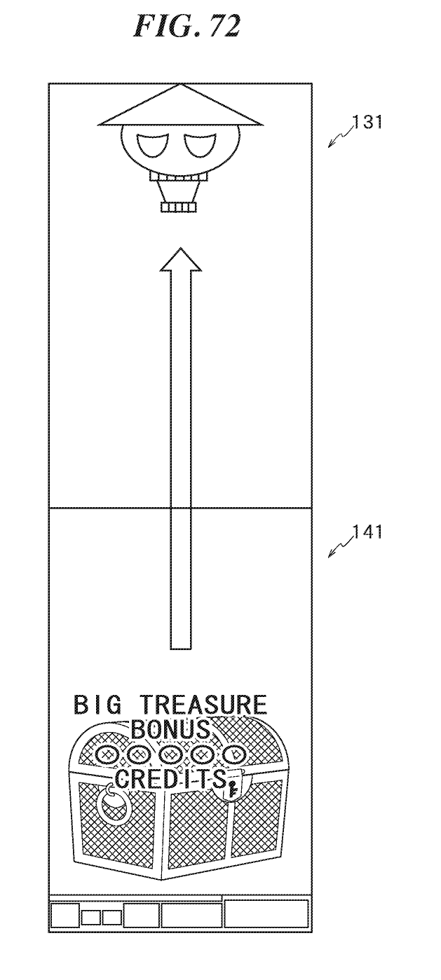

As shown in FIG. 72, a treasure chest is first displayed largely in a lower part of the lower image display panel 141. An instruction signboard is then displayed, and cleared three seconds later. The text “Select treasure chest and get dividend! Reach the end and you will acquire a big treasure bonus.” is displayed on the signboard. After that, an effect is produced in which Captain Skull appears on the upper image display panel 131 and brings a treasure chest up to an upper part of the lower image display panel 141. At this time, the voice of the Captain Skull saying that “I'm glad you are here. Good for you. Get the treasure!” is output from the loudspeakers 112. The text “BIG TREASURE BONUS” and the number of credits as the dividend are displayed on the treasure chest.

When the player does not perform any manipulation for three minutes during the advertisement, Captain Skull on the upper image display panel 131 moves his mouth as if he is speaking, and the voice of Captain Skull is output from the loudspeakers 112. When some credits are input while he is speaking, the effect during the Captain Skull's advertisement is skipped. The ON/OFF of the Captain Skull's speaking function can be switched by changing the settings (AUDIT). A plurality of patterns are prepared for the words he speaks, and one of them is selected at random. The speed at which Captain Skull opens and closes his mouth changes depending on the words he speaks. The setting item in the AUDIT is found in the following location: AUDIT->STTINGS->SOFTWARE SETTINGS. The speaking function is disabled when “DISABLE” is set for the function name “IDLE ADVERTISE VOICE” and is enabled when “ENABLE” is set.

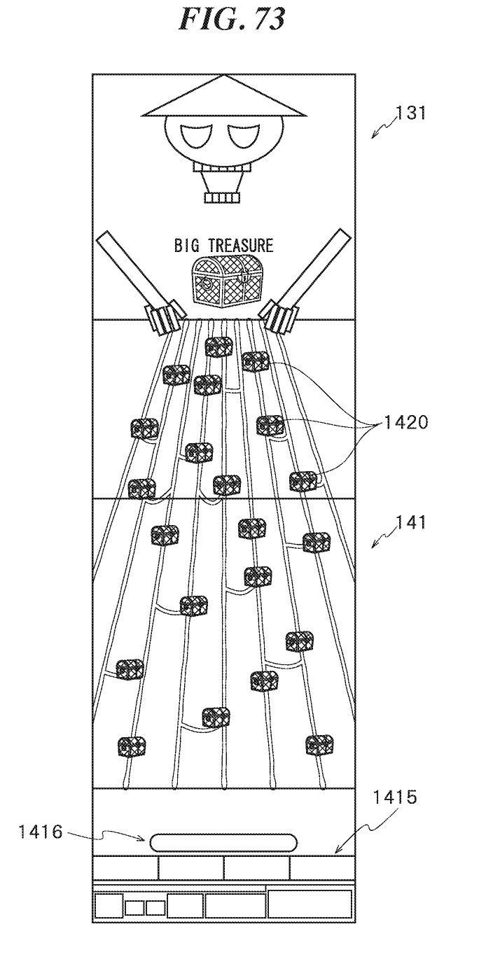

Next, as shown in FIG. 73, a standby screen is displayed. This screen is the basic display screen in the grand bonus game. Specifically, a dividend table 1415 for the grand bonus game is placed in a lower part of the lower image display panel 141. A key counter 1416 is placed above the dividend table 1415. The upper end of the lower image display panel 141 and the lower end of the upper image display panel 131 are connected to form a continuous region, and a web-shaped rope is displayed. A plurality of treasure chests 1420 are placed on the rope. In this embodiment, the plurality of treasure chests 1420 is the subjects of selection in the grand bonus game.

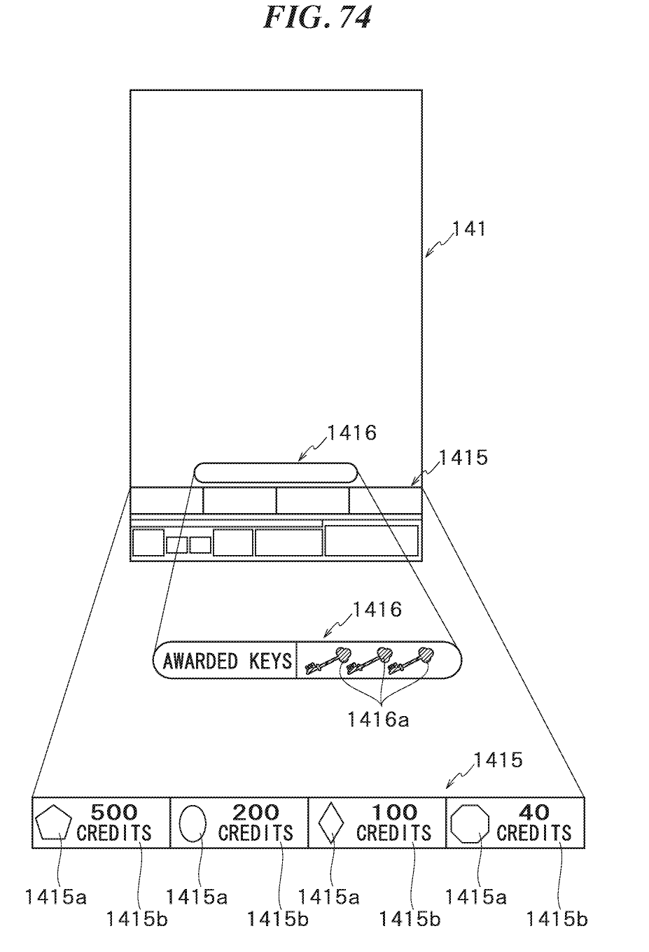

FIG. 74 is a diagram illustrating the dividend table 1415 and the key counter 1416 on the lower image display panel 141. In the dividend table 1415, a dividend amount 1415b is set for each of four types of jewels 1415a. Each of the four types of jewels 1415a is acquired as a result of a stage in which a treasure chest 1420 as a subject of selection in one stage is selected. In other words, any of the jewels 1415a is in the selected treasure chest 1420, a dividend amount 1415b set for the jewel 1415a is awarded.

The key counter 1416 has three key storage regions 1416a. Every time the player obtains a key from the selected treasure chest 1420, one key storage region 1416a changes to store a key. The probability of acquiring the goal dividend in the grand bonus game increases depending on the number of keys stored in the key storage regions 1416a.

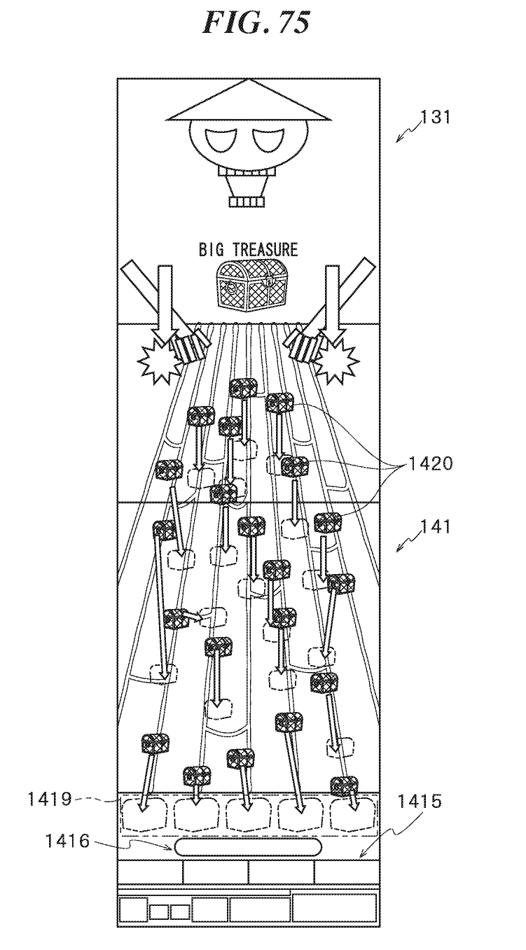

As shown in FIG. 75, when the grand bonus game is started, an effect is produced in which Captain Skull in an upper part of the upper image display panel 131 hits the ground and the screen shakes. Using this as a trigger, an effect is produced in which the treasure chests 1420 on the rope move toward the bottom of the screen. After the effect is produced repeatedly, a plurality of treasure chests 1420 are placed in an option placing region 1419 above the key counter 1416. Then, a text prompting the player to select one of the treasure chests 1420 is displayed.

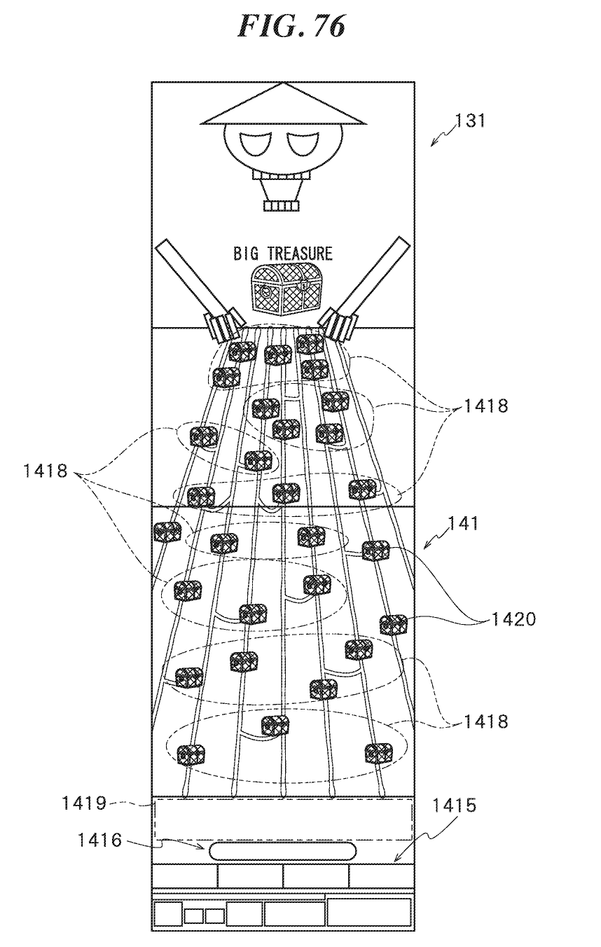

As shown in FIG. 76, sets (option sets 1418) of treasure chests 1420 to be lined up in the option placing region 1419 at the same time are previously determined among the plurality of treasure chests 1420 on the rope. In other words, an effect is produced in which the treasure chests 1420 included in one option set 1418 on the rope are sequentially lined up in the option placing region 1419. As shown in FIG. 76, the number of treasure chests 1420 in each option set 1418 is not constant, and an option number equal to or smaller than an upper limit is previously determined. As described above, in the grand bonus game, a stage in which the player is allowed to select a treasure chest 1420 from one option set 1418 can be repeated plural times. The treasure chests 1420 that are not included in the option sets 1418 among the plurality of treasure chests 1420 on the rope do not reach the option placing region 1419.

The contents of the option sets 1418 in one stage are previously determined as a map pattern. When the grand bonus game is started, a map pattern for use in the grand bonus game is selected from a plurality of map patterns. The map patterns are described later.

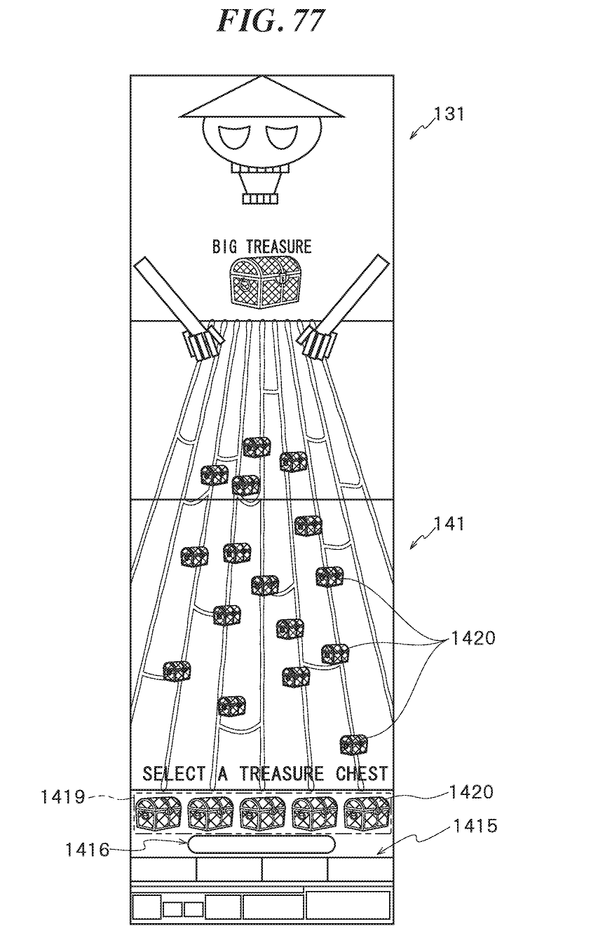

As shown in FIG. 77, when the treasure chests 1420 as options are placed in the option placing region 1419, the player can select one of the treasure chests 1420. In other words, the player is allowed to perform an input manipulation after all the treasure chest 1420 included in an option set 1418 are placed in the option placing region 1419. When any of the treasure chests 1420 is selected by the player, the content of the option is displayed as a stage result and the stage is terminated.

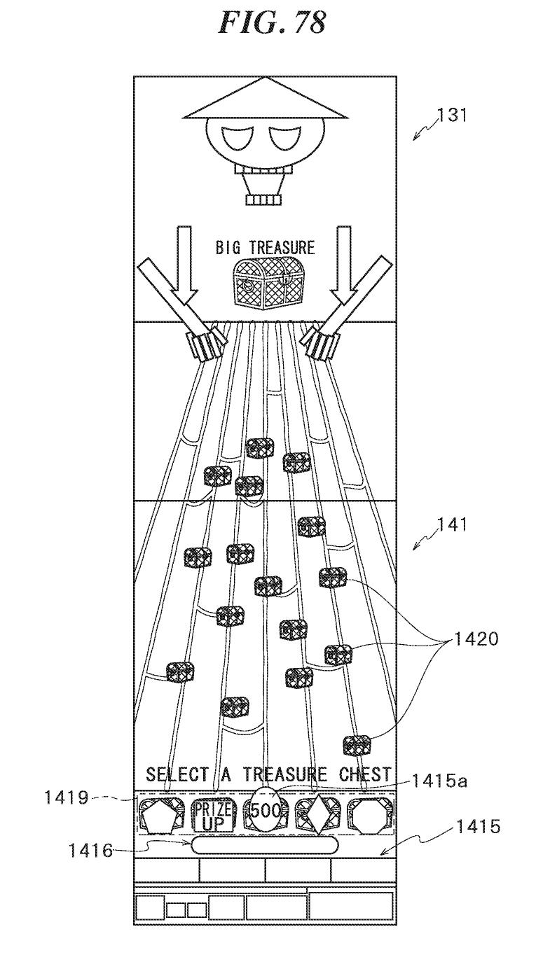

As shown in FIG. 78, when a jewel 1415a is in the treasure chests 1420 selected by the player, a dividend amount set for the selected jewel 1415a is displayed. When one option is selected from a plurality of options as described above, one stage is terminated. Then, as shown in FIG. 75, Captain Skull hits the ground, and treasure chests 1420 are placed in the option placing region 1419 to start the next stage.

As the contents of the treasure chests 1420, there are a prize-up and a monster in addition to the above-mentioned jewels 1415a. The prize-up functions as a prize-up option that increases the dividends from the jewels 1415a. Every time a prize up is selected, the dividend amount set for each type of jewel 1415a increases.

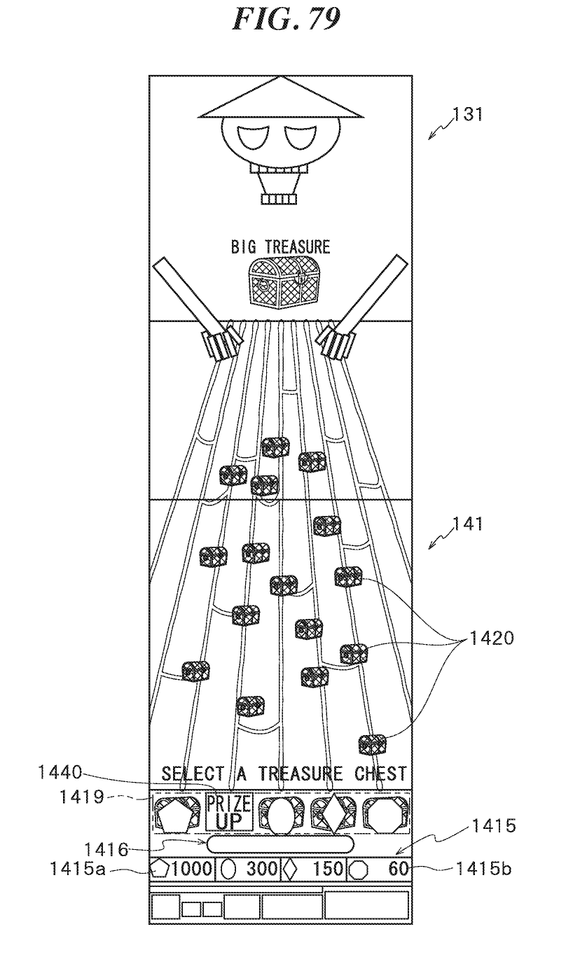

Specifically, as shown in FIG. 79, when a prize up 1440 is in the treasure chest 1420 selected by the player, the dividend amounts set for the jewels 1415a in the dividend table 1415 are increased. Specifically, an effect is produced in which the dividend amount 1415b set for each jewel 1415a in the dividend table 1415 is greatly expanded and changed to a font that looks shining and incremental displaying is carried out to increase the dividend amounts. When a prize up 1440 appears, the voice of Captain Skull saying “Mwahaha! You are clear-headed.” is output from the loudspeakers 112.

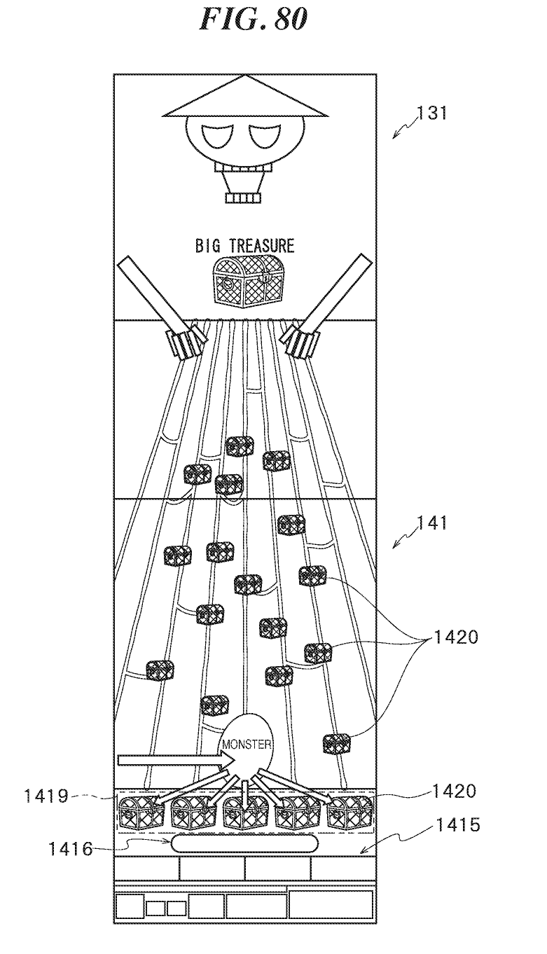

As shown in FIG. 80, when a monster is included in the option set, an effect is produced in which the emerged monster breaks up into pieces and those pieces enter all the treasure chests 1420 before the player is allowed to select one of the treasure chests 1420. At this time, the voice of Captain Skull saying “Watch out for the monster!” is output from the loudspeakers 112.

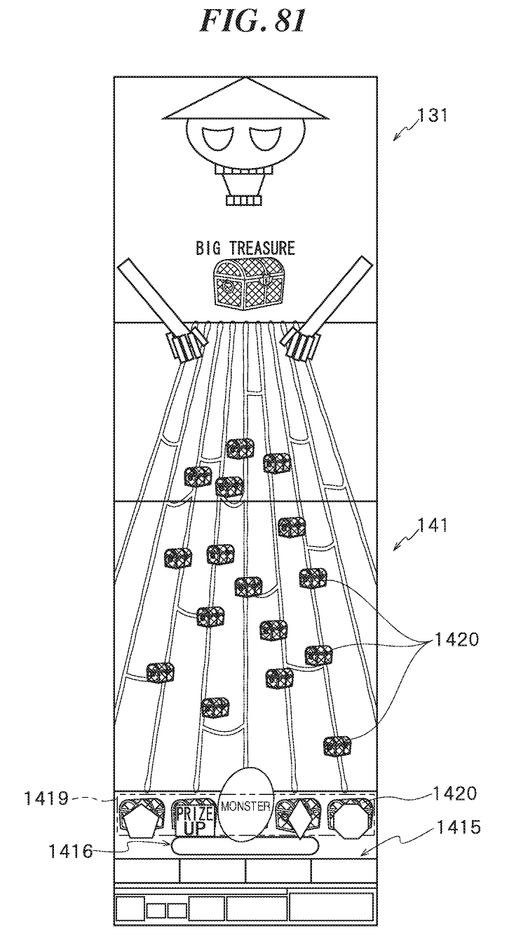

As shown in FIG. 81, when the monster appears from the treasure chest 1420 selected by the player, the grand bonus game is terminated without proceeding to the next stage or producing an effect for presenting a goal dividend. In other words, the monster is a terminating option that terminates the bonus game. When the monster appears, the voice of the monster saying “Gee!” is output from the loudspeakers 112. Then, the voice of Captain Skull saying “It's all over! Heehaw!” is output from the loudspeakers 112.

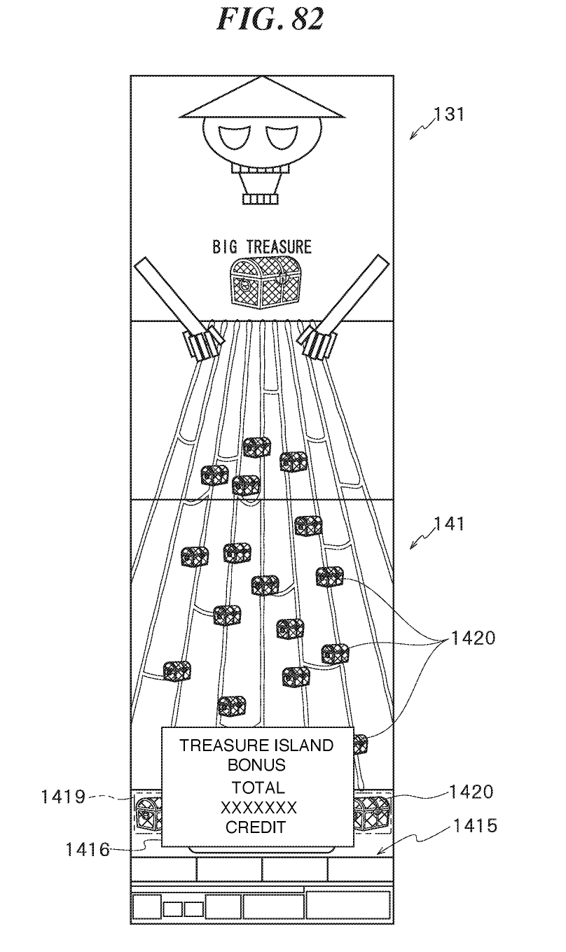

Then, as shown in FIG. 82, a total win signboard is displayed. The maximum digit number of the signboard is seven. When the total win has reached 25 times or more of the bet number in the base game in which this bonus game is triggered, an effect is produced in which a rain of coins falls on the display screen. When the total win has reached 50 times or more of the bet number in the base game in which this bonus game is triggered, an effect is produced in which a rain of coins and jewels falls on the display screen. After that, if the player is awarded a jackpot game, the game moves on to the jackpot game. If the player is not awarded a jackpot game, the game returns to the base game.

On the other hand, when all the stages set in a map pattern are completed before any terminating option is selected, an effect relating to the goal dividend is produced on the basis of the stage results in all the completed stages.

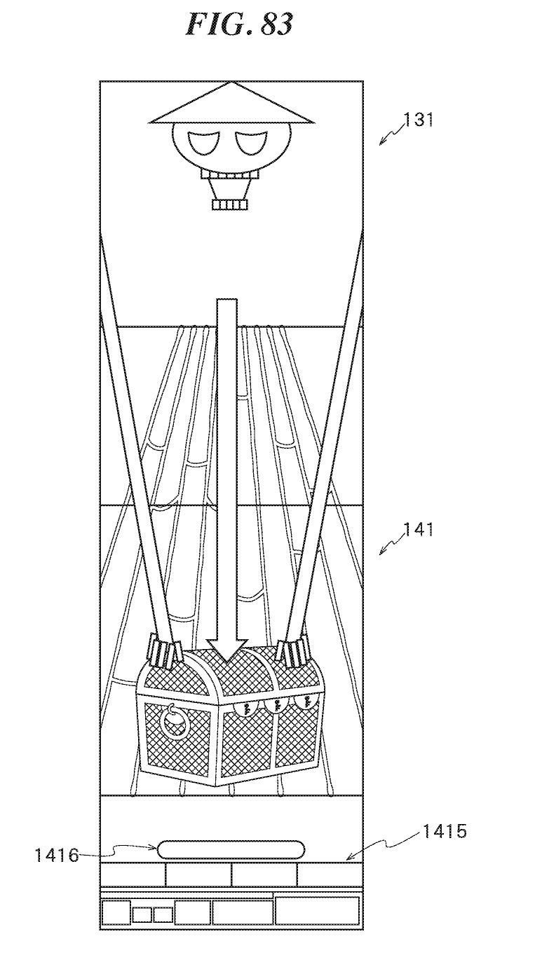

As shown in FIG. 83, when the last stage result is not the terminating option, an effect is produced in which Captain Skull grabs the treasure chest in upper part of the upper image display panel 131 and stretches his arms to move the treasure chest to the center of the lower image display panel 141. When the player can open the treasure chest having three key holes with the keys collected in the key storage regions 1416a of the key counter 1416, a goal dividend is awarded. The keys can be acquired at random together with the contents of the treasure chests 1420 when the treasure chests 1420 are opened in the previous stages.

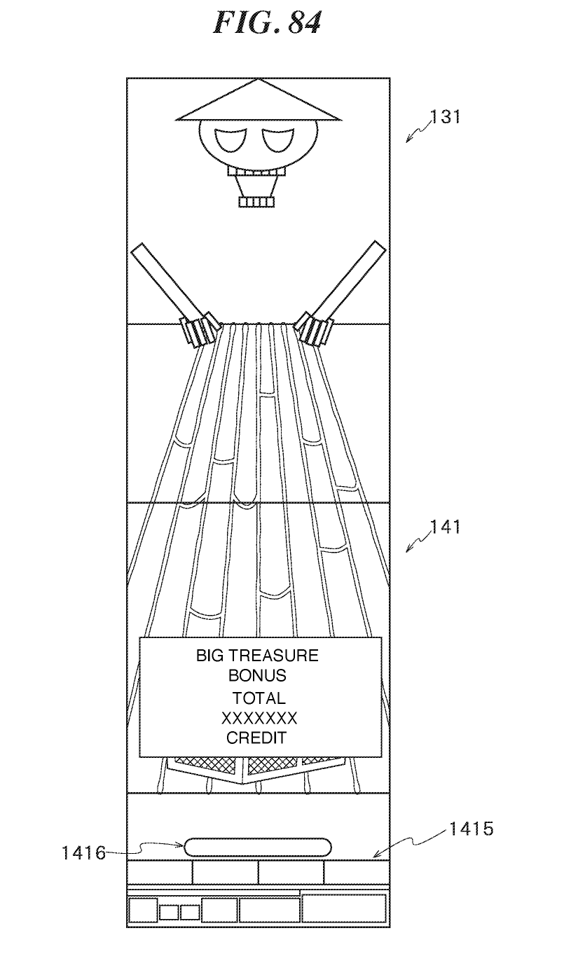

As shown in FIG. 84, when a goal dividend can be acquired, a big treasure bonus signboard showing the goal dividend is displayed. Specifically, this signboard is displayed after an effect is produced in which the treasure chest opens, and the dividend amount on the signboard is started to increment. The goal dividend is increased according to the number of times the prize up 1440 appeared in the previous stages. In other words, the goal dividend is set to a credit amount higher than that which has been set in the previous stage every time a prize up 1440 appears.

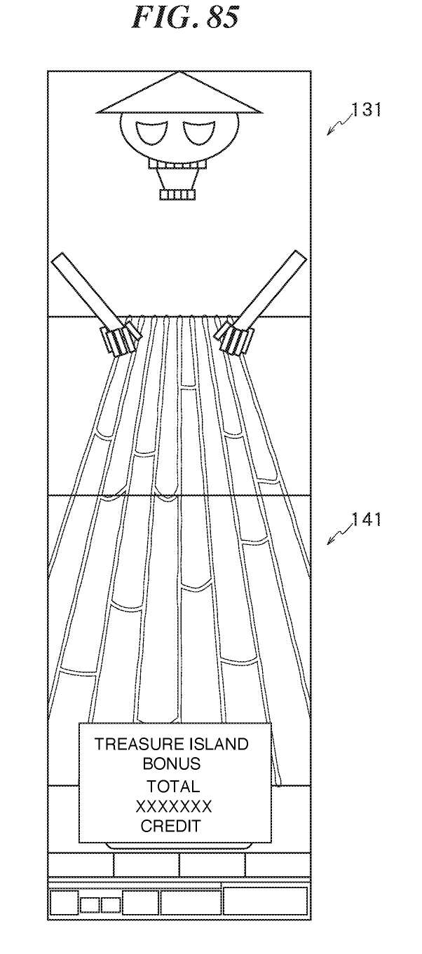

As shown in FIG. 85, a total win signboard is displayed after the big treasure bonus signboard is cleared. The maximum digit number of the signboard is seven. When the total win has reached 25 times or more of the bet number in the base game in which this bonus game is triggered, an effect is produced in which a rain of coins falls on the display screen. When the total win has reached 50 times or more of the bet number in the base game in which this bonus game is triggered, an effect is produced in which a rain of coins and jewels falls on the display screen. After that, if the player is awarded a jackpot game, the game moves on to the jackpot game. If the player is not awarded a jackpot game, the game returns to the base game.

(Display Screen: Challenge for Jackpot (Jackpot Game))

When a prescribed condition is fulfilled after each bonus game executed by the bonus selection is terminated, Challenge for Jackpot is executed at random.

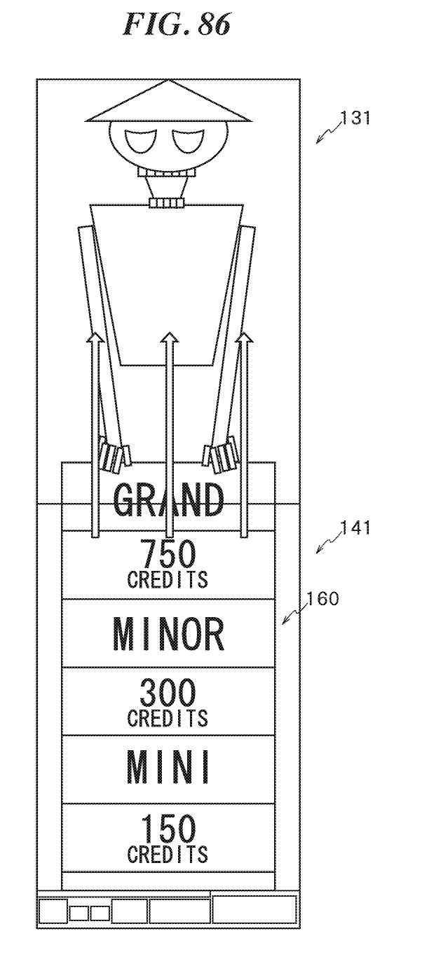

As shown in FIG. 86, when a jackpot game is started, an effect is produced in which Captain Skull pulls up a JP video reel 160 from a lower part of the lower image display panel 141 onto the upper image display panel 131.

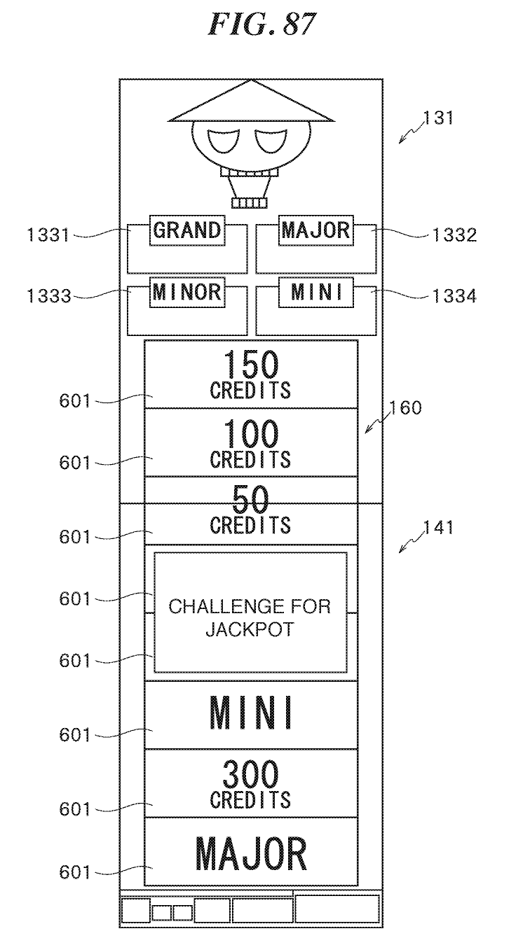

Then, as shown in FIG. 87, a title is displayed. The title is cleared after it is displayed for a predetermined period of time, and is not displayed during the jackpot game. A dividend table is displayed at the center of the upper image display panel 131. The dividend table includes a grand jackpot amount display part 1331, a major jackpot amount display part 1332, a minor jackpot amount display part 1333, and a mini-jackpot amount display part 1334. As described above, jackpot amounts are displayed in the dividend table.

The payouts of the jackpot amounts displayed in the grand jackpot amount display part 1331, the major jackpot amount display part 1332, the minor jackpot amount display part 1333 and the mini-jackpot amount display part 1334 may be referred to as “grand jackpot,” “major jackpot,” “minor jackpot” and “mini-jackpot,” respectively. They may be collectively referred to as “jackpot.” The jackpot may be also referred to as “progressive.”

The jackpot game is a game in which a symbol array of JP symbols 601 is scrolled in the JP video reel 160 displayed across a lower part of the upper image display panel 131 and the entire lower image display panel 141, and a dividend is offered on the basis of the result of the stoppage of the symbol array.

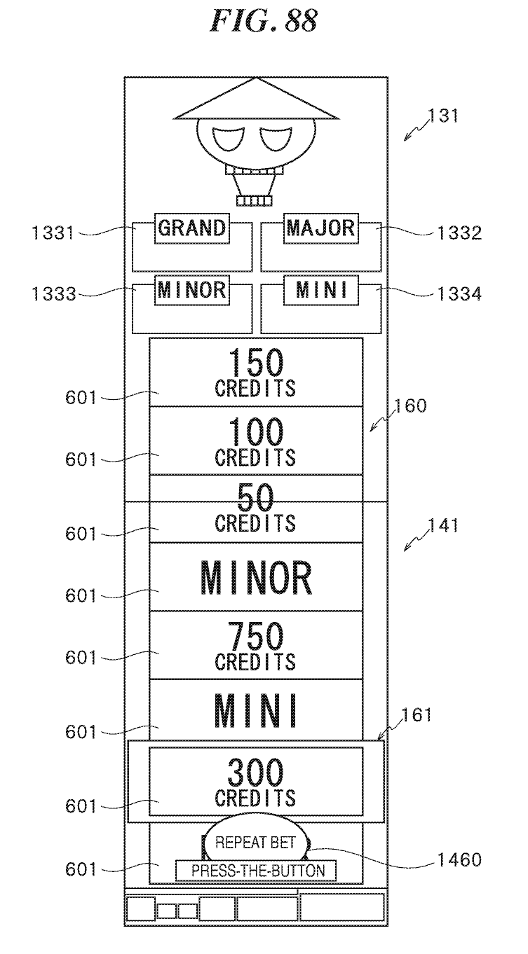

As shown in FIG. 88, a determination pane 161 showing a determination position is then displayed on the JP video reel 160. The determination position is set on the JP video reel 160, and the result is determined, depending on the content of the JP symbol 601 (determination subject symbol) that is stopped in the determination position. In other words, the content of the JP symbol 601 stopped in the determination position indicated by the determination pane 161 is awarded to the player. Then, a press-the-button image 1460 including an image of the repeat bet button 46 is displayed in a lower part of the lower image display panel 141, and the gaming machine waits in a state of prompting the player to perform an input manipulation.

The contents of the JP symbol 601 include grand jackpot, major jackpot, minor jackpot, mini-jackpot, various types of fixed dividend, and respin. When the JP symbol 601 of grand jackpot is stopped in the determination position, the jackpot amount displayed in the grand jackpot amount display part 1331 is given. When the JP symbol 601 of major jackpot is stopped in the determination position, the jackpot amount displayed in the major jackpot amount display part 1332 is given. When the JP symbol 601 of minor jackpot is stopped in the determination position, the jackpot amount displayed in the minor jackpot amount display part 1333 is given. When the JP symbol 601 of mini-jackpot is stopped in the determination position, the jackpot amount displayed in the mini-jackpot amount display part 1334 is given. When the JP symbol 601 of any of the various types of fixed dividend is stopped in the determination position, the same number of credits as the number displayed in the JP symbol 601 is offered. When the JP symbol 601 of respin is stopped in the determination position, a respin for stopping the JP video reels 160 can be executed one more time. In the respin, one is added to the number of the determination subject symbols before the respin. For example, when the number of the determination subject symbols is one, the number is increased to two and the determination position indicated by the determination pane 161 is expanded to include two JP symbols 601.

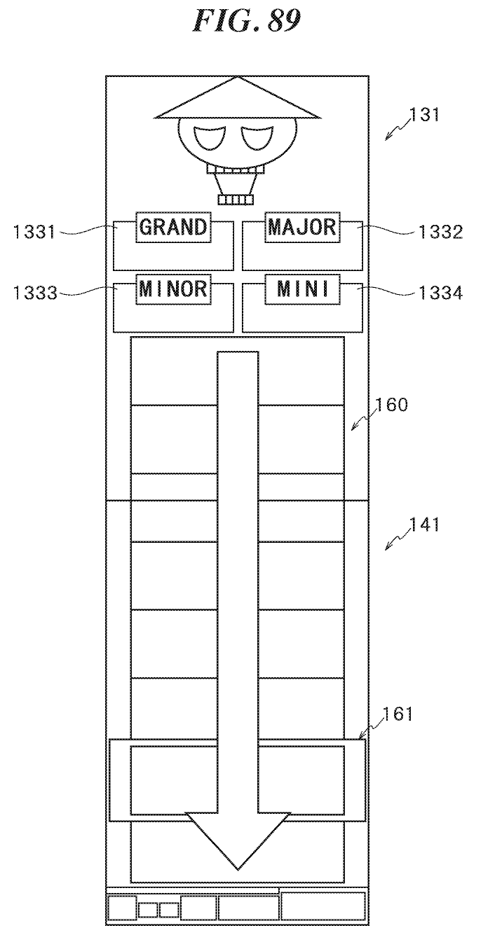

As shown in FIG. 89, when the repeat bet button 46 is pressed, the JP video reel 160 starts scrolling. The scroll of the JP video reel 160 is automatically stopped.

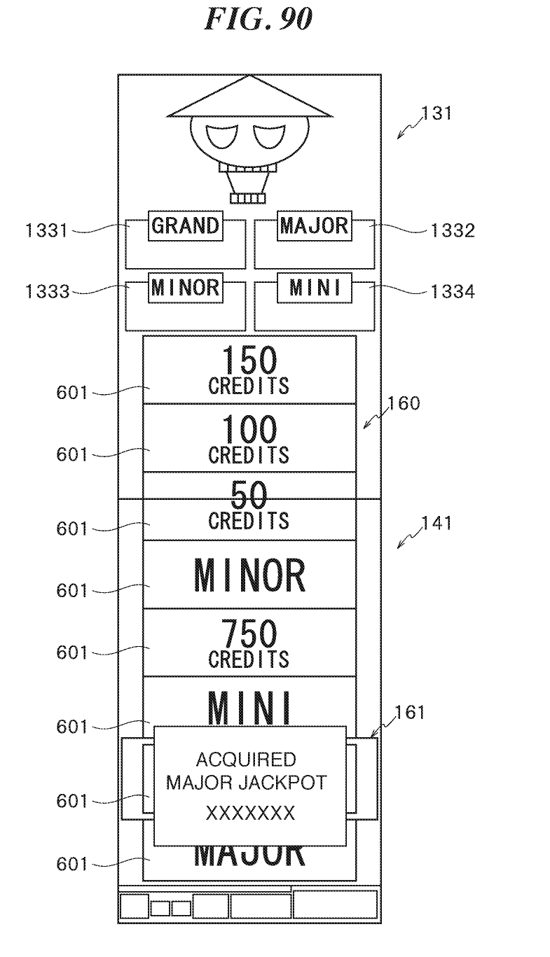

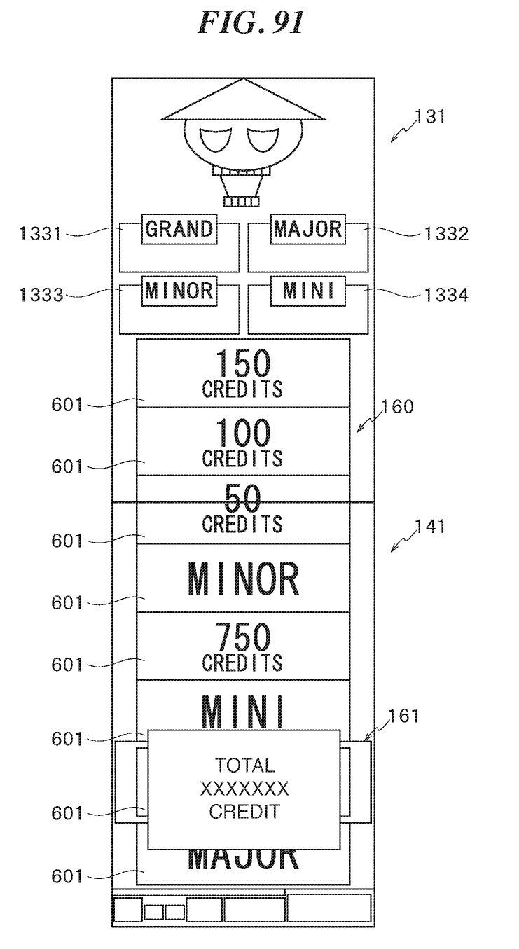

As shown in FIG. 90, when the JP symbol 601 of jackpot is stopped in the determination pane 161, a jackpot signboard showing the type of jackpot and amount of money acquired is displayed. In FIG. 90, an example is shown in which major jackpot is acquired. On the jackpot signboard, the amount of money the player can actually acquire, not the number of credits is displayed. The maximum number of digits of the amount of money is set to two digits for the currency sign+10-digit number+one digit after the decimal point. When the JP symbol 601 of any of the various types of fixed dividend is stopped in the determination pane 161, the jackpot signboard is not displayed and, as shown in FIG. 91, a total win signboard is displayed.

As shown in FIG. 91, a total win signboard is displayed subsequent to the jackpot signboard, and the credits displayed on the win meter 402 are added. The maximum digit number of the credits is set to 11. When the total win has reached 25 times or more of the bet number in the base game in which the bonus game executed before this jackpot game was triggered, an effect is produced in which a rain of coins falls on the display screen. When the total win has reached 50 times or more of the bet number in the base game in which the bonus game executed before this jackpot game was triggered, an effect is produced in which a rain of coins and jewels falls on the display screen. After that, the flow returns to the base game.

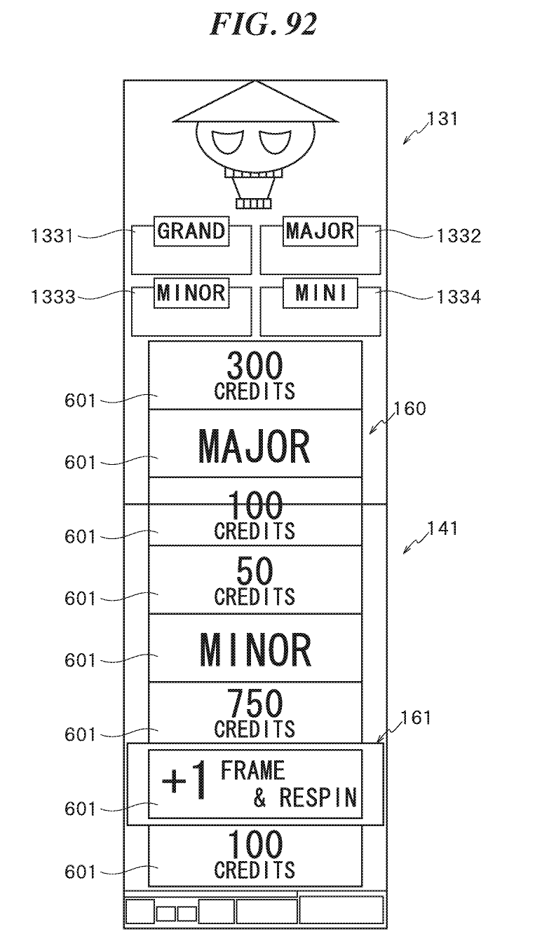

FIG. 92 shows a state in which the JP symbol 601 of respin has been stopped in the determination pane 161. As described above, when the JP symbol 601 of respin is stopped in the determination pane 161, it is possible to scroll and rearrange the JP video reel 160 again.

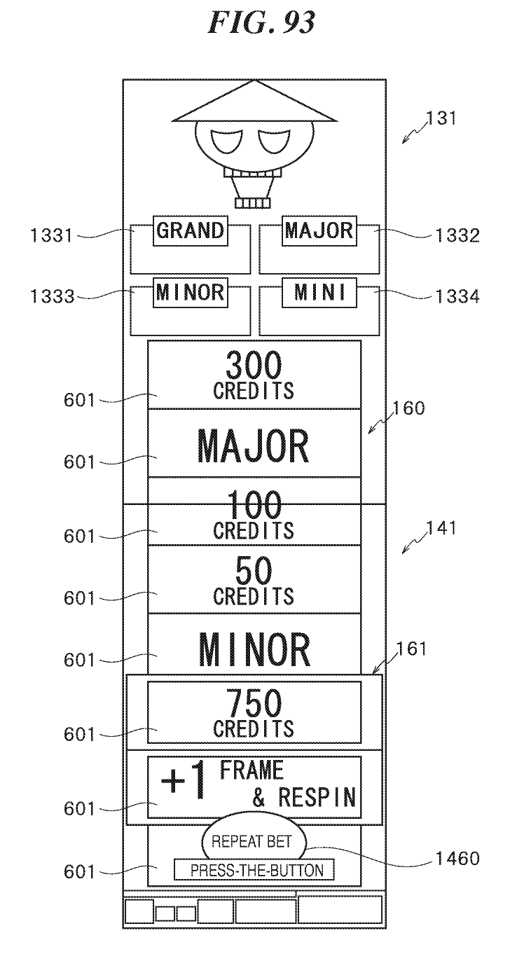

As shown in FIG. 93, when the JP symbol 601 of respin is stopped in the determination pane 161, an effect is produced in which the determination position indicated by the determination pane 161 expands. Then, the press-the-button image 1460 is displayed.

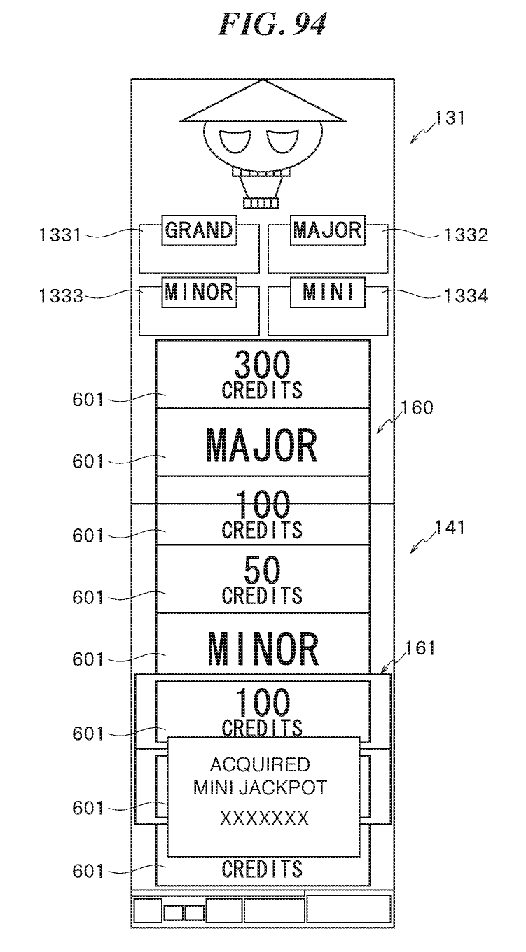

As shown in FIG. 94, a jackpot signboard is displayed when the JP video reel 160 is stopped after respin and the JP symbols 601 of jackpot and fixed dividend are rearranged in the determination pane 161. On the jackpot signboard, the amount of money the player can actually acquire, not the number of credits, is displayed. The maximum number of digits of the amount of money is set to two digits for the currency sign+10-digit number+one digit after the decimal point. When a plurality of JP symbols 601 of jackpot is rearranged in the determination pane 161, a jackpot signboard showing a superior jackpot is displayed first and a jackpot signboard showing an inferior jackpot is displayed thereafter. As described above, jackpot signboards showing all the jackpots are displayed. On the jackpot signboards, incremental display of the acquired amount of money is appeared. When any fixed dividend is acquired in addition to a jackpot, a figure including the fixed dividend is displayed on the jackpot signboard. After that, a total win signboard is displayed as shown in FIG. 91.

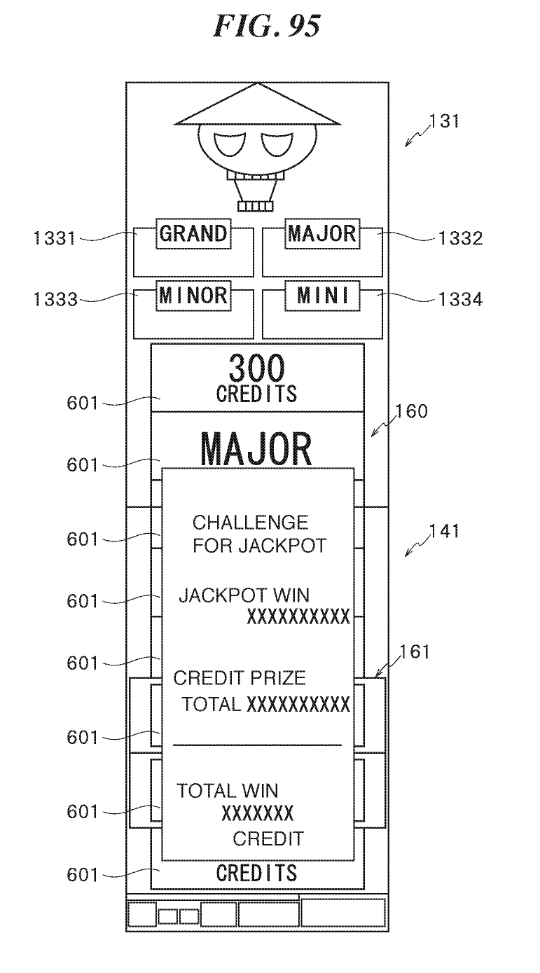

As shown in FIG. 95, when a jackpot and a fixed dividend are simultaneously rearranged in the determination pane 161, a breakdown total win signboard including the breakdown of the jackpot and fixed dividend is displayed. On the breakdown total win signboard, the amount of credits acquired from the jackpot, the fixed dividend acquired from the fixed dividend and the total of these credits are displayed. Even when the player wins a jackpot a plurality of times, the total amount of credits acquired from the jackpots is displayed. On the breakdown total win signboard, the amount of money obtained from jackpots is converted to credits, and expressed in credits.

(Content of Program)

Next, the program executed by the slot machine 1 and tables used in the program are described.

(Main Control Processing)

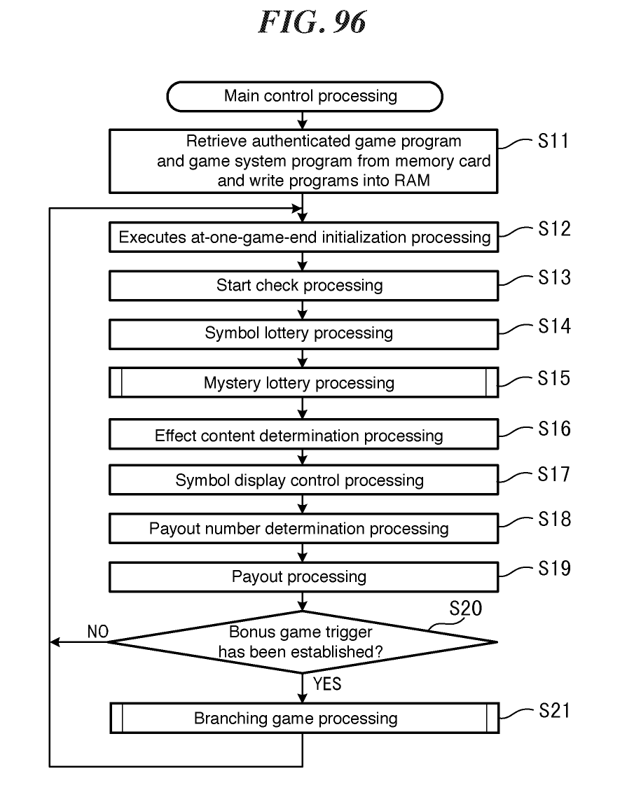

Referring to FIG. 96, first, main control processing is described.

First of all, when the slot machine 1 is powered on, the main CPU 71 retrieve the authenticated game program and game system program from the memory card 54 via the gaming board 50 and writes the programs into the RAM 73 (S11).

Next, the main CPU 71 executes at-one-game-end initialization processing (S12). For example, data that becomes unnecessary every time one game is terminated in the workspace of the RAM 73, such as the BET numbers and symbols determined by lottery, is deleted.

Next, the main CPU 71 executes start check processing (S13). In this processing, processing for checking inputs from switches corresponding to various buttons and subtracting bet credits are executed. In this embodiment, bet buttons 34, 35, 37, 38 and 39 have a function of a spin button. When any of the bet buttons 34, 35, 37, 38 and 39 is pressed, the process proceeds to step S14.

Next, the main CPU 71 executes symbol lottery processing (S14). In this processing, symbols to be stopped are determined on the basis of a random number for symbol determination.

Specifically, the main CPU 71 first extracts a random number for symbol determination. Next, the main CPU 71 determines symbols of the video reels 151 to 155 to be stopped by lottery. The main CPU 71 performs a lottery for each of the video reels 151 to 155 to determine the code numbers of the symbols to be stopped at the reference positions in the video reels 151 to 155. Actually, the symbols to be rearranged in the symbol display region 150 are determined after the size of the display pane for the video reels 151 to 155 is determined in the next mystery lottery processing. Then, the main CPU 71 stores the symbols to be stopped in the reference positions in the symbol storage regions provided in the RAM 73 for each of the video reels 151 to 155. At this time, the plurality of symbols may be determined with an equal probability, or a weight may be set for each of the plurality of symbols so that each symbol may be determined with a probability of weight/total of weights.

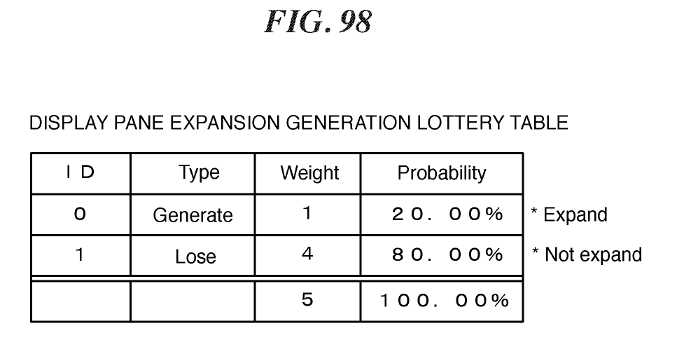

Next, the main CPU 71 executes mystery lottery processing (S15). The mystery lottery processing is described later with referring to FIG. 98.

Next, the main CPU 71 executes effect content determination processing (S16). The main CPU 71 extracts a random number for effects, and selects one of a plurality of predetermined effect contents by lottery.

Next, the main CPU 71 executes symbol display control processing (S17). In this processing, scrolling of the symbol arrays of the video reels 151 to 155 is started, and part of each symbol array is stopped in the display pane determined in the mystery lottery processing in step S15 based on the symbols to be stopped determined in the symbol lottery processing in step S14. In addition, various effects relating to the arrangement of symbols determined in the mystery lottery processing, including expansion of the display pane, addition of additional display blocks and change of the inferior picture symbols 502 to the top symbol 503a, are produced.

Next, the main CPU 71 executes payout number determination processing (S18). In this processing, it is determined whether a prize is established as a predetermined number of symbols stopped in the symbol display region 150 continue from the video reel 151 to the video reel 155 with reference to a symbol combination table stored in the RAM 73. It is also determined whether a scatter win by the feature symbols 505 is established. The awarded dividend is stored in the payout number storage region of the RAM 73.

Next, payout processing is executed (S19). The main CPU 71 adds the value stored in the payout number storage region to the value on the credit number counter stored in the credit number storage region of the RAM 73.

Next, the main CPU 71 determines whether a bonus game trigger has been established (S20). In this embodiment, the shift to a bonus game is triggered when three or more “FEATURE” symbols are stopped in the symbol display region 150. When it is determined that a bonus game trigger has been established (S20: YES), the main CPU 71 executes branching game processing (S21), which is described later. Various bonus games are invoked from the branching game processing.

The main CPU 71 returns to step S12 if it is determined that a bonus game trigger has not been established in step S20 (S20: NO) or after the branching game processing in step S21 is completed.

(Mystery Lottery Processing)

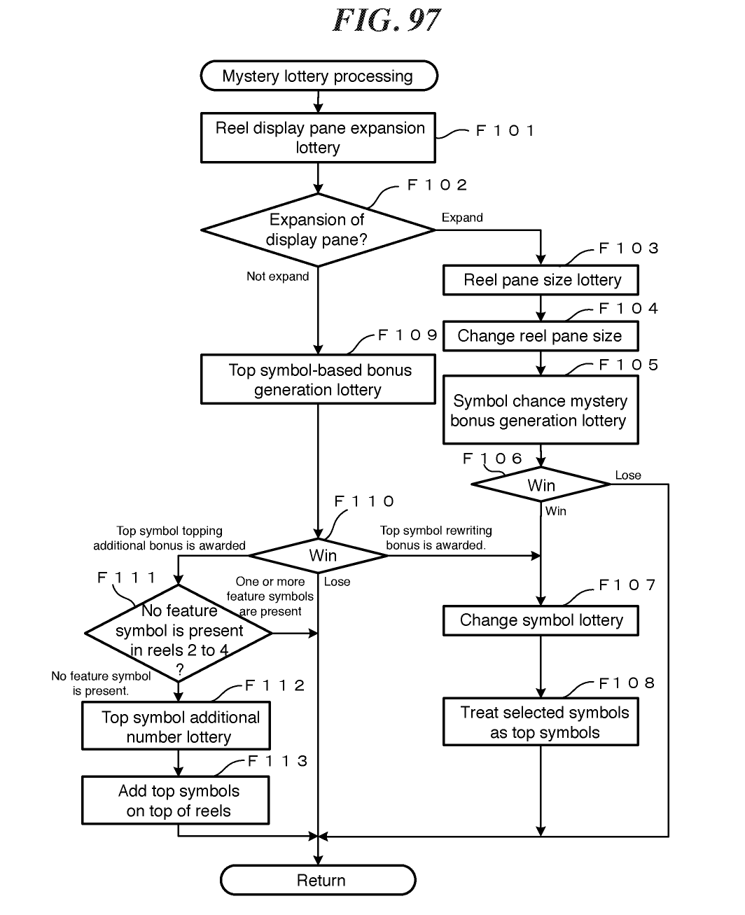

Now, referring to FIG. 97, the mystery lottery processing that is executed in step S15 of the main control processing (see FIG. 96) is specifically described.

First, the main CPU 71 performs a reel display pane expansion lottery (F101). The reel display pane expansion lottery is a lottery for determining whether to form an arrangement pattern in which some display blocks 28 are added to the five-column by four-row arrangement pattern as a standard pattern of the display blocks 28 (the No. 0 arrangement pattern shown in FIG. 13A) (whether or not to expand the reel display pane).

When expansion is selected by the reel display pane expansion lottery (F102: Expand), the main CPU 71 performs a reel pane (the video reels 151 to 155) size lottery (F103). It is determined by the reel pane size lottery which of the plurality of arrangement patterns of the display blocks 28 (No. 1 to No. 20 arrangement patterns shown in FIG. 13A to FIG. 13D) is used. Then, the main CPU 71 changes the size of the reel pane to the size of the determined arrangement pattern, and produces an effect for increasing the number of display blocks 28 (F104). After that, the main CPU 71 performs a symbol chance mystery bonus generation lottery (F105). Then, the main CPU 71 determines whether or not the player wins in the symbol chance mystery bonus generation lottery (F106).

When it is determined that the player wins in the symbol chance mystery bonus generation lottery (F106: Win), the main CPU 71 performs a change symbol lottery (F107). The change symbol lottery is processing for determining the inferior picture symbols 502 that is treated as the top symbols 503a. Then, the main CPU 71 executes processing for treating the selected inferior picture symbols 502 as the top symbols 503a (F108). In other words, the main CPU 71 configures the settings for changing the selected inferior picture symbols 502 to the top symbols 503a in determination of line dividends and the settings for producing an effect in which the inferior picture symbols 502 are changed to the top symbols 503a when the symbols 501 are rearranged in the lower image display panel 141. Then, the main CPU 71 terminates this routine and returns to the main control processing. When the player does not win in the symbol chance mystery bonus generation lottery in F106 (F106: Lose), the main CPU 71 terminates this routine and returns to the main control processing.

When it is determined by the reel display pane expansion lottery in F101 that no expansion is made (F102: Not expand), the main CPU 71 performs a top symbol-based bonus generation lottery (F109). The top symbol-based bonus generation lottery is a lottery for determining whether or not to award a top symbol stacking mystery bonus (top symbol topping additional bonus) and determining whether or not to award a symbol chance mystery bonus (top symbol rewriting bonus).

When the player is awarded a symbol chance mystery bonus in the top symbol-based bonus generation lottery (F110: Award top symbol rewriting bonus), the main CPU 71 advances the process to step F107. When the player is awarded neither of the mystery bonuses in the top symbol-based bonus generation lottery (F110: Lose), the main CPU 71 terminates this routine and returns to the main control processing.

On the other hand, when the player is awarded a top symbol stacking mystery bonus in the top symbol-based bonus generation lottery (F110: Win top symbol topping additional bonus), it is determined whether or not any feature symbols 504 are rearranged in the video reels 152 to 154 (F111). One or more feature symbols 504 are rearranged in the video reel 152 to 154 (F111: one or more feature symbols are present), the main CPU 71 advances the process to F114.

If no feature symbol 504 is rearranged in the video reels 152 to 154 (F111: No feature symbol is present), then the main CPU 71 performs a top symbol additional number lottery (F112). The top symbol additional number lottery is processing for determining how many additional display blocks 28a are added to each of the video reels 151 to 155. Then, the main CPU 71 configures the setting for adding the determined numbers of additional display blocks 28a to the video reels 151 to 155 (F113). After that, the main CPU 71 terminates this routine and returns to the main control processing.

(Mystery Lottery Processing: Table)

Various tables used in the mystery lottery processing described with reference to FIG. 97 are described. The figures used in the following descriptions of tables including the above tables are not limited to values mentioned. Also, the values of dividends stored in the tables are values that are used when the standard bet is 25 credits. The values of dividends stored in the tables are doubled when the standard bet is 50 credits, tripled when the standard bet is 75 credits, and quadruplicated when the standard bet is 100 credits.

(Mystery Lottery Processing: Table: Display Pane Expansion Generation Lottery Table)

Referring to FIG. 98, the display pane expansion generation lottery table is described. The display pane expansion generation lottery table is used in the reel display pane expansion lottery (F101) in the mystery lottery processing (see FIG. 97). As shown in FIG. 98, weights of “1” and “4” are set respectively for the two types of cases consisting of a case with an ID of “0” where a reel display pane is expanded (“Generate”) and a case with an ID of “1” where a reel display pane is not expanded (“Lose”). In other words, the expansion of the reel display pane occurs with a probability of 20.00% and does not occur with a probability of 80.00%.

(Mystery Lottery Processing: Table: Reel Pane Lottery Table)

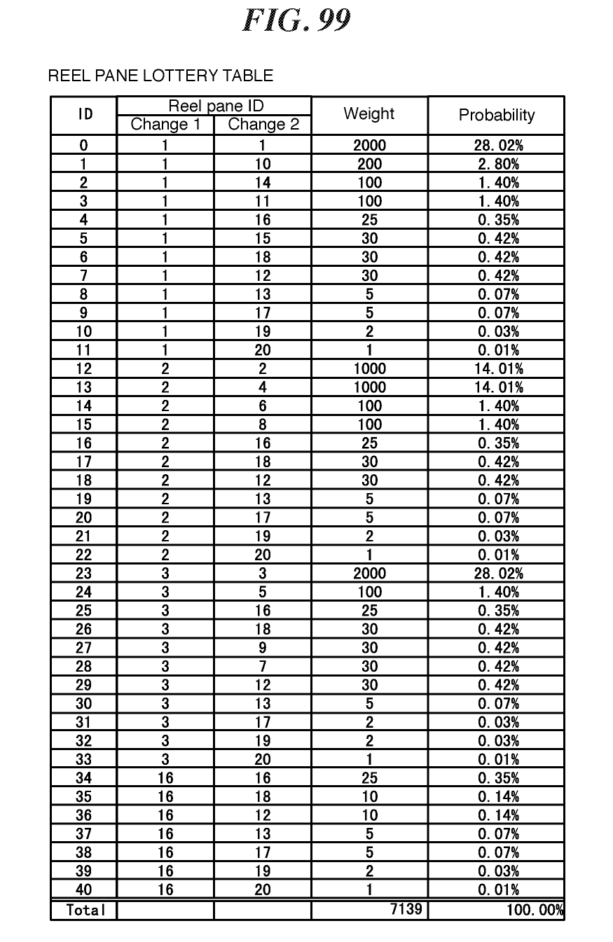

Referring to FIG. 99, a reel pane lottery table is described. The reel pane lottery table is used in the reel pane size lottery (F102) in the mystery lottery processing (see FIG. 97). As shown in FIG. 99, “Change 1” and “Change 2” are associated as reel pane IDs with each of IDs “0” to “40,” and a weight is set for each ID. The selection probability of each ID is determined by the weight. The figures set for “Change 1” and “Change 2” correspond to the code numbers of the arrangement patterns of the display blocks 28 described with reference to FIG. 13A to FIG. 13D and FIG. 14.

When the video reels 151 to 155 are expanded, an effect is produced in which the change occurs in at most two steps. In other words, during variable display of the symbol arrays, the video reels 151 to 155 are first displayed in the No. 0 arrangement pattern, then in the arrangement pattern set in Change 1 and then in the arrangement pattern set in Change 2. When the same arrangement pattern is set in Change 1 and Change 2, the second change of the video reels 151 to 155 does not occur.

(Mystery Lottery Processing: Table: Symbol Change Mystery Bonus Generation Table)

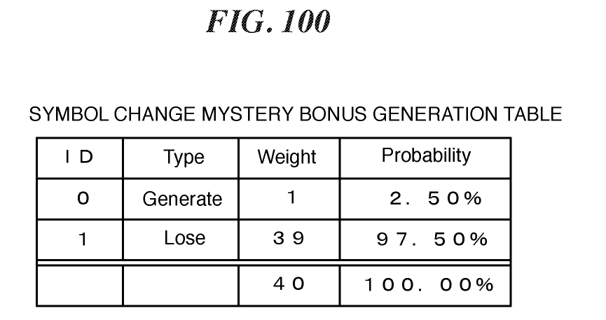

Referring to FIG. 100, a symbol change mystery bonus generation table is described. The symbol change mystery bonus generation table is used in the symbol chance mystery bonus generation lottery (F105) in the mystery lottery processing (see FIG. 97). As shown in FIG. 100, weights of “1” and “39” are set respectively for two options consisting of “Generate” with an ID of “0” and “Lose” with an ID of “1.” In other words, the expansion of the reel display pane occurs with a probability of 2.50% and does not occur with a probability of 97.50%.

(Mystery Lottery Processing: Table: Top Symbol-Based Bonus Generation Lottery Table)

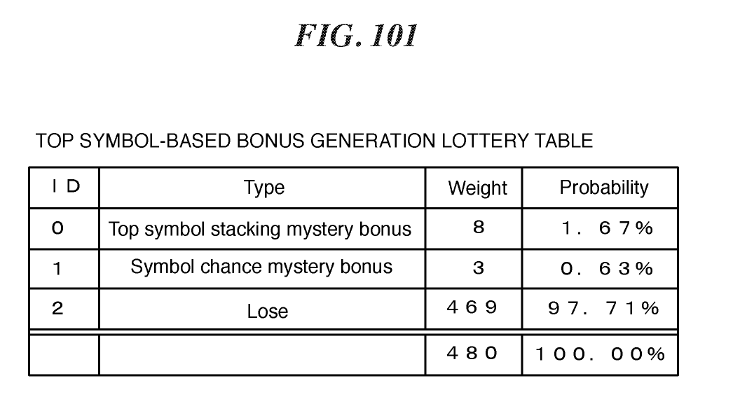

Referring to FIG. 101, a top symbol-based bonus generation lottery table is described. The top symbol-based bonus generation lottery table is used in the top symbol-based bonus generation lottery (F109) in the mystery lottery processing (see FIG. 97). As shown in FIG. 101, weights of “8,” “3” and “469” are set respectively for three options consisting of “top symbol stacking mystery bonus” with an ID of “0,” “symbol chance mystery bonus” with an ID of “1” and “lose” with an ID of “2”. In other words, the top symbol stacking mystery bonus occurs with a probability of 1.67%, the symbol chance mystery bonus occurs with a probability of 0.63% and does not occur with a probability of 97.71%. However, the top symbol stacking mystery bonus is not executed when even one feature symbol 504 is rearranged in any of the video reels 152 to 154 even when the player is awarded a top symbol stacking mystery bonus in a top symbol-based bonus generation lottery using the top symbol-based bonus generation lottery table.

(Mystery Lottery Processing: Table: Top Symbol Addition Table)

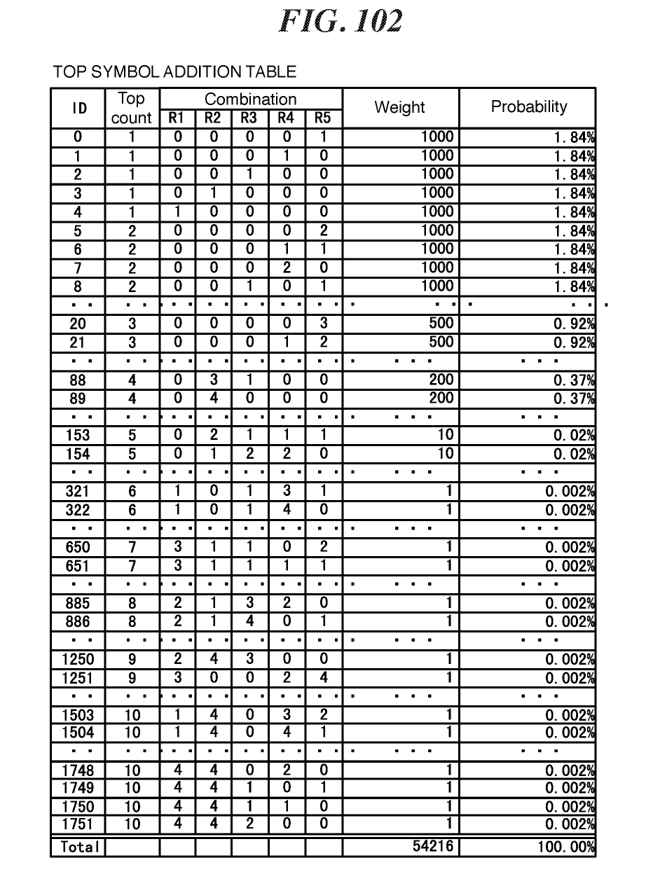

Referring to FIG. 102, a top symbol addition table is described. The top symbol addition table is used in the top symbol additional number lottery (F112) in the mystery lottery processing (see FIG. 97). As shown in FIG. 102, a top count and combinations “R1” to “R5” are associated with each of IDs “0” to “1751,” and a weight is set for each ID. The selection probability of each ID is determined by the weight.

The top count means the total number of the top symbols 503a to be added. In the top symbol stacking mystery bonus, the upper limit of the total number of the top symbols 503a to be added is set to 10. The upper limit of the top symbols 503a to be added to each of the video reels 151 to 155 is set to four.

In the combinations, R1 to R5 represent the video reels 151 to 155, respectively. The numbers set for R1 to R5 represent the number of the top symbols 503a to be added to the video reels 151 to 155, respectively. In the combinations, the upper limit of each of R1 to R5 is set to four, and all patterns in which the upper limit of the total of R1 to R5 is 10 are set.

A weight of 1000 is set for all the IDs with a top count of 1 or 2. A weight of 500 is set for all the IDs with a top count of 3. A weight of 200 is set for all the IDs with a top count of 4. A weight of 10 is set for all the IDs with a top count of 5. A weight of 1 is set for all the IDs with a top count of 6 to 10. As a result, the selection probability of each ID is determined.

(Mystery Lottery Processing: Table: Change Symbol Lottery Table)

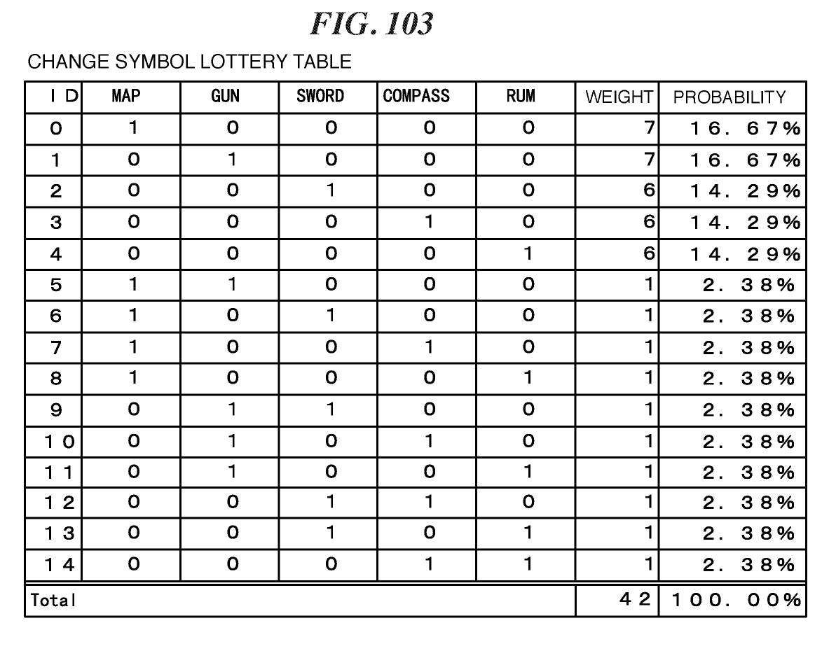

Referring to FIG. 103, a change symbol lottery table is described. The change symbol lottery table is used in the change symbol lottery (F107) in the mystery lottery processing (see FIG. 97). As shown in FIG. 103, “1” or “0” is set for each of five inferior picture symbols 502 (“MAP,” “GUN,” “SWORD,” “COMPASS” and “RUM”) of each of IDs “0” to “14,” and a weight is set for each ID. The selection probability of each ID is determined on the basis of the weight.

The “1” set for the five inferior picture symbols 502 in the change symbol lottery table means that the symbol is treated as the top symbol 503a in the symbol chance mystery bonus. The “0” set for the five inferior picture symbols 502 in the change symbol lottery table means that the symbol is not treated as the top symbol 503a but treated equally as in a normal base game. In the change symbol lottery table, all the patterns in which at most two types of the five inferior picture symbols 502 are treated as top symbol 503a are set.

(Branching Game Processing)

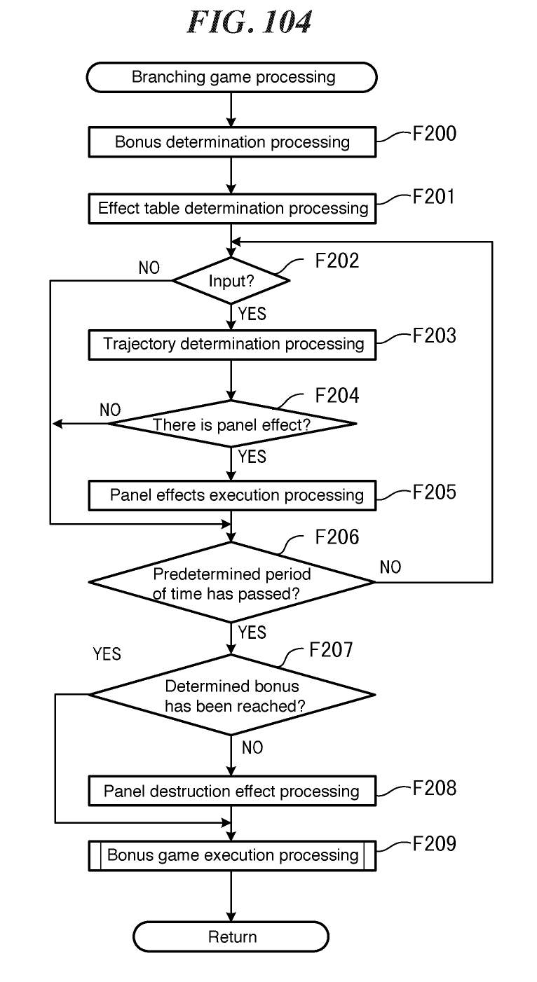

Now, referring to FIG. 104, branching game processing that is executed in step S21 of the main control processing (see FIG. 96) is specifically described.

First, the main CPU 71 executes bonus determination processing (F200). In other words, the main CPU 71 previously determines by lottery which of the mini-bonus game, minor bonus game, major bonus game, and grand bonus game is executed. Then, the main CPU 71 executes effect table determination processing (F201).

After that, the main CPU 71 determines whether or not the player has performed an input manipulation (F202). When the player has performed an input manipulation (F202: YES), the main CPU 71 executes trajectory determination processing. In other words, the main CPU 71 determines the direction in which the cannonball flies with respect to the panel, whether or not the cannonball hits the panel, and how the cannonball misses the panel when it does not hit on the basis of the direction in which the player slides his or her finger on the lower image display panel 141 or a trajectory pattern. Then, the main CPU 71 determines whether or not there is a panel effect (F204). In other words, the main CPU 71 determines whether or not the cannonball misses the panel on the basis of the determined trajectory or whether or not the panel changes (the state of cracks changes or the panel is destroyed), depending on the durability of the panel. When there is a panel effect (F204: YES), the main CPU 71 executes panel effect execution processing (F205).

If it is determined in step F202 that the player has not perform an input manipulation (F202: NO), and then it is determined in step F204 that there is no change in the panel (F204: NO) or after the panel effects execution processing in step F205 is completed, the main CPU 71 determines whether or not a predetermined period of time has passed. If a predetermined period of time has not passed (F206: NO), then the main CPU 71 returns the process to F202.

On the other hand, If predetermined period of time has passed (F206: YES), then the main CPU 71 determines whether or not the determined bonus has been reached (F207). In other words, the main CPU 71 determines whether or not all the panels before the panel corresponding to the bonus game determined in step F200 have been destroyed. If the determined bonus has not been reached (F207: NO), the main CPU 71 executes panel destruction effect processing (F208). In other words, the main CPU 71 displays an effect in which the panels before the panel corresponding to the bonus game determined in step F200 are destroyed.

When the determined bonus has been reached in step F207 (F207: YES) or after the panel destruction effect processing in step F208 is completed, the main CPU 71 executes bonus game execution processing (F209). In the bonus game execution processing, the program of the bonus game determined in step F200 is executed.

(Branching Game: Table)

A table used in the branching game is described.

(Branching Game: Table: Bonus Game Distribution Lottery Table)

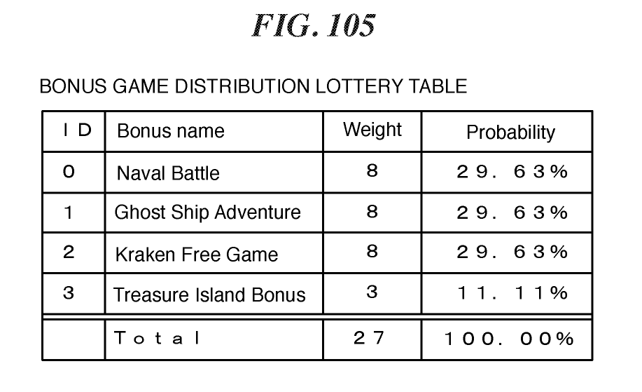

Referring to FIG. 105, a bonus game distribution lottery table is described. The bonus game distribution lottery table is used in bonus determination processing (F200) in the branching game processing (see FIG. 104). As shown in FIG. 105, the bonus games (Naval Battle, Ghost Ship Adventure, Kraken Free Game, Treasure Island Bonus) are associated with “0” to “3” IDs, respectively, and a weight is set for each ID. The selection probability of each ID (each bonus game) in the bonus game determination processing is determined based on the weight.

(Branching Game: Table: Panel Durability Tables)

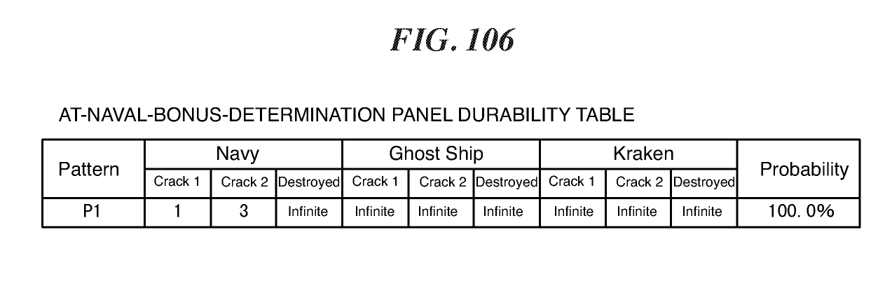

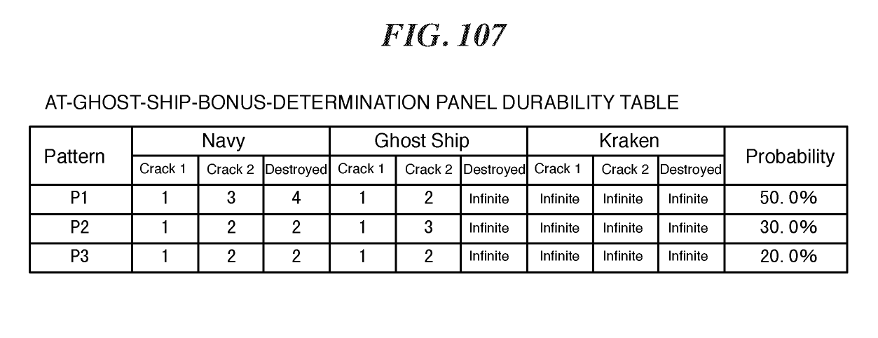

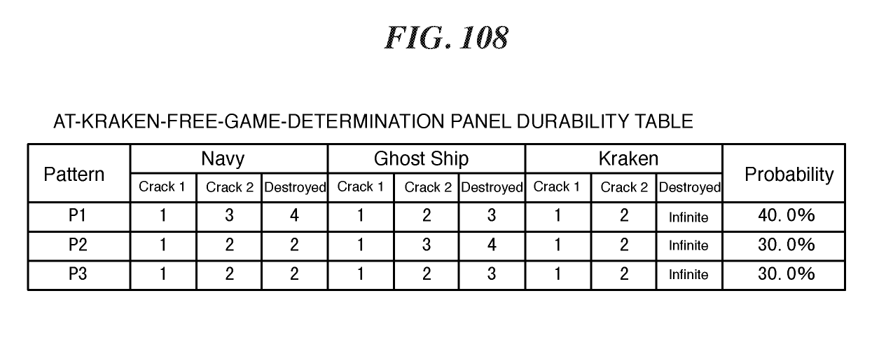

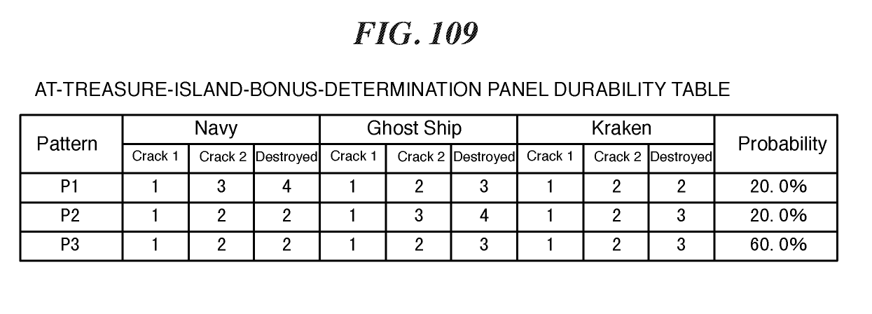

Referring to FIG. 106 to FIG. 109, panel durability tables are described. A panel durability table is provided for each of the bonus games that is selected in the bonus determination processing (F200) in the branching game processing (see FIG. 104). When the determined bonus game is Naval Battle (mini-bonus game), an at-naval-bonus-determination panel durability table shown in FIG. 106 is used. When the determined bonus game is Ghost Ship Adventure (minor bonus game), an at-Ghost-Ship-bonus-determination panel durability table shown in FIG. 107 is used. When the determined bonus game is Kraken Free Game (major bonus game), an at-Kraken-Free-game-determination panel durability table shown in FIG. 108 is used. When the determined bonus game is Treasure Island Bonus (grand bonus game), an at-Treasure-Island-Bonus-determination panel durability table shown in FIG. 109 is used.

In the effect table determination processing (F201) in the branching game processing (see FIG. 104), it is determined which of the panel durability tables is used. Then, each panel durability table is used to determine whether or not there is a panel effect of step F204. As shown in FIG. 106 to FIG. 109, in each panel durability table, changes in state are associated with the number of hit cannonballs for each panel (for example, for each of the panel images 1322 to 1324 in FIG. 35). Specifically, each of the panel images 1322 to 1324 changes from the initial first state to a second state with crack 1, then to a third state with crack 2, and finally to a fourth, destroyed, state. In each panel durability table, at least one pattern in which the number of hit cannonballs necessary to reach the next state is associated with each state change is stored. Specifically, when “1” is stored in crack 1 of Navy, the state changes from the initial first state to the second state with crack 1 when the player hits the major bonus game panel image 1322 with a cannonball once. When “Infinite” is stored, it means that the state does not change any more.

(Bonus Game Processing)

In the bonus game execution processing in step F209 of the branching game processing (see FIG. 104), the bonus game of the type determined in the bonus determination processing in step F200 of the branching game processing is executed. In the following, bonus game execution processing for each bonus game is described.

(Mini-Bonus Game)

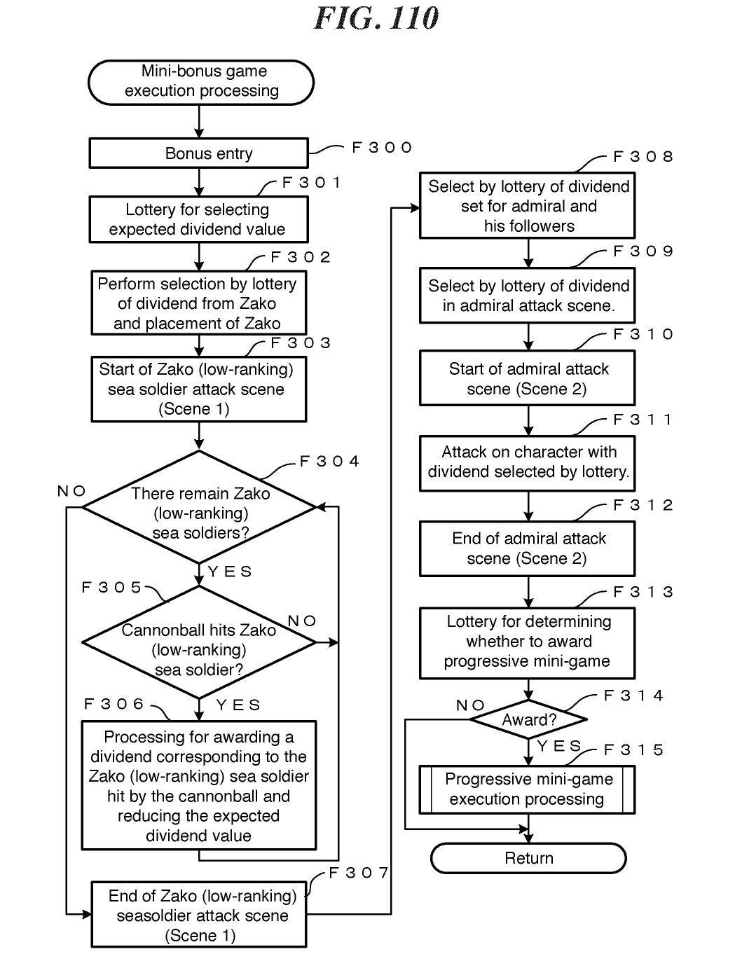

First, referring to FIG. 110, bonus game execution processing (mini-bonus game execution processing) that is executed when Naval Battle (mini-bonus game) is executed is specifically described.

(Mini-Bonus Game: Mini-Bonus Game Execution Processing)

First, the main CPU 71 executes bonus entry processing (F300). In other words, an introduction effect and so on are produced. Then, the main CPU 71 performs a lottery for selecting an expected dividend value (F301) to determine the expected value of the dividend that can be acquired in the entire mini-bonus game. Then, the main CPU 71 performs selection by lottery of the dividend from a Zako (low-ranking) sea soldier and placement of Zako (low-ranking) sea soldiers (F302). In other words, the main CPU 71 determines the dividend amount to be associated with the soldiers on the vessel in the battle with low-ranking soldiers as a first scene.

Then, the main CPU 71 starts the first scene (low-ranking sea soldier attack scene) (F303). In the first scene, the main CPU 71 first determines whether or not there remain low-ranking sea soldiers (F304). When there remain low-ranking sea soldiers (F304: YES), the main CPU 71 determines whether or not a cannonballs shot from the cannon in response to an input manipulation by the player hits a low-ranking sea soldier (F305). When a cannonball from the cannon hits a low-ranking sea soldier (F305: YES), the main CPU 71 executes processing for awarding a dividend corresponding to the low-ranking sea soldier hit by the cannonball and reducing the expected dividend value (F306). In other words, the main CPU 71 produces an effect in which the low-ranking sea soldier hit by the cannonball collapses or the like, and updates the “remaining expected dividend value,” which is the value obtained by subtracting the dividend from the low-ranking sea soldier hit by the cannonball from the expected dividend value. The “remaining expected dividend value” is set to the expected dividend value at the beginning, and, every time a low-ranking sea soldier hit by a cannonball collapses, it is updated by subtracting the dividend from the low-ranking sea soldier therefrom. When a cannonball from the cannon does not hit any of the low-ranking sea soldiers in F305 (F305: NO) or after the processing in F306 is completed, the main CPU 71 returns the process to F304. When it is determined that there remains no low-ranking sea soldier in F304 (F304: NO), the main CPU 71 terminates the first scene (low-ranking sea soldier attack scene) (F307).

After that, the main CPU 71 selects a dividend set for the admiral and his followers (subordinate A and subordinate B) by lottery (F308). Then, the main CPU 71 determines the dividend in the admiral attack scene by lottery (F309). Then, the main CPU 71 starts a second scene (admiral attack scene) (F310). After that, the main CPU 71 displays an effect in which the character corresponding to the dividend selected by lottery is attacked (F311). Then, the main CPU 71 terminates the second scene (admiral attack scene). After that, the main CPU 71 performs a lottery for determining whether or not to award a progressive mini-game (Jackpot game) (F313). Then, the main CPU 71 determines whether or not the player is awarded a progressive mini-game (F314). When the player is awarded a progressive mini-game (F314: YES), the main CPU 71 terminates this routine and returns the process to the branching game processing after executing jackpot game execution processing (F315). When the player is not awarded a progressive mini-game (F314: NO), the main CPU 71 terminates this routine, and returns the process to the branching game processing.

(Mini-Bonus Game: Table)

Tables used in the mini-bonus game are described.

(Mini-Bonus Game: Table: Expected Dividend Value Lottery Table)

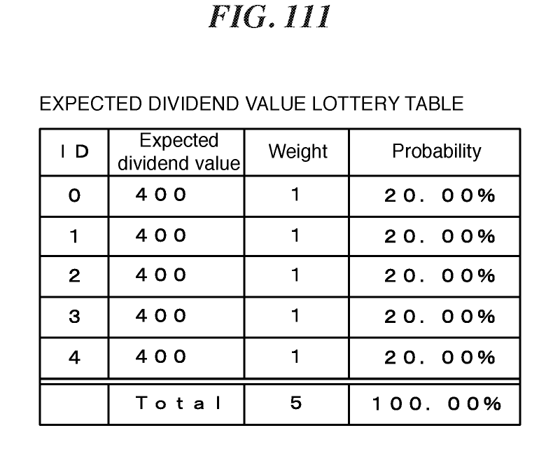

Referring to FIG. 111, an expected dividend value lottery table is described. The expected dividend value lottery table is used in the lottery for selecting an expected dividend value (F301) in the mini-bonus game execution processing (see FIG. 110). As shown in FIG. 111, an expected dividend value is associated with each of IDs “0” to “4,” and a weight is set for each ID. The selection probability of each ID is determined based on the weight.

(Mini-Bonus Game: Table: Zako (Low-Ranking) Sea Soldier Dividend Arrangement Pattern Table)

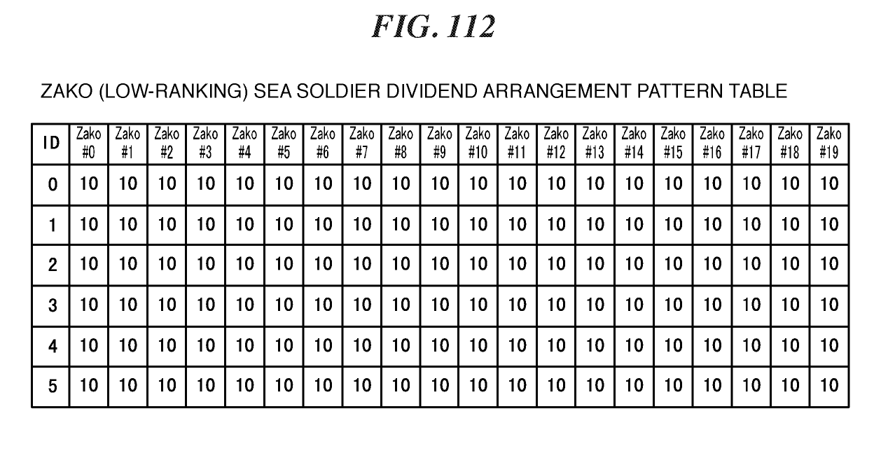

Referring to FIG. 112, a Zako (low-ranking) sea soldier dividend arrangement pattern table is described. The Zako (low-ranking) sea soldier dividend arrangement pattern table is used in the selection by lottery of the dividend from a Zako (low-ranking) sea soldier and placement of Zako (low-ranking) sea soldiers (F302) in the mini-bonus game execution processing (see FIG. 110). As shown in FIG. 112, a dividend from each of the placed Zako (low-ranking) sea soldiers is associated with each of IDs “0” to “5.”

(Mini-Bonus Game: Table: Zako (Low-Ranking) Sea Soldier Dividend Pattern Lottery Table)

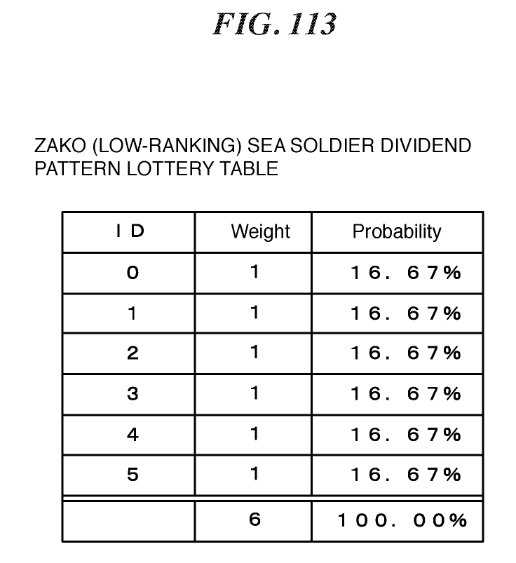

Referring to FIG. 113, an expected dividend value lottery table is described. The expected dividend value lottery table is used in the selection by lottery and placement of a low-ranking sea soldier dividend arrangement (F302) in the mini-bonus game execution processing (see FIG. 110). As shown in FIG. 113, a weight is associated with each of IDs “0” to “5” to determine the selection probability of each ID. The IDs in the Zako (low-ranking) sea soldier dividend pattern lottery table is associated with the IDs in the Zako (low-ranking) sea soldier dividend arrangement pattern table (see FIG. 112), and an ID is determined by a lottery using the Zako (low-ranking) sea soldier dividend pattern lottery table, and dividends corresponding to the ID in the Zako (low)-ranking sea soldier dividend arrangement pattern table are used.

(Mini-Bonus Game: Table: Dividend Set Determination Table)

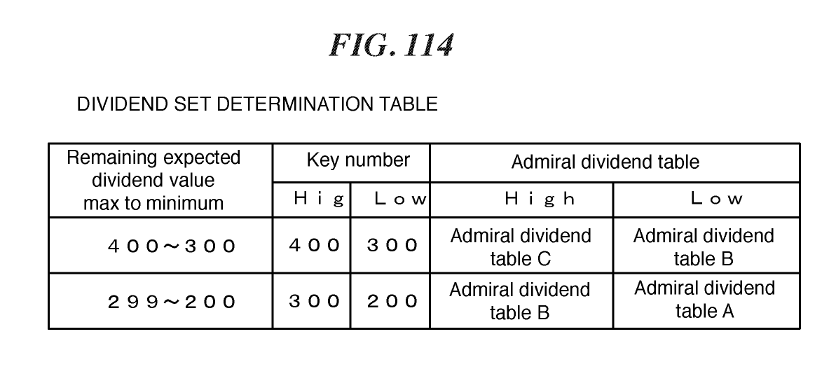

Referring to FIG. 114, a dividend set determination table is described. The dividend set determination table is used in the selection by lottery of the dividend set for the admiral and his followers (F308) in the mini-bonus game execution processing (see FIG. 110). As shown in FIG. 114, High and Low key numbers are associated with each range of the “remaining expected dividend value,” and an admiral dividend table, which is described later, is associated with each of the High and Low key numbers. It is determined which of the admiral dividend tables is used on the basis of “remaining expected dividend value” with reference to the dividend set determination table.

Specifically, one of the ranges of the “remaining expected dividend value” stored in the dividend set determination table is selected on the basis of the “remaining expected dividend value” at the time when the second scene is started. Then, a value obtained by dividing the value obtained by subtracting the “Low key number” corresponding to the selected range from the “remaining expected dividend value” by a value obtained by subtracting the “Low key number” from the “High key number” is the selection probability with which the “High key number” is selected. When the “High key number” is selected, the admiral dividend table corresponding to the range of the “remaining expected dividend value” to which the “High key number” belongs is used.

When the “High key number” is not selected, the “Low key number” is selected. In other words, a value obtained by dividing the value obtained by subtracting the “remaining expected dividend value” from the “High key number” corresponding to the selected range by a value obtained by subtracting the “Low key number” from the “High key number” is the probability with which the “Low key number” is selected. When the “Low key number” is selected, the admiral dividend table corresponding to the range of the “remaining expected dividend value” to which the “Low key number” belongs is used.

(Mini-Bonus Game: Table: Admiral Dividend Tables)

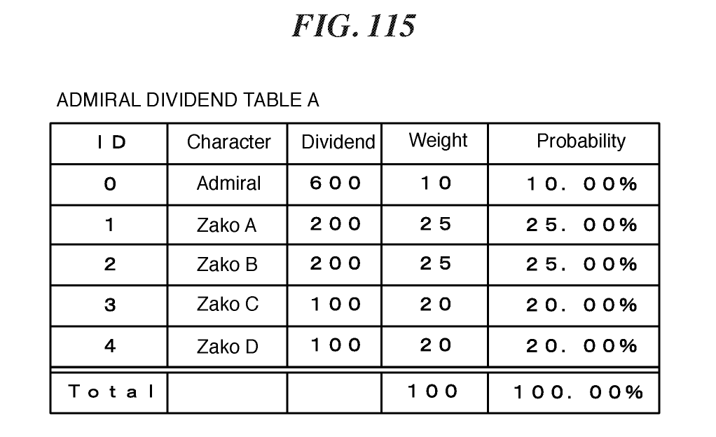

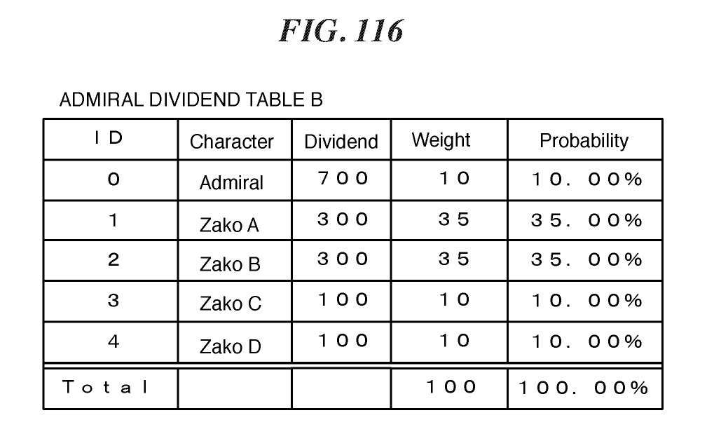

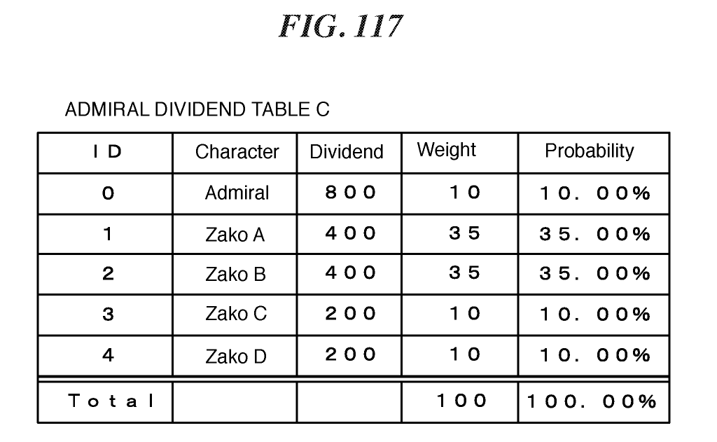

Referring to FIG. 115 to FIG. 117, admiral dividend tables A to C are described. The admiral dividend tables A to C correspond to the admiral dividend tables in the dividend set determination table. In other words, it is determined which of the admiral dividend tables A to C is used on the basis of the dividend set determination table. In the admiral dividend tables A to C, a dividend is associated with each of IDs “0” to “4” corresponding respectively to “Admiral,” “Zako (low-ranking) sea soldier A,” “Zako (low-ranking) sea soldier B,” “Zako (low-ranking) sea soldier C” and “Zako (low-ranking) sea soldier D.” The selection probability of each ID is determined on the basis of the weight set for the ID.

(Minor Bonus Game)

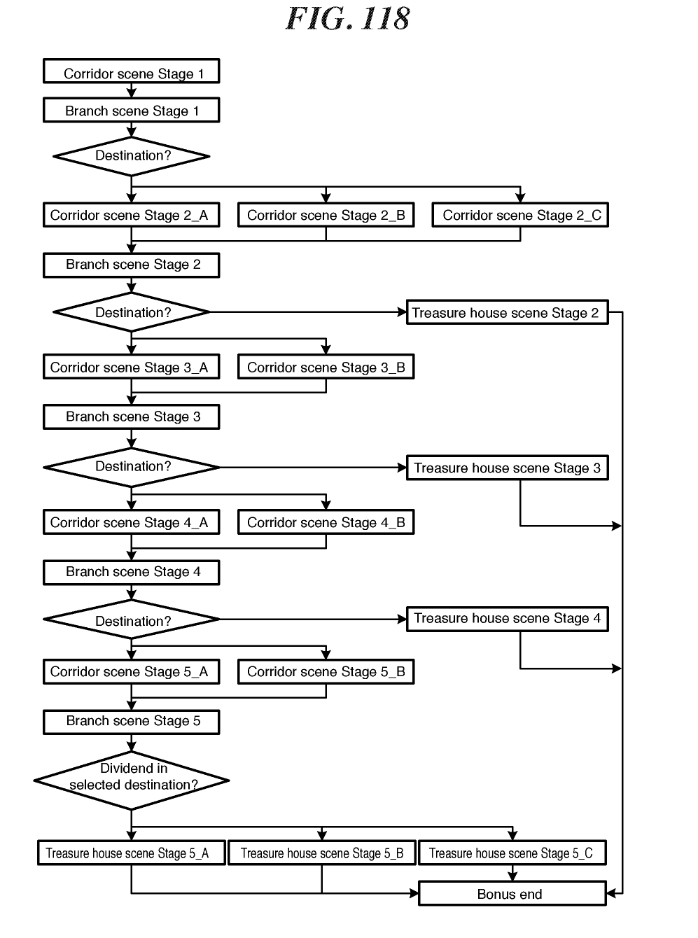

First, referring to FIG. 118, the flow of transition of scenes in Ghost Ship Adventure (Minor bonus game) is described.

(Minor Bonus Game: Flow of Transition of Scenes)

As shown in FIG. 118, Ghost Ship Adventure is always started with “corridor scene Stage 1.” The transition destination of the “corridor scene Stage 1” is “branch scene Stage 1.” Transition destinations are branched from the “branch scene Stage 1,” and the candidates for the destination from the branch are “corridor scene Stage 2_A,” “corridor scene Stage 2_B” and “corridor scene Stage 2_B.” The “corridor scene Stage 2_B” is used in two transition destinations.

The transition destination from all of the “corridor scene Stage 2_A,” “corridor scene Stage 2_B,” and the “corridor scene Stage 2_B” is the “branch scene Stage 2.” Transition destinations are branched at the “branch scene Stage 2,” and the candidates for the destination from the branch are “treasure house scene Stage 2,” “corridor scene Stage 3_A” and “corridor scene Stage 3_B.” When the “treasure house scene Stage 2” is selected as the transition destination, the minor bonus game is terminated after a dividend is awarded.

The transition destination from the “corridor scene Stage 3_A” and the “corridor scene Stage 3_B” is “branch scene Stage 3.” Transition destinations are branched at the “branch scene Stage 3 and the candidate for the destination from the branch are “treasure house scene Stage 3,” “corridor scene Stage 4_A,” and “corridor scene Stage 4_B.” When the “treasure house scene Stage 3” is selected as the transition destination, the minor bonus game is terminated after a dividend is awarded.

The transition destination from the “corridor scene Stage 4_A” and the “corridor scene Stage 4_B” is “branch scene Stage 4.” Transition destinations are branched at the “branch scene Stage 4,” and the candidates for the destination from the branch are “treasure house scene Stage 4,” “corridor scene Stage 5_A” and “corridor scene Stage 5_B.” When the “treasure house scene Stage 4” is selected as the transition destination, the minor bonus game is terminated after a dividend is awarded.

The transition destination from the “corridor scene Stage 5_A and the “corridor scene Stage 5_B” is “branch scene Stage 5.” Transition destinations are branched at the “branch scene Stage 5,” and candidates for the destination from the branch are “treasure house scene Stage 5_A,” “treasure house scene Stage 5_B” and “treasure house scene Stage 5_C.” When the “treasure house scene Stage 4” is selected as the transition destination, the minor bonus game is terminated after a dividend is awarded.

As described above, the minor bonus game is constituted of corridor scenes, branch scenes and treasure house scenes. In the minor bonus game, a corridor scene always leads to a branch scene, and a branch scene leads to a corridor scene or treasure house scene. In other words, in the minor bonus game, when a repetition of a corridor scene and a branch scene is completed, the scene transitions to a treasure house scene. Then, the minor bonus game is terminated.

(Minor Bonus Game)

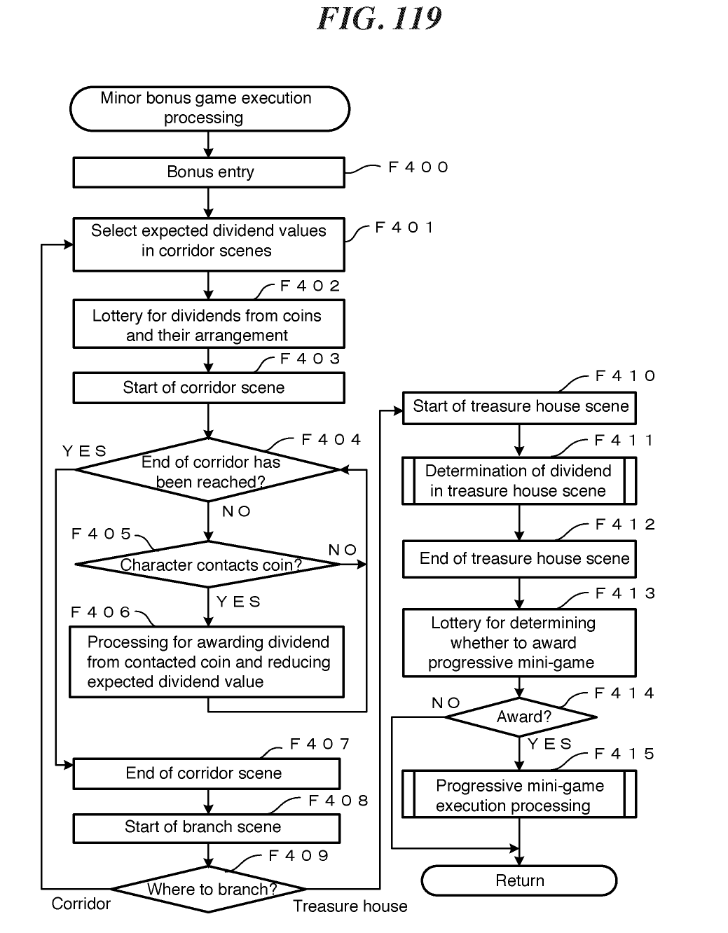

Now, referring to FIG. 119, bonus game execution processing in a case where Ghost Ship Adventure (Minor bonus game) is executed (Minor bonus game execution processing) is specifically described.

(Minor Bonus Game: Bonus Game Execution Processing)

First, the main CPU 71 executes bonus entry processing (F400). In other words, an introduction effect or the like is produced and the transition of scenes is determined. Then, the main CPU 71 selects the expected dividend values in the corridor scenes by lottery (F401). Then, the main CPU 71 determines the dividends from coins and their arrangement (F402). In other words, the main CPU 71 determines the dividend per coin in the corridor scene, the arrangement pattern of coins in the corridor scene, and so on.

Then, the main CPU 71 starts a corridor scene in which the player acquires coins by manipulating a character (F403). The main CPU 71 determines whether or not the end of a corridor has been reached (F404). In other words, it is determined whether or not one corridor scene is completed. When the end of a corridor has not been reached (F404: NO), the main CPU 71 determines whether or not the character manipulated by the player contacts a coin in the corridor scene (F405). When the character contacts a coin (F405: YES), the main CPU 71 executes processing for awarding the dividend from the contacted coin and reducing the expected dividend value (F406). In other words, the main CPU 71 produces an effect in which a dividend is displayed on the contacted coin or the like, and updates the “remaining expected dividend value” by subtracting the dividend from the coin from the expected dividend value. The “remaining expected dividend value” is set to the expected dividend value at the beginning, and, every time the character contacts a coin, the “remaining expected dividend value” is updated by subtracting the dividend from the contacted coin therefrom. When the character does not contact any coins in F405 (F405: NO) or after the processing in F406 is completed, the main CPU 71 returns the process to F404. When it is determined that the end of a corridor has been reached in F404 (F404: YES), the main CPU 71 terminates the corridor scene (F407).

Then, the main CPU 71 starts a branch scene (F408). Then, the main CPU 71 determines whether to branch to a corridor scene or treasure house from the branch scene (F409). When the scene branches to a corridor scene (F409: Corridor), the main CPU 71 advances the process to step F401. On the other hand, when the scene branched to a treasure house scene (F409: treasure house), the main CPU 71 starts the treasure house scene (F410).

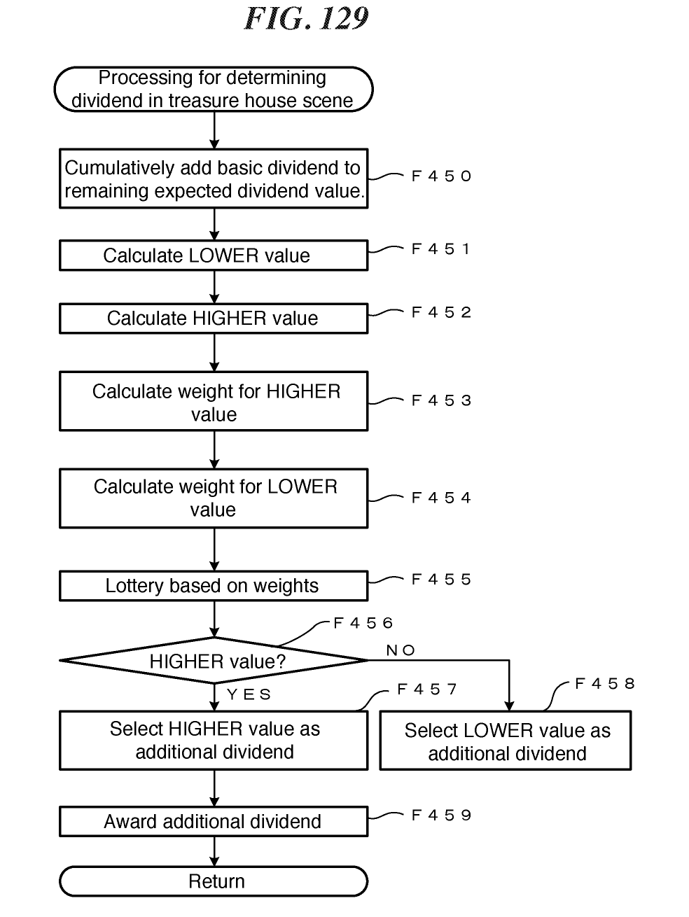

When the treasure house scene is started, the main CPU 71 determines the dividend that can be acquired in the treasure house scene (F411). The processing for determining the dividend in a treasure house scene is described later with reference to FIG. 129. Then, the main CPU 71 terminates the treasure house scene. Then, the main CPU 71 performs a lottery for determining whether or not to award a progressive mini-game (Jackpot game) (F413). Then, the main CPU 71 determines whether or not the player is awarded a progressive mini-game (F414). When the player is awarded a progressive mini-game (F414: YES), the main CPU 71 terminates this routine and returns the process to the branching game processing after executing jackpot game execution processing (F415). When the player is not awarded a progressive mini-game (F414: NO), the main CPU 71 terminates this routine and returns the process to the branching game processing.

(Minor Bonus Game: Branch Flow)

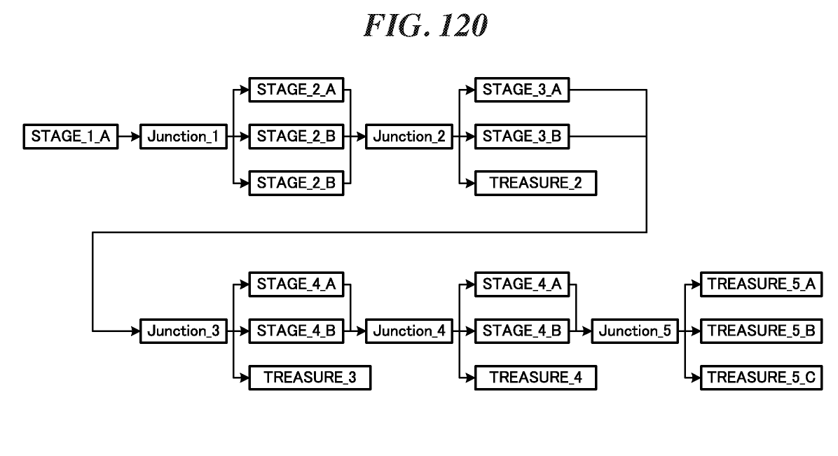

As shown in FIG. 120, a unique identification name has been determined for each of the corridor scenes, branch scenes and treasure house scenes. The identification names are used in the tables described below.

(Minor Bonus Game: Table)

Tables used in the minor bonus game are described.

(Minor Bonus Game: Table: Transfer Destination Lottery Table)

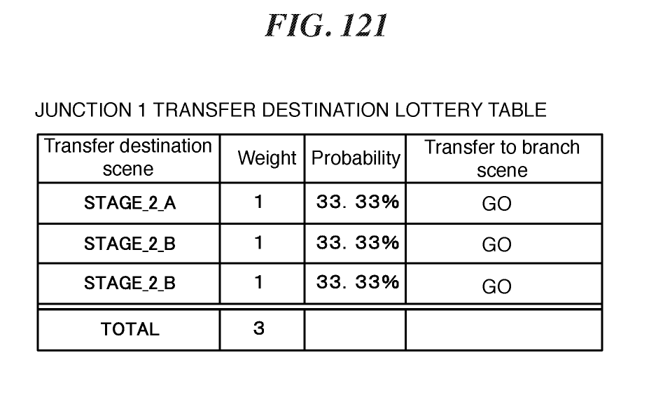

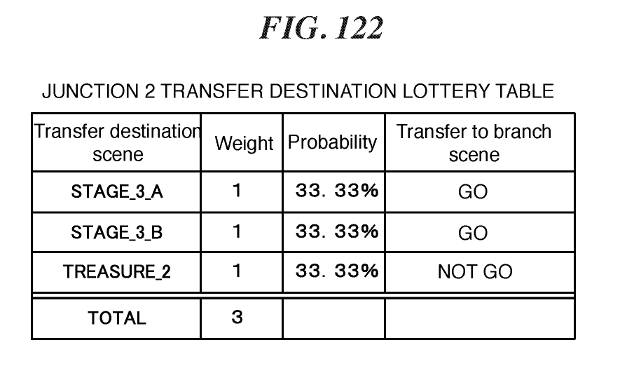

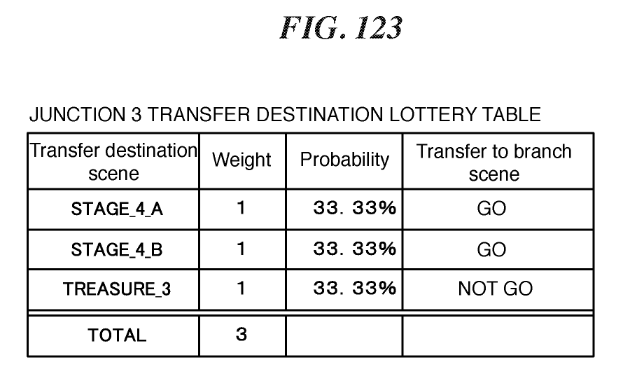

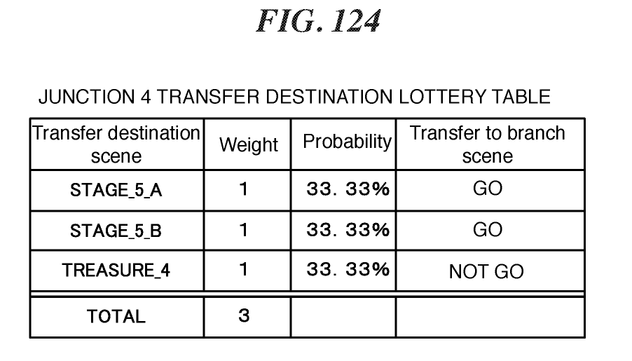

Referring to FIG. 121 to FIG. 125, transfer destination lottery tables (a junction 1 transfer destination lottery table, a junction 2 transfer destination lottery table, a junction 3 transfer destination lottery table, a junction 4 transfer destination lottery table, and a junction 5 transfer destination lottery table) are described. The transfer destination lottery tables are used in the determination of the branch destination (F409) in the minor bonus game execution processing (see FIG. 119).

As shown in FIG. 121 to FIG. 125, a transfer destination lottery table for determining the transfer destination is provided for each branch scene (junction). This embodiment has five branch scenes, and a junction 1 transfer destination table to a junction 5 transfer destination table are prepared for each of the branch scenes. The identification name of a corridor scenes or treasure house scene to which the branch scene can be transferred is stored in the transfer destination scene, and a weight is set for each transfer destination. The selection probability of each transfer destination is determined on the basis of the weight set for the transfer destination.

(Minor Bonus Game: Table: Expected Dividend Value Determination Table)

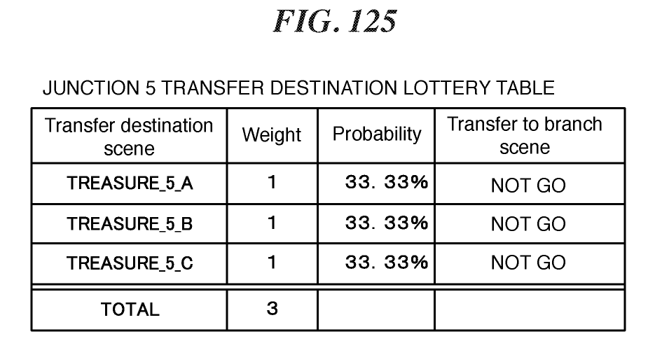

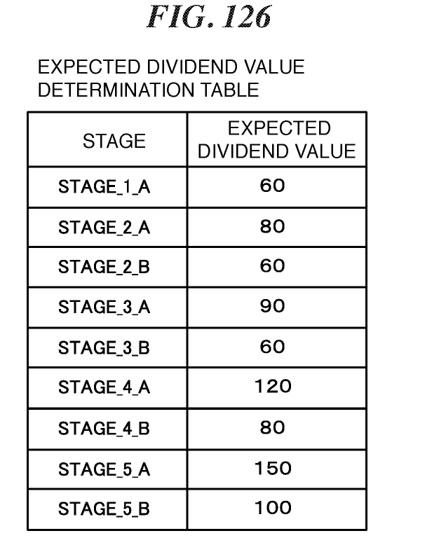

Referring to FIG. 126, an expected dividend value determination table is described. The expected dividend value determination table is used in the determination of the expected dividend values in the corridor scenes (F401) in the minor bonus game execution processing (see FIG. 119). In the expected dividend value determination table, an expected dividend value is associated with each of the corridor scenes stored as stages. In other words, in the determination of the expected dividend values in the corridor scenes, an expected dividend value corresponding to the executed corridor scene is selected. Thus, the expected dividend value from the entire minor bonus game is the total of the expected dividend values in all the corridor scenes constituting the minor bonus game. Because it is determined by lottery which of the corridor scenes is selected, the expected value can be made different every time the minor bonus game is executed. This further reduces the possibility of the player recognizing that the credits that can be obtained in the entire minor bonus game are previously determined.

(Minor Bonus Game: Table: Arranged Coin Number Table)

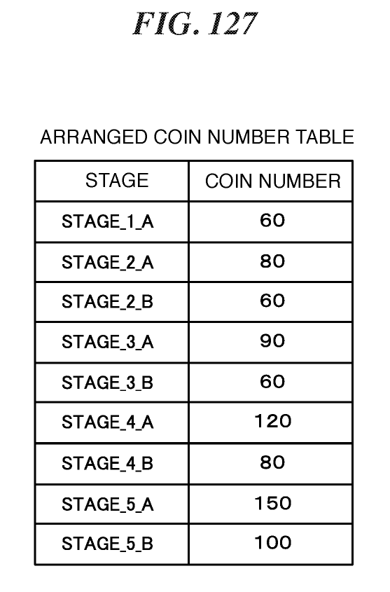

Referring to FIG. 127, an arranged coin number table is described. The arranged coin number table is used in the selection by lottery of the dividends from coins and their arrangement (F402) in the minor bonus game execution processing (see FIG. 119). In the arranged coin number table, a coin number is associated with each of the corridor scenes stored as stages. In other words, in the selection by lottery of the dividends from coins and their arrangement, a coin number corresponding to the executed corridor scene is selected. A plurality of types of arrangement of coins is prepared for each stage (corridor scene) in advance, and one of them is selected by lottery.

(About Dividend Per Coin)

Here, a method for determining the dividend per coin is described. As shown in FIG. 119, the dividend per coin is determined for each stage (corridor scene). As the dividend per coin, a value obtained by dividing the “remaining expected dividend value” by the “total number of coins in the remaining stages including the current stage (which is hereinafter referred to as “remaining coin number”)” and rounding the resulting value down to the nearest integer.

Specifically, the calculation of the dividend per coin in the “STAGE_1_A” in a case where the player reaches “TREASURE_4” through “STAGE_1_A,” “STAGE_2_A,” “STAGE_3_B” and “STAGE_4_A” is described. The expected dividend values are determined to be 60, 80, 60 and 120 for “STAGE_1_A,” “STAGE_2_A,” “STAGE_3_B” and “STAGE_4_A,” respectively, with reference to the expected dividend value determination table (FIG. 126). Thus, the total of the dividends is 320. Because no coin has been taken as “STAGE_1_A” has not been started, the “remaining expected dividend value” is set to 320, which is equal to the total of dividends. The coin numbers are determined to be 60, 80, 60 and 120 for “STAGE_1_A,” “STAGE_2_A,” “STAGE_3_B” and “STAGE_4_A,” respectively, with reference to the arranged coin number table (FIG. 127). Because no coin has been taken as “STAGE_1_A” has not been started, the “remaining coin number” is set to 320, which is equal to the total of the above coin numbers. Thus, a dividend per coin of 1 is obtained by dividing the “remaining expected dividend value” 320 by the “remaining coin number” 320.

A case where the dividend per coin in “STAGE_3_B” is calculated under the same conditions is described. However, the description is based on the assumption that no coin has been taken in “STAGE_1_A” and “STAGE_2_A.” Because the “remaining expected dividend value” is reduced every time a coin is collected, the “expected dividend value” remains unchanged from the initial set value 320 in this case. Because the coin numbers are determined to be 60 and 120 for “STAGE_3_B” and “STAGE_4_A,” respectively, with reference to the arranged coin number table (FIG. 127), the remaining coin number is set to 180, which is equal to the total of the above coin numbers. Thus, a dividend per coin of 1 is obtained by dividing the “remaining expected dividend value” 320 by the “remaining coin number” 180 and rounding the resulting value down to the nearest integer.

When no coins has been taken in “STAGE_1_A,” “STAGE_2_A” and “STAGE_3_B,” a dividend per coin of 2 is obtained by dividing the “remaining expected dividend value” 320 by the “remaining coin number” 120 and rounding the resulting value down to the nearest integer.

(Minor Bonus Game: Table: Basic Dividend Table)

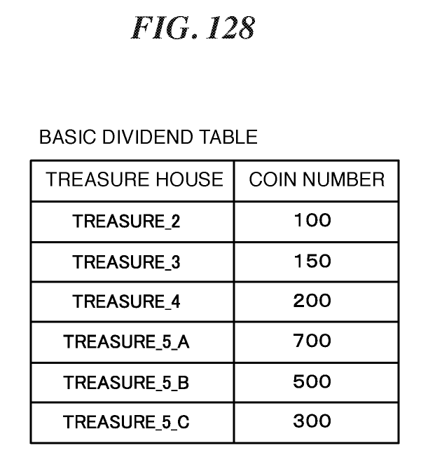

Referring to FIG. 128, a basic dividend table is described. The basic dividend table is used in the determination of the dividend in a treasure house scene (F411) in the minor bonus game execution processing (see FIG. 119). In the basic dividend table, a dividend is associated with each treasure house scene. In other words, in the determination of the dividend in a treasure house scene, a dividend corresponding to the treasure house scene that is acquired with reference to the basic dividend table is added to the “remaining expected dividend value.”

(About Dividend from Treasure House Scene)

Here, referring to FIG. 129, the processing for determining the dividend in a treasure house scene is described. First, the main CPU 71 cumulatively adds a basic dividend to the “remaining expected dividend value” (F450). The “remaining expected dividend value” has been updated, every time the player acquired a dividend by overlapping the character with a coin in the corridor scenes, by subtracting the dividend therefrom. In other words, the “remaining expected dividend value” is a value obtained by subtracting all the coin dividends (additional dividends) from the “expected dividend value.” The main CPU 71 cumulatively adds a basic dividend associated with each treasure house scene in the basic dividend table (see FIG. 128) to the “remaining expected dividend value.”

Next, the main CPU 71 calculates a LOWER value (F451). The LOWER value is a value obtained by rounding the “remaining expected dividend value” down to a predetermined place value (in this embodiment, to the nearest hundred). Next, the main CPU 71 calculates a HIGHER value (F452). The HIGHER value is a value obtained by rounding the “remaining expected dividend value” up to a predetermined place value (in this embodiment, to the nearest hundred). The additional dividend that is awarded to the player in a treasure house scene is a credit value corresponding to either the LOWER value or the HIGHER value. When the LOWER value and the HIGHER value are calculated, the same basic digit number is used.

Next, the main CPU 71 calculates a weight for the HIGHER value (F453). The weight for the HIGHER value is a value obtained by subtracting the LOWER value from the “remaining expected dividend value” determined in step F450. Then, the main CPU 71 calculates a weight for the LOWER value (F454). The weight for the LOWER value is a value obtained by subtracting the “remaining expected dividend value” determined in step F450 from the HIGHER value.

Next, the main CPU 71 selects either the HIGHER value or the LOWER value by lottery based on the weight for the HIGHER value and the weight for the LOWER value (F455).

Then, the main CPU 71 determines whether or not the HIGHER value is selected by lottery (F456). When the HIGHER value is selected (F456: YES), credits corresponding to the HIGHER value are determined as the additional dividend (F457). When the HIGHER value is not selected (F456: NO), credits corresponding to the LOWER value are determined as the additional dividend (F458).

As described above, the HIGHER value is selected as an additional dividend with a probability equal to a value obtained by dividing a “value obtained by subtracting the LOWER value from the residual expected value” by a “value obtained by subtracting the LOWER value from the HIGHER value.” The LOWER value is selected as an additional dividend with a probability equal to a value obtained by dividing a “value obtained by subtracting the residual expected value from the HIGHER value” by a “value obtained by subtracting the LOWER value from the HIGHER value.” Because this allows the additional dividend to have a round number with the figures below a predetermined digit being “0,” the possibility of the player recognizing that the credit that can be acquired in the entire bonus game is previously determined may be reduced. Consequently, there is a possibility that the player can retain an interest in the intervention into the progress of the bonus game.

(Major Bonus Game)

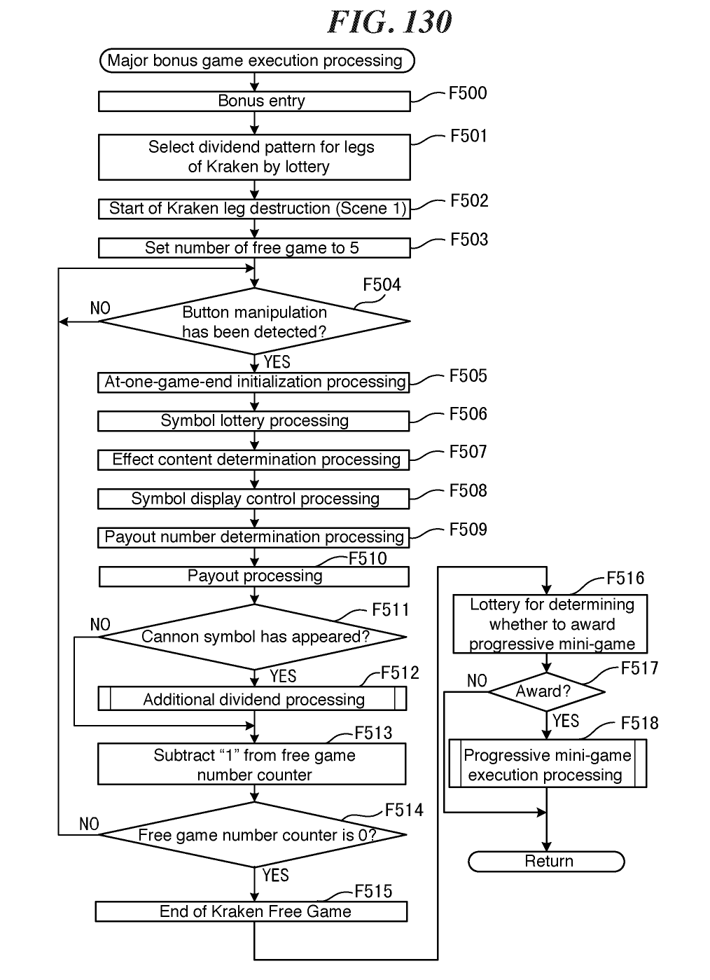

Now, referring to FIG. 130, bonus game execution processing (Major bonus game execution processing) in a case where Kraken Free Game (Major bonus game) is executed is specifically described.

(Major Bonus Game: Major Bonus Game Execution Processing)

First, the main CPU 71 executes bonus entry processing (F500). In other words, settings for introduction effect and symbol arrangement and so on are configured. Then, the main CPU 71 selects a dividend pattern for the legs of Kraken by lottery (F501). In other words, the main CPU 71 determines dividends for the eight legs that appear on the upper image display panel 131. Then, the main CPU 71 start a Kraken leg destruction scene of scene 1 (F502). Then, the main CPU 71 sets the number of free games to five (F503).

Then, the main CPU 71 determines whether or not a button manipulation has been detected (F504). While the bet buttons are used to progress the free games, for example, the present invention is not limited thereto. When it is determined no button manipulation has been detected (F504: NO), the gaming machine waits for a button manipulation. However, processing for counting a predetermined period of time may be executed and the next step may be started when a predetermined period of time has passed.

On the other hand, when it is determined that a button manipulation has been detected (F504: YES), the main CPU 71 executes at-one-game-end initialization processing (F505) as in the case of the main control processing. Next, the main CPU 71 executes symbol lottery processing (F506) similar to that in the main control processing.

Next, the main CPU 71 executes effect content determination processing (F507) as in the case of the main control processing. Next, the main CPU 71 executes symbol display control processing (F508) as in the case of the main control processing. Next, the main CPU 71 executes payout number determination processing (F509) as in the case of the main control processing.

Next, the main CPU 71 executes payout processing (F510). In this payout processing, the main CPU 71 adds the dividend determined in the payout number determination processing in S108 to the win meter 402 and to the value stored in a free game payout number counter. The free game payout number counter is a region in which the total of payout numbers determined during the free games is stored. Then, when the free game processing is completed, the main CPU 71 adds the value stored in the free game payout number counter to the value stored in a credit number counter in the RAM 73. In other words, the total of payout numbers determined in the free games is collectively paid out.

Next, the main CPU 71 determines whether or not at least one cannon symbol has appeared in the video reels 151 to 155 (F511). When at least one cannon symbol has appeared (F511: YES), additional dividend processing is executed (F512). The additional dividend processing is described later. When no cannon symbol has appeared (F511: NO) or after the additional dividend processing is completed, the main CPU 71 subtracts one from the value stored in a free game number counter (F513).

Next, the main CPU 71 determines whether or not the value stored in the free game number counter is 0 (F514). When it is determined that the value stored in the free game number counter is not 0 (F514: NO), the main CPU 71 proceeds to the processing in F504.

On the other hand, when it is determined that the value stored in the free game number counter is 0 (F514: YES), the Kraken Free Game is terminated (F515). After that, the main CPU 71 performs a lottery for determining whether or not to award a progressive mini-game (Jackpot game) (F516). Then, the main CPU 71 determines whether or not the player is awarded a progressive mini-game (F517). When the player is awarded a progressive mini-game (F517: YES), the main CPU 71 terminates this routine and returns the process to the branching game processing after executing jackpot game execution processing (F518). When the player is not awarded a progressive mini-game (F517: NO), the main CPU 71 terminates this routine and returns the process to the branching game processing.

(Major Bonus Game: Additional Dividend Processing)

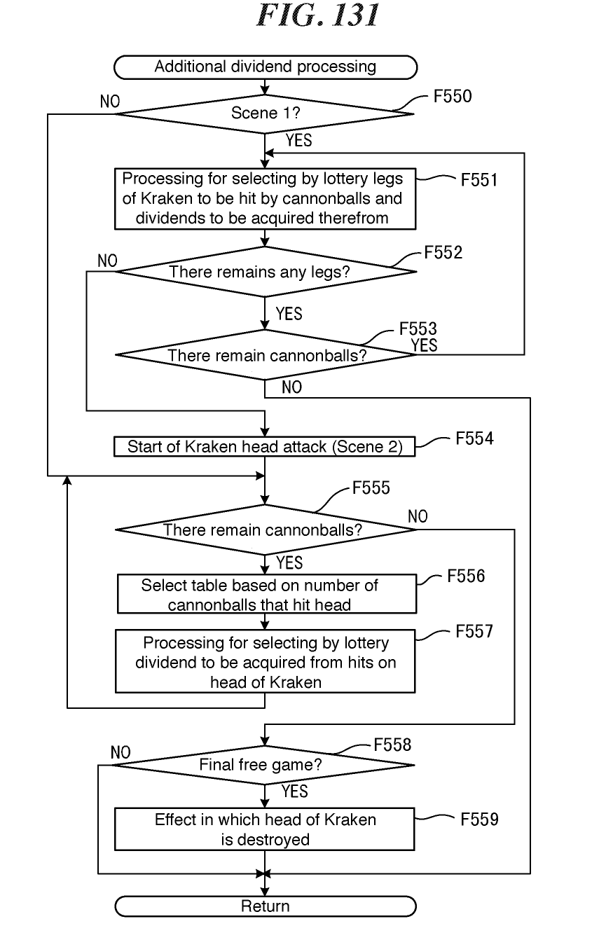

Now, referring to FIG. 131, additional dividend processing executed in step F512 of the major bonus game execution processing is specifically described.

First, the main CPU 71 determines whether or not the current scene is scene 1 (Kraken leg destruction scene) (F550). When the current scene is scene 1, the main CPU 71 executes processing for selecting by lottery the legs of Kraken to be hit by cannonballs and dividends to be acquired therefrom (F551). In other words, the main CPU 71 determines which of the legs is hit by each shot cannonball and awards a dividend corresponding to the leg hit by the cannonball. After that, the main CPU 71 determines whether or not there remain any legs (F552). When there remains any legs (F552: YES), the main CPU 71 determines whether or not there remain cannonballs (F553). The number of cannonballs is determined by the number of the cannon symbols 506 rearranged in the video reels 151 to 155. In other words, the player can attack the same number of times as the number of the cannon symbols 506 that appear every time the video reels 151 to 155 are rearranged. When there remain cannonballs (F553: YES), the main CPU 71 advances the process to step F551 and the player can attack the legs again. On the other hand, when there remains no cannonball (F553: NO), the main CPU 71 terminates this routine and returns the process to the major bonus game execution processing.

When there remains no leg in step F552 (F552: NO), the main CPU 71 starts the Kraken head attack scene of scene 2 (F554). When the current scene is not scene 1 in step F550 (the current scene is scene 2) (F550: NO) or after the Kraken head attack scene of scene 2 is started in step F554, the main CPU 71 determines whether or not there remain cannonballs (F555).

When it is determined that there remain cannonballs in step F555, the main CPU 71 selects a table on the basis of the number of cannonballs that hit the head (F556). In other words, the main CPU 71 counts the number of hits every time the head is attacked although not shown. Then, the main CPU 71 executes processing for selecting by lottery the dividend to be acquired from the hits on the head of Kraken (F557). In other words, the main CPU 71 determines a dividend by lottery using the table selected in step F556. After that, the main CPU 71 advances the process to step F555 again, and determines whether there remain cannonballs.

When it is determined in step F555 that there remains no cannonball (F555: NO), the main CPU 71 determines whether or not the current game is the final free game (F558). Then, when the current game is the final free game (F558: YES), the main CPU 71 produces an effect in which the head of Kraken is destroyed (F559). After producing an effect in which the head of Kraken is destroyed in step F559 or when it is determined in step F558 that the current game is not the final free game, the main CPU 71 terminates this routine and returns the process to the major bonus game execution processing.

(Modifications of Major Bonus Game)

As described above, in the major bonus game of this embodiment, free games that require no bet are repeated and dividends different from the line dividends can be acquired on the basis of the number of the cannon symbols 506 rearranged. Then, depending on the number of cannon symbols 506 rearranged, the scene is changed from scene 1 to scene 2. When at least one cannon symbol 506 is rearranged in the final free game, an ending effect in which Kraken is destroyed is always produced on the upper image display panel 131 (see FIG. 70). However, the present invention is not limited thereto. A lottery for determining whether or not to produce an ending effect may be performed and a dividend may be awarded when an ending effect is produced as described below.

For example, the gaming machine may include: a symbol display device (the lower image display panel 141) having a plurality of variable display regions (the video reels 151 to 155), in each of which, after a symbol array in which symbols (symbols 501) are arranged is variably displayed, some of the symbols (symbols 501) arranged in the symbol array are rearranged one each in a plurality of blocks (the display blocks 28) in the variable display regions (the video reels 151 to 155); and a controller (the main CPU 71 or the like) for executing a base game that requires betting and a bonus game (Major bonus game) in which a plurality of free games that are triggered in the base game and require no betting are executed from the first to Nth times, controls the symbol display device (the lower image display panel 141) according to the games and displays the result. The controller (the main CPU 71 or the like) awards, when a predetermined number or more of symbols (the symbols 501) of the same type are located on any of effective lines as a result of the rearrangement of the symbols (the symbols 501), a line dividend according to the type of the symbols (the symbols 501); awards, when there appear one or more specific symbols (cannon symbols 506) as a result of the execution of the free game and rearrangement of the symbols (the symbols 501), an additional dividend according to the number of the specific symbols (the cannon symbols 506) sequentially in addition to the line dividend; and awards, when one or more specific symbols are rearranged in the Nth free game (final free game) of the first to Nth free games, an additional special dividend in addition to the line dividend and the additional dividend with a probability determined by the number of the specific symbols rearrange in all the plurality of free games including the Nth free game.

In other words, the probability with which an effect in which Kraken is destroyed by the final attack is displayed increases depending on the number of attacks to the legs or head of Kraken (as the number of attacks is greater). Then, the controller (the main CPU 71) may produce the ending effect only when the special dividend is awarded. The special dividend may offer a greater number of credits than the additional dividends.

(Major Bonus Game: Table)

Tables used in the major bonus game are described.

(Major Bonus Game: Table: Leg Dividend Pattern Table)

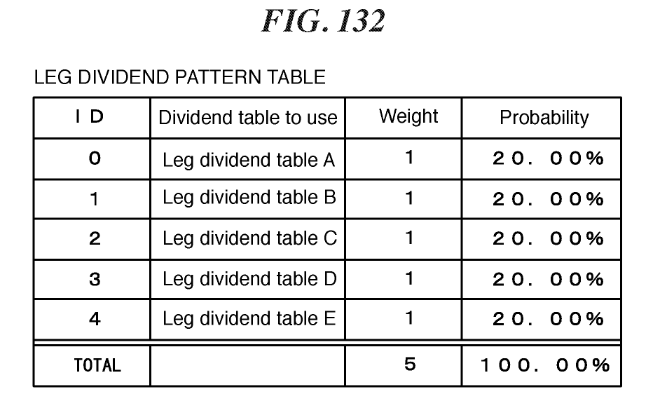

Referring to FIG. 132, a leg dividend pattern table is described. The leg dividend pattern table is used in the selection by lottery of a dividend pattern for the legs of Kraken (F501) in the major bonus game execution processing (see FIG. 130). As shown in FIG. 132, in the leg dividend pattern table, one of leg dividend tables (leg dividend tables A to E) used as leg dividend patterns is associated with each of stored IDs in which any of “0” to “5” is stored. The selection probability of each ID is determined by a weight set for the ID. The same weight is set for the IDs in the leg dividend pattern table, and each leg dividend table is selected with an equal probability.

(Major Bonus Game: Table: Leg Dividend Table)

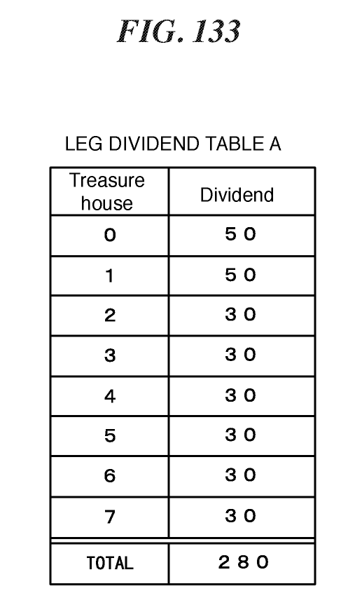

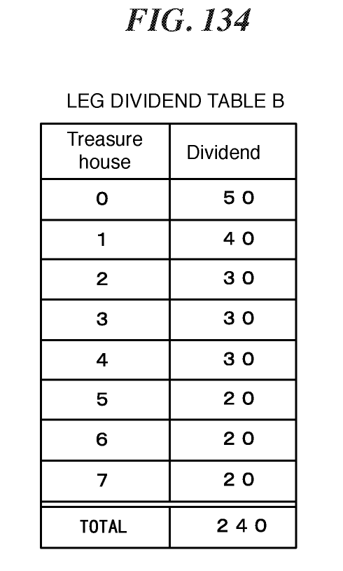

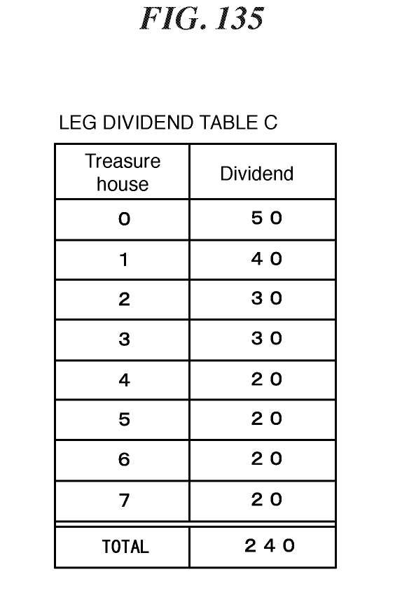

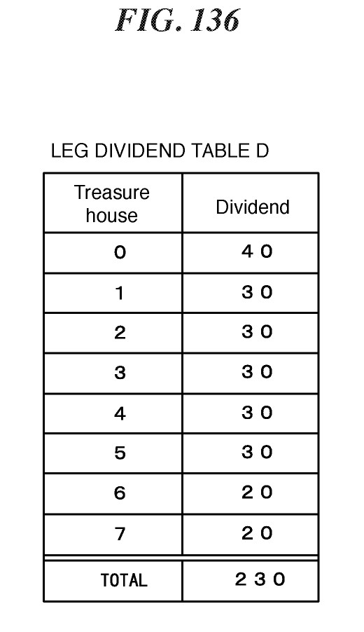

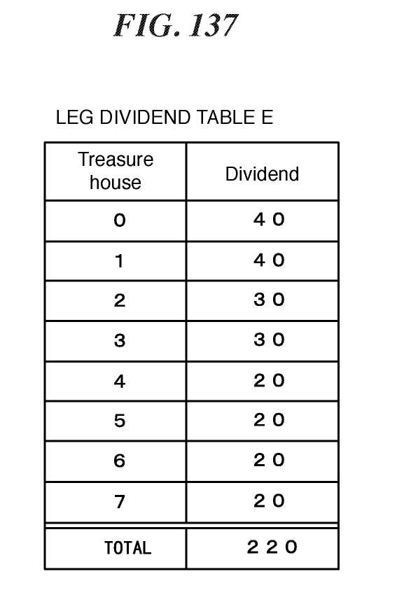

Referring to FIG. 133 to FIG. 137, the leg dividend tables (leg dividend table A, leg dividend table B, leg dividend table C, leg dividend table D and leg dividend table E) are described. The leg dividend tables are used in the selection by lottery of the dividend pattern for the legs of Kraken (F501) in the major bonus game execution processing (see FIG. 130). As shown in FIG. 133 to FIG. 137, in each leg dividend table, a dividend is associated with each of IDs in which one of “0” to “7” is stored. The selected leg dividend table is referred to in the selection by lottery of the legs of Kraken to be hit by cannonballs and dividends to be acquired therefrom (F551) in the additional dividend processing (see FIG. 131). In other words, a dividend corresponding to the ID of the leg selected from the remaining legs with an equal probability is awarded.

(Major Bonus Game: Table: Head Dividend Tables)

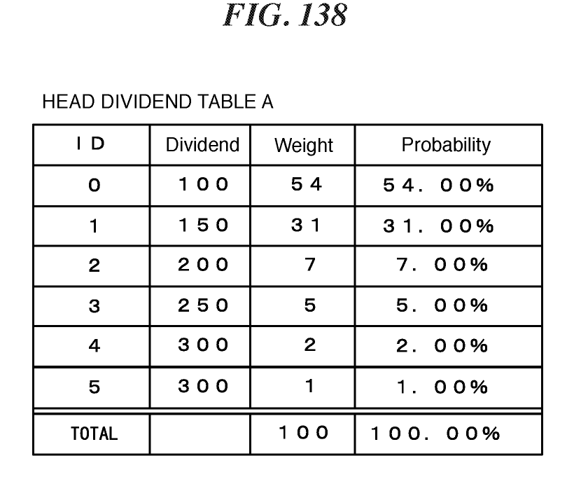

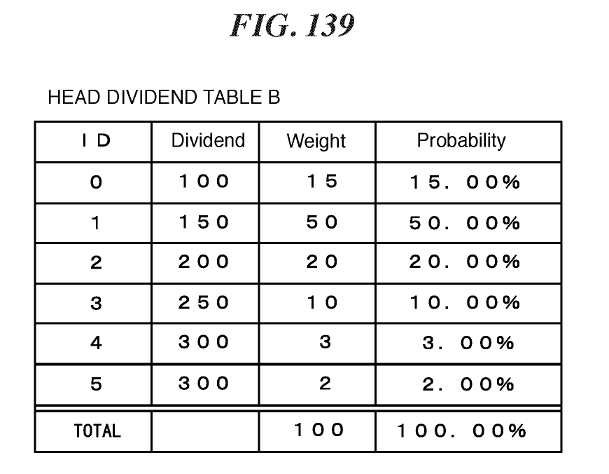

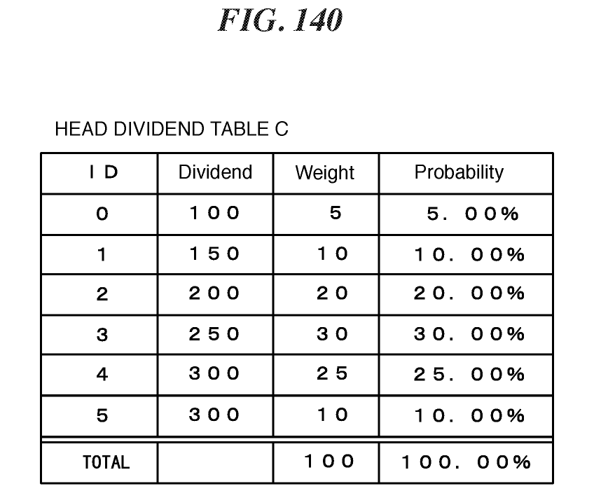

Referring to FIG. 138 to FIG. 140, head dividend tables (head dividend table A, head dividend table B and head dividend table C) are described. The head dividend tables are used in the selection of a table based on the number of cannonballs that hit the head (F556) and in the selection by lottery of the dividend to be acquired from the hits on the head of Kraken (F557) in the additional dividend processing (see FIG. 131). As shown in FIG. 138 to FIG. 140, in each head dividend table, a dividend is associated with each of IDs in which one of “0” to “5” is stored.

In the selection of a table based on the number of cannonballs that hit the head (F556), one of the head dividend table A, head dividend table B and head dividend table C is selected on the basis of the number of attacks already delivered on the head. Specifically, when the number of attacks already delivered on the head is one or two, the head dividend table A is selected. When the number of attacks already delivered on the head is three or four, the head dividend table B is selected. When the number of attacks already delivered on the head is five or more, the head dividend table C is selected. Then, in the selection by lottery of the dividend to be acquired from the hits on the head of Kraken (F557), it is determined by lottery which dividend is awarded with reference to the selected head dividend table.

(Grand Bonus Game)

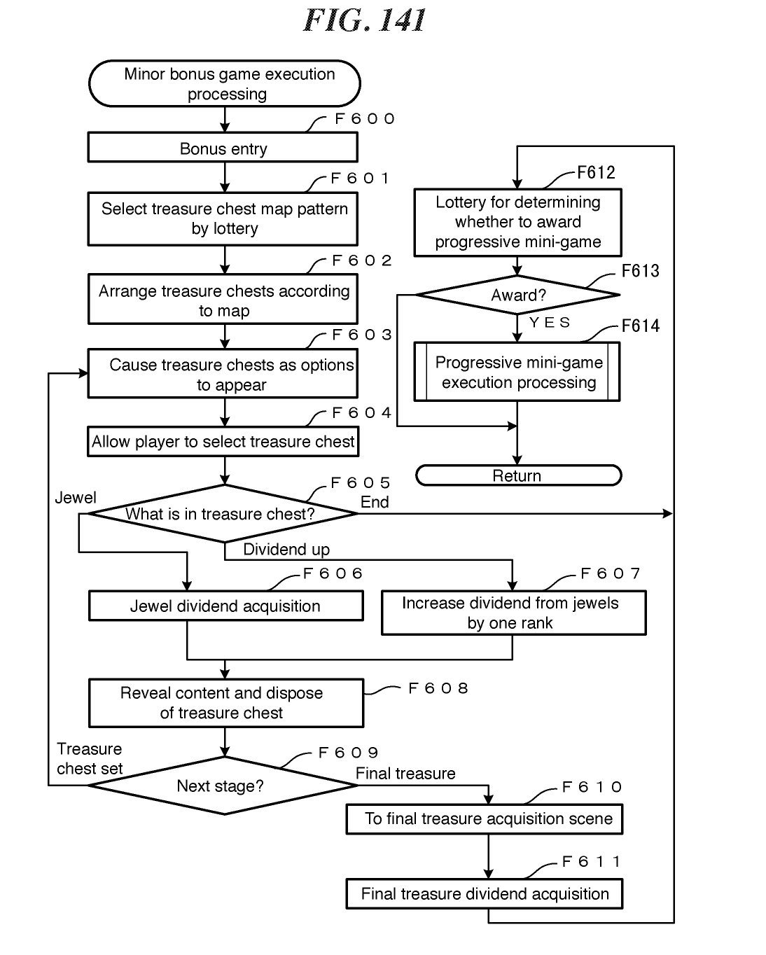

Now, referring to FIG. 141, bonus game execution processing in a case where Treasure Island Bonus (Grand bonus game) is executed (Grand bonus game execution processing) is specifically described.

(Grand Bonus Game: Grand Bonus Game Execution Processing)

First, the main CPU 71 executes bonus entry processing (F600). In other words, an introduction effect or the like is produced. Then, the main CPU 71 selects by lottery a treasure chest map pattern (F601) to determine treasure chests 1420 that appears as the option sets 1418 in each stage of the grand bonus game. Next, the main CPU 71 arranges all the treasure chests 1420 according to the selected map pattern on the upper image display panel 131 and the lower image display panel 141 (F602).

Then, the main CPU 71 causes the treasure chests 1420 as the option sets 1418 to appear in the option placing region 1419 (F603). Then, after the player selects one of the treasure chests 1420 (F604), the main CPU 71 determines the content of the treasure chest (F605).

When the treasure chest contains a jewel (F605: Jewel), the main CPU 71 executes jewel dividend acquisition processing (F606). In other words, the main CPU 71 distinguishes the type of the jewel and awards the player a dividend currently set for the type of jewel. When the treasure chest contains a dividend up (prize up) (F605: Dividend up), the main CPU 71 executes processing for increasing the level of the dividends from the jewels by one rank (F607). In other words, the level of the dividend currently set for each type of jewel is raised by one rank. In other words, when a jewel appears next time, the dividend from the jewel is raised. When the dividend currently set for each type of jewel has reached an upper limit, the main CPU 71 does not raise the level of the dividend. When the treasure chest contains end (F605: End), the main CPU 71 terminates this routine.

After step F606 or step F607, the main CPU 71 executes processing for revealing the contents of the treasure chests and disposing of the treasure chests (F608). In other words, the main CPU 71 displays the contents of the treasure chests 1420 that the player did not select and clears the treasure chests 1420 displayed in a line in the option placing region 1419 as an option set 1418.

Then, the main CPU 71 determines whether or not there is a next stage (F609). When there is a next stage (F609: Treasure chest set), the main CPU 71 advances the process to step F603, and allows the player to select a treasure chest 1420 again.

On the other hand, when there is no next stage in step F609 and the goal has been reached (F609: Final treasure), the main CPU 71 executes final treasure acquisition scene effect processing (F610). Then, the main CPU 71 executes final treasure dividend acquisition processing (F611). In other words, the main CPU 71 executes processing for awarding the player a goal dividend determined on the basis of the number of prize ups. As described above, keys may be randomly contained in the treasure chests 1420 together with a jewel or prize up so that the player can open the final treasure with the keys.

Then, the main CPU 71 performs a lottery for determining whether or not to award a progressive mini-game (Jackpot game) (F612). Then, the main CPU 71 determines whether or not the player is awarded a progressive mini-game (F613). When the player is awarded a progressive mini-game (F613: YES), the main CPU 71 terminates this routine and returns the process to the branching game processing after executing jackpot game execution processing (F614). When the player is not awarded a progressive mini-game, the main CPU 71 terminates this routine and returns the process to the branching game processing.

(Grand Bonus Game: Table)

Tables used in the grand bonus game are described.

(Grand Bonus Game: Table: Map Pattern Table)

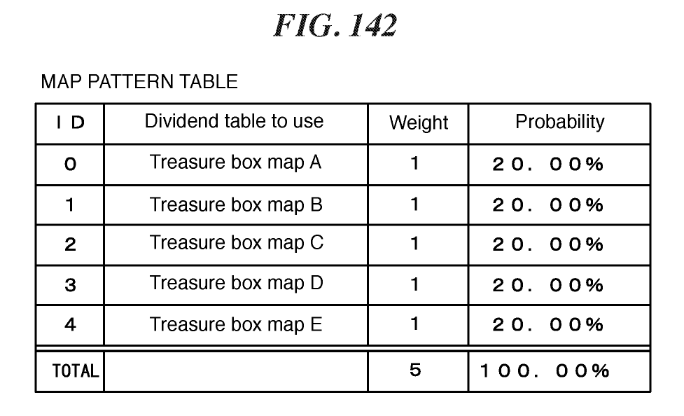

Referring to FIG. 142, a map pattern table is described. The map pattern table is used in the selection by lottery of a treasure chest map pattern (F601) in the grand bonus game execution processing (see FIG. 141). In the map pattern table shown in FIG. 142, one of treasure box map tables (treasure box map tables A to E) used as map patterns is associated with each of IDs in which one of “0” to “4” is stored. The selection probability of each ID is determined by a weight set for the ID. The same weight is set for the IDs in the map pattern tables, and each dividend table is selected with an equal probability.

(Grand Bonus Game: Table: Treasure Chest Content Table)

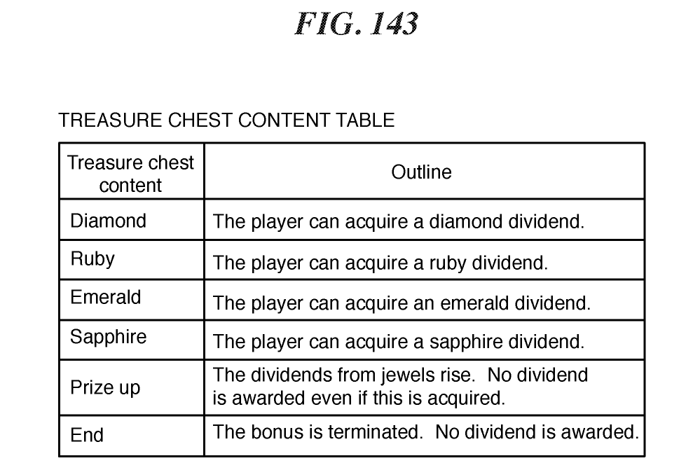

Referring to FIG. 143, a treasure chest content table is described. In the treasure chest content table, the items that can be selected as contents of the treasure chests 1420 are defined. The treasure chests 1420 contain a jewel (diamond, ruby, emerald or sapphire), prize up or end. When a jewel is selected, a dividend is awarded. When prize up is selected, the level of the dividend from each jewel is raised by one rank. When end is selected, the grand bonus game is terminated.

(Grand Bonus Game: Table: Treasure Box Map Tables)

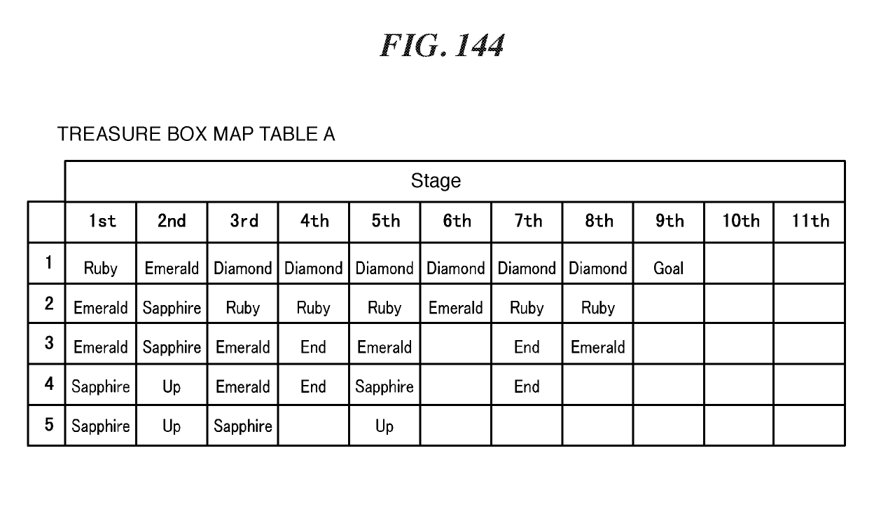

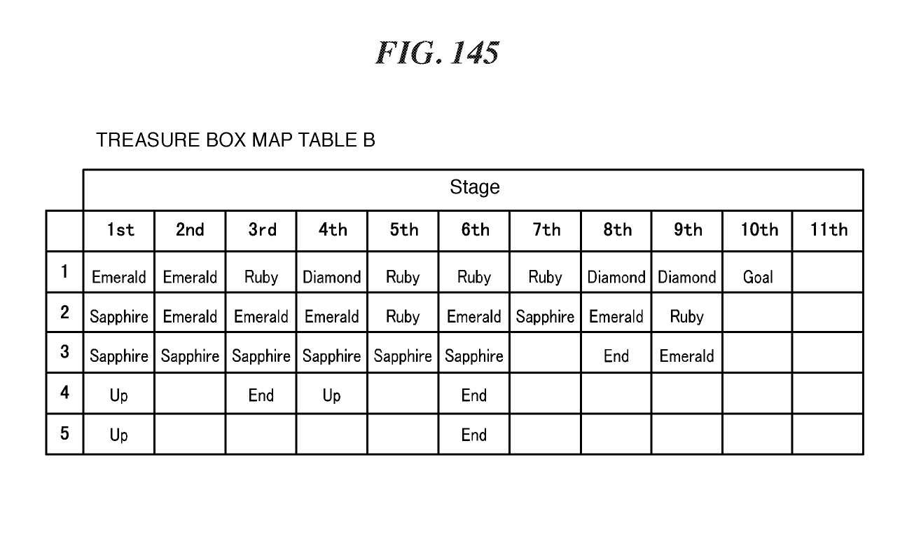

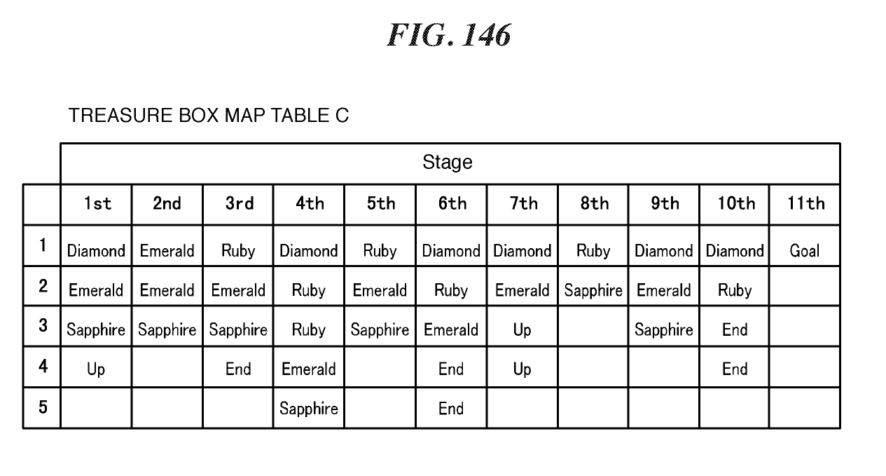

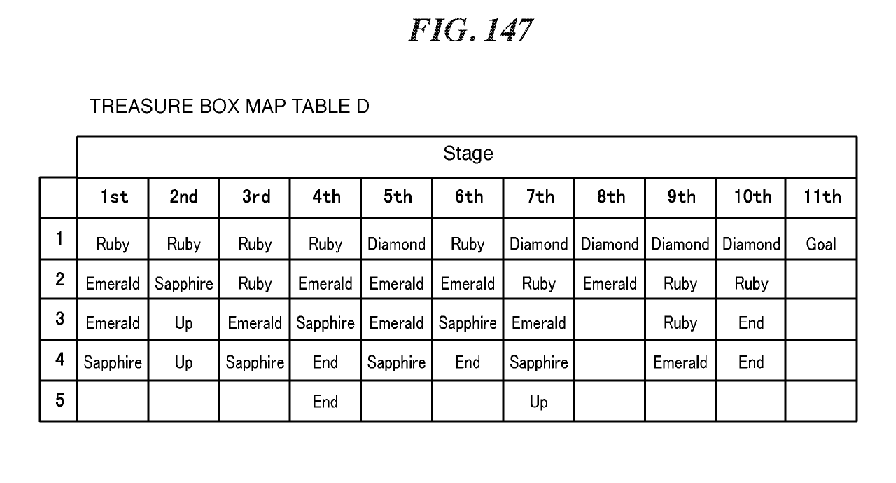

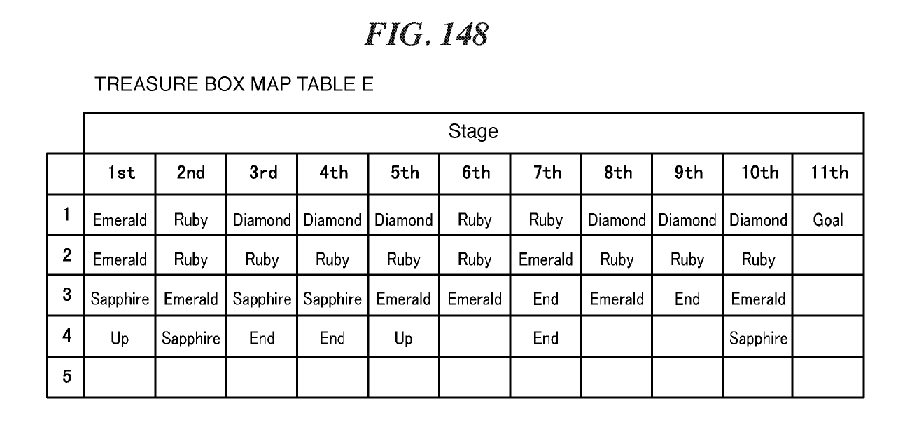

Referring to FIG. 144 to FIG. 148, treasure box map tables (treasure box map table A, treasure box map table B, treasure box map table C, treasure box map table D and treasure box map table E) are described. It is determined which of the treasure box map tables is used in the selection by lottery of a treasure chest map pattern (F601) in the grand bonus game execution processing (see FIG. 141). The treasure box map tables are used in arranging the treasure chests according to a map (F602) in the grand bonus game execution processing (see FIG. 141).

As shown in FIG. 144 to FIG. 148, in each of the treasure box map tables, at most five options, each indicating the content of a treasure chest, are associated with each of 1st to maximum 11th stages.

(Grand Bonus Game: Table: Jewel Dividend Table)

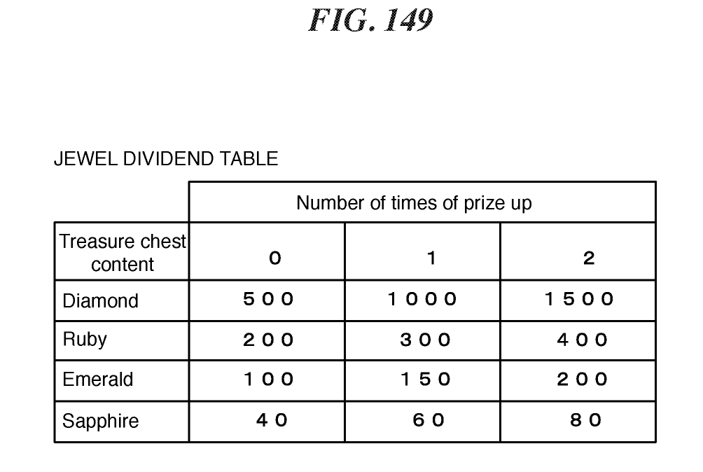

Referring to FIG. 149, a jewel dividend table is described. The jewel dividend table is used in jewel dividend acquisition processing (F606) and in raising the level of the dividends from the jewels (F607) in the grand bonus game execution processing (see FIG. 141). As shown in FIG. 149, in the jewel dividend table, a dividend is associated with each type of selectable jewels. Different dividends are set for different number of times of prize ups.

The jewel dividend table is referred to in the jewel dividend acquisition processing (F606) to acquire a dividend amount determined on the basis of the current number of times of prize ups and the selected jewel. The jewel dividend table is also referred to in raising the level of the dividends from the jewels by one rank (F607) to acquire a dividend amount corresponding to the number of times of prize ups obtained by adding one to the current number of times of prize ups. When the current number of times of prize ups is “2,” the level of the dividends from the jewels is not raised.

(Grand Bonus Game: Table: Final Treasure Dividend Table)

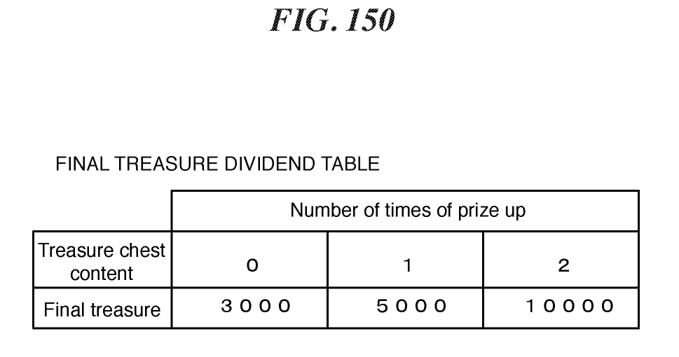

Referring to FIG. 150, a final treasure dividend table is described. The final treasure dividend table is used in the final treasure dividend acquisition processing (F611) in the grand bonus game execution processing (see FIG. 141). As shown in FIG. 150, in the final treasure dividend table, a dividend as the final treasure is associated with each number of times of prize ups.

The final treasure dividend table is referred to in the final treasure dividend acquisition processing (F611) to acquire a dividend amount determined on the basis of the current number of times of prize ups.

(Jackpot Game)

Now, Challenge for Jackpot (Jackpot game) is specifically described.

(Jackpot Game: Lottery for Determining Whether or not to Award a Progressive Mini-Game)

Processing for performing a lottery to determine whether or not to award a progressive mini-game that is executed in each bonus game execution processing is described.

(Jackpot Game: Lottery for Determining Whether or not to Award a Progressive Mini-Game: Progressive Mini-Game Generation Lottery Table)

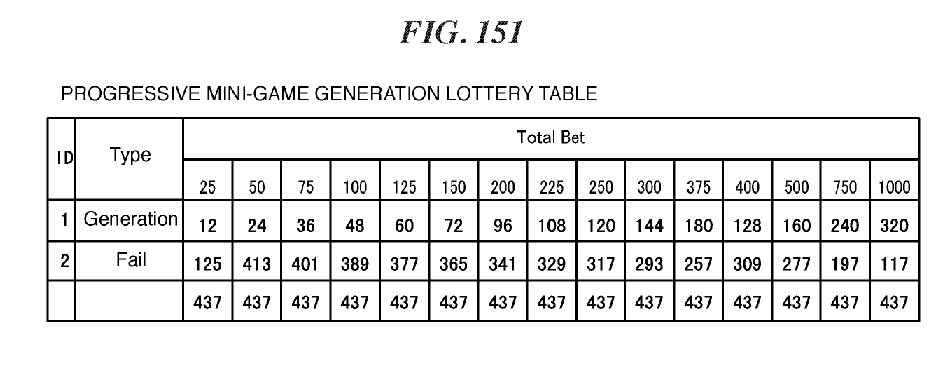

Referring to FIG. 151, a progressive mini-game generation lottery table used in the processing for performing a lottery to determine whether or not to award a progressive mini-game is described. As shown in the progressive mini-game generation lottery table in FIG. 151, a weight is set for each of two IDs “1” and “2” for each total bet.

In other words, the main CPU 71 acquires weights for “Generation” and “Fail” for the total bet number in a base game before each bonus game is executed with reference to the progressive mini-game generation lottery table in the processing for performing a lottery to determine whether or not to award a progressive mini-game. Then, the main CPU 71 performs a lottery using the weights. Then, when the “Generation” is selected, the main CPU 71 executes a jackpot game. When “Fail” is selected, the main CPU 71 returns the process to the base game without executing a jackpot game. As shown in FIG. 151, as the total bet amount is greater, the probability with which a jackpot game is executed is higher.

(Jackpot Game: Progressive Initial Value Settable Pattern Table)

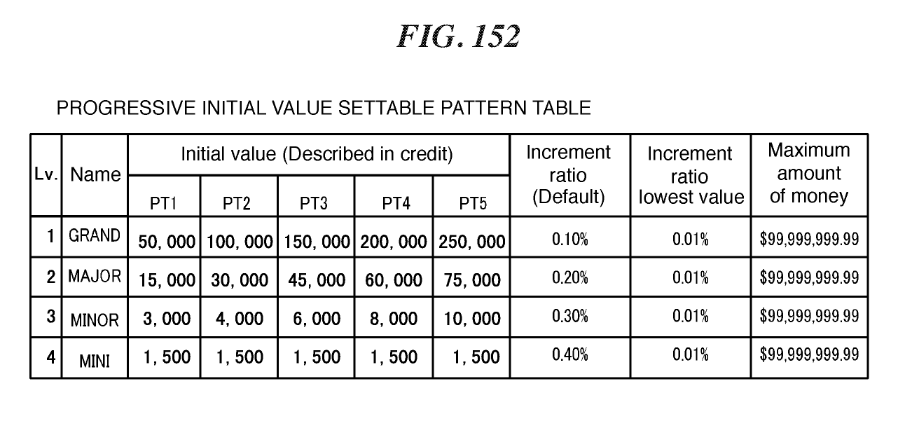

Referring to FIG. 152, a progressive initial value settable pattern table that is referred to in order to determine each jackpot amount before a jackpot game is started is described. As shown in FIG. 152, the initial value of a jackpot amount can be selected from five patterns. Which of the five patterns is selected is determined by preliminary settings. The jackpot amount is not multiplied on the basis of the bet amount of the player.

(Jackpot Game: Jackpot Game Execution Processing)

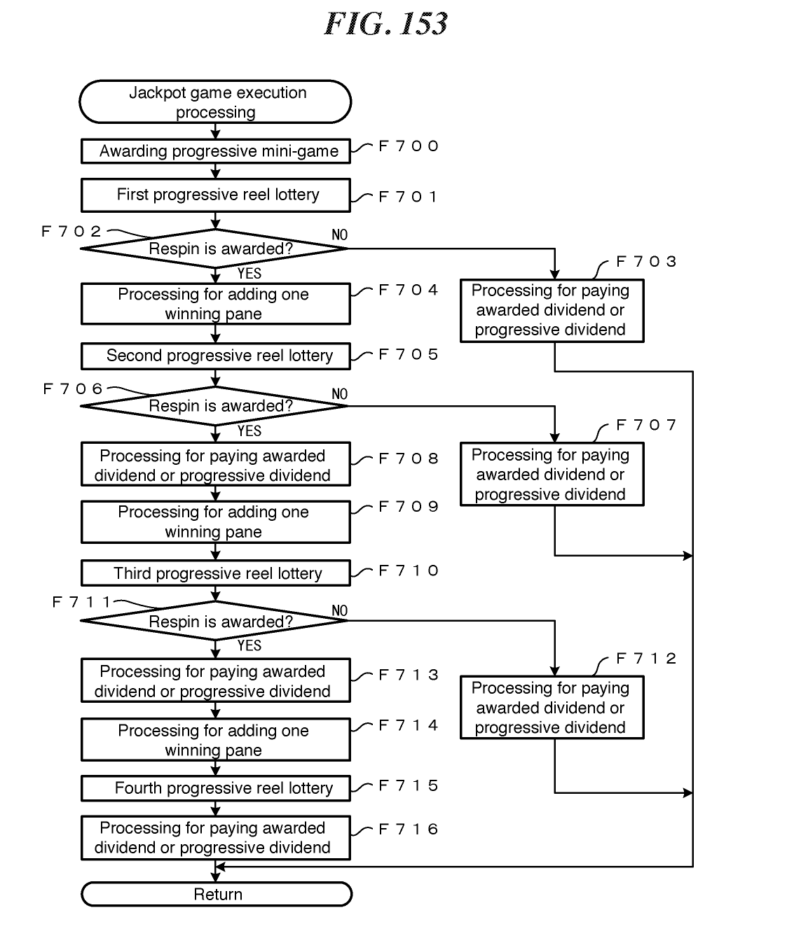

Referring to FIG. 153, Jackpot game execution processing that is invoked from each bonus game execution processing is described.

First, the main CPU 71 executes processing at a time of awarding a progressive mini-game (F700). Specifically, the main CPU 71 performs production of an introduction effect, selection of JP symbol arrays used in the JP video reel 160, and so on. Then, the main CPU 71 performs a first progressive reel lottery (F701). Then, the main CPU 71 determines whether or not the player is awarded a respin (F702). When the player is not awarded a respin (F702: NO), the main CPU 71 executes processing for paying an awarded dividend or a progressive dividend (F703). Then, the main CPU 71 terminates the current routine.

When the player is awarded a respin (F702: YES), the main CPU 71 executes processing for adding one winning pane (determination pane 161) (F704). Then, the main CPU 71 performs a second progressive reel lottery (F705). Then, the main CPU 71 determines whether or not the player is awarded a respin (F706). When the player is not awarded a respin (F706: NO), the main CPU 71 executes processing for paying an awarded dividend or a progressive dividend (F707). Then, the main CPU 71 terminates the current routine.

When the player is awarded a respin (F706: YES), the main CPU 71 executes processing for paying a dividend awarded in addition to the respin or a progressive dividend (F708). Then, the main CPU 71 executes processing for adding one more winning pane (determination position of the determination pane 161) (F709). Then, the main CPU 71 performs a third progressive reel lottery (F710). Then, the main CPU 71 determines whether or not the player is awarded a respin (F711). When the player is not awarded a respin (F711: NO), the main CPU 71 executes processing for paying an awarded dividend or a progressive dividend (F712). Then, the main CPU 71 terminates the current routine.

When the player is awarded a respin (F711: YES), the main CPU 71 executes processing for paying a dividend awarded in addition to the respin or a progressive dividend (F713). Then, the main CPU 71 executes processing for adding one more winning pane (determination position of the determination pane 161) (F714). Then, the main CPU 71 performs a fourth progressive reel lottery (F715). Then, the main CPU 71 executes processing for paying an awarded dividend or a progressive dividend (F716). Then, the main CPU 71 terminates the current routine.

(Jackpot Game: Tables)

Tables used in the jackpot game are described.

(Jackpot Game: Table: Progressive Reel Content Table)

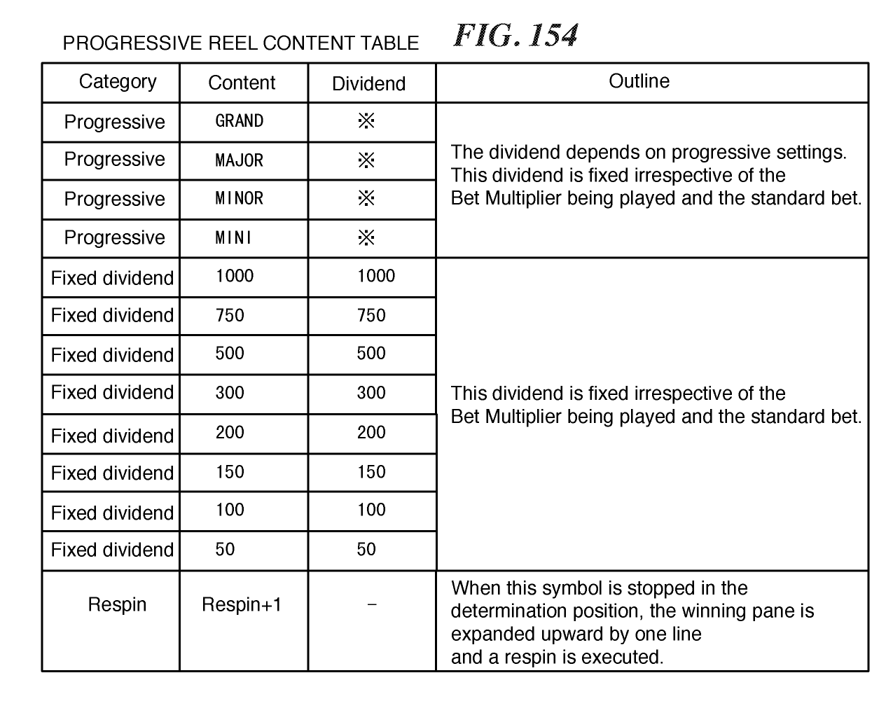

As shown in FIG. 154, the JP symbols 601 of the symbol array in the progressive reel (the JP video reel 160) can be divided into a progressive category, a fixed dividend category and respin. The JP symbols 601 in the progressive category are “GRAND,” “MAJOR,” “MINOR” and “MINI.” When the “GRAND” symbol enters the determination pane 161, a grand jackpot is awarded. When the “MAJOR” symbol enters the determination pane 161, a major jackpot is awarded. When the “MINOR” symbol enters the determination pane 161, a minor jackpot is awarded. When the “MINI” symbol enters the determination pane 161, mini-jackpot is awarded.

The JP symbols 601 in the fixed dividend category include symbols of “1000,” “750,” “500,” “300,” “200,” “150,” “100” and “50.” When a JP symbol 601 in the fixed dividend enters the determination pane 161, the same number of credits as the figure is awarded. When the JP symbol 601 of respin enters the determination pane 161, the JP video reel 160 can be scrolled once again after adding one determination position to the determination pane 161, and a winning determination is made in the expanded determination pane 161 after the scrolling is stopped.

(Jackpot Game: Table: JP Symbol Lottery Table)

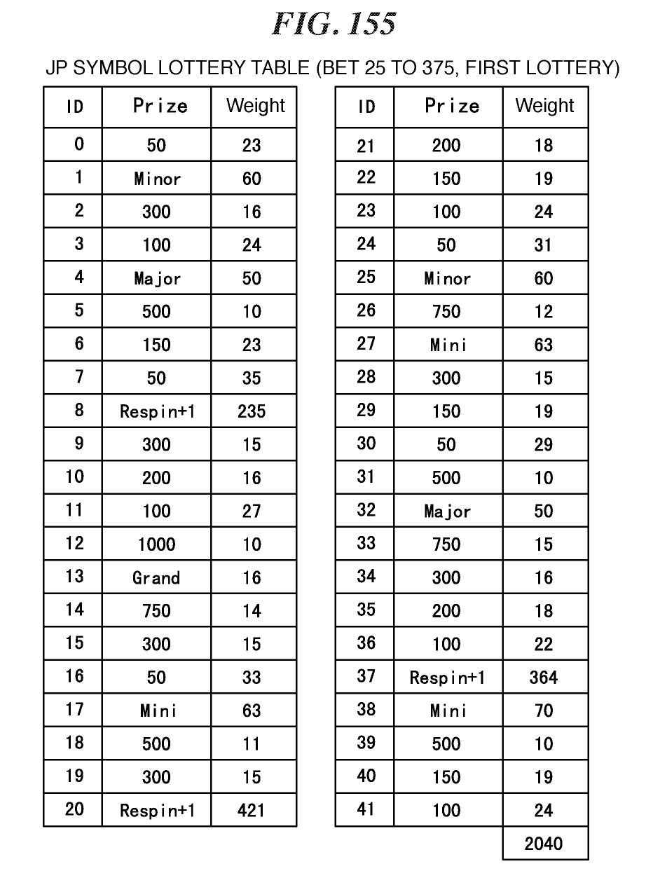

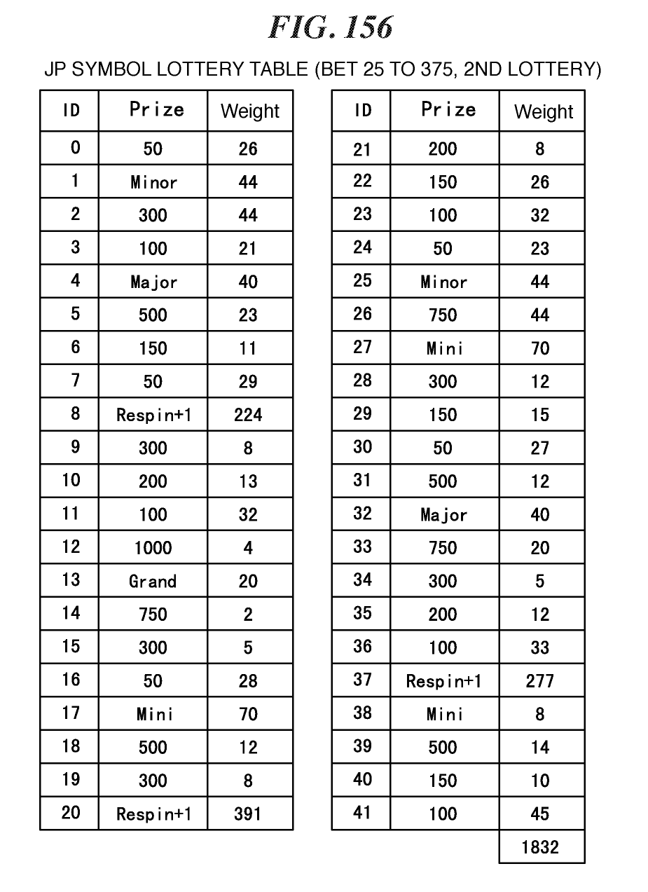

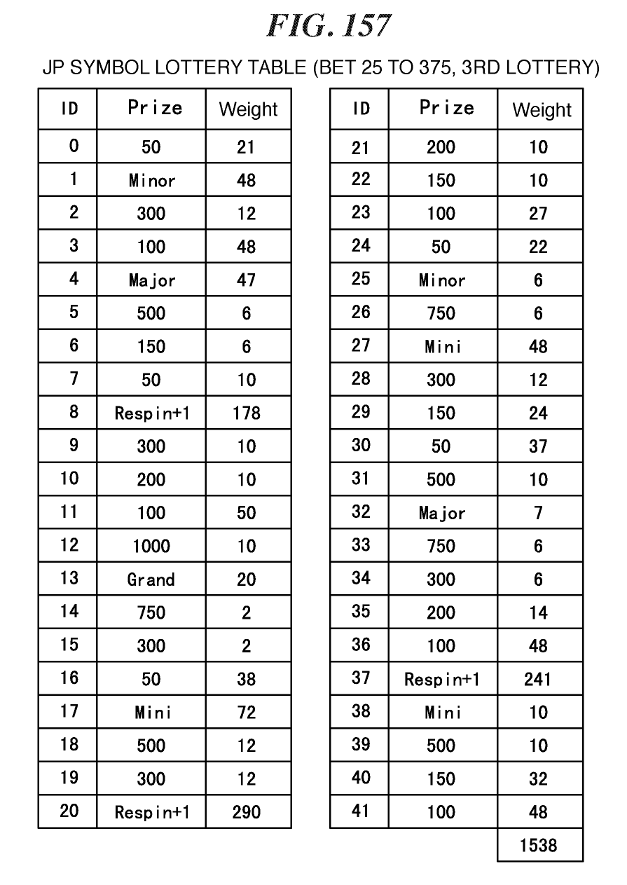

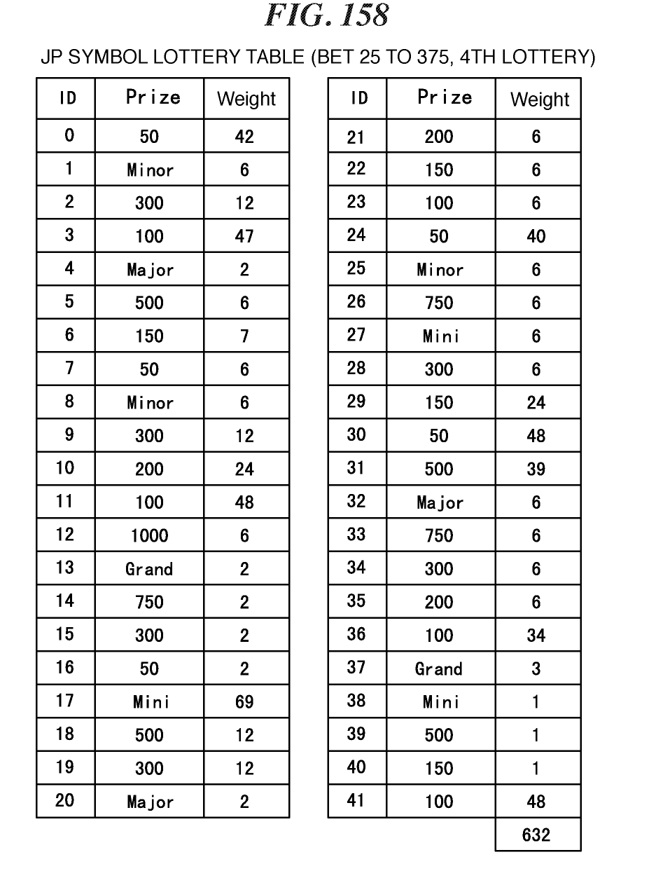

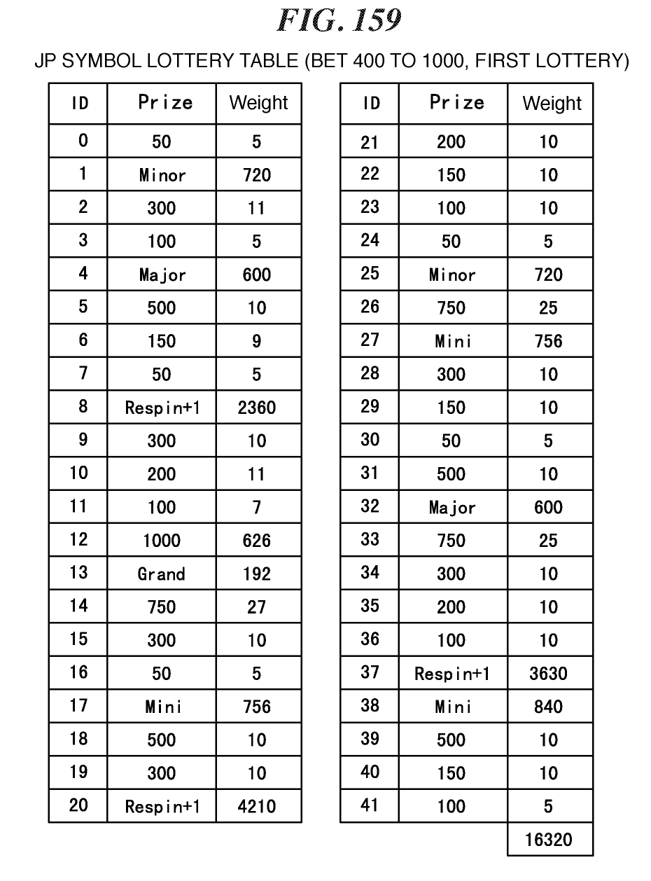

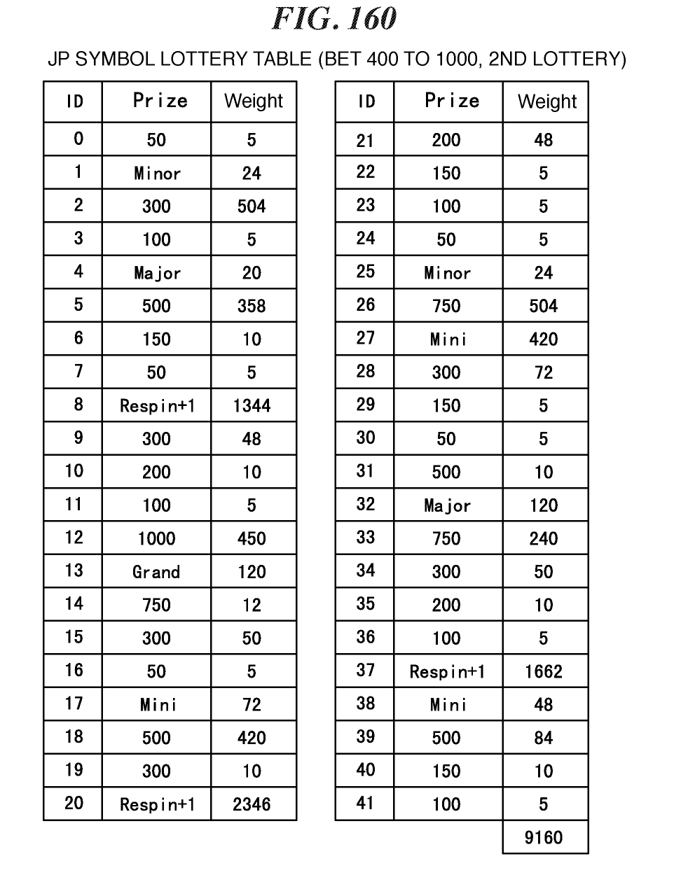

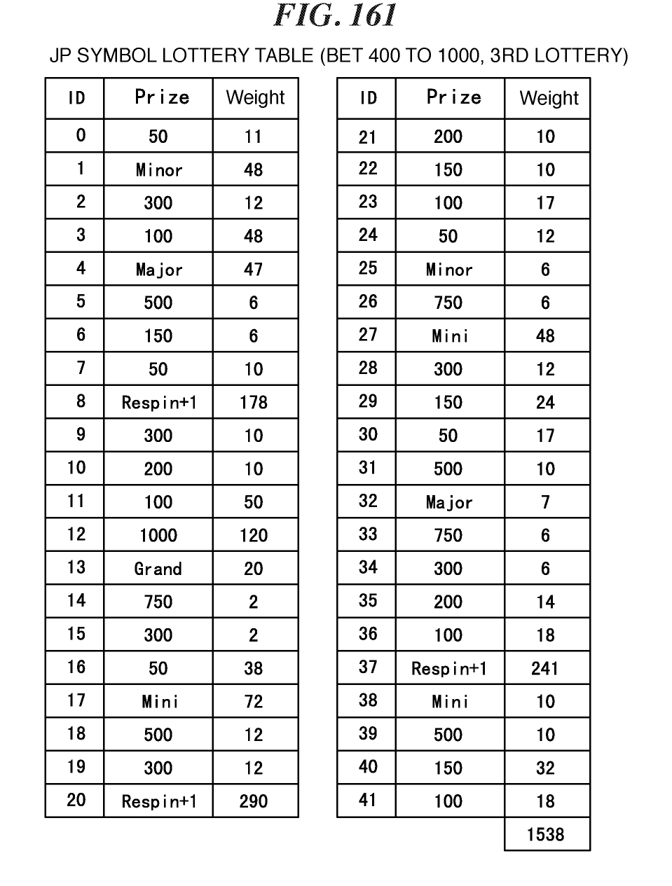

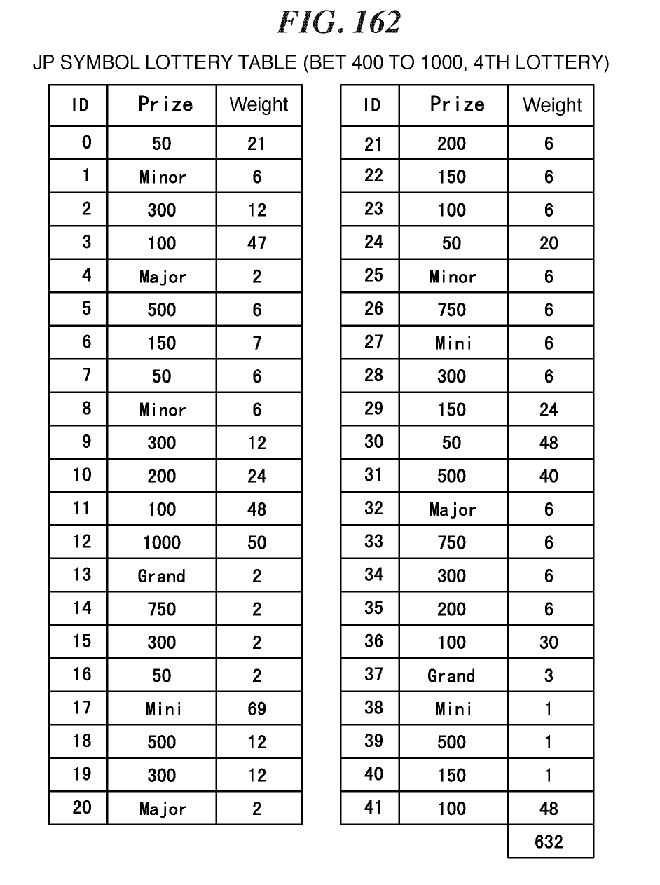

Referring to FIG. 155 to FIG. 162, JP symbol lottery tables in which each symbol in the symbol array of the JP video reel 160 is associated with a weight for the symbol are described. As shown in FIG. 155 to FIG. 162, a code number is associated with each of the JP symbols 601 arranged in the symbol array. In the first to fourth progressive reel lotteries (F701, F705, F710 and F715) in the jackpot game execution processing (see FIG. 153), a code number or code numbers of the JP symbol(s) 601 to be stopped in the determination pane 161 is determined by lottery. As shown in FIG. 155 to FIG. 162, a weight is set for each of the JP symbols 601 in the symbol array. In the first to fourth progressive reel lotteries (F701, F705, F710 and F715) in the jackpot game execution processing (see FIG. 153), the JP symbol(s) 601 to be stopped in the determination pane 161 is determined on the basis of the weights.

A different type of JP symbol lottery table is used depending on the total bet amount in the base game in which each bonus game that invokes a jackpot game is triggered. Specifically, different types of JP symbol lottery tables are used between when the total bet is 25 to 375 and when the total bet is 400 to 1000. A different type of JP symbol lottery table is used in each of the first to fourth progressive reel lottery (F701, F705, F710 and F715) in the jackpot game execution processing (see FIG. 153). In other words, a total of eight types JP symbol lottery tables are used differently.

(Other Configurations)

Other configurations adoptable to the slot machine 1 constituted as described above are described below.

(Bet Configuration)

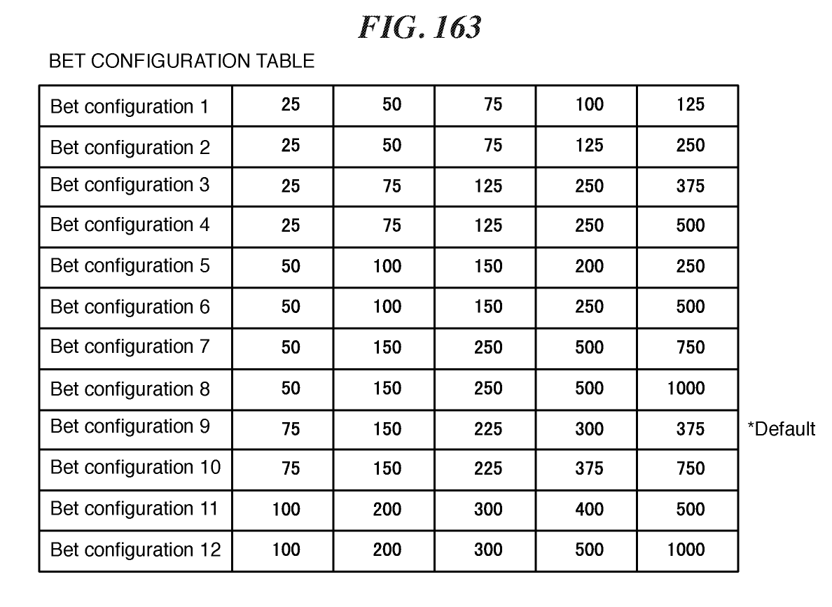

As shown in FIG. 163, in this embodiment, 12 types of bettable amount sets are prepared. The amounts that are bet by pressing the bet buttons 34, 35, 37, 38 and 39 are changed by previously selecting one of the 12 types of bet.

(Spin Table)

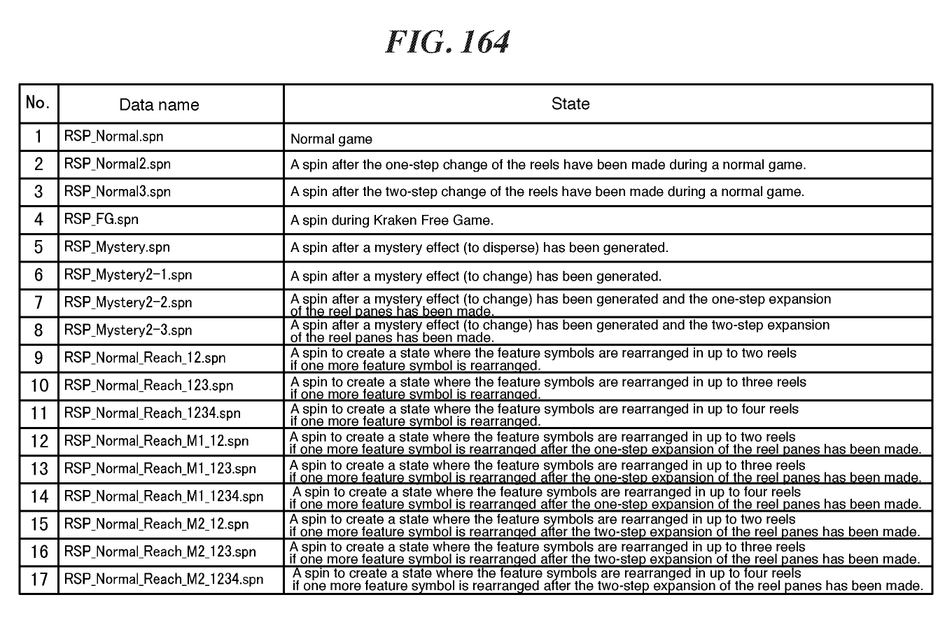

FIG. 164 is a spin table of spin data used depending on the playing state of the slot machine 1. The spin table has No. columns, data name columns and state columns. An effect from scroll display to stop of the video reels 151 to 155 is produced using the data stored in the data name column corresponding to the state stored in the state column.

(WIN Effects)

The effects that are produced on the upper image display panel 131 and the lower image display panel 141 at times of awarding a prize are described.

(WIN Effect: Pattern 1)

First, a pattern in which there is a line dividend from three kinds or more of top symbols and the criterion for a BIG WIN is not met (pattern 1) is described.

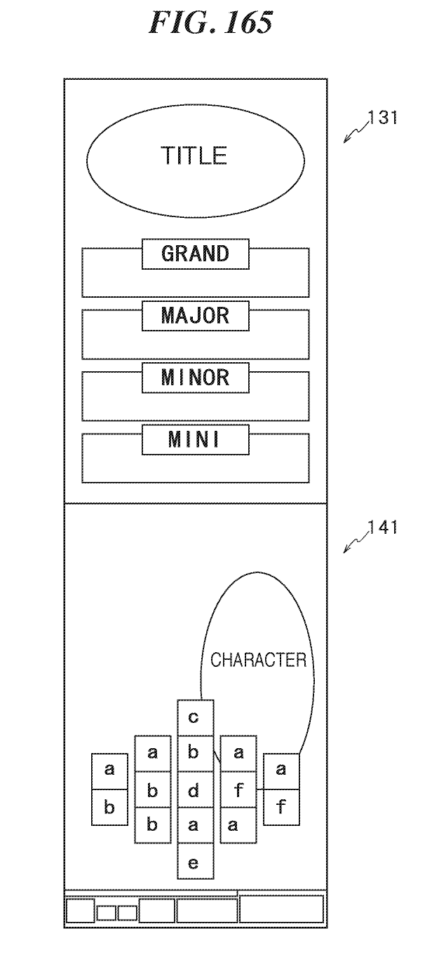

As shown in FIG. 165, the reels are stopped and wins are generated. The symbols indicated by “a” are the top symbols.

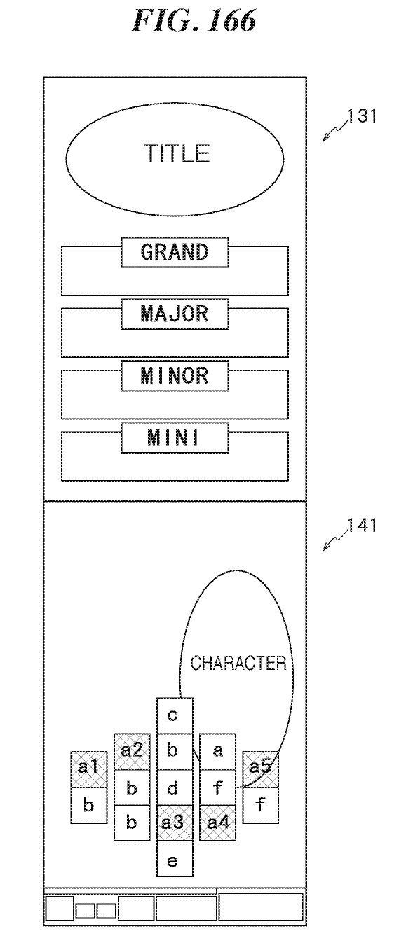

As shown in FIG. 166, animations are displayed in sequence in the order of a1->a2->a3->a4->a5. For example, an animation in which the character turns around is displayed on the a1 symbol, an animation in which the character puts a hand on the holder is displayed on the a2 symbol, an animation in which the character draw a gun is displayed on the a3 symbol, an animation in which the character shoots the gun is displayed on the a4 symbol, and an animation in which the character winks is displayed on the a5 symbol. As described above, in the slot machine 1, different animations (top symbol animations 5031 to 5035 (see FIG. 30)) are employed for different top symbols 503a rearranged in the video reels 151 to 155. In the above example, a five-frame cartoon in which the character turns around in the top symbol animation 5031 (first frame), puts a hand on the gun holder in the top symbol animation 5032 (second frame), draws a gun in the top symbol animation 5033 (third frame), shoots the gun in the top symbol animation 5034 (fourth frame) and winks in the top symbol animation 5035 (fifth frame) can be displayed. As a result, because each of the top symbol animations 5031 to 5035 on the top symbols 503a rearranged in the video reels 151 to 155 can be compared to a frame of a cartoon, a winning effect with narrativity provided by a five-frame cartoon consisting of the top symbol animations 5031 to 5035 can be produced. The animations are different from each other, but are produced so that they are repeated at the same length of time. When top symbols appear outside the panes in a mysterious manner, animations are also displayed on those parts in the same manner. At this time, a win increment is not executed yet.

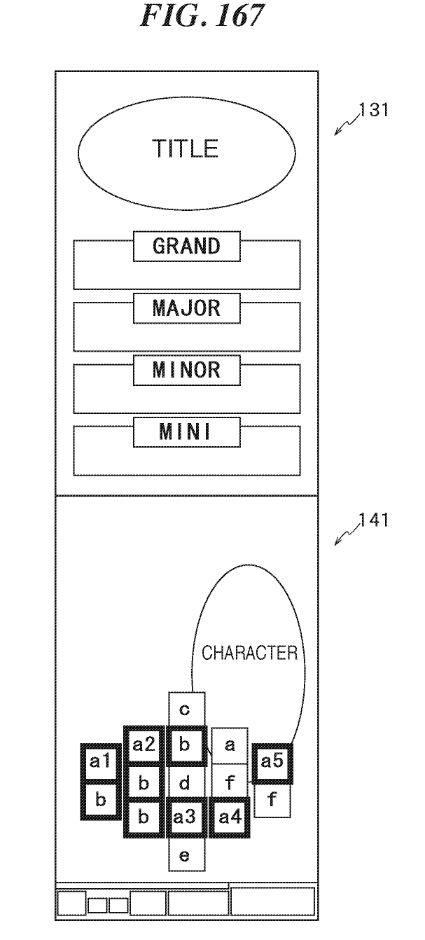

As shown in FIG. 167, all the symbols generating wins are surrounded by panes of the same color (for one second). At the same time, all the symbol animations relating to the wins are started. Animations different from those described above is displayed simultaneously on the top symbols. Here, a win increment is simultaneously executed.

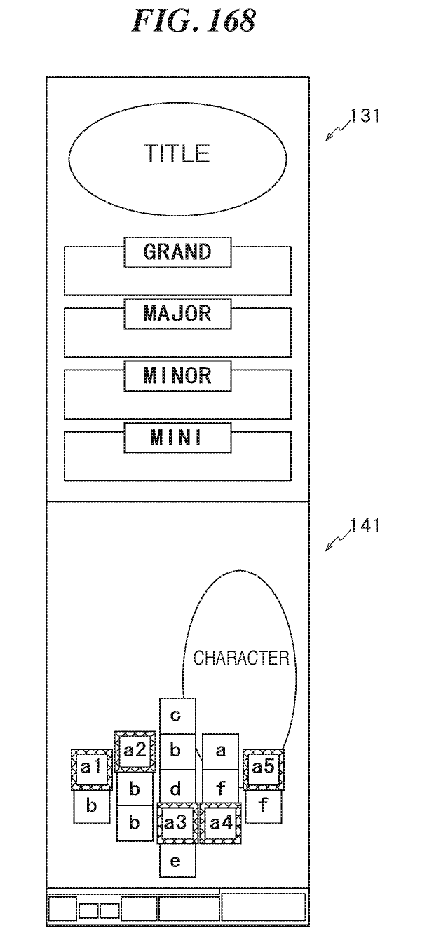

Then, as shown in FIG. 168, a win display appears for one second for each type of winning symbols. The win display appears in descending order of the dividend from the symbols.

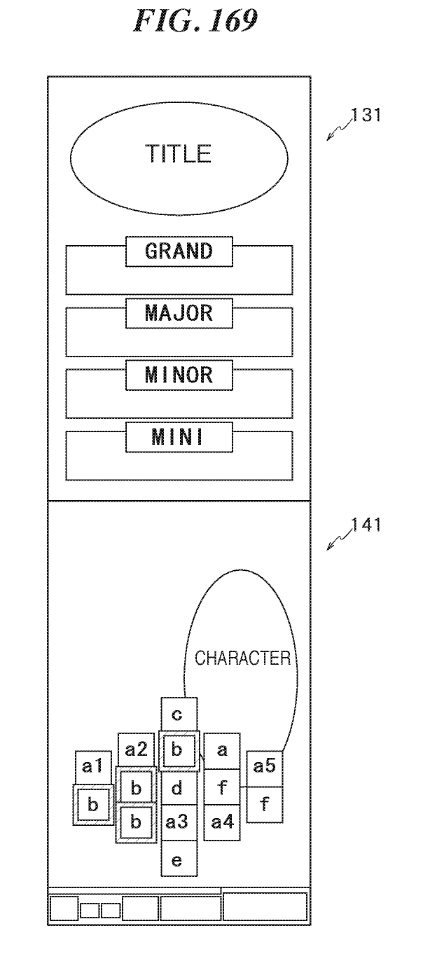

As shown in FIG. 169, the win display of the next winning symbols is started every time one second passes. The colors of the panes are set as described below. In other words, a win display is made for each type of winning symbols in the order of red->blue->yellow->pink->green->light blue->red->(thereafter, loop). When the win displays of all the winning symbols are completed, the display returns to the symbols with the highest dividend.

(WIN Effect: Pattern 2)

Next, a pattern in which there is a line dividend derived from three kinds or more of top symbols and a criterion for a BIG WIN is met (pattern 2) is described. First, the screens shown in FIG. 165 and FIG. 166 are displayed.

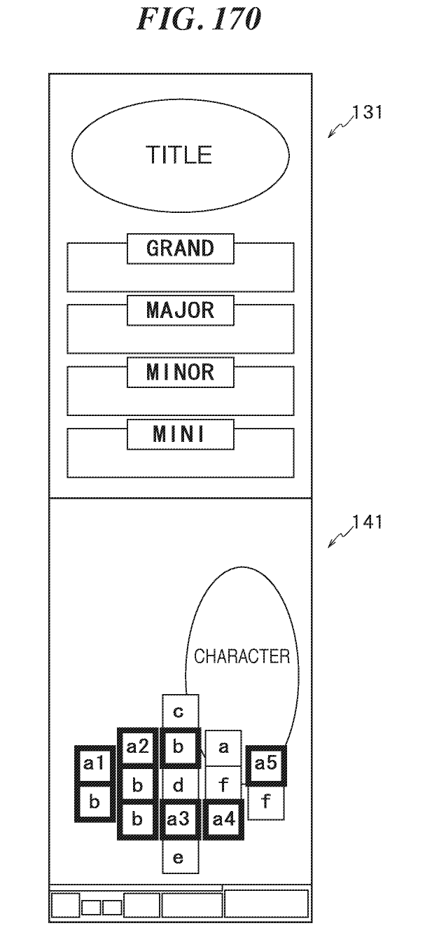

Then, as shown in FIG. 170, all the symbols generating wins are surrounded by panes of the same color (for one second). At the same time, all the symbol animations relating to the wins are started. Different animations as described above are continuously displayed simultaneously on the top symbols. Then, together with the display of the text “GREAT” or “BIG WIN,” a dedicated meter is displayed to start increment of the dividend amount. When the reel pane has been expanded to the top of the lower image display panel 141, the meter is displayed on the reel pane. The maximum digit number of the meter is set to 11. The text is selected as described below. Specifically, when the dividend amount is 50 times or more of the total bet, the text “GREAT” is used and an effect is produced in which a rain of coins and jewels falls. When the dividend amount is 25 times or more and less than 50 times the total bet, the text “BIG WIN” is used and effect is produced in which a rain of only coins falls.

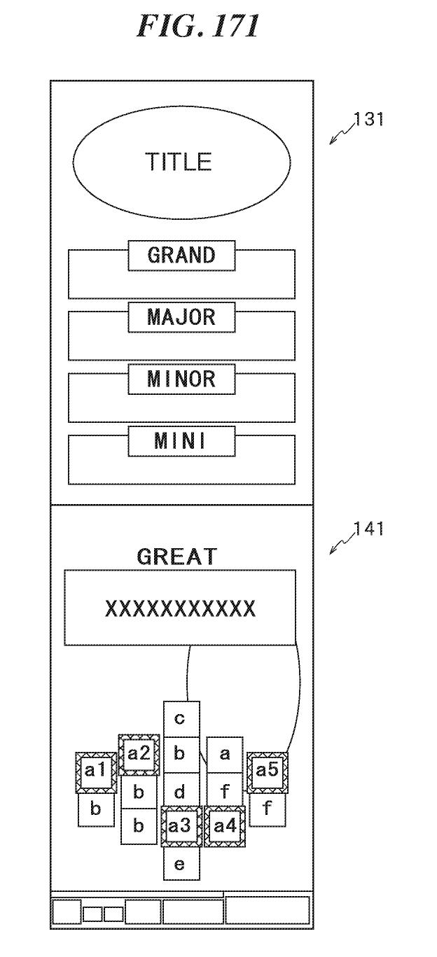

Then, as shown in FIG. 171, a win display appears for one second for each type of winning symbols. The win display appears in descending order of the dividend from the symbols. The display of the text “GREAT” or “BIG WIN” is continued until two seconds pass after the completion of the increment. Then, as shown in FIG. 169, the win display of each symbol is continued.

(WIN Effect: Pattern 3)

Next, a pattern in which there is no line dividend derived from three kinds or more of top symbols and a criterion for a BIG WIN is not met (pattern 3) is described. In pattern 3, the animations different for each reel as shown in FIG. 166 are not displayed in contrast to pattern 1. In other words, the screens shown in FIG. 165, FIG. 167, FIG. 168 and FIG. 169 are displayed.

(WIN Effect: Pattern 4)

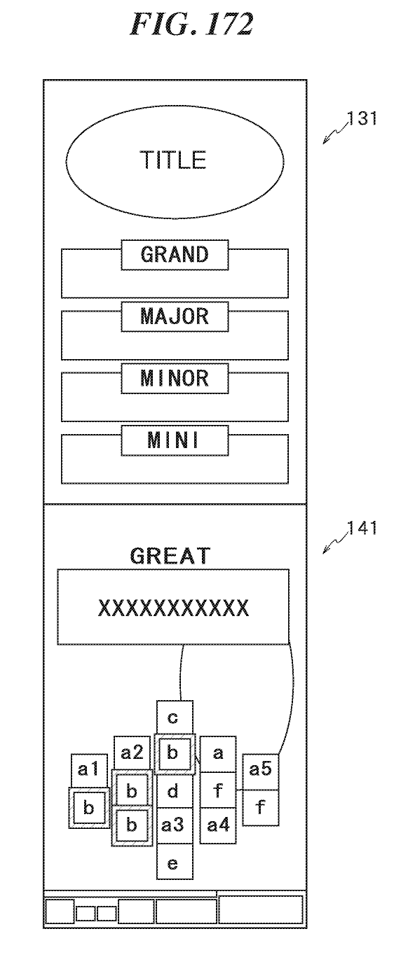

Next, a pattern in which there is no line dividend derived from three kinds or more of top symbols and a criterion for a BIG WIN is met (pattern 4) is described. In pattern 4, the animations different for each reel as shown in FIG. 166 are not displayed in contrast to pattern 2. In other words, the screens as shown in FIG. 165, FIG. 167, FIG. 171 and FIG. 172 are displayed.

(Meter Display)

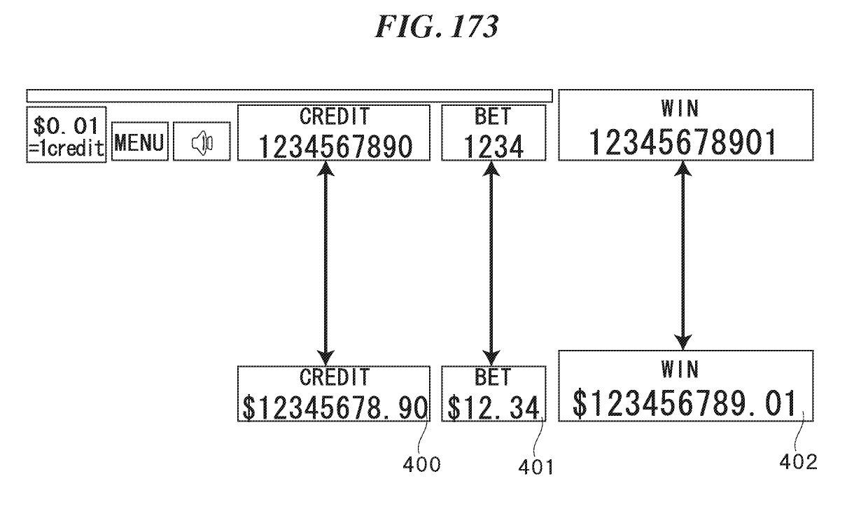

As shown in FIG. 173, the credit meter 400, the bet meter 401 and the win meter 402 may be ones in which the display unit is switched between credits and amount of money when the display part of any of the meters 400 to 402 is touched. When an amount less than one credit is stored in the slot machine 1, the unit may be automatically switched to the amount of money. The win amount in the current game is displayed on the win meter 402. While the figure displayed on the win signboard is being incremented in a game, incremental display of the figure on the win meter 402 is also carried out as the figures are linked to each other. During a free game, the sum of the dividend at the time when the free game was triggered and the win amount accumulated during the free game is displayed. Thus, a value different from the amount displayed on the win signboard is displayed. For example, when the scatter dividend at the time of trigger is 100 credits, the dividend acquired in the first spin is 30 credits and the dividend acquired in the second spin is 200 credits, incremental display of the value from 0 to 200 is carried out on the win signboard after the second spin, whereas incremental display of the value from 130 to 330 is carried out on the win meter 402. When the player wins in a gamble game, the figure on the win meter 402 is changed to a figure increased as a result of the gamble game. When the player loses in a gamble game, the figure on the win meter 402 immediately becomes zero.

The total bet amount with which the player played last is displayed on the bet meter 401. Even when the bet is changed during idling in a game in which effective lines are selectable, the figure on the bet meter 401 is not changed. Only when a game is actually played, the figure on the bet meter 401 is updated.

The figure on the credit meter 400 is updated by subtracting the bet amount simultaneously with the start of a game. When the player is awarded a prize, the amount on the win meter 402 is added to the figure on the credit meter 400. The figure on the credit meter 400 is updated to a value after the addition without incremental display.

(Touch Icon)

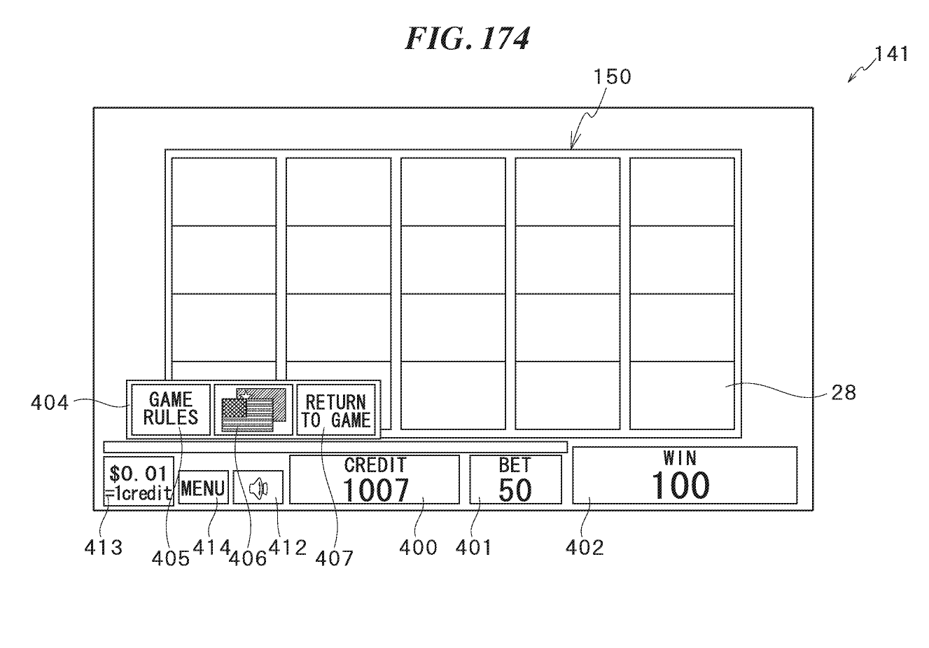

As shown in FIG. 174, when the menu touch icon 414 is manipulated by touch, a menu window 404 is displayed. A game rules icon 405, a language selection icon 406 and a return-to-game icon 407 are provided in the region of the menu window 404. When the game rules icon 405 is manipulated by touch, a help screen is displayed. When the language selection icon 406 is manipulated by touch, the display language can be switched between English and Chinese with the menu window 404 kept displayed. When the return-to-game icon 407 is manipulated by touch, the menu window 404 is cleared. The menu window 404 is also cleared when the control panel 30 is manipulated, when no manipulation is performed for 30 seconds, when a region outside the menu window 404 is touched, and when some cash is put into the gaming machine. The game rules icon 405 may be provided in place of the menu touch icon 414.

The current denomination previously set is displayed on a denomination display 413. Specifically, the denomination display 413 has an upper section and a lower section, the upper section displaying the amount of money or game points and the lower section displaying the credit number corresponding to the amount of money or game points in the upper section. The display form of the denomination may be switchable by touch manipulation of the player. The volume level touch icon 412 changes the game volume level in three levels. Every time the volume level touch icon 412 is touched, the game volume level is changed in the order of low->medium->high->low->medium-> . . . .

(Help Screen)

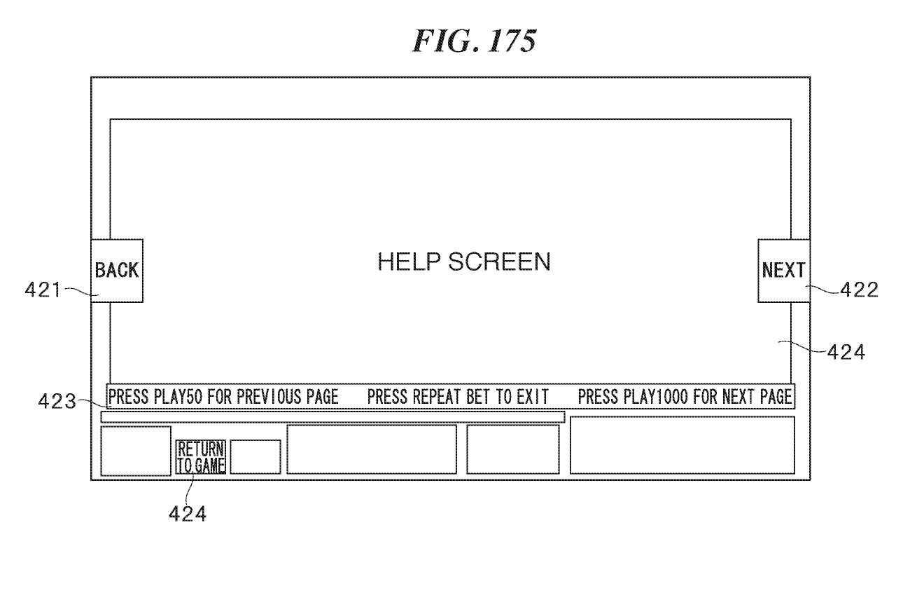

The help screen that is displayed on the lower image display panel 141 when the game rules icon 405 is manipulated by touch is described. As shown in FIG. 175, a help screen 420 is displayed at the center of the lower image display panel 141. A back touch icon 421 is displayed on the left side of the help screen 420, and a next touch icon 422 is displayed on the right side of the help screen 420. An instruction display 423 is displayed below the help screen 420. A return-to-game icon 424 is displayed in the region where the menu touch icon 414 was displayed.

A plurality of pages are switchably displayed on the help screen 420. Specifically, an explanation of the entire game, a line configuration table, an explanation of feature games, a dividend table, an explanation of icons and so on are displayed on the help screen 420. The range of credits with which the player can play (“PLAY XXX TO YYY CREDITS”) is displayed as well as a notice saying that all the dividends are paid by the slot machine 1 or an attendant. In addition, a notice saying that the display unit on the credit meter 400, the bet meter 401, and the win meter 402 can be switched between credits and amount of money when the display part of any of the meters 400 to 402 is touched is also displayed.

When the back touch icon 421 is manipulated by touch, the previous page is displayed. When the next touch icon 422 is manipulated by touch, the next page is displayed. When the return-to-game icon 424 is manipulated by touch, the help screen is terminated. The help screen may be terminated when no manipulation is performed for three minutes, when credits are input, when an error occurs, the repeat bet button 46 on the control panel is manipulated, and so on. When a game rules button for activation of the help screen is on the control panel, for example, the help screen may be terminated when this button is manipulated.

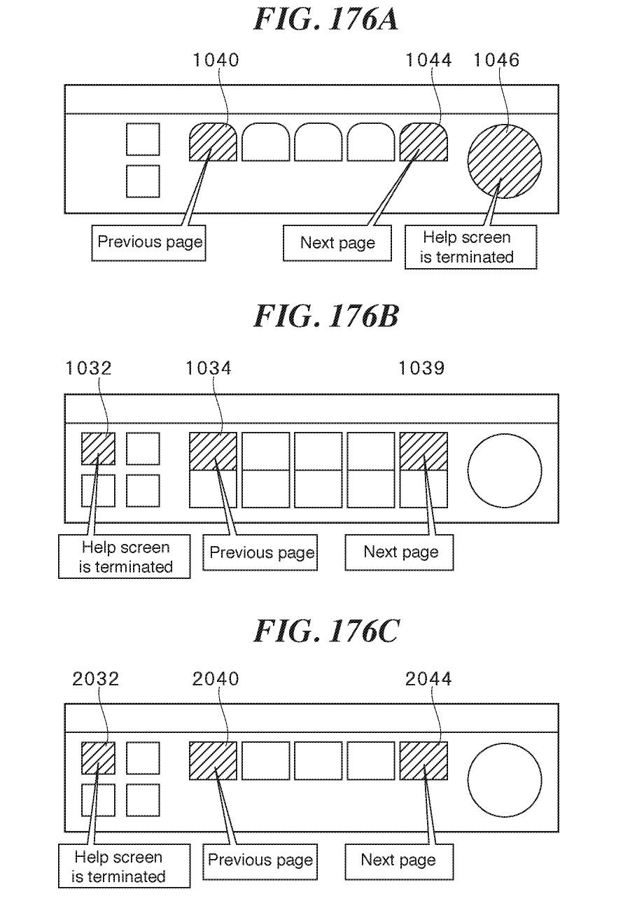

An explanation of how to use the help screen with the control panel 30 is displayed on the instruction display 423. For example, as shown in FIG. 176A, when the number of pay lines to be made effective is fixed and there are buttons for specifying only the bet number, a notice saying that the previous page is displayed by pressing a play 50 button 1040 that specifies 50 bets, the help screen is terminated by pressing a repeat bet button 1046 and the next page is displayed by pressing a play 1000 button 1044 that specifies 1000 bets is displayed on the instruction display 423. As shown in FIG. 176B, for example, when the pay lines to be made effective are selectable, a notice saying that the previous page is displayed by pressing a 1 BET button 1034 used to specify one bet for each line, the help screen is terminated by pressing the game rules button 1032 and the next page is displayed by pressing a 20 BET button 1039 used to specify 20 bets for each line is displayed on the instruction display 423. As shown in FIG. 176C, for example, when the number of pay lines to be made effective is fixed and there are buttons for specifying only the bet number, a notice saying that the previous page is displayed by pressing a play 50 button 2040 that specifies 50 bets, the help screen is terminated by pressing a game rules button 2032, and the next page is displayed by pressing a play 1000 button 2044 that specifies 1000 bets is displayed on the instruction display 423.

(Ticket Out Screen)

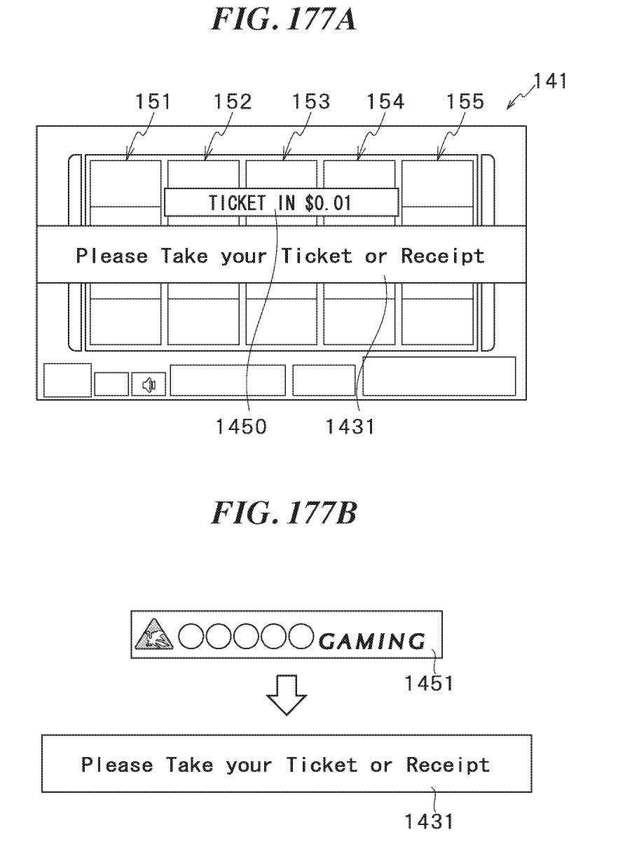

When the cashout button 32 on the control panel 30 is manipulated, a payout message is displayed together with the payout of a ticket. A message such as “CASH IN/CASH OUT” is displayed. The message is displayed at such a height that it is not hidden by a pop-up system message. Specifically, as shown in FIG. 177A, the payout message (ticket payout signboard 1431) is displayed below the system font 1450 displayed on the lower image display panel 141.

As shown in FIG. 177B, when the cashout button 32 is pressed, a payout message (ticket payout signboard 1431) of a dedicated text is displayed after a logo animation 1451 is displayed for about two seconds.

When the upper limit of payout set in the slot machine 1 is exceeded when the cashout button 32 is pressed, a call attendant screen is displayed and an attendant is called. When the slot machine 1 is reset by the called attendant, the screen as shown in FIG. 177A is displayed and a ticket is paid out. A payout message such as “Please take your Handpay Receipt” is displayed.

When the player requests payout of an amount exceeding the upper limit determined by regulations when the cashout button 32 is pressed, a call attendant screen is displayed and an attendant is called. When the slot machine 1 is reset by the called attendant, the screen, as shown in FIG. 177A, is displayed and a ticket is paid out. A payout message such as “Please take your Jackpot Receipt” is displayed.

When the entertainment facility (casino or the like) in which the slot machine 1 is installed pays outs a “PLAYABLE ONLY TICKET” as a service (without money) when, for example, a player is enrolled as a member, the screen, as shown in FIG. 177A, is displayed and a ticket is paid out. This ticket is dedicated for playing games and cannot be cashed. A payout message such as “Please take your Playable Only Ticket” is displayed.

When someone tries to insert a ticket into a printer, the screen as shown in FIG. 177A is displayed. A payout message such as “Please take your Ticket or Receipt” is displayed.

(Gamble Game)

The operation process of the gamble game is described. The limit of value a player can win in a gamble is set in AUDIT. The upper limit of the number of times a player can win in a gamble is also set in AUDIT. The number of times a player can win is at most five, and the upper limit can be set within the range. Whether the touch panel can be used or not can be changed depending on the country.

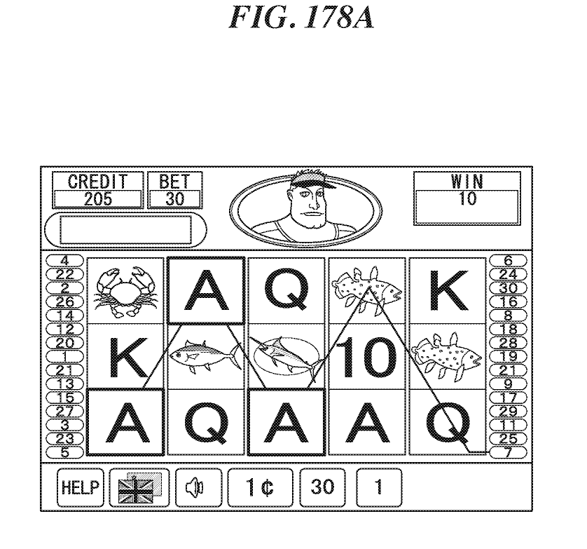

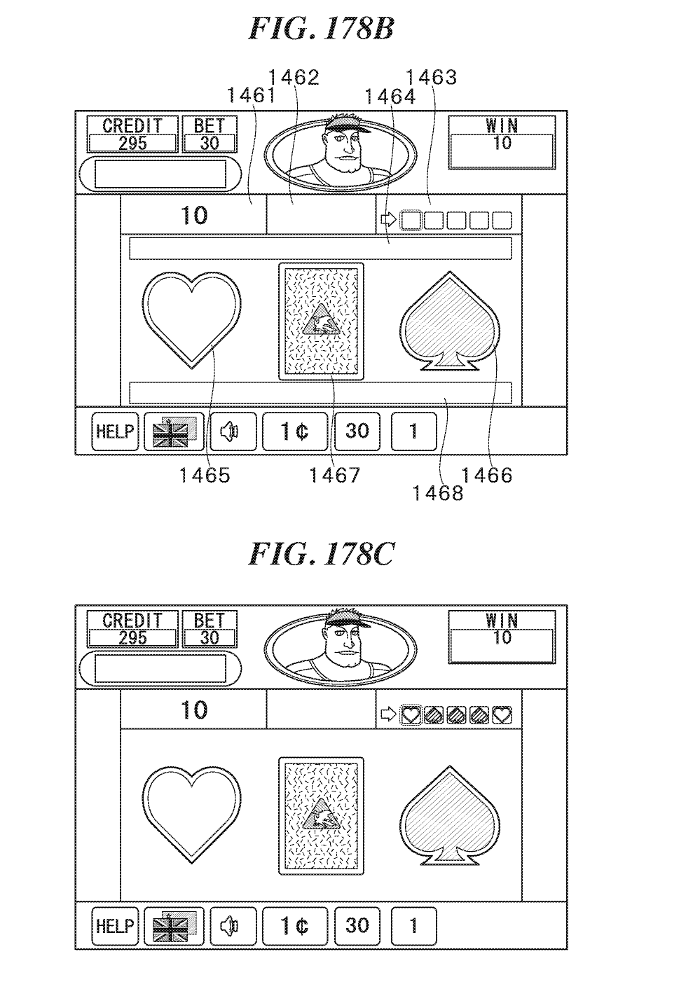

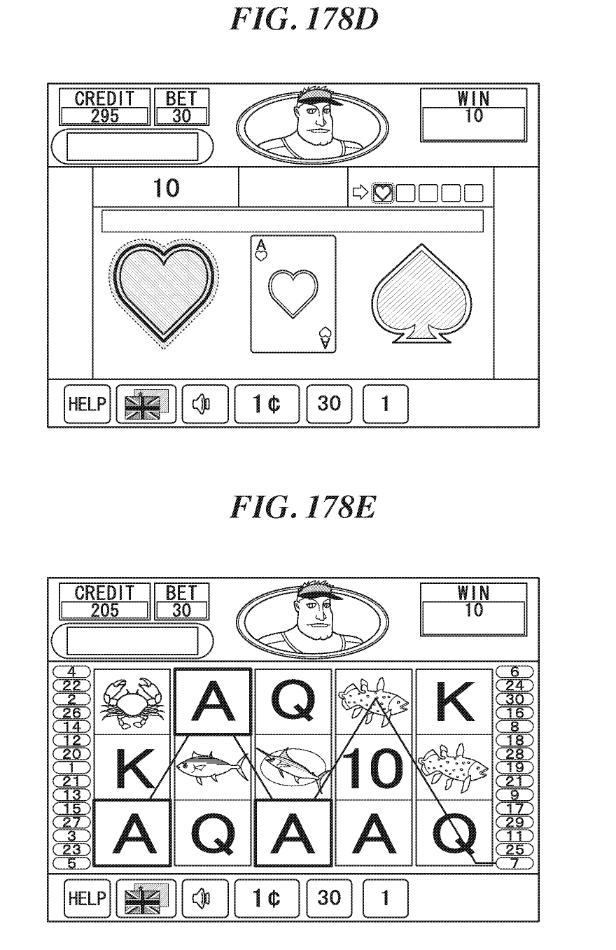

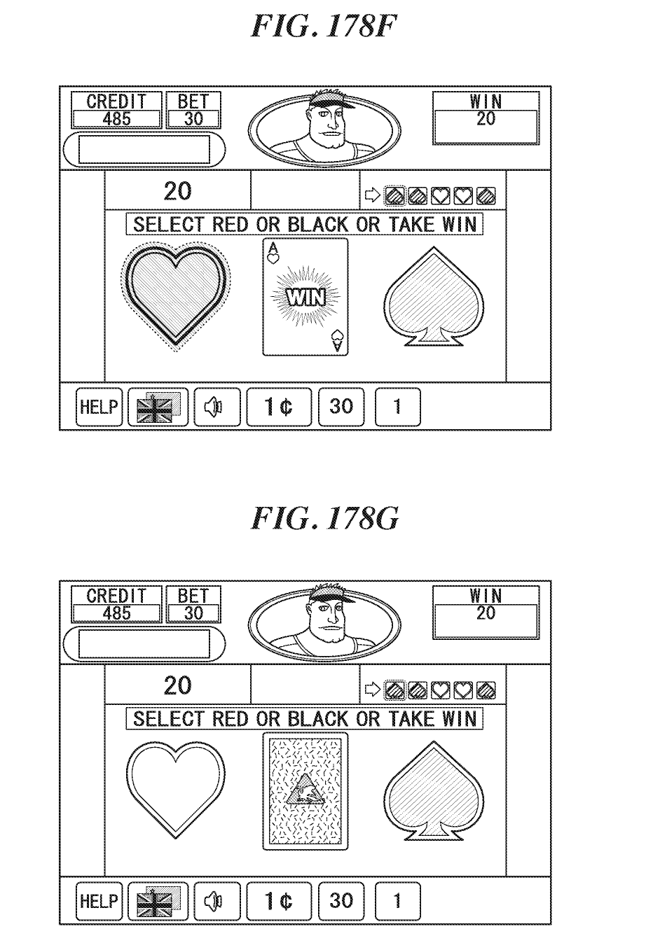

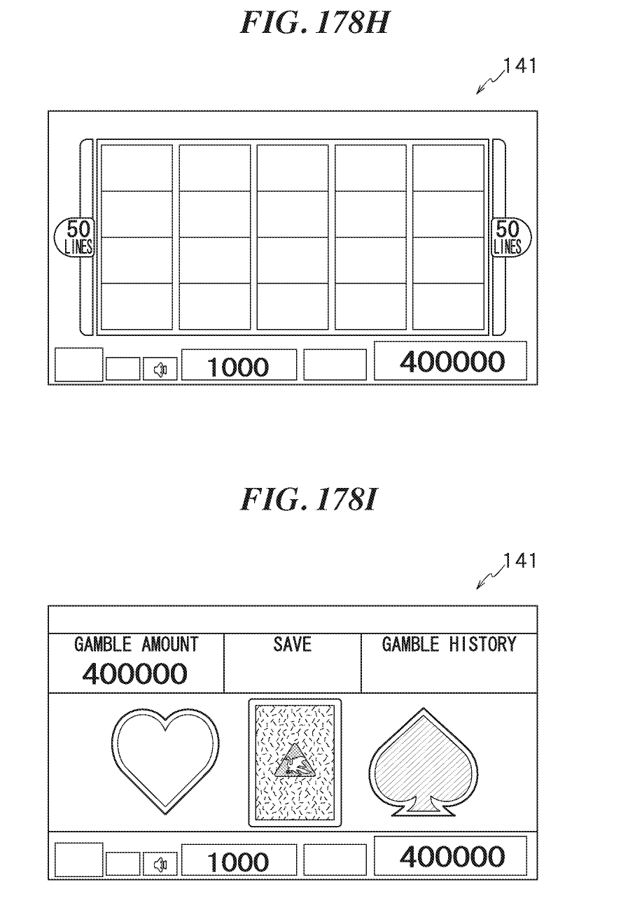

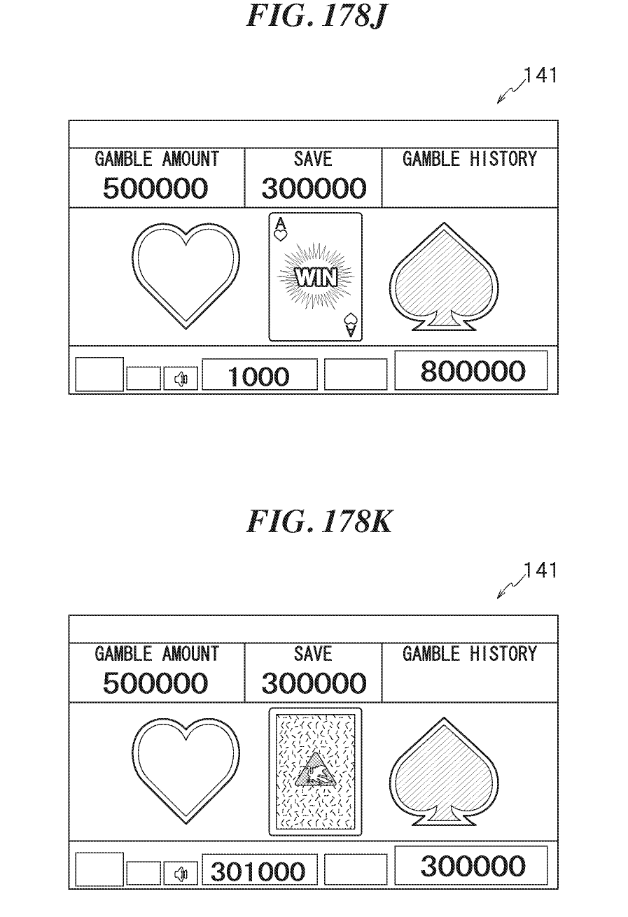

Specifically, as shown in FIG. 178A, a win is generated. Then, as shown in FIG. 178B, a gamble screen is displayed.

Now, referring to FIG. 178B, the gamble screen is described. The gamble screen includes a gamble amount 1461, a save meter 1462, a history display region 1463, a first explanation display region 1464, a red selection region 1465, a black selection region 1466, a result display region 1467, and a second explanation display region 1468.

In the gamble amount 1461, the amount of money bet in the gamble game is displayed in the units of credits or amount of money. When the player wins in the gamble game, the value shown in this region is increased. The value displayed in the gamble amount 1461 is displayed in the same unit as used in the meters 400 to 402. When the meters 400 to 402 display the number of credits, the gamble amount 1461 also displays the number of credits. When the meters 400 to 402 display the amount of money, the gamble amount 1461 also displays the amount of money.

When the WIN amount exceeds the limit of bet in a gamble game (Gamble limit), the credits corresponding to the excess is displayed on the save meter 1462. The value displayed in the save amount display region 1462 is retained. The value displayed on the save meter 1462 is displayed in the same unit as that used in the meters 400 to 402. When the meters 400 to 402 display the number of credits, the save meter 1462 also displays the number of credits. When the meters 400 to 402 display the amount of money, the save meter 1462 also displays the amount of money.

In the history display region 1463, card histories in the last five gamble games are displayed. The further to the left, the newer the displayed history is, and the further to the right, the older the displayed history is. Immediately after the program is cleared, the card histories in the history display region 1463 are empty until a gamble is played.

In the first explanation display region 1464, a message for prompting the player to select red or black or to take the win is displayed. The red selection region 1465 and the black selection region 1466 are options in a gamble game. Red or black can be selected by touching the area of either of the regions 1465 and 1466. In the result display region 1467, the color of the card (red or black) and the result of the gamble game are displayed after red or black is selected by the player. In the second explanation display region 1468, a message indicating the rules of the gamble game, the upper limit of the number of times of the gambles, and the upper limit of the money amount that can be acquired in one gamble game is displayed.

When the gamble screen as described above is displayed, a message “PLAY ON, GAMBLE or TAKE WIN” is cleared. At this time, the red button, the black button and the take win button are illuminated. The other buttons are extinguished except the change button.

As shown in FIG. 178C, the amount of bet is displayed in the gamble amount. When “red” or “black” is selected, the process proceeds to the processing for displaying the screen in FIG. 178D if the player loses, while the process proceeds to the processing for displaying the screen in FIG. 178E if the player wins. When the take win is selected, the win value is added to the credits at once, and the process returns to an idle state. At this time, when “red” or “black” is selected, the red button, the black button and the take win button are extinguished. When the take win is selected, the button LEDs also return to an idle state.

As shown in FIG. 178D, when the player loses in the gamble, the option that was not selected turns dark. The history of the card is displayed in the leftmost area of the gamble history column at once, and the previous card histories are shifted to the right. Animation is not used to show the trajectory of the shift; the card histories are shifted at once. The result of the center card is displayed at once. At this time, neither the win meter nor the gamble amount meter is changed. A fail sound is played, and the process proceeds to the processing for displaying the main game screen 1.2 seconds later. At this time, the red button, the black button, and the take win button are extinguished.

As shown in FIG. 178E, the win meter turns to 0 when the screen is changed to the main game screen. The button LEDs also return to an idle state. As shown in FIG. 178F, when the player wins in the gamble, the option that was not selected turns dark. The history of the card is displayed in the leftmost area of the gamble history column at once, and the previous card histories are shifted to the right. Animation is not used to show the trajectory of the shift; the card histories are shifted at once. After that, a normal card and a card with a text “WIN” is displayed alternately one frame at a time, and a success sound is played (for 1.2 seconds). Then, the value increased as a result of the gamble is added to the win meter at once. The gamble amount is not changed at this time.

When the number of times of the gamble played has reached the upper limit, the gaming machine returns to an idle state after the win value is added to the credits at once. When the number of times of the gamble played has not reached the upper limit, the screen changes to the one shown in FIG. 178G. At this time, the red button, the black button and take win button are extinguished.

As shown in FIG. 178F, the card is turned over. Then, the process returns to the processing for displaying the screen in FIG. 178D. At this time, when “red” or “black” is selected, the red button, the black button, and the take win button are extinguished. When take win is selected, the button LEDs also return to an idle state.

(Gamble Game: Gamble Limit)

The gamble game in a case where a win exceeding the gamble limit is generated is described. Suppose that a win worth $4000.00 is generated when the upper limit of the bet in a gamble game is set to $5000.00 as shown in FIG. 178H. When gamble is selected here, the value “400000” representing $4000.00 is displayed in the gamble amount as shown in FIG. 178I. Then, as shown in FIG. 178J, when the player wins in the gamble, the amount exceeding the maximum bet number of gamble (“300000”) is displayed on the save meter, and the maximum bet number (“500000”) is displayed in the gamble amount. In other words, $5000.00 is bet in the next gamble. The amount the player can acquire if the player decided to collect at this time is displayed on the win meter. Then, as shown in FIG. 178K, if the player loses in the next gamble, the credit amount on the win meter is changed to the saved amount, and the saved amount is added to the credit meter. Then, the screen changes to the base game screen and the game is over.

(Win Effect: Increment Speed and Win Sound)

Wins are divided into 24 ranks according to the size of win, and different increment speeds and win sounds are used depending on the rank.

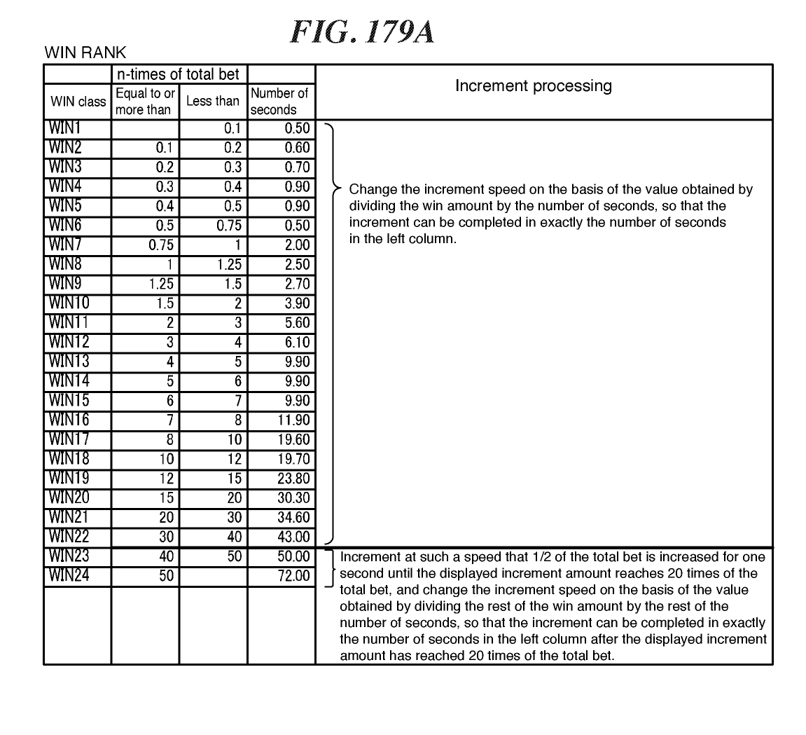

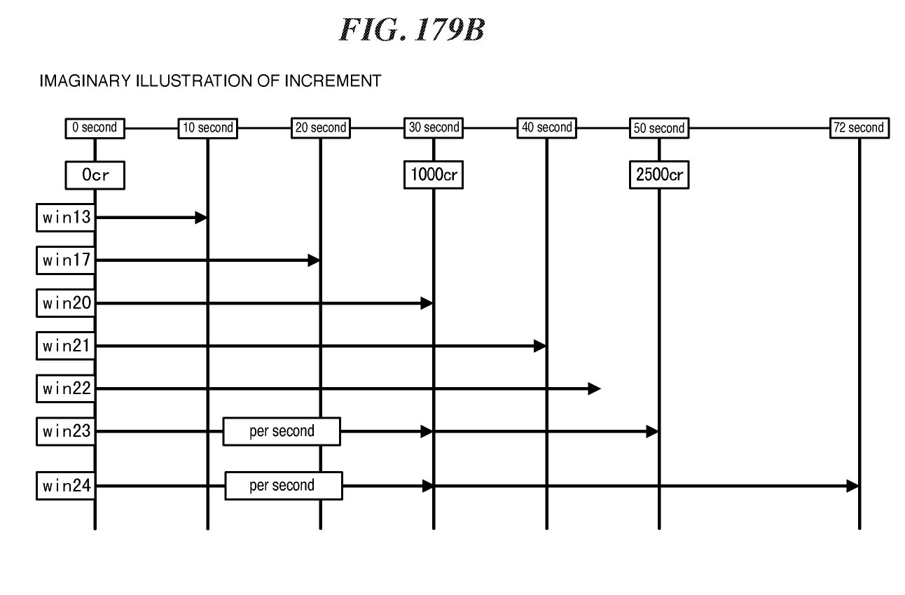

Specifically, as shown in FIG. 179A, the win rank is expressed by the relationship between the win class and the increment processing. Then, in “win 1” to “win 22,” the increment speed is changed, based on the value obtained by dividing the win amount by the number of seconds, so that the increment is completed in exactly the number of seconds. In “win 23” to “win 24,” the increment proceeds at such a speed that ½ of the total bet is increased for one second until the displayed increment amount reaches 20 times of the total bet, and the increment speed is changed, based on the value obtained by dividing the remaining win amount by the remaining number of seconds, so that the increment can be completed in exactly in the number of seconds after the displayed increment amount has reached 20 times of the total bet. As a result, the increment is carried out in an image as shown in FIG. 179B, for example. The incremental display as described above can be skipped by pressing the repeat bet button 46 or the cashout button 32. When the incremental display is skipped, the incremental display is moved on to the next step after the final figure is displayed for 0.2 seconds.

While the embodiments of the present invention have been described in the foregoing, the embodiments are intended only to show specific examples and not to limit the present invention. The specific configurations of each means and so on may be changed in design as needed. The effects described in the embodiments of the present invention are only the most desirable effects that are produced by the present invention, and the effects of the present invention are not limited to those described in the embodiments of the present invention.

In the above detailed description, emphasis is on the characteristic features so that the present invention can be understood more easily. The present invention is not limited to the embodiments described in the above detailed description, and is applicable to a wide variety of other embodiments. The terms and their usage in this specification are used to describe the present invention adequately, not to limit the interpretation of the present invention. It is believed that those skilled in the art could easily come up with other configurations, systems, methods and so on included in the concept of the present invention based on the concept of the invention described in this specification. Thus, the description in the claims shall be deemed to include equivalent construction insofar as it does not depart from the technical idea of the present invention. The purpose of the abstract is to enable technicians who belongs to the Patent Office or public institutions and to this technical field but are not familiar with patents, law terms or technical terms to understand the technical content and the essence of this application immediately through a brief study. Thus, the abstract is not intended to limit the scope of the invention which should be evaluated on the basis of the description of the claims. It is desirable that the object of the present invention and the specific effects of the present invention be interpreted in careful consideration of literature and so on that have been already disclosed in order to fully understand them.

The above detailed description includes processing that is executed in a computer. The above description and expressions are for the purpose of enabling those skilled in the art to understand the present invention most efficiency. In this specification, each processing used to derive one result should be understood to be self-consistent processing. Each processing involves transmission, reception, recording and so on of electrical or magnetic signals. While such signals are expressed in bits, values, symbols, characters, terms, figures and so on in the steps in each processing, it should be noted that these are used merely for convenience of description. While the steps in each processing may be described using expressions that are used to describe human behaviors, all the processing described in this specification is basically executed by various types of devices. Other configurations required to execute each processing will be apparent from the above description.

### DESCRIPTION OF REFERENCE NUMERALS AND SYMBOLS

1: slot machine
28: display block
28a: additional display block
30: control panel
69: touch panel
71: main CPU
131: upper image display panel
141: lower image display panel
150: symbol display region
151, 152, 153, 154, 155: video reel
501: symbol
503a: top symbol
504: feature symbol
506: cannon symbol

What is claimed is:

1. A gaming machine, comprising:
a symbol display device having a plurality of variable display regions, wherein in each of the variable display regions, after a symbol array in which symbols are arranged is variably displayed, some of the symbols arranged in the symbol array are rearranged one each in a plurality of blocks in the variable display regions; and
a controller configured to execute games and control the symbol display device according to the games,
wherein the controller awards, when a predetermined number of or more symbols of the same type are located on any of effective lines selecting one block of each of the variable display regions as a result of the rearrangement of the symbols, a line dividend according to the type of the symbols and
wherein the controller determines whether or not to expand the variable display regions to add the blocks, before the rearrangement of the symbols, and arrange top symbols with the highest line dividend in the blocks irrespective of the symbol arrays when it is determined that the blocks are added, and determines the line dividend according to effective lines based on all the blocks including the blocks added.

2. The gaming machine according to claim 1, further comprising a storage part for storing probability information for a lottery corresponding to the number of blocks to be added to each of the variable display regions,
wherein the controller determines the number of blocks to be added to each of the variable display regions on the basis of the probability information stored in the storage part when it is determined that the blocks are added.
